(19) United States
(12) Patent Application Publication
(10) Pub. No.: US 2024/0268372 A1
(43) Pub. Date: Aug. 15, 2024

(54) Methods and Compositions for Extending Organ and Tissue Preservation

(71) Applicant: The General Hospital Corporation, Boston, MA (US)

(72) Inventors: Mustafa Korkut Uygun, Newton, MA (US); Siavash Raigani, Cambridge, MA (US); Shannon Tessier, Framingham, MA (US); Heidi Yeh, Lincoln, MA (US); Casie A. Pendexter, Rockland, MA (US); Stephanie EJ Cronin, Nashville, TN (US); Reinier De Vries, Boston, MA (US); Mehmet Toner, Charlestown, MA (US)

(21) Appl. No.: 18/560,000

(22) PCT Filed: May 10, 2022
(86) PCT No.: PCT/US2022/072229

§ 371 Date: Nov. 9, 2023

Related U.S. Application Data
(60) Provisional application No. 63/186,376, filed on May 10, 2021.

(51) Int. Cl. A01N 1/02

(52) U.S. Cl. CPC A01N 1/0226; A01N 1/0221; A01N 1/0284

(57) ABSTRACT

The present disclosure relates to a perfusate, a storage solution, or a recovery solution having an apoptosis inhibitor. Also disclosed are various uses, including preserving a biological tissue sample and mitigating ischemia-reperfusion injury in such samples.

### CROSS-REFERENCE TO RELATED APPLICATION

This application claims the benefit of U.S. Provisional Patent Application No. 63/186,376, filed on May 10, 2021, which is incorporated herein by reference in its entirety.

### STATEMENT OF GOVERNMENT INTEREST

This invention was made with Government support under Contract Nos. NIH R01 DK096075, R01 DK107875, R01 DK114506, and NIH K99 HL143149 awarded by the National Institutes of Health and under Contract no. NSF-1941543 awarded by the National Science Foundation. The Government has certain rights in the invention.

### FIELD

The present disclosure relates to a perfusate, a storage solution, or a recovery solution having an apoptosis inhibitor. Also disclosed are various uses, including preserving a biological tissue sample and mitigating ischemia-reperfusion injury in such samples.

### BACKGROUND

Various strategies can be employed for tissue and organ preservation. Such strategies could address the increasing need for supply of donor tissue and organs for transplantation.

### SUMMARY

The present disclosure relates to a perfusate or a solution having an apoptosis inhibitor (e.g., a caspase inhibitor or any other described herein). In particular embodiments, such a perfusate/solution can prevent or mitigate cell injury or death in a biological tissue sample. Methods of using such a perfusate/solution, as well as various other components that can be employed within the perfusate/solution, are described herein.

In a first aspect, the present disclosure encompasses a method for preserving a biological tissue sample, the method including: providing the biological tissue sample with a perfusate or a solution including an apoptosis inhibitor for a first time period, thereby providing a treated biological tissue sample.

In some embodiments, said providing includes perfusing the biological tissue sample with the perfusate; storing the biological tissue sample in the solution; or exposing the biological tissue sample to the perfusate or the solution. In particular embodiments, the perfusate or the solution includes a normothermic perfusion solution, a subnormothermic perfusion solution, a hypothermic perfusion solution, a subzero perfusion solution, or a storage solution.

In some embodiments, said providing is conducted prior to, during, and/or after: cooling the biological tissue sample to a subnormotheric condition (e.g., from about 12° C. to 35° C. or any other temperature range described herein), a hypothermic condition (e.g., from about 0° C. to 12° C. or any other temperature range described herein), or a subzero condition (e.g., below −4° C. or any other temperature range described herein). In particular embodiments, the hypothermic condition or the subzero condition includes hypothermic cooling, supercooling, subzero non-freezing, partial freezing, cryopreservation, or vitrification.

In some embodiments, said providing includes: storing the biological tissue sample in a storage solution including a first apoptosis inhibitor; and perfusing the biological tissue sample with the perfusate including a second apoptosis inhibitor, wherein the first and second apoptosis inhibitors are same or different. In particular embodiments, said storing includes a hypothermic condition or a subzero condition (e.g., during transport).

In some embodiments, the apoptosis inhibitor is a caspase inhibitor, a BID inhibitor, a BAD inhibitor, a BAX inhibitor, a BAK inhibitor, a cytochrome C inhibitor, a cathepsin inhibitor, a granzyme B inhibitor, a pyroptosis inhibitor, and/or a necroptosis inhibitor. In other embodiments, the caspase inhibitor is a pan-caspase inhibitor. In yet other embodiments, the caspase inhibitor is emricasan (IDN-6556), VX-765 (belnacasan), Q-VD-OPh, VX-166, VX-740, GS-9540, Ac-DEVD-CHO, Ac-FLTD-CMK, Z-DEVD-FMK, INF 4E, Z-VAD-FMK, or a derivative thereof. In particular embodiments, the caspase inhibitor is a caspase 3 inhibitor, a caspase 7 inhibitor, a caspase 4 inhibitor, a caspase 8 inhibitor, a caspase 1 inhibitor, a caspase 2 inhibitor, a caspase 6 inhibitor, a caspase 9 inhibitor, or a caspase 10 inhibitor.

In some embodiments, a concentration of the caspase inhibitor is maintained during the first time period. In other embodiments, a concentration of the caspase inhibitor is altered during the first time period (e.g., increased or decreased in concentration, as compared to an initial concentration).

In some embodiments, the perfusate or the solution further includes one or more kinase inhibitors, Rho-kinase inhibitors, polyamines, integrated stress response inhibitors, reactive oxygen species scavengers, and/or antioxidants.

In some embodiments, said providing includes delivering to an in vitro system or an ex vivo system, in which the system further includes the biological tissue sample. In other embodiments, said providing includes injecting the biological tissue sample (e.g., with the perfusate or the solution).

In some embodiments, the method further includes (e.g., after said providing): loading the biological tissue sample with one or more agents (e.g., any described herein); cooling the biological tissue sample by exposure to a subnormothermic condition, a hypothermic condition, and/or a subzero condition; unloading the one or more agents from the biological tissue sample; and delivering the apoptosis inhibitor to the biological tissue sample for a second time period. In particular embodiments, a concentration of the apoptosis inhibitor is maintained or altered during the second time period. In other embodiments, the apoptosis inhibitor employed in the first time period is the same or different from the apoptosis inhibitor in the second time period.

In some embodiments, the one or more agents are selected from protectants, cryoprotectants, ice nucleators, ice modulators, oxygen carrier agents, oncotic agents, crystalloid components, colloidal components, growth factors, vasodilators, kinase inhibitors, Rho-kinase inhibitors, polyamines, integrated stress response inhibitors, reactive oxygen species scavengers, antioxidants, and combinations thereof, as well as any agent described herein.

In a second aspect, the present disclosure encompasses a method for preserving a biological tissue sample, the method including: flushing the biological tissue sample with a solution; and perfusing the biological tissue sample with a perfusate by machine perfusion, wherein at least one of the solution or the perfusate includes an apoptosis inhibitor. In particular embodiments, both the solution and the perfusate includes an apoptosis inhibitor, in which the apoptosis inhibitor in the solution and in the perfusate can be the same or different.

In some embodiments, the solution and/or the perfusate includes one or more agents selected from protectants, cryoprotectants, ice nucleators, ice modulators, oxygen carrier agents, oncotic agents, crystalloid components, colloidal components, growth factors, vasodilators, kinase inhibitors, Rho-kinase inhibitors, polyamines, integrated stress response inhibitors, reactive oxygen species scavengers, antioxidants, and/or combinations thereof, as well as any agent described herein.

In a third aspect, the present disclosure encompasses a method for preserving a biological tissue sample, the method including: storing the biological tissue sample in a solution, wherein the solution includes an apoptosis inhibitor.

In some embodiments, the solution includes one or more agents selected from protectants, cryoprotectants, ice nucleators, ice modulators, oxygen carrier agents, oncotic agents, crystalloid components, colloidal components, growth factors, vasodilators, kinase inhibitors, Rho-kinase inhibitors, polyamines, integrated stress response inhibitors, reactive oxygen species scavengers, antioxidants, and/or combinations thereof, as well as any described herein.

In a fourth aspect, the present disclosure encompasses a method for preserving a biological tissue sample, the method including:
providing the biological tissue sample with:
   an optional first perfusate or an optional first solution at a normothermic temperature;
   an optional second perfusate or an optional second solution at a subnormothermic temperature;
   a third perfusate or a third solution at a hypothermic temperature; and
   an optional fourth perfusate or an optional fourth solution at a subzero temperature;
cooling the biological tissue sample to a hypothermic temperature or a subzero temperature;
warming the biological tissue sample to a recovery temperature (e.g., a hypothermic and/or subnormothermic temperature); and
perfusing the biological tissue sample with a recovery solution, thereby providing a treated and recovered biological tissue sample.

In some embodiments, the first perfusate, the first solution, the second perfusate, the second solution, the third perfusate, the third solution, the fourth perfusate, the fourth solution, and/or the recovery solution includes an apoptosis inhibitor.

In other embodiments, the first perfusate, the first solution, the second perfusate, the second solution, the third perfusate, the third solution, the fourth perfusate, the fourth solution, and/or the recovery solution includes one or more agents selected from protectants, cryoprotectants, ice nucleators, ice modulators, oxygen carrier agents, oncotic agents, crystalloid components, colloidal components, growth factors, vasodilators, kinase inhibitors, Rho-kinase inhibitors, polyamines, integrated stress response inhibitors, reactive oxygen species scavengers, antioxidants, and combinations thereof, as well as any agent described herein.

In a fifth aspect, the present disclosure encompasses a method of mitigating ischemia-reperfusion injury in a biological tissue sample, the method including: providing (e.g., perfusing) the biological tissue sample with a perfusate or a solution including an apoptosis inhibitor for a first time period, thereby providing a treated biological tissue sample.

In some embodiments, said providing (e.g., perfusing) includes delivering (e.g., the perfusate) to an in vitro system or an ex vivo system, in which the system further includes the biological tissue sample. In other embodiments, said providing includes injecting (e.g., the perfusate) the biological tissue sample.

In a sixth aspect, the present disclosure encompasses a perfusate, a storage solution, or a recovery solution including, per 500 mL volume: between 50 nM to 100 μM of an apoptosis inhibitor; and one or more crystalloid or colloidal components (e.g., any described herein).

In a seventh aspect, the present disclosure encompasses a normothermic perfusate or a subnormothermic perfusate including, per 500 mL volume: between 50 nM to 100 μM of an apoptosis inhibitor; and a base medium (e.g., any described herein). In particular embodiments, the base medium includes Dulbecco's Modified Eagle Medium (DMEM), Williams' Medium E (WE), gelofusine, a Steen solution, reconstituted blood, a hemoglobin-based oxygen carrier, a synthetic hemoglobin substitute, a perfluorocarbon-based oxygen carrier (PFC), plasma, or a component thereof (e.g., an amino acid, a vitamin, a buffer, an inorganic salt, an oncotic agent, red blood cells, platelets, and the like).

In an eighth aspect, the present disclosure encompasses a normothermic perfusate including, per 500 mL volume: between 50 nM to 100 μM of an apoptosis inhibitor; between 50 mL and 200 mL of an oxygen carrier agent; between 1 g and 20 g of albumin; and between 1,000 and 10,000 units (U) of heparin.

In a ninth aspect, the present disclosure encompasses a subnormothermic perfusate including, per 500 mL volume: between 50 nM to 100 μM of an apoptosis inhibitor; between 1 g and 20 g of albumin; between 0 g and 50 g of poly(ethylene glycol) (e.g., 35 kDa PEG or any described herein); and between 2 g and 30 g of 3-O-methyl D-glucose.

In a tenth aspect, the present disclosure encompasses a hypothermic perfusate including, per 500 mL volume: between 50 nM to 100 μM of an apoptosis inhibitor; and a base medium (e.g., any described herein). In particular embodiments, the base medium includes a Histidine-Tryptophan-Ketoglutarate (HTK) solution, a University of Wisconsin cold storage solution (UW-CSS), a University of Wisconsin machine perfusion solution (UW-MPS), an Institute-George-Lopez (IGL-1) solution, or a component thereof (e.g., an amino acid, a vitamin, a buffer, an inorganic salt, an oncotic agent, and the like).

In an eleventh aspect, the present disclosure encompasses a hypothermic perfusate including, per 500 mL volume: between 50 nM to 100 μM of an apoptosis inhibitor; between 1 g and 20 g of albumin; between 1 g and 50 g of poly(ethylene glycol) (e.g., 35 kDa PEG or any described herein); between 1 g and 80 g of hydroxyethyl starch; between 2 g and 30 g of 3-O-methyl D-glucose; between 2 g and 30 g of raffinose; and between 5 mL and 120 mL of a cryoprotectant.

In a twelfth aspect, the present disclosure encompasses a subzero perfusate including, per 500 mL volume: between 50 nM to 100 μM of an apoptosis inhibitor; between 5 μL and 150 μL of insulin; between 0.1 g and 2 g of glutathione; between 1 g and 50 g of poly(ethylene glycol) (e.g., 35 kDa PEG); between 1 g and 80 g of hydroxyethyl starch; between 2 g and 30 g of 3-O-methyl D-glucose; between 2 g and 30 g of raffinose; between 2 g and 30 g of trehalose; between 10 mL and 120 mL of a cryoprotectant; and between 0.1 g and 2 g of an ice nucleator/modulator.

In a thirteenth aspect, the present disclosure encompasses a recovery solution including, per 500 mL volume: between 50 nM to 100 μM of an apoptosis inhibitor; between 0.1 g and 5 g of glutathione; between 1 g and 20 g of albumin; and between 0 g and 50 g of poly(ethylene glycol) (e.g., 35 kDa PEG).

In any embodiment herein, the apoptosis inhibitor can be a caspase inhibitor, a pan-caspase inhibitor, a broad spectrum caspase inhibitor, a selective caspase inhibitor, an irreversible caspase inhibitor, a reversible caspase inhibitor, a caspase 1 inhibitor, a caspase 2 inhibitor, a caspase 3 inhibitor, a caspase 4 inhibitor, a caspase 5 inhibitor, a caspase 6 inhibitor, a caspase 7 inhibitor, a caspase 8 inhibitor, a caspase 9 inhibitor, a caspase 10 inhibitor, a caspase 11 inhibitor, a caspase 12 inhibitor, or a caspase 14 inhibitor.

In any embodiment herein, the caspase inhibitor is emricasan (IDN-6556), VX-765 (belnacasan), Q-VD-OPh, VX-166, VX-740, GS-9540, Ac-DEVD-CHO, Ac-FLTD-CMK, Z-DEVD-FMK, INF 4E, Z-VAD-FMK, or a derivative thereof.

In any embodiment herein, the apoptosis inhibitor is a caspase inhibitor selected from emricasan (IDN-6556), VX-765 (belnacasan), Q-VD-OPh, VX-166, VX-740, GS-9540, Ac-DEVD-CHO, Ac-FLTD-CMK, Z-DEVD-FMK, INF 4E, Z-VAD-FMK, or a derivative thereof.

In any embodiment herein, the perfusate or the solution further includes one or more BID inhibitors, BAD inhibitors, BAX inhibitors, BAK inhibitors, cytochrome C inhibitors, cathepsin inhibitors, granzyme B inhibitors, pyroptosis inhibitors, necroptosis inhibitors, kinase inhibitors, Rho-kinase inhibitors, polyamines, integrated stress response inhibitors, reactive oxygen species scavengers, antioxidants, and/or combinations thereof.

In any embodiment herein, the perfusate or the solution further includes one or more agents. Such agents can be selected from protectants, cryoprotectants, ice nucleators, ice modulators, oxygen carrier agents, oncotic agents, crystalloid components, colloidal components, growth factors, vasodilators, kinase inhibitors, Rho-kinase inhibitors, polyamines, integrated stress response inhibitors, reactive oxygen species scavengers, and/or antioxidants, as well as combinations thereof.

In any embodiment herein, the perfusate or the solution further includes one or more agents selected from a sugar, glycerol, ethylene glycol, polyethylene glycol (PEG), 3-O-methyl-D-glucose (3-OMG), 1,2-propanediol, trehalose, dimethyl sulfoxide (DMSO), trolox (6-hydroxy-2,5,7,8-tetramethylchroman-2-carboxylic acid), 3-O-methyl-D-glucopyranose, trehalose, or combinations thereof.

In any embodiment herein, the perfusate or the solution further includes a Histidine-Tryptophan-Ketoglutarate (HTK) solution, a University of Wisconsin cold storage solution (UW-CSS), a University of Wisconsin machine perfusion solution (UW-MPS), an Institute-George-Lopez (IGL-1) solution, a Celsior solution, a Polysol solution, gelofusine, a EuroCollins (EC) solution, a hypertonic citrate/Marshalls (HOC) solution, a Steen solution, a Unisol solution, Dulbecco's Modified Eagle Medium (DMEM), Williams' Medium E (WE), reconstituted blood, a hemoglobin-based oxygen carrier, a synthetic hemoglobin substitute, a perfluorocarbon-based oxygen carrier (PFC), plasma, or a component thereof (e.g., an amino acid, a vitamin, a buffer, an inorganic salt, an oncotic agent, red blood cells, platelets, and the like).

In any embodiment herein, the perfusate or the solution further includes University of Wisconsin cold storage solution (UW-CSS), wherein the University of Wisconsin cold storage solution includes: about 100 mM potassium lactobionate, about 25 mM KH₂PO₄, about 5 mM MgSO₄, about 30 mM raffinose, about 5 mM adenosine, about 3 mM glutathione, about 1 mM allopurinol, and about 50 g/L hydroxyethyl starch.

In any embodiment herein, the biological tissue sample is a solid organ, a vascularized tissue sample, a tissue sample, a graft, or an allograft. Other non-limiting types of biological tissue samples are described herein, such as, e.g., all or part of a heart, kidney, lung, skin, ovary, pancreas, or liver, lung, skin, or bone for use in organ transplantation

In any embodiment herein, the treated biological tissue sample or the treated and recovered biological tissue sample is viable, as determined by measuring one or more of a tissue adenosine triphosphate (ATP) to adenosine monophosphate (AMP) ratio, a tissue ATP to adenosine diphosphate (ADP) ratio, lactate levels, potassium concentration, cell-free DNA (cfDNA) levels, damage-associated molecular pattern (DAMP) levels, alanine aminotransferase (ALT) levels, aspartate aminotransferase (AST) levels, tissue specific injury marker levels, bile levels, pH levels, flow rates, pressure levels, cytokine levels, caspase levels, cytokeratin levels, terminal deoxynucleotidyl transferase dUTP nick end labeling (TUNEL), swelling and weight gain, percentage of edema, vascular resistance, oxygen consumption, lactic acid dehydrogenase (LDH) levels, flavin mononucleotide (FMN) levels, and ischemia. Additional details follow.

### Definitions

Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Where values are described in the present disclosure in terms of ranges, endpoints are included. Furthermore, it should be understood that the description includes the disclosure of all possible sub-ranges within such ranges, as well as specific numerical values that fall within such ranges irrespective of whether a specific numerical value or specific sub-range is expressly stated.

Unless otherwise defined, all technical and scientific terms used herein have the same meaning as commonly understood by one of ordinary skill in the art to which this invention belongs. Methods and materials are described herein for use in the present invention; other, suitable methods and materials known in the art can also be used. The materials, methods, and examples are illustrative only and not intended to be limiting. All publications, patent applications, patents, sequences, database entries, and other references mentioned herein are incorporated by reference in their entirety. In case of conflict, the present specification, including definitions, will control. In addition, the materials, methods, and examples are illustrative only and not intended to be limiting.

Various embodiments of the features of this disclosure are described herein. However, it should be understood that such embodiments are provided merely by way of example, and numerous variations, changes, and substitutions can occur according to those skilled in the art without departing from the scope of this disclosure. It should also be understood that various alternatives to the specific embodiments described herein are also within the scope of this disclosure.

Other features and advantages of the present disclosure will be apparent from the following detailed description, the figures, and the claims.

### BRIEF DESCRIPTION OF THE DRAWINGS

The following drawings illustrate certain embodiments of the features and advantages of this disclosure. These embodiments are not intended to limit the scope of the appended claims in any manner. Like reference symbols in the drawings indicate like elements.

FIG. 1 shows a non-limiting schematic of various components in a perfusate or a solution interacting with a biological tissue sample.

FIG. 2 shows a non-limiting schematic of a protocol for preserving a biological tissue sample.

FIG. 3 shows a non-limiting schematic of pathways resulting in apoptosis, necroptosis, or pyroptosis. Provide are tissue necrosis factor (TNF) receptor; TNF-related apoptosis-inducing ligand (TRAIL) receptor; Fas ligand (FasL) receptor; Toll-like receptors (TLRs); interleukin-1 (IL-1) receptor (IL-1R); FAS-associated death domain (FADD); receptor interacting protein kinase 1 (RIPK1); receptor interacting protein kinase 3 (RIPK3); B-cell lymphoma 2 (BCL-2 or Bcl2); B-cell lymphoma-extra large (BCL-xL); Bcl2 homologous antagonist/killer (BAK); Bcl2-associated X (BAX); apoptotic protease activating factor 1 (Apaf-1); induced myeloid leukemia cell differentiation protein (MCL-1); mixed lineage kinase (MLK); pro-interleukin-18 (Pro-IL-18); interleukin-18 (IL-18); pro-interleukin-1β (Pro-IL-1β); interleukin-1β (IL-1β); gasdermin D (GSDMD); and N-terminal fragment of gasdermin D (GSDMD N′).

FIG. 4 shows a non-limiting schematic of pathways involving cell death and immune activation.

FIG. 5 shows perfusate cell death and cytokine analysis in non-viable (circle) and viable (square) livers. Provided are analysis of apoptosis biomarkers of caspase-3/7 enzyme activity (left) and cleaved cytokeratin 18 (right). Wilcoxon ranksum test (Mann-Whitney): *P<0.05.

FIG. 6 shows a non-limiting liver preservation and normothermic machine perfusion (NMP) protocol. Emricasan (5 mg/kg liver) or vehicle control (1 mL dimethyl sulfoxide (DMSO)) was added to the circulating perfusate immediately prior to connection of the liver to the NMP device. Serial tissue biopsies and perfusate samples were taken at indicated time points for subsequent analysis. * indicates a discordance between EM perfusions (bile samples taken at 3, 6, 9, and 12 hours) and control perfusions (bile samples taken at 4, 8, and 12 hours). NMP, normothermic machine perfusion; WIT, warm ischemic time; CIT, cold ischemic time; RNAseq, bulk RNA sequencing.

FIG. 7A-7H shows hepatocellular perfusion metrics during NMP. Individual liver data for emricasan-treated livers (line with triangles or no symbol). Median and interquartile ranges shown for AHF (line with squares) and IHF (line with circles) groups. Dashed black line shows the cutoff used to determine adequate hepatocellular function for A) arterial lactate, B) portal flow, C) arterial flow, and D) perfusate pH. E) Volume of bicarbonate supplementation required to maintain pH>7.3 shown for each group. Only the inadequate functioning EM liver continued to require bicarbonate after 2 hours of NMP. F) Bile production shown for each group. No significant difference was seen though to livers in the AHF group were omitted due to technical issues with bile collection. G) Data for arterial lactate and PVRw are provided for livers that were stratified as being low risk (EM1, EM2, and viable control livers) or high risk (EM3-EM5 and nonviable control livers). H) Data for arterial lactate and PVRw (at 2 hours) are provided for emricasan-treated livers and controls. NMP, normothermic machine perfusion; AHF, adequate hepatocellular function; IHF, inadequate hepatocellular function; EM, emricasan; PVRw: portal vein resistance, weight normalized.

FIG. 8 shows cholangiocellular functional criteria during liver NMP. Various cholangiocellular functional criteria were demonstrated. Technical issues with bile collection prevented accurate measurement of bile in 2 livers from the AHF group. Bile pH and bicarbonate is shown collectively for all available livers. Additional functional data comparing bile and perfusate glucose, pH, and bicarbonate are shown only for EM livers as equivalent data points were not available for the control livers. NMP, normothermic machine perfusion; AHF, adequate hepatocellular function; IHF, inadequate hepatocellular function; EM, emricasan.

FIG. 9 shows principal component (PC) and gene ontology (GO) analysis of transcriptional changes during NMP. PCA of EM, AHF, and IHF groups for PCl and PC2 at 0 (pre-perfusion), 3, 6 hours of NMP shown in (A) composite form and B) with individual EM livers. PC2 clearly distinguishes AHF from IHF livers, whereas PCl captures time-dependent transcriptional changes. The worst functioning liver (EM5) demonstrates the least transcriptional change during NMP. C) Hierarchical clustering heatmap of the top 10% of genes accounting for the variation in PC1. GO network analysis indicates PC1 is enriched for gene expression accounting for DNA transcription and RNA translation (gray networks), which is upregulated in all three groups during NMP. D) The top 10% of genes accounting for the variation in PC2 show remarkable differences between the three groups. GO network analysis indicates significant upregulation of genes involved in immune response activation and cell migration (light gray networks) in the IHF group compared to AHF and EM groups. AHF and EM groups demonstrated comparatively increased expression of genes related to mitochondrial membrane integrity (dark gray network) compared to IHF livers. AHF, adequate hepatocellular function; IHF, inadequate hepatocellular function; EM, emricasan; PC, principal component.

FIG. 10 shows gene expression and ontology analysis of principal component 3 (PC3). A) Combined and B) individual principal component plots for PC3 across PC1. C) Hierarchical clustering heatmap of the top 10% of genes accounting for the variation in PC3. GO network analysis indicates PC3 is enriched for gene expression accounting for mitosis (forest green networks) and DNA transcription (beige networks). In contrast to AHF and IHF livers, EM livers appear to demonstrate overall upregulation of mitosis-related genes. AHF, adequate hepatocellular function; IHF, inadequate hepatocellular function; EM, emricasan.

FIG. 11A-11B shows Ingenuity Pathway Analysis (IPA) of differentially expressed genes. Dot plots contain significant A) canonical pathways (CP) and B) upstream regulators (UR) for the arbitrary P value cut-off indicated in the legend (10⁻⁷ for CPs and 10⁻¹⁴ for URs). Results are shown for differentially expressed genes at 3 and 6 hours of NMP compared to the pre-perfusion (0 hour) baseline. The size of each dot represents the number of downstream target genes in our gene set that were in the IPA gene set for that CP or UR. The color of each dot represents the P value for the CP or UR. NMP, normothermic machine perfusion; AHF, adequate hepatocellular function; IHF, inadequate hepatocellular function; EM, emricasan.

FIG. 12 shows volcano plots of differentially expressed genes during NMP. A) Significant upregulated (dark gray) and downregulated (light gray) genes shown for each group at 3 and 6 hours of NMP compared to pre-perfusion. The absolute number of differentially expressed genes appeared lower in the EM compared to AHF and IHF groups. B) Select GO term volcano plots shown for comparison of EM to AHF groups at 6 hours of NMP. Significant differentially expressed genes within each GO term are labelled. Genes related to inflammatory signaling and leukocyte migration were significantly upregulated in AHF compared to EM livers. Horizontal dashed line indicates the adjusted P value (false discovery rate) cutoff of 0.05. Vertical dashed lines indicate the log 2 fold change cutoff −1 and 1. NMP, normothermic machine perfusion; GO, gene ontology; AHF, adequate hepatocellular function; IHF, inadequate hepatocellular function; EM, emricasan; ER, endoplasmic reticulum.

FIG. 13 shows selective volcano plots for all group comparisons. Individual time-point comparisons at 3 and 6 hours of NMP among all groups are demonstrated for the select gene ontology processes demonstrated in FIG. 12. Differentially expressed genes meeting the false discovery rate (FDR) >0.05 threshold are labeled. NMP, normothermic machine perfusion; AHF, adequate hepatocellular function; IHF, inadequate hepatocellular function; EM, emricasan.

FIG. 14A-14P shows perfusate cell death, cytokine analysis, and other markers. Addition of emricasan to NMP resulted in significantly lower perfusate levels of the apoptosis biomarkers A) cleaved cytokeratin 18 and B) caspase-3/7 enzyme activity. C) Cell-free DNA, a DAMP, was significantly lower in the perfusate of EM livers at 1 and 6 hours. Levels of pro-inflammatory cytokines D) interleukin-6 (IL-6), E) interleukin-8 (IL-8), and F) interferon-γ were also significantly lower in EM livers compared to control groups. Perfusate levels of G) tumor necrosis factor-α (TNF-α) and G) interleukin-1β (IL-1β) were qualitatively lower but did not reach significance. I) Heatmap of canonical pathways involved in ischemic-reperfusion injury (IRI). The significance threshold was set to −log₁₀ P value >7 for comparison of 3- and 6-hour gene sets to the pre-perfusion (0 hour) baseline for each group. Kruskal-Wallis test: ##P<0.01, #P<0.05; Wilcoxon ranksum test: **P<0.01, * P<0.05. J) Heatmap of pro-inflammatory and pro-death genes in EM-treated livers compared to controls (viable and nonviable livers), including interleukin (IL, such as IL6, IL1B, IL8, and IL10), tumor necrosis factor (TNF), interferon γ (IFNG), and caspase (CASP, such as CASP1-8). Other markers were assessed in EM-treated livers and controls (viable and nonviable livers), including K) alanine aminotransferase (ALT, left) and blood urea nitrogen (BUN, right); L) high mobility group box protein 1 (HMGB1); M) interleukin-17A (IL-17A, left) and interleukin-10 (IL-10, right); N) cathepsin D; and O) vascular endothelial cadherin (VE cadherin, left), CD31 (middle), and thrombomodulin (right). P) Histology analysis to assess the degree of inflammatory cell infiltrate, necrosis, and ischemic-reperfusion injury (IRI). NMP, normothermic machine perfusion; AHF, adequate hepatocellular function; IHF, inadequate hepatocellular function; EM, emricasan.

FIG. 15 shows downstream target gene expression for selected proinflammatory cytokine. Proinflammatory cytokines from FIG. 14A-14I were analyzed as upstream regulators in IPA for downstream target gene expression. EM livers demonstrate categorically lower enrichment of target genes compared to IHF and AHF groups. NMP, normothermic machine perfusion; AHF, adequate hepatocellular function; IHF, inadequate hepatocellular function; EM, emricasan; IPA, Ingenuity Pathway Analysis; TNF, tumor necrosis factor; IL1B, interleukin-1 J; IFNG, interferon-γ; CXCL8, C-X-C motif chemokine ligand 8 (also known as interleukin-8).

FIG. 16 shows autophagy and the unfolded protein response during liver NMP. Western immunoblots of A) phosphorylated to total protein ratio of eiF2α, B) phosphorylated to total protein ratio P70S6K, C) Beclin, and D) LC3B-II to LC3B-I ratio. E) Immunohistochemistry for LC3B demonstrating patterns of autophagosome assembly during perfusion among the three groups. F) Western immunoblots of p62. Kruskal-Wallis test: ##P<0.01, #P<0.05; Wilcoxon ranksum test: **P<0.01, *P<0.05. NMP, Normothermic machine perfusion; AHF, adequate hepatocellular function; IHF, inadequate hepatocellular function; EM, emricasan; eiF2α, eukaryotic initiation factor 2α; P70S6K, P70 S6 kinase; LC3B, microtubule-associated protein 1 light chain 3 beta.

FIG. 17 shows necroptosis and protein controls during NMP. A) Western immunoblot analysis of phosphorylated and total levels of the necroptosis marker mixed lineage kinase domain-like (MLKL). Phosphorylated MLKL protein was below the level of detection at pre-perfusion and after 6 hours of NMP. B) j-actin and glyceraldehyde-3-phosphate dehydrogenase (GAPDH) levels for all three groups. NMP, normothermic machine perfusion; AHF, adequate hepatocellular function; IHF, inadequate hepatocellular function; EM, emricasan.

FIG. 18 shows the effect of drug treatment on cell viability (left) and cell attachment (right) in primary rat hepatocytes following three days of static cold storage (SCS) at 4° C. Data are provided for hepatocytes treated with control (labeled “Control”) and with drug (labeled “Drug Treatment”). The drug included a CEPT cocktail having chroman 1 (a Rho-kinase (ROCK) inhibitor), emricasan (a pan-caspase inhibitor), polyamines (a combination of putrescine, spermidine, and spermine), and trans-integrated stress-response (ISR) inhibitor (trans-ISRIB; 2-(4-chlorophenoxy)-N-[4-[[2-(4-chlorophenoxy)acetyl]amino]cyclohexyl]acetamide, trans isomer).

FIG. 19 shows the effect of drug treatment on metabolic activity (left) and ATP luminescence (right) in primary rat hepatocytes following three days of SCS. Data are provided for hepatocytes treated with control (labeled “Control”) and with a CEPT cocktail (labeled “Drug Treatment”).

FIG. 20 shows the effect of SCS on mitochondrial membrane permeability in rat hepatocytes, which demonstrates that there is increased permeability with time during cold storage, as demonstrated by reduced uptake of the JC-1 dye. Reduced accumulation is a marker of unhealthy mitochondria/apoptosis. Provided are fluorescence microphotographs of rat hepatocytes (left) and a graph quantifying mitochondrial membrane permeability (right).

FIG. 21A-21B shows the effect of SCS at 4° C. on primary rat liver sinusoidal endothelial cells (LSECs). Provided are brightfield and fluorescence microphotographs of LSECs for (A) fresh control (first row) and 1 day at SCS (second and third rows) and (B) 3 days at SCS with a standard live/dead stain (calcein/ethidium homodimer) and nuclei stain to indicate cells (Hoescht). The results show increasing amount of cell death during three days of cold storage, and that the use of apoptosis inhibitor cocktail qualitatively increases viability of cells after three days of storage.

FIG. 22 shows non-limiting study schematic and perfusion metrics. A) Representative images of two human livers being prepared for machine perfusion. B) Study schematic indicating periods of warm and cold ischemia during procurement followed by normothermic machine perfusion. Data and sample collection time points are indicated by “x” under the perfusion time bar. C) Criteria used to determine hepatocellular function are shown for individual livers (triangle symbols: nonfunctional, circle symbols: functional). Functional livers are primarily characterized by the ability to clear lactate below the 2.5 mmol/L threshold. Dotted black line indicates criteria thresholds. *P<0.05 for group comparison at indicated time point. Lactate assay upper limit is 20 mmol/L. D) Hepatocellular necrosis scores at individual time points demonstrate no significant difference between groups. Representative H&E images of functional and nonfunctional livers are shown. Scale bar: 200 microns. CIT, cold ischemic time; H&E, hematoxylin and eosin; F, functional liver; N, nonfunctional liver; WIT, warm ischemic time.

FIG. 23 shows additional functional metrics for individual livers during NMP. A) Perfusate glucose concentrations during NMP. * indicates P<0.05 for group comparison; assay upper limit 700 mg/dL. B) Bile production and visually homogenous liver perfusion of individual livers. C) Perfusate urea concentration indicating urea synthesis in individual livers. * indicates P<0.05 for group comparison. Liver F2 6-hour perfusate sample not available. D) ALT and E) AST levels after initiation of NMP. * indicates P<0.05 for group comparison. N, nonfunctional liver; F, functional liver; T.E., technical error.

FIG. 24 shows additional cholangiocellular functional metrics. A) Bile volume and B-E) quality metrics after 4, 8, and 12 hours of NMP are shown. Liver N2 produced <1 mL of bile within the time intervals, limiting testing for some metrics. Bile collection was not possible in two livers due to technical errors. Liver F1 demonstrated persistent hemobilia after core needle biopsy, limiting accurate bile sampling. Liver F2 did not produce any bile owing to an unrecognized ductal obstruction due to the biliary cannula. N, nonfunctional liver; F, functional liver.

FIG. 25 shows a comparison of differential gene expression patterns in functional and nonfunctional livers. (A) Three-dimensional (3-D) PCA plot demonstrates clustering of individual livers at 0, 3, and 6 h of perfusion (dark gray: nonfunctional, light gray: functional). (B) Circular heatmaps for each group represent the top 10% of genes accounting for the variance in PC1. *FDR <0.05 for either 3 h vs. 0 h or 6 h vs. 0 h comparison. (C) Volcano plots (FDR vs. fold change) comparing gene expression between time points in functional and nonfunctional livers. Genes meeting the FDR cutoff <0.05 are shown in dark gray (upregulated) and light gray (downregulated); nonsignificant genes are shown in black. D) Activation Z-scores of the top significant (P<10⁻¹⁴) upstream regulators from IPA enriched in both functional and nonfunctional groups at 3 and 6 h relative to preperfusion (0 h). E) Heatmaps show differential expression of downstream gene targets for the top four upstream regulators (log₂FC shown for 3 h vs. 0 h and 6 h vs. 0 h comparisons, FDR cutoff <0.05); nonsignificant expression indicated by white space). F, functional livers; FDR, false discovery rate; IPA, ingenuity pathway analysis; N, nonfunctional livers; PCl, principal component 1; TNF, tumor necrosis factor; IL1β, interleukin 1β; NF-κB, nuclear factor-κβ subunit; IFNγ, interferon γ.

FIG. 26 shows that the top 10% of genes accounting for variation in principal component 3. Circular heatmaps display normalized expression of the genes accounting for the top 10% of variation in principal component 3 (PC3) from PCA. GO parental terms are used to categorize genes into 3 major subcategories. Differential expression did not reach significance (FDR<0.05) for any genes when compared within groups at 3 h vs 0 h or 6 h vs 0 h. GO, gene ontology.

FIG. 27 shows two-dimensional principal component analysis plots. (A) 2D plot of PC1/PC2 demonstrates close clustering of pre-perfusion (0 hour) gene sets of individual livers. Functional livers tend to cluster together after initiation of perfusion. Nonfunctional liver N1 demonstrates a similar shift in gene expression to the functional livers. (B) 2D plot of PC1/PC3 more effectively discriminates differences in the expression sets between functional and nonfunctional livers. Functional livers again cluster together, though nonfunctional livers demonstrate divergent patterns relative to one another. N, nonfunctional liver; F, functional liver.

FIG. 28 shows Ingenuity Pathway Analysis of differentially expressed genes (FDR<0.05) at 3 h and 6 h of perfusion versus 0 h in nonfunctional and functional livers. Dot plots contains significant canonical pathways (A) and upstream regulators (B) for the arbitrary P value cut-off indicated in the legend (10⁻⁷ for CPs and 10⁻¹⁹ for URs). The size of each dot represents the number of downstream targets gene in our gene set that were in the IPA gene set for that CP or UR. The color of each dot represents the P value for the CP or UR. N, nonfunctional livers; F, functional livers.

FIG. 29 shows ischemia-reperfusion injury and innate immunity in functional and nonfunctional livers. A) Heatmap displays enrichment of canonical pathways related to innate immunity derived from IPA. The significance threshold was set to −log₁₀ P value >7 for comparisons of 3- and 6-h gene sets to preperfusion (0 h) baseline for each group. Lobular (B) and portal (C) inflammatory infiltrate as scored by a blinded pathologist. Representative H&E images for functional and nonfunctional livers are displayed. Scale bars: 200 mm (lobular), 100 mm (portal). (D) Damage-associated molecular pattern (HMGB1) and oxidative stress (8-OHdG) levels in circulating perfusate. Liver F2 6-h perfusate sample not available. (E) Perfusate levels of cytokines involved in IRI response. Liver F2 6-h perfusate sample not available. F, functional livers (light gray); H&E, hematoxylin-eosin; HMGB1, high mobility group box 1; IFNγ, interferon γ; IL-6, interleukin-6; IPA, ingenuity pathway analysis; JAK/STAT, Janus kinase/signal transducer and activator of transcription; N, nonfunctional livers (dark gray); NF-κB, nuclear factor-κB subunit; 8-OHdG, 8-hydroxy-2′deoxyguanosine; TNFα, tumor necrosis factor α.

FIG. 30 shows volcano plots for untargeted perfusate proteomics. Top row: Unadjusted P-value vs. fold change for functional compared to nonfunctional livers at 1 h, 3 h, and 6 h of normothermic machine perfusion. Bottom row: Adjusted P-value (FDR) vs. fold change for the same time point comparisons. FDR cutoff<0.05 was used. Dark gray dots indicate protein enriched in perfusate of functional relative to nonfunctional livers. Light gray dots indicate protein enriched in perfusate of nonfunctional relative to functional livers. N, nonfunctional livers; F, functional livers; FDR, false discovery rate.

FIG. 31 shows activation of autophagy in response to injury and stress during NMP. (A) Western blot of phosphorylated and total eIF2α with densitometry ratios. (B) circular heatmaps demonstrating differential expression of genes associated with the GO term “autophagy” in functional and nonfunctional livers. Asterisk (*) next to gene names indicates FDR<0.05 for either 3 h vs. 0 h or 6 h vs. 0 h comparison. (C) Phospho-/total P70S6K, LC3-I/-II, and P62 Western blots for both groups with densitometry ratios. β-Actin and GAPDH levels are shown as control and demonstrate variability between human livers. (D) Representative images of LC3 immunohistochemistry shown for both groups. Scale bar: 100 mm. eIF2α, eukaryotic initiation factor 2α; FDR, false discovery rate; F, functional livers (light gray); GO, gene ontology; LC3-I/-II, light chain 3-I/II; N, nonfunctional livers (dark gray); NMP, normothermic machine perfusion.

FIG. 32 shows that nonfunctional livers demonstrate higher perfusate concentrations of lysosomal protein components. (A) Significantly enriched perfusate proteins from proteomic analysis with FDR<0.05 after 3 hours of NMP displayed. Column bars indicate log₂FC between functional and nonfunctional groups. (B) Circulating levels of cathepsin D are significantly higher after 3 hours of perfusion in the nonfunctional compared to functional livers (P=0.0495), confirming results from perfusate proteomic analysis. After 6 hours of perfusion, cathepsin D levels remain qualitatively higher, though did not reach significance due to a missing sample for liver F2. Concentrations derived by ELISA.

FIG. 33 shows prosurvival and regenerative signaling during NMP. (A) Heatmap displays enrichment of canonical pathways related to prosurvival and regenerative signaling derived from IPA. The significance threshold was set to −log₁₀ P value >7 for comparison of 3- and 6-h gene sets to the preperfusion (0 h) baseline for each group. (B) Western blot of phosphorylated and total ERK (top) with densitometry ratios (bottom). (C) Heatmap displaying differential expression of downstream ERK targets in functional and nonfunctional livers (log₂FC shown for 3 h vs. 0 h and 6 h vs. 0 h comparisons, FDR cutoff<0.05); nonsignificant expression indicated by white space). Target list derived from upstream regulator analysis in IPA. (D) Heatmap of downstream gene target differential expression for HGF. (E) Perfusate concentration of HGF in both groups after 6 and 12 h of NMP. Liver F2 6-h perfusate sample not available. F, functional livers; FDR, false discovery rate; HGF, hepatocyte growth factor; IPA, ingenuity pathway analysis; JAK/STAT, Janus kinase/signal transducer and activator of transcription; log₂FC, log₂ fold change; N, nonfunctional livers; NF-κB, nuclear factor-κB subunit; NMP, normothermic machine perfusion.

FIG. 34 shows expression heatmap of genes involved in cell cycle entry. Normalized expression of genes involved in cell cycle entry (manually curated) in functional and nonfunctional livers. No gene reached the significance cutoff (FDR<0.05) in either group for comparisons of 3 h vs 0 h or 6 h vs 0 h. N, nonfunctional livers; F, functional livers.

FIG. 35 shows that optimization of the (un)loading of cryoprotective agents improves gross outcomes after partial freezing. (a) Weight gain during SNMP recovery during the initial partial freezing protocol (left) and the optimized protocol (right). (b) Vascular resistance between the portal vein and inferior vena cava during SNMP recovery during the initial partial freezing protocol (left) and the optimized protocol (right). (c) Photo showing inhomogeneous preconditioning during with the initial protocol. (d) Photo showing the extensive and inhomogeneous injury after partial freezing using the initial protocol.

FIG. 36 shows a non-limiting partial freezing protocol. a) Schematic overview of the partial freezing protocol showing the target liver temperature, perfusion pressures during the subsequent steps in the protocol. The numbers in circles match the explanation of the protocol in the introduction and method and method section. The perfusion solutions and the rate of change between the solutions are shown in light gray. See Table 7 for the exact composition of the solutions. b) Photos of the livers during the consecutive steps of the protocol. From left to right; SNMP preloading, HMP preloading, partial freezing, CPA unloading, functional recovery during SNMP, and start of simulated transplantation. SPS, subnomothermic preconditioning solution; HPS, hypothermic preloading solution; TS, thawing solution; SNMP, subnormothermic machine perfusion; HMP, hypothermic machine perfusion; CPA, cryoprotective agent.

FIG. 37 shows the use of propylene glycol as a non-limiting permeating cryoprotective agent that improves liver function after partial freezing. Effect of permeating cryoprotective agents on liver function after partial freezing: a) weight gain as percentage of the procurement weight; b) vascular resistance between the portal vein and the intrahepatic vena cava; c) flowrate in the portal vein; d) oxygen uptake; e) lactate concentration in the portal vein; and f) bile production. Controls: 24 hours hypothermic preservation. GLY, glycerol; EG, ethylene glycol; PG, propylene glycol. Stars denote statistical significance (two-way ANOVA, followed by Tukey's post-hoc test): *0.01<p<0.05; **0.001<p<0.01; ***0.0001<p<0.001; ****p<0.0001. Boxes: median with interquartile range. Whiskers: min max.

FIG. 38 shows that liver function is impaired after partial freezing at lower temperatures but largely unaffected by extended storage durations. Provided are data regarding a) weight gain as percentage of the procurement weight; b) vascular resistance between the portal vein and the intrahepatic vena cava; c) flowrate in the portal vein; d) oxygen uptake; e) lactate concentration in the portal vein; and f) bile production. Controls: 24 hours hypothermic preservation. PG −10C 1 d, propylene glycol with 1 day at −10° C.; PG −15C 1 d, propylene glycol with 1 day at −15° C.; PG-15C 5 d, propylene glycol with 5 days at −15° C. Stars denote statistical significance (two-way ANOVA, followed by Tukey's post-hoc test): *0.01<p<0.05; **0.001<p<0.01; ***0.0001<p<0.001; ****p<0.0001. Boxes: median with interquartile range. Whiskers: min max.

FIG. 39 shows another non-limiting experimental design for partial freezing in eight consecutive steps: (1) liver procurement, (2) preconditioning during subnormothermic machine perfusion (SNMP), (3) CPA preloading during hypothermic machine perfusion (HMP), (4) loading of final storage solution and ice modulators during HMP, (5) partial freezing of rat liver, (6) thawing of rat liver, (7) unloading of cryoprotective agents (CPAs) during HMP, and (8) functional recovery of frozen rat livers during SNMP.

FIG. 40 shows perfusion metrics comparing partially frozen rat livers stored for 1 (n=6) and 5 (n=7) days at −10° C. (n=4) vs −15° C. (n=9) with 12% glycerol and 4 hours of recovery during SNMP revealed no functional differences between the groups. (A) Oxygen consumption, defined as outflow oxygen minus inflow oxygen, adjusted for liver weight and flow rate, (B) inflow lactate, (C) resistance, defined as the perfusion pressure in the PV divided by the flow rate and adjusted for liver weight after procurement, (D) percent weight gain, defined as percentage increase of liver weight at the end of recovery compared to liver weight after procurement, (E) ATP, and (F) energy charge. Two-way ANOVA, followed by Tukey's post-hoc test for (A)-(C). Unpaired two-tailed t-test for (D)-(F). Boxes: median with interquartile range. Whiskers: min to max. Significance level: p<0.05.

FIG. 41 shows perfusion metrics comparing rat livers partially frozen at −15° C. with antifreeze glycoprotein (AFGP, n=4) or with X/Z-1000 ice modulators (n=4) versus 12% glycerol control (n=13), with 4 hours of recovery during SNMP. There was higher t=0 resistance and energy charge in X/Z-1000 livers, and lower ATP levels in glycerol livers. (A) Oxygen consumption, defined as outflow oxygen minus inflow oxygen, adjusted for liver weight and flow rate, (B) portal vein (PV) lactate, (C) vascular resistance, defined as the perfusion pressure in the PV divided by the flow rate and adjusted for liver weight after procurement, (D) percent weight gain, defined as percentage increase of liver weight at the end of recovery compared to liver weight after procurement, (E) adenosine triphosphate (ATP), and (F) energy charge (EC). Stars denote statistical significance (two-way ANOVA, followed by Tukey's post-hoc test for (A)-(C), one-way ANOVA, followed by Tukey's post-hoc test for (D)-(F): *0.01<p<0.05; **0.001<p<0.01. Error bars represent standard deviation. Boxes: median with interquartile range. Whiskers: min to max.

FIG. 42 shows 40×H&E staining of rat liver parenchyma after partial freezing for 1 day (A-D) and 5 days (E-H) with X/Z-1000, AFGP ice modulators versus 12% glycerol only.

FIG. 43 shows 40×terminal deoxynucleotidyl transferase dUTP nick end labeling (TUNEL) staining of rat liver parenchyma after partial freezing for 1 day (A-D) and 5 days (E-H) with X/Z-1000, AFGP ice modulators versus 12% glycerol only.

### DETAILED DESCRIPTION

The present disclosure relates to exposing a biological tissue sample with a perfusate or a solution including an apoptosis inhibitor. In one non-limiting embodiment, a method can include perfusing the biological tissue sample with a perfusate including an apoptosis inhibitor (e.g., for a first time period), thereby providing a treated biological tissue sample. In another non-limiting embodiment, a method can include providing the perfusate or the solution to the biological tissue sample, in which the perfusate or the solution includes an apoptosis inhibitor.

Without wishing to be limited by mechanism, the use of one or more apoptosis inhibitors can reduce or prevent cell death, especially endothelial cells, as compared to cells that are not exposed to such inhibitors. Furthermore, such inhibitor(s) can be employed during any phase of processing or treating the sample having such cells, including phases such as during preconditioning and recovery during perfusion. In use, perfusates and solutions including one or more apoptosis inhibitors can be delivered to or perfused into biological tissue samples.

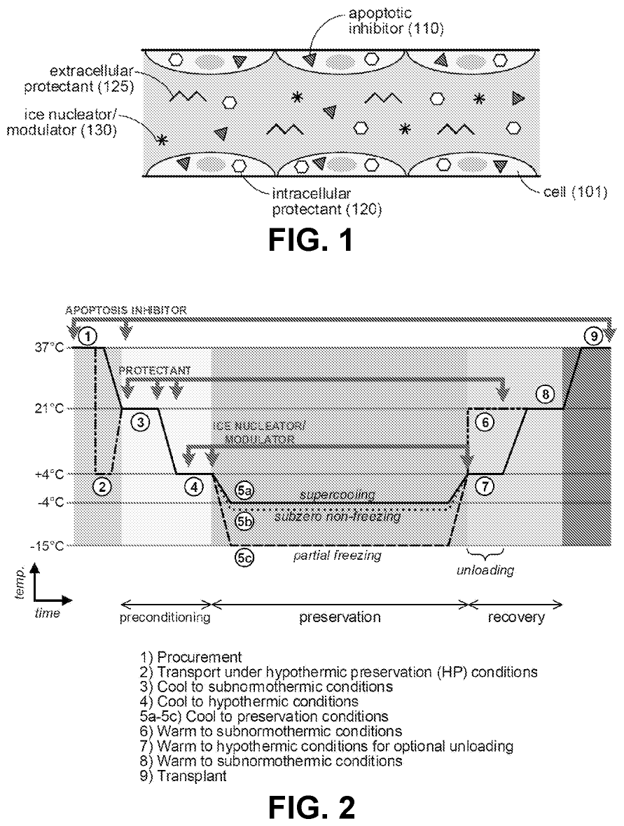

Components for perfusates and solutions are described herein. Such components can interact with the biological tissue sample to provide treated or preserved tissue samples. In one non-limiting instance, a perfusate is used to perfuse a vascularized sample. For example, FIG. 1 shows a non-limiting schematic of various components in a perfusate or a solution (used interchangeably herein) interacting with a biological tissue sample. As can be seen, the perfusate/solution can include an apoptosis inhibitor 110, which interacts with cells 101. In use, the apoptosis inhibitor can act to reduce the likelihood of cells to undergo apoptosis. Perfusates and solutions can be delivered in any useful manner, e.g., using hand flushing or machine perfusion, using injections, placing the biological tissue sample within a container holding the perfusate/solution, or otherwise exposing the biological tissue sample to the perfusate/solution.

Apoptosis inhibitors can be introduced at any useful phase of processing or treating the biological sample. FIG. 2 shows a non-limiting protocol for preserving a biological tissue sample. Such a protocol can include one or more of the following operations:
(1) procurement of the tissue sample;
(2) transport of the tissue sample, such as, e.g., optionally under hypothermic preservation (HP) or subzero conditions;
(3) cooling to subnormothermic conditions (e.g., from about 12-35° C.);
(4) cooling to hypothermic conditions (e.g., from about 0-12° C.);
(5) cooling to preservation conditions, such as to (5a) supercooling conditions,
(5b) subzero non-freezing conditions, (5c) partial freezing conditions, or other conditions, such as cryofreezing or vitrification conditions;
(6) optionally warming to subnormothermic conditions;
(7) warming to hypothermic conditions with optional unloading of agents;
(8) warming to subnormothermic conditions; and/or
(9) transplant of the tissue sample.

In general, the temperatures described herein are provided under standard pressure (e.g., about 1 atm). Such temperatures can be altered by changing the operating pressures, and the present disclosure encompasses such altered temperatures. For instance, temperature ranges can be adjusted by manipulation of pressure that the tissue is exposed to and preserved under, for instance by use of high pressure vessels, vacuum environments, or restriction of volume during phase change leading to increased pressure. In one non-limiting instance, the operations herein can be conducted under isochoric (constant-volume) conditions with optional changes in pressure. Such methods and alterations would be understood by one skilled in the art.

Operation (1) can include obtaining a biological tissue sample from a source (e.g., a subject, a tissue donor, or an organ donor, e.g., a human or non-human subject) at a normothermic temperature (e.g., about 35-40° C., e.g., about 37° C.).

Operation (2) can include transporting the sample at a temperature that is lower than a normothermic temperature (e.g., about 35-40° C., e.g., about 37° C.). A lower temperature can include a subnormothermic temperature (e.g., about 12-35° C. or about 15-25° C., e.g., about 21° C.) in a subnormothermic perfusion solution (e.g., any described herein) or a hypothermic temperature (e.g., about 2-5° C., e.g., about 4° C.) in a hypothermic perfusion solution (e.g., any described herein).

Operation (3) can include cooling or warming the sample to a subnormothermic temperature (e.g., about 12-35° C. or about 15-25° C., e.g., about 21° C.) in a subnormothermic perfusion solution, e.g., using machine perfusion.

Operation (4) can include cooling the sample from a subnormothermic temperature (e.g., about 12-35° C., or about 15-25° C., e.g., about 21° C.) to a hypothermic temperature (e.g., about 2-5° C., e.g., about 4° C.), e.g., in a subnormothermic perfusion solution or a hypothermic perfusion solution. Cooling can include perfusing (e.g., using hand flushing or machine perfusion) the biological sample with hypothermic perfusion solution (e.g., 4° C.) to allow uniform perfusion of the biological tissue sample prior to subzero preservation conditions.

Operation (5) can include cooling to any number of preservation conditions. Such preservation conditions can include supercooling (e.g., about 0° C. to −20° C., which can occur up to the heterogeneous nucleation limit; or about 0° C. to −4° C., e.g., such as in operation 5a), subzero preservation (e.g., below −4° C.; or about 0° C. to −38.15° C., which can occur up to the homogeneous nucleation limit), subzero non-freezing (e.g., about −4° C. to −10° C., such as in operation 5b; or at a temperature range that can be described as supercooling from about 0° C. to −20° C. yet at equilibrium due to use of freezing point depressants), partial freezing (e.g., about −10° C. to −20° C., such as in operation 5c; or at a temperature range in which ice has been specifically induced with control on the timing of induction and on the location within tissue, such as about 0° C. to −38.15° C.), cryofreezing or cryopreservation (e.g., about −80° C. to −150° C.; or about −38.15° C. to −146° C.), or vitrification (e.g., ice-free cryopreservation from about −80° C. to −150° C. or −80° C. to −146° C.).

Other preservation conditions can include subzero preservation in a subzero preservation solution to a subzero temperature (e.g., about −2° C. to −20° C.), as well as hypothermic cooling (e.g., about 0° C. to 12° C.). Operation (5) can include any useful cooling operation, including any cooling that occurs below +4° C. Such cooling can be performed, e.g., slowly enough to prevent freezing/formation of ice crystals, e.g., at a rate of about −0.1° C./minute) the biological tissue sample g., by a method wherein the biological tissue sample is placed in a container (e.g., an organ isolation bag), air is removed from the container to reduce liquid-air interfaces (this step is enabling to achieve supercooled preservation of the biological tissue sample), and/or the biological tissue sample is placed in a warming and/or cooling unit having temperature regulation and rate-controlled cooling (e.g., a chiller). The sample can be maintained at such temperatures for preservation for a desired amount of time.

Operations (6)-(8) include warming (slowly enough to prevent freezing/formation of ice crystals, e.g., at a rate of about −0.1° C./minute) the biological tissue sample in a preservation condition to a subnormothermic temperature (e.g., about 12-35° C., or about 15-25° C., e.g., about 21° C.) or a hypothermic temperature (e.g., about 2-5° C., e.g., about 4° C.), a hypothermic temperature (e.g., about 2-5° C., e.g., about 4° C.), e.g., by a method wherein the biological tissue sample is placed in a warming and/or cooling unit having temperature regulation and rate-controlled warming (e.g., by shutting down the chiller and allowing it to warm to a hypothermic temperature above freezing, e.g., 4° C.). Such warming can include optionally unloading of agents, which can include the use of a perfusate (e.g., a recovery solution) to remove the preservation solution from the sample. Warming (rapidly or gradually) the sample from a hypothermic temperature (e.g., about 2-5° C., e.g., about 4° C.) to a subnormothermic temperature (e.g., about 12-35° C., or about 15-25° C., e.g., about 21° C.) can include the use of a recovery solution.

Operation (9) includes further gradually or rapidly warming the sample from a subnormothermic or hypothermic temperature to a normothermic temperature. In some embodiments, the biological tissue sample is connected to the perfusion system and perfused using a solution, e.g., a subnormothermic perfusion solution or recovery solution, or another solution (e.g., blood or a blood substitute), at a normothermic temperature (e.g., 37° C.).

In any embodiment herein, the hypothermic temperature can be between about 0-12° C., 1-10° C., between 2-8° C., between 3-6° C., or about 4° C. In some embodiments, the subnormothermic temperature can be between about 12-35° C., 15-30° C., 18-25° C., or about 21° C. In some embodiments, the normothermic temperature can be between about 35° C. and 40° C., e.g., about 36° C., about 37° C., about 38° C., about 39° C., or about 40° C.

In one embodiment, subzero preservation can refer to the preservation of biological tissue samples at temperatures below the freezing temperature of water (i.e., 0° C.). Subzero preservation has the potential to extend the storage limits of biological tissue samples such as organs, as the metabolic rate halves for every 10° C. reduction in temperature, thereby reducing the rate of biological tissue sample deterioration.

In another embodiment, subzero non-freezing preservation can refer to cooling a substance such as a liquid or a liquid within a biological tissue to a temperature below its melting point (or freezing point) without solidification or crystallization (e.g., ice crystal formation). Under normal atmospheric conditions, ice transitions to water at 0° C., i.e., the melting point. Nevertheless, the observed freezing temperature for pure water is usually below the melting point. Subzero non-freezing conditions can include storage at approximately −4° C., for example, −5° C. to −3° C., −6° C. to −2° C., or −7° C. to −1° C. In some embodiments, subzero non-freezing can allow preservation at lower temperature than high subzero storage temperature (e.g., below −4° C., −5° C., −6° C., −7° C., −8° C., −9° C., −10° C., −11° C., −12° C., −13° C., −14° C., −15° C., −16° C., −17° C., −18° C., −19° C., −20° C., −25° C., −30° C., −35° C., −40° C., or even lower temperature). Subzero non-freezing preservation can include supercooling. In some embodiments, the methods can include using freezing point depressors and/or higher pressure.

During one or more of operations (1) to (9), one or more apoptosis inhibitors can be introduced to the cells (or loaded) by way of a perfusate. In one instance, the inhibitor can be introduced as soon as the tissue sample is obtained. In another instance, the inhibitor is incidentally removed during unloading and then re-introduced to the tissue sample. In yet another instance, the inhibitor is provided prior to or during more than one operation (e.g., prior to or during operation (3), prior to or during operation (6) if present, prior to or during operation (7) if present, prior to or during operation (8), and prior to operation (9)). In another instance, the inhibitor is provided after operation (1), prior to operation (3), and prior to operation (9).

The loading phase can include subjecting the biological tissue sample to normothermic machine perfusion with a normothermic perfusion, e.g., by flushing, perfusing, and/or submerging the sample with the normothermic perfusion solution at a normothermic temperature (e.g., 35-40° C., e.g., about 37° C.). The normothermic perfusion solution may optionally include one or more apoptosis inhibitors (e.g., caspase inhibitors, or any described herein).

The loading phase can include subjecting the biological tissue sample to subnormothermic machine perfusion with a subnormothermic perfusion, e.g., by flushing, perfusing, and/or submerging the sample with the subnormothermic perfusion solution and cooling to a subnormothermic temperature (e.g., 15-25° C., e.g., 21° C.). The subnormothermic perfusion solution may optionally include one or more apoptosis inhibitors (e.g., caspase inhibitors, or any described herein).

The loading phase can include subjecting the biological tissue sample to hypothermic machine perfusion with a hypothermic perfusion, e.g., by flushing, perfusing, and/or submerging the sample with the hypothermic perfusion solution and cooling to a hypothermic temperature (e.g., 2-5° C., e.g., about 4° C.). The hypothermic perfusion solution may optionally include one or more apoptosis inhibitors (e.g., caspase inhibitors, or any described herein).

In a further portion of the loading phase, the biological tissue sample can be cooled (e.g., rapidly or gradually) to a hypothermic temperature (e.g., 2-5° C., e.g., about 4° C.), e.g., with flushing, perfusing, and/or submerging the sample with the same sub-normothermic perfusion solution at about 4° C. As used herein, a hypothermic temperature is above the freezing point of water, i.e., is above 0° C. Once the hypothermic temperature is reached, the sample can be maintained at 4° C. for a selected time period, e.g., about 1 hour, e.g., 30-90 or 45-90 minutes. In some embodiments, the biological tissue sample is flushed, perfused, and/or submerged with a preservation solution as described herein and maintained at a hypothermic temperature (e.g., 2-5° C., e.g., 4° C.).

Transitions between operations can occur while ramping the temperature at certain temperature rates (e.g., cooling rates or heating rates). In addition, one or more operations may be skipped or repeated through the entire process. Furthermore, additional operations may be performed, such as storing the biological tissue sample in a storage solution. The storage solution can optionally include the apoptosis inhibitor, as well as one or more components described herein for a perfusate. Storage can occur at any useful condition (e.g., a hypothermic condition, such as during transport).

The perfusate can include other components to protect the cell. As seen in FIG. 1, the perfusate can include an intracellular protectant 120 configured to enter cells 101, an extracellular protectant 125 configured to remain outside of cells 101, and an ice nucleator or modulator 130 configured to control ice formation in proximity to the cells 101.

Such protectants and ice nucleators/modulators can be introduced at any useful phase of processing or treating the biological sample. For instance, using the operations in FIG. 2, the protectant can be provided before exposing the sample to subnormothermic samples (e.g., about 12-35° C.). In one instance, the protectant is provided prior to or during one or more operations (e.g., prior to or during operation (3), prior to or during operation (4), prior to or during operation (6) if present, and/or prior to or during operation (7) if present). Such protectants can be used in combination with one or more apoptosis inhibitors.

The ice nucleator/modulator can be provided before exposing the sample to hypothermic conditions (e.g., at or below 12° C.). In one instance, the ice nucleator/modulator is provided prior to or during one or more operations (e.g., prior to or during operation (4), prior to or during operation (5), prior to operation (6) if present, and/or prior to operation (7) if present). Such ice nucleators/modulators can be used in combination with one or more protectants and/or apoptosis inhibitors.

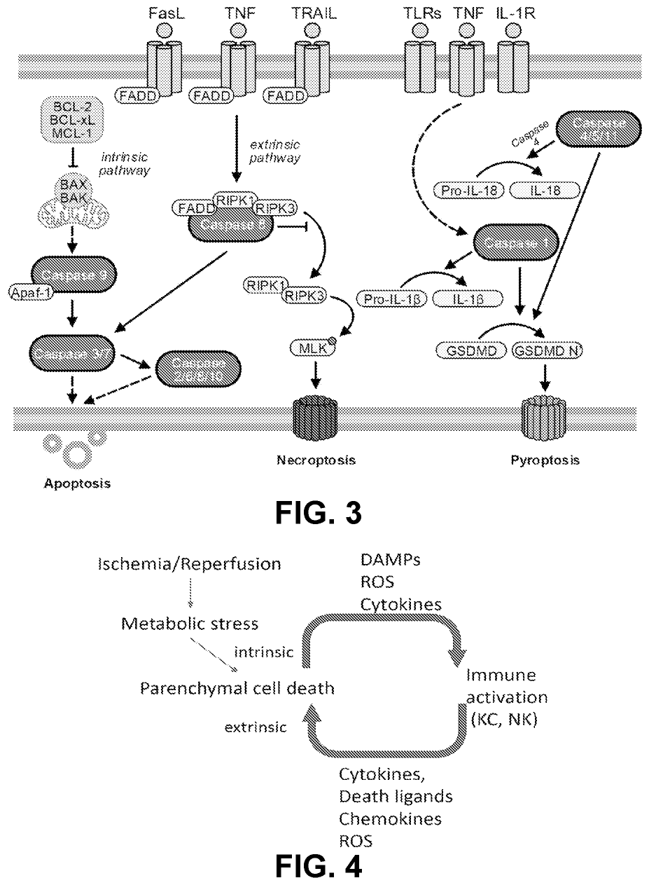

While apoptosis inhibitors are discussed herein, other inhibitors may be employed. For instance, cellular networks and proteins involved in apoptosis are also interrelated with necroptosis and pyroptosis pathways. FIG. 3 shows non-limiting pathways resulting in apoptosis, necroptosis, or pyroptosis. As can be seen, caspase 8 is involved in both apoptosis and necroptosis pathways, such that an apoptosis inhibitor that targets caspase 8 may likely affect both apoptosis and necroptosis. Accordingly, the apoptosis inhibitors herein can include an inhibitor for a protein that results in apoptosis, necroptosis, and/or pyroptosis. Such an inhibitor can include an apoptosis inhibitor, a pyroptosis inhibitor, a necroptosis inhibitor, a caspase inhibitor, a BAX inhibitor, a BAK inhibitor, a RIPK1 inhibitor, a RIPK3 inhibitor, or any other described herein.

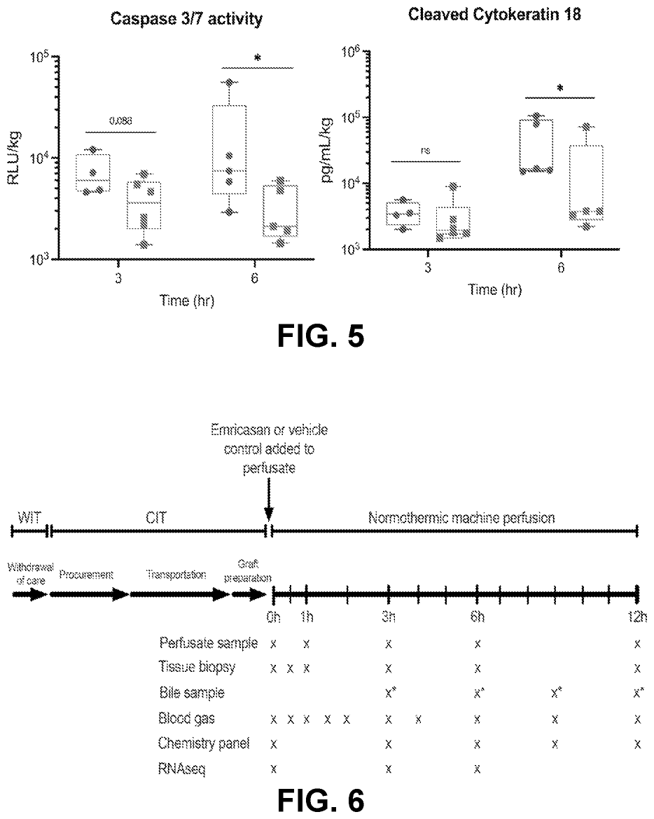

As described herein, apoptosis inhibitors can be used to shift the equilibrium between cell death (apoptosis) and autophagy. Such shifts, in turn, can result in improved cellular function of tissue samples. FIG. 4 shows a non-limiting, proposed mechanism, in which ischemia/reperfusion injury (IRI) leads to cell death, such as by way of apoptosis, necroptosis, and/or pyroptosis. This in turn can release intracellular pro-inflammatory cytokines, damage-associated molecular patterns (DAMPs), and reactive oxygen species (ROS), which activate pro-inflammatory and pro-death pathways. These cycles can repeat, thereby propagating the cycle of cell death and inflammation. Indeed, as seen in FIG. 5, non-viable tissue sample exhibited increased caspase 3/7 activity and increased presence of cleaved cytokeratin 18, which are both biomarkers for apoptosis.

### Methods

The present disclosure encompasses the use of apoptosis inhibitor(s) in the presence of a biological sample. Such use can include perfusing, delivering, exposing, or otherwise providing such inhibitor(s) in the proximity to a cell of the biological sample. Perfusing can include, e.g., delivering to sample within an in vitro system or an ex vivo system; or by direct injection into the sample. An in vitro system can include any apparatus employed in conjunction with the sample, such as to provide useful fluids, reagents, conditions (e.g., flow conditions or temperature conditions), and the like. For instance, the in vitro system can include tubing, containers, pumps, and the like to store the sample and/or to deliver a solution to a vasculature of the sample.

A solution including the apoptosis inhibitor can be employed in any useful operation. In one instance, the solution is a flush solution employed during procurement of the biological tissue sample. In another instance, the solution is a flush solution employed prior to transplant. In yet another instance, the solution is a storage solution employed during static cold storage (SCS).

The methods herein can include any useful operation(s) to preserve the biological tissue sample. For instance, the method can include perfusing the sample with the apoptosis inhibitor(s) for a first time period. The method can further include, e.g., loading the sample with one or more agents; cooling the sample by exposure to a subnormothermic condition, a hypothermic condition, and/or a subzero condition; unloading the one or more agents from the sample; and delivering the apoptosis inhibitor to the biological tissue sample for a second time period. A concentration of the apoptosis inhibitor can be maintained during the second time period to be about the same as the concentration in the first time period. Alternatively, the concentration of the apoptosis inhibitor can be altered during the second time period.

Furthermore, a temperature of the first and second time period can be the same or different. For example, the anti-apoptotic activity of the apoptosis inhibitor will likely be higher closer to physiological temperature, as compared to subnormothermic, hypothermic, or subzero zero conditions. Indeed, the apoptosis inhibitor can be delivered at any temperature during any operation and will likely become more active once the temperature rises to the levels that the compound becomes active or cellular machinery resumes. In this way, temperature can be adjusted dynamically within a particular operation of a process or during the process. The temperature can be adjusted by increasing or decreasing the temperature of a container containing the sample, or by increasing or decreasing the temperature of a perfusate being perfused through the sample.

Similarly, the dose or concentration of the apoptosis inhibitor can be adjusting dynamically within a particular operation of a process or during the process. Such adjustments can be made temporally or based on one or more readouts from one or more assays. Non-limiting assays include measuring one or more of a tissue adenosine triphosphate (ATP) to adenosine monophosphate (AMP) ratio, a tissue ATP to adenosine diphosphate (ADP) ratio, lactate levels, potassium concentration, cell-free DNA (cfDNA) levels, damage-associated molecular pattern (DAMP) levels, alanine aminotransferase (ALT) levels, aspartate aminotransferase (AST) levels, tissue specific injury marker levels, bile levels, pH levels, flow rates, pressure levels, cytokine levels, caspase levels, cytokeratin levels, terminal deoxynucleotidyl transferase dUTP nick end labeling (TUNEL), swelling and weight gain, percentage of edema, vascular resistance, oxygen consumption, lactic acid dehydrogenase (LDH) levels, flavin mononucleotide (FMN) levels, and ischemia. The concentration of the apoptosis inhibitor can be adjusted by increasing or decreasing the concentration within a perfusate, as well as by increasing or decreasing the flow rate of the perfusate being delivered to the biological tissue sample. Non-limiting DAMPs include adenosine triphosphate (ATP), amyloid beta (AD), biglycan, calreticulin, cathelicidin (LL37), cell-free DNA (cfDNA), cyclophilin A (CypA), defensins, decorin, eosinophil-derived neurotoxin, extracellular DNA, extracellular RNA, F-actin, fibronectin extra domain A (FN-EDA), fibrinogen, formyl peptide, glypicans, granulysin, heat-shock proteins (HSPs, such as HSP27, HSP40, HSP60, HSP70, and the like), heparan sulfate, histones, high-mobility group box 1 (HMGB1), high mobility group nucleosome binding domain 1 (HMGN1), interleukin-1α (IL-1α), interleukin-33 (IL-33), low molecular weight (LMW) hyaluronan, mitochondrial DNA (mtDNA), mitochondrial (TFAM), mitochondrial reactive oxygen species (mROS), purine metabolites (e.g., nucleotides, uric acid, or nucleosides), tenascin C, versican, spliceosome-associated protein 130 (SAP130), S100 proteins (e.g., S100A8, S100A9, or S100A12), syndecans, transcription factor A, uric acid, and combinations thereof.

Non-limiting examples of tissue specific injury marker levels can include levels of alanine aminotransferase (ALT), aspartate aminotransferase (AST), soluble cytokeratin-18 (CK18), fragmented CK18, soluble Fas (CD95/APO-1) receptor, Fas Ligand (FasL/CD95L), soluble tumor necrosis factor-alpha (TNF-α) receptor, TNF-α, soluble TNF-related apoptosis-inducing ligand receptor (TRAIL-R), TRAIL, high-mobility group box-1 (HMGB1) protein, small non-coding RNAs (miRNAs, e.g., miR-21, miR-34a, miR-122, miR-192, or miR-451), kidney injury molecule-1 (KIM-1), neutrophil gelatinase-associated lipocalin (NGAL), interleukin-18 (IL-18), liver-type fatty acid-binding protein (L-FABP), N-acetyl-β-D-glucosaminidase (NAG), tissue inhibitor of metalloproteinase-2 (TIMP-2), insulin-like growth factor-binding protein 7 (IGFBP7), brain-type natriuretic peptide (BNP), N-terminal prohormone of BNP (NT-proBNP), cardiac troponin T, cardiac troponin I, galectin 3 (Gal-3), growth differentiation factor 15 (GDF15), heart-type fatty acid binding protein (hFABP), mid-region of N-terminal prohormone of atrial-type natriuretic peptide (MR-proANP), myosin binding protein-C (MyBP-C), and soluble suppression of tumorigenicity 2 (sST2).

In particular embodiments, the temperature and/or the flow rate of perfusion can be attuned to deliver the inhibitor(s) effectively while minimizing additional injury to the cells. The perfusate may further include various metabolic and pharmaceutical supplements to boost this effect. Such supplements can include reactive oxygen species (ROS) scavengers, antioxidants, and the like.

The apoptosis inhibitor may be employed in one or more different operations. In one embodiment, a method can include flushing the sample with a solution; and perfusing the sample with a perfusate (e.g., by machine perfusion). In particular, at least one of the solution or the perfusate can include the apoptosis inhibitor. In other embodiments, both the solution and the perfusate can include the apoptosis inhibitor. The same or different inhibitors may be present in the solution and the perfusate. In yet other embodiments, the method can include storing the biological tissue sample in a solution, in which the solution includes the apoptosis inhibitor.

Use of the apoptosis inhibitor may preserve the tissue sample. Yet, in other embodiments, the method can mitigate or treat ischemia-reperfusion injury (IRI) in a biological tissue sample. IRI may occur during tissue procurement, transport, and may be displayed during any perfusion step during any of the steps of operation. In some embodiments, the biological tissue samples can be perfused using hypothermic machine perfusion (HMP; 0-12° C.), sub-normothermic machine perfusion (SNMP; 12-35° C.), normothermic machine perfusion (NMP; >35° C.), or using gradual rewarming whereby the temperature of the biological tissue sample is gradually raised.

In one embodiment, the method includes perfusing the biological tissue sample with a perfusate including the apoptosis inhibitor, thereby providing a treated biological tissue sample. In another embodiment, the method for mitigating IRI includes flushing the sample with a solution having the apoptosis inhibitor; and then perfusing the sample with a perfusate by machine perfusion. In yet another embodiment, the method for mitigating IRI perfusing the sample with a perfusate by machine perfusion, in which the perfusate includes the apoptosis inhibitor.

Perfusing can include the use of one or more perfusates, in which the perfusate(s) can include one or more apoptosis inhibitors. In one instance, the method can include perfusing the sample with: a first perfusate at a normothermic temperature; a second perfusate at a subnormothermic temperature; a third perfusate at a hypothermic temperature; a fourth perfusate at a subzero temperature; and/or a recovery solution. The first perfusate, the second perfusate, the third perfusate, the fourth perfusate, and/or the recovery solution can include the apoptosis inhibitor

The method can optionally further include: cooling the sample to a hypothermic temperature or a subzero temperature; and/or warming the sample to a recovery temperature (e.g., a hypothermic and/or subnormothermic temperature). Such cooling and warming can include the use of any perfusate described herein.

For any methods herein, the first perfusate/solution, the second perfusate/solution, the third perfusate/solution, the fourth perfusate/solution, and/or the recovery solution can further include one or more other agents. Such agents can be selected from protectants, cryoprotectants, ice nucleators, ice modulators, oxygen carrier agents, oncotic agents, crystalloid components, colloidal components, growth factors, vasodilators, kinase inhibitors, Rho-kinase inhibitors, polyamines, integrated stress response inhibitors, reactive oxygen species scavengers, antioxidants, and combinations thereof, as well as any described herein.

While the apoptosis inhibitor may be present in any useful perfusate or solution, it is not required to be present in every perfusate or solution employed during the preservation protocol. In some instances, the tissue sample can be flushed with a solution having one or more crystalloid components immediately before implant or transplant. Such a solution can be used to flush out the preservation solutions.

In another embodiment, the method can include: flushing the biological tissue sample with a solution; and perfusing the biological tissue sample with a perfusate (e.g., by machine perfusion), in which at least one of the solution or the perfusate comprises an apoptosis inhibitor. In particular embodiments, flushing can occur immediately before machine perfusion. In this way, an organ can be prepared for machine perfusion and then flushed with a solution, which can occur before connecting tissue sample to a machine for machine perfusion. A solution (e.g., having one or more crystalloid components, base media, or components from a base medium) can be used to flush the organ and to remove a high-potassium preservation solution. Optionally, the apoptosis inhibitor is added to the flush solution to provide a treated sample that can then be connected to the machine.

The method herein can be employed for any useful purpose. In one embodiment, the method can include altering the flow rate and/or pressure of a solution circulating in the organ to limit the vascular pressure/resistance below a threshold to minimize injury to the endothelial lining. The solution can include one or more apoptosis inhibitors, as well as other agents described herein.

In another embodiment, the method can include altering the osmolarity and/or viscosity of a solution by altering the concentration of agents to reduce cell injury due to osmotic shock, shear stress, or shearing away of the endothelial lining. The solution can include one or more apoptosis inhibitors, protectants, ice nucleator/modulators, as well as other agents described herein.

### Apoptosis Inhibitors

The present disclosure encompasses the use of one or more apoptosis inhibitors. Such inhibitors can include small molecules, chemical molecules, polymers, proteins, polynucleotides and nucleic acids (e.g., RNAs, including microRNAs) to inhibit pathways (or proteins within such pathways) for apoptosis, pyroptosis, or necroptosis (e.g., as in FIG. 3). Such inhibitors can include apoptosis inhibitors, such as emricasan (IDN-6556), VX-765 (belnacasan), Q-VD-OPh, VX-166, VX-740, GS-9540, Ac-DEVD-CHO, Ac-FLTD-CMK, Z-DEVD-FMK, INF 4E, Z-VAD-FMK, QVDOPH, ABT 199, ABT 199, BH3I 1, BI-6C9, Bim-IN-1, BT3, HA 14-1, LQZ-71, ML 311, oroxyloside, S 12, SRS11-92, YM 155 (survivin suppressant), and the like; pyroptosis inhibitors, such as MCC950 (CRID3 sodium salt), disulfiram, LDC7559, Ac-FLTD-CMK, morroniside, and the like; necroptosis inhibitors, such as GSK-074 (GSK2593074A), GSK-872, GSK-840, GSK583, GSK547, GSK2982772, GSK3145095, GSK-843, HS-1371, WEHI-345, (RIP1, RIP3, dual inhibitors), necrostatin 1, necrostatin 2, oroxyloside, RIPA-56, and the like, as well as combinations of any of these.

In particular embodiments, the inhibitor is a caspase inhibitor, a BID inhibitor, a BAD inhibitor, a BAX inhibitor, a BAK inhibitor, a cytochrome C inhibitor, a cathepsin inhibitor, or a granzyme B inhibitor.

Non-limiting caspase inhibitors include a caspase inhibitor, a pan-caspase inhibitor, a broad spectrum caspase inhibitor, a selective caspase inhibitor, an irreversible caspase inhibitor, a reversible caspase inhibitor, a caspase 1 inhibitor, a caspase 2 inhibitor, a caspase 3 inhibitor, a caspase 4 inhibitor, a caspase 5 inhibitor, a caspase 6 inhibitor, a caspase 7 inhibitor, a caspase 8 inhibitor, a caspase 9 inhibitor, a caspase 10 inhibitor, a caspase 11 inhibitor, a caspase 12 inhibitor, or a caspase 14 inhibitor. Particular caspase inhibitors include emricasan (IDN-6556), VX-765 (belnacasan), Q-VD-OPh ((3S)-5-(2,6-difluorophenoxy)-3-[[(2S)-3-methyl-2-(quinoline-2-carbonylamino)butanoyl]amino]-4-oxopentanoic acid), VX-166 ((3S)-3-[[(2S)-2-[3-(methoxycarbonylamino)-2-oxopyridin-1-yl]butanoyl]amino]-4-oxo-5-(2,3,5,6-tetrafluorophenoxy)pentanoic acid), VX-740 (pralnacasan), GS-9540 (m-PEG25-amido-PEG24-acid), Ac-DEVD-CHO (N-acetyl-Asp-Glu-Val-Asp-aldehyde), Ac-FLTD-CMK (N-acetyl-Phe-Leu-Thr-Asp-CH₂Cl), Z-DEVD-FMK (benzyloxycarbonyl-Ile-Glu-Thr-Asp-fluoromethylketone), Z-LEHD-FMK (benzyloxycarbonyl-Leu-Glu-His-Asp-fluoromethylketone), INF 4E (NLRP3-IN-9, ethyl 2-((2-chlorophenyl)(hydroxy)methyl) acrylate), Z-VAD-FMK (benzyloxycarbonyl-Val-Ala-Asp-fluoromethylketone), and the like.

The dose of an inhibitor can be about 0.1 mg/kg or greater, see, e.g., Hogel N C et al., Characterization of IDN-6556 (3-{2-(2-tert-Butylphenylaminooxalyl)-amino]-propionylamino}-4-oxo-5-(2,3,5,6-tetrafluoro-phenoxy)-pentanoic Acid): a Liver-Targeted Caspase Inhibitor, J. Pharmacol. Exp. Therap. 2003; 309:634-640, which is incorporated herein by reference in its entirety. In other embodiments, the dose is about 0.01 mg/kg to 0.5 mg/kg.

In some embodiments, the inhibitor is a BH3 interacting-domain death agonist (BID) inhibitor. Non-limiting BID inhibitors include 4-phenylsulfanyl-phenylamine derivatives, BI-6C9 (N-[4-(4-aminophenyl)sulfanylphenyl]-4-[(4-methoxyphenyl) sulfonylamino]butanamide), TC9-305 (N-((3s,5s,7s)-adamantan-1-yl)-4-((4-(1-(3,4-dimethoxybenzyl)-6-oxo-1,2,3,6-tetrahydropyridin-3-yl)-6-(trifluoromethyl)pyrimidin-2-yl)sulfonyl)butanamide), N-(2-hydroxy-5-methylphenyl)-4-((4-(thiophen-2-yl)-6-(trifluoromethyl) pyrimidin-2-yl)sulfonyl)butanamide, BI-11A7 (N-[4-[4-(4-aminophenyl) sulfanylanilino]-4-oxobutyl]-2,4-dihydroxybenzamide), 3-o-tolylthiazolidine-2,4-dione, and the like, as well as combinations thereof.

In some embodiments, the inhibitor is a Bcl-2-associated death promoter (BAD) inhibitor. Non-limiting BAD inhibitors include NPB (CS-0067927, N-cyclopentyl-3-((4-(2,3-dichlorophenyl)piperazin-1-yl)(2-hydroxyphenyl)methyl)benzamide) and the like.

In some embodiments, the inhibitor is a BAX inhibitor. Non-limiting BAX inhibitors include PD98059 (2-(2-amino-3-methoxyphenyl)-4H-1-benzopyran-4-one), vitamin E, tanshinone, BAX activation inhibitor 1 (BAI1, 1-(3,6-dibromo-9H-carbazol-9-yl)-3-(piperazin-1-yl)propan-2-ol), BAX activation inhibitor 2 (BAI2, 3,6-dibromo-9-(2-fluoro-3-piperazin-1-ylpropyl)carbazole), Bax inhibitor peptide V5, MSN-125, MSN-50, lower range of molecular weight of xanthan gum (LRWXG), and the like, as well as combinations thereof.

In some embodiments, the inhibitor is a BAK inhibitor. Non-limiting BAK inhibitors include MSN-50, MSN-125, BH3I-1, WEHI-9625, and the like, as well as combinations thereof.

In some embodiments, the inhibitor is a cytochrome C inhibitor. Non-limiting cytochrome C inhibitors include minocycline, methazolamide, gamma-tocotrienol (GTT), 3-hydroxypropyl-triphenylphosphonium (TPP)-conjugated imidazole-substituted oleic acid (TPP-IOA), TPP-conjugated imidazole-substituted stearic acid (TPP-ISA), TPP-conjugated imidazole-substituted (at position 6 of the) stearic acid (TPP-6-ISA), and the like, as well as combinations thereof.

In some embodiments, the inhibitor is a cathepsin inhibitors. Non-limiting cathepsin inhibitors include balicatib, Cathepsin Inhibitor 1, calpeptin, CA 074, E 64, L 006235, pepstatin A, SID 26681509, and the like, as well as combinations thereof.

In some embodiments, the inhibitor is a granzyme B inhibitor. Non-limiting granzyme B inhibitors include human intracellular serpin proteinase inhibitor (PI)9, VTI-1002 (viDA Therapeutics, Inc., Vancouver, BC, Canada), Z-AAD-CMK (Z-Ala-Ala-Asp-CH2Cl), Ac-IEPD-CHO (N-Acetyl-Ile-Glu-Pro-Asp-al), 3,4-dichloroisocoumarin, and the like, as well as combinations thereof.

The inhibitors herein (e.g., apoptosis, necroptosis, and/or pyroptosis inhibitors) can be employed with other agents. Such agents can include one or more kinase inhibitors (e.g., baricitinib, KX-1004, MS-265246, CCT-241533, and the like), Rho-kinase inhibitors (e.g., Rho-associated coiled-coil-forming protein serine/threonine kinase (ROCK) inhibitors, such as chroman 1, Y-27632, thiazovivin, fasudil, blebbistatin, fasudil, pinacidil, GSK 269962, SAR407899, GSK429286A, and the like), polyamines (e.g., putrescine, cadaverine, spermine, spermidine, norspermidine, and the like), integrated stress response inhibitors (trans-ISRIB, N,N′-trans-1,4-cyclohexanediylbis[2-(4-chlorophenoxy)acetamide]), as well as combinations thereof.

The inhibitors herein (e.g., apoptosis, necroptosis, and/or pyroptosis inhibitors) can be employed with reactive oxygen species (ROS) scavengers. Non-limiting ROS scavengers include glutathione, ascorbate, ascorbic acid, allopurinol, mannitol, tryptophan, dimethyl sulfoxide (DMSO), N,N′-dimethylthiourea (DMTU), pyruvate and salts thereof (e.g., sodium salts), trolox (6-hydroxy-2,5,7,8-tetramethylchroman-2-carboxylic acid), tocopherol (e.g., α-tocopherol), uric acid, sodium azide, 4,5-dihydroxybenzene-1,3-disulfonate (Tiron), carotenoids, and the like, as well as combinations thereof.

The inhibitors herein (e.g., apoptosis, necroptosis, and/or pyroptosis inhibitors) can be employed with antioxidants. Non-limiting antioxidants include coenzyme Q₁₀ (CoQ₁₀), bucillamine, ascorbic acid (vitamin C), retinol (vitamin A), vitamin E, reduced glutathione, tocopherol (e.g., α-tocopherol), a carotenoid (e.g., α-carotene, lutein, and the like), a flavonoid (e.g., luteolin, quercetin, resveratrol, and the like), proline, melatonin, quercetin, and the like.

The inhibitors herein (e.g., apoptosis, necroptosis, and/or pyroptosis inhibitors) can be employed with any useful combination of agents, such as one or more inhibitors in combination with one or more agents selected from kinase inhibitors, Rho-kinase inhibitors, polyamines, integrated stress response inhibitors reactive oxygen species (ROS) scavengers, and/or antioxidants.

### Perfusates and Solutions, as Well as Agents Thereof

The present disclosure encompasses the use of an apoptosis inhibitor within a perfusate or a solution, in which the terms “perfusate” and “solution” are used interchangeably. The perfusate can be configured in any useful manner. For instance, non-limiting perfusates include a normothermic perfusion solution, a subnormothermic perfusion solution, a hypothermic perfusion solution, or a subzero perfusion solution.

A perfusate can be understood to be any fluid capable of improving or maintaining the vitality of a cell, tissue, organ (including decellularized and recellularized organs), bioscaffold, and the like. Improving or maintaining vitality can include one or more of the following: maintenance of appropriate osmotic pressure, maintenance of appropriate oncotic pressure, maintenance of appropriate temperature, inhibition of apoptosis, inhibition of necroptosis, inhibition pyroptosis, inhibition of decay, inhibition of microbial growth, and the like. Non-limiting perfusates and their components include those described in Int. Pub. No. WO 2018/232110, which is incorporated herein by reference in its entirety.

Depending on its desired use, the perfusate may or may not include an apoptosis inhibitor. As also described herein, the perfusate can further include one or more agents selected from kinase inhibitors, Rho-kinase inhibitors, polyamines, integrated stress response inhibitors, reactive oxygen species scavengers, antioxidants, and combinations thereof. Examples of such agents are described herein.

Furthermore, the perfusate can include other further agents, such as protectants, cryoprotectants, ice nucleators, ice modulators, oxygen carrier agents, oncotic agents, crystalloid components, colloidal components, growth factors, vasodilators, and the like.

A cryoprotectant can include compounds or solutions of compounds, that can be used to perfuse, immerse, or contact a biological tissue sample (e.g., an organ or tissue) to preserve viability of the biological tissue sample, e.g., during storage at subzero temperatures. Non-limiting cryoprotectants include 3-O-methyl-D-glucose (3-OMG, e.g., 0.05-0.5 M, e.g., about 0.2 M 3-OMG), 3-O-methyl-D-glucopyranose, glycerol (GLY), ethylene glycol (EG), propylene glycol (PG), dimethyl sulfoxide (DMSO), poly(ethylene glycol) (PEG, e.g., 5-40 kD, e.g., 35 kD PEG or lower molecular weight PEGs, e.g., 8 kD, e.g., PEG 8000, PEG35000, e.g., about 0.1 to 5% w/v), poly(vinylpyrrolidone) (PVP), poly(vinyl alcohol) (PVA), polyglycerol, decaglycerol, acetol, fructose, trehalose, raffinose, sorbitol, mannitol, hydroxyethyl starch (HES), dextran, albumin, N-methyl formamide, acetamide, hydroxyurea, urea, pyridine, trolox (6-hydroxy-2,5,7,8-tetramethylchroman-2-carboxylic acid), a polymer, a starch, a sugar (e.g., 5-200 mM), a sugar alcohol, an oncotic agent, an aryl glycoside, an aryl aldonamide, an amide, and the like, as well as combinations thereof.

Non-limiting ice nucleators or ice modulators include an antifreeze glycoprotein (AFGP), inulin, a poly(vinyl alcohol) (PVA, e.g., X-1000, which is a 2 kilodalton (kDa) PVA), a polyglycerol (e.g., Z-1000), a polyvinyl alcohol/polyglycerol combination, ice nucleation protein (UniProtKB P06620), SnoMax® (a snow inducer based on proteins from Pseudomonas syringae from SnowMax LLC, Englewood, CO), IceStart™ (from Asymptote, Cambridge, UK), and the like, as well as combinations thereof. Other ice nucleators or modulators can include inorganic materials, such as soot, dust, fine particulates (microparticles, nanoparticles, mineral particles, or the like), silver iodide, silver oxide, or alumina crystals; or organic compounds, such as carbohydrates, phospholipids, proteins, alcohols, long chain aliphatic alcohols, amino acids (e.g., aspartic acid), or lipoproteins. The ice nucleator can also be microorganism, e.g., virus, bacteria (e.g., ice nucleating bacteria), or fungi.

In some embodiments, the ice nucleator, ice modulator, or cryoprotectant is a recrystallization inhibitor. Non-limiting recrystallization inhibitors include p-methoxyphenyl-β-D-galactopyranoside (β-PMP-Gal), p-methoxyphenyl-β-D-glucopyranoside (β-PMP-Glc), p-methoxyphenyl-β-D-mannopyranoside (β-PMP-Man), p-hydroxyphenyl-β-D-glucopyranoside (β-pOHPh-Glc), p-methylphenyl-β-D-glucopyranoside (β-pMePh-Glc), phenyl-β-D-glucopyranoside (β-Ph-Glc), p-nitrophenyl-β-D-glucopyranoside (β-pNO₂Ph-Glc), p-fluorophenyl-β-D-glucopyranoside (β-pFPh-Glc), p-bromophenyl-β-D-glucopyranoside (β-pBrPh-Glc), m-methoxyphenyl-β-D-glucopyranoside (β-mOMePh-Glc), p-methoxybenzyl-D-D-glucopyranoside (β-PMB-Glc), p-methoxyphenyl-2,3,4,6-tetra-O-acetyl-a-D-glucopyranoside (α-PMP-Glc), N-(4-chlorophenyl)-D-gluconamide, and the like, as well as combinations thereof.

Oxygen carrier agents may be present to deliver oxygen to the biological tissue sample. Non-limiting oxygen carrier agents include reconstituted blood, hemoglobin-based oxygen carriers (HBOC, such as, e.g., Hemopure), synthetic hemoglobin substitutes, a perfluorocarbon-based oxygen carrier (PFC), and the like.

Oncotic agents can include any biocompatible large molecule that will not go into the cells of the tissue. Non-limiting oncotic agents include albumin, starch, dextran, and the like. Oncotic agents can include polymers or colloids such as poly(ethylene glycol) (PEG), starches (e.g., pentastarch), dextran, or polysaccharides; and the oxygen carrier and the cryoprotectants can also act as oncotic agents that increase the osmolality of the solution sufficiently to pull water back from the surrounding tissues to reduce swelling.

Non-limiting crystalloid components include lactate, gluconate, acetate, bicarbonate, malate, dextrose, mannitol, cations (e.g., sodium, potassium, calcium, magnesium, and others), and the like, as well as combinations thereof.

Non-limiting colloid components include albumin, starch, dextran, and the like.

Non-limiting growth factors include epidermal growth factor (EGF, e.g., recombinant human EGF), vascular endothelial growth factor (VEGF, e.g., recombinant human VEGF), basic fibroblast growth factor (e.g., recombinant human bFGF), platelet derived growth factor (PDGF), insulin-like growth factor (IGF) (e.g., IGF-1, IGF-2), and the like, as well as combinations thereof.

Non-limiting vasodilators include BQ123, alprostadil, prostacyclin, verapamil, a prostaglandin, alpha-adrenoceptor antagonists (“alpha-blockers”), endothelin receptor antagonists (“ERAs”), angiotensin converting enzyme inhibitors (“ACE inhibitors”), and the like, as well as combinations thereof.

The apoptosis inhibitors can be combined with any agent herein, as well as with one or more components from a base medium to form a perfusate. Non-limiting base media and their components include those described in U.S. Pat. Nos. 6,395,467 and 7,741,018, each of which is incorporated herein by reference in its entirety. Such components can include one or more anti-inflammatory agents such as hydrocortisone; buffers such as phosphate buffered saline (“PBS”), Krebs-Ringer buffer (“KRB”) (available from Sigma Aldrich, Inc. of St. Louis, Mo.), and the like; amino acids such as L-arginine, L-glutamine, and the like; inorganic salts such as sodium chloride, calcium chloride, potassium chloride, and the like; substrates for metabolism, such as glucose and other carbohydrates, lactate, fatty acids, other energy sources, vitamins, and the like; hormones such as insulin; antibiotics such as penicillin and/or streptomycin; glucagon; and/or anticoagulants such as heparin.

In other embodiments, the base media can include one or more crystalloid and colloid solutions. In yet other embodiments, the base media can include an oxygen carrier agent, an albumin, and combinations thereof. In some embodiments, the base media can include reconstituted blood, red blood cells, plasma, or components therein.

In one embodiment, the perfusate or solution includes components for Dulbecco's Modified Eagle Medium (DMEM) having amino acids (e.g., glycine, arginine, cystine, glutamine, histidine, isoleucine, leucine, lysine, methionine, phenylalanine, serine, threonine, tryptophan, tyrosine, valine, salts thereof, and combinations of any of these), vitamins (e.g., choline chloride, D-calcium pantothenate, folic acid, nicotinamide, pyridoxal hydrochloride, riboflavin, thiamine hydrochloride, i-inositol, and combinations thereof), inorganic salts (e.g., calcium chloride, ferric nitrate, magnesium sulfate, potassium chloride, sodium bicarbonate, sodium chloride, sodium phosphate monobasic, and combinations thereof), about 4.5 g/L glucose, optionally about 0.11 g/L sodium pyruvate, and optionally about 15.9 mg/L phenol red.

In one embodiment, the perfusate or solution includes components for advanced Dulbecco's Modified Eagle Medium (DMEM) having amino acids (e.g., glycine, alanine, arginine, asparagine, aspartic acid, cystine, glutamic acid, histidine, isoleucine, leucine, lysine, methionine, phenylalanine, proline, serine, threonine, tryptophan, tyrosine, valine, salts thereof, and combinations of any of these), vitamins (e.g., ascorbic acid, choline chloride, D-calcium pantothenate, folic acid, niacinamide, pyridoxal hydrochloride, riboflavin, thiamine hydrochloride, i-inositol, and combinations thereof), inorganic salts (e.g., calcium chloride, ferric nitrate, magnesium sulfate, potassium chloride, sodium bicarbonate, sodium chloride, sodium phosphate monobasic, and combinations thereof), about 4.5 g/L glucose, optionally about 0.11 g/L sodium pyruvate, about 1.9 mg/L ethanolamine, about 1 mg/L glutathione, about 400 mg/L albumin, about 7.5 mg/L human transferrin, about 10 mg/L insulin, and optionally about 15 mg/L phenol red.

In one embodiment, the perfusate or solution includes components for Williams' Medium E having amino acids (e.g., glycine, alanine, arginine, asparagine, aspartic acid, cysteine, cystine, glutamic acid, histidine, isoleucine, leucine, lysine, methionine, phenylalanine, proline, serine, threonine, tryptophan, tyrosine, valine, salts thereof, and combinations of any of these), vitamins (e.g., ascorbic acid, biotin, choline chloride, D-calcium pantothenate, ergocalciferol, folic acid, menadione sodium bisulfate, niacinamide, pyridoxal hydrochloride, riboflavin, thiamine hydrochloride, vitamin A (acetate), vitamin B12, alpha tocopherol, i-inositol, and combinations thereof), inorganic salts (e.g., calcium chloride, cupric sulfate, ferric nitrate, magnesium sulfate, manganese chloride, potassium chloride, sodium bicarbonate, sodium chloride, sodium phosphate monobasic, zinc sulfate, and combinations thereof), about 2 g/L glucose, about 0.05 mg/L glutathione (reduced), about 0.03 mg/L methyl linoleate, optionally about 10 mg/L phenol red, and about 25 mg/L sodium pyruvate.

In one embodiment, the perfusate or solution includes components for a University of Wisconsin (UW) cold storage solution (UW-CSS) having about 50 g/L hydroxyethyl starch (HES), about 100 mM lactobionate, about 30 mM raffinose, about 25 mM KH₂PO₄, about 5 mM MgSO₄, about 5 mM adenosine, about 3 mM glutathione, and about 1 mM allopurinol.

In one embodiment, the perfusate or solution includes components for a University of Wisconsin (UW) gluconate solution (UW-G) having about 100 mM gluconate, about 25 mM KH₂PO₄, about 5 mM MgSO₄, about 30 mM raffinose, about 5 mM adenosine, about 3 mM glutathione, about 1 mM allopurinol, and about 50 g/L hydroxyethyl starch.

In one embodiment, the perfusate or solution includes components for a University of Wisconsin (UW) machine perfusion solution (UW-MPS) having about 50 g/L hydroxyethyl starch, about 30 mM mannitol, about 85 mM gluconate, about 5 mM ribose, about 10 mM dextrose or glucose, about 25 mM KH₂PO₄, about 10 mM HEPES (4-(2-hydroxyethyl)-1-piperazineethanesulfonic acid), about 5 mM adenine, and about 3 mM glutathione.

In one embodiment, the perfusate or solution includes components for a Histidine-Tryptophan-Ketoglutarate (HTK) solution having about 38 mM mannitol, about 180 mM histidine, about 2 mM tryptophan, and about 1 mM ketoglutarate.

In one embodiment, the perfusate or solution includes components of a Custodiol HTK cardioplegia solution having about 15 mM sodium chloride, about 9 mM potassium chloride, about 4 mM magnesium chloride, about 18 mM histidine hydrochloride, about 180 mM histidine, about 2 mM tryptophan, about 30 mM mannitol, about 0.015 mM calcium chloride, about 1 mM ketoglutarate.

In one embodiment, the perfusate or solution includes components for an Institute-George-Lopez (IGL-1) solution having about 0.03 mM PEG-35, about 100 mM lactobionate, about 30 mM raffinose, about 25 mM KH₂PO₄, about 5 nM MgSO₄, about 5 mM adenosine, about 3 mM glutathione, and about 1 mM allopurinol.

In one embodiment, the perfusate or solution includes components for a Celsior solution having about 60 mM mannitol, about 80 mM lactobionate, about 30 mM histidine, about 20 mM aminoglutaminic acid, and about 3 mM glutathione.

In one embodiment, the perfusate or solution includes components for a Polysol solution having about 20 mM PEG-35, about 5.3 mM trehalose, about 3.2 mM raffinose, about 6.3 mM histidine, about 5 mM adenosine, and about 5.6 mM glutathione.

In one embodiment, the perfusate or solution includes components for gelofusine having about 4% w/v solution of succinylated gelatin.

In one embodiment, the perfusate or solution includes components for a EuroCollins (EC) solution having about 195 mM glucose, about 15 mM K₂HPO₄, about 42.5 mM KH₂PO₄, and about 10 mM NaHCO₃.

In one embodiment, the perfusate or solution includes components for a hypertonic citrate/Marshalls (HOC) solution having about 80 mM citrate, about 185 mM mannitol, and about 40 mM MgSO₄.

In one embodiment, the perfusate or solution includes components for a Steen solution having about 70 g/L human serum albumin and about 5 g/L dextran 40.

In one embodiment, the perfusate or solution includes components for a Unisol (UHK) solution having about 6% w/v dextran 40, about 30 mM lactobionate, about 25 mM mannitol, about 70 mM gluconate, about 20 to 25 mM glucose or sucrose or a combination of glucose and sucrose, about 2.5 mM KH₂PO₄, about 5 mM KHCO₃ or NaHCO₃, about 35 mM HEPES (4-(2-hydroxyethyl)-1-piperazineethanesulfonic acid), optionally about 3 mM glutathione, and about 2 mM adenosine.

In one embodiment, the perfusate or solution includes reconstituted blood, whole blood, plasma, platelets, red blood cells, a hemoglobin-based oxygen carrier, a synthetic hemoglobin substitute, and/or a perfluorocarbon-based oxygen carrier (PFC).

The perfusate or solution can include one or more crystalloid or colloid components, such as any described herein. Such components can include HES, PEG-35, gelatin, starch, dextran, proteins such as albumin, sugars (e.g., glucose, dextrose, sucrose, and the like), and the like in the optional presence of one or more ions (e.g., sodium, chloride, as well as other cations and anions).

The perfusate or solution can include one or more of any agents described herein. Such agents can include protectants, cryoprotectants, ice nucleators, ice modulators, oxygen carrier agents, oncotic agents, crystalloid components, colloidal components, growth factors, vasodilators, apoptosis inhibitors, caspase inhibitors, BID inhibitors, BAD inhibitors, BAX inhibitors, BAK inhibitors, cytochrome C inhibitors, cathepsin inhibitors, granzyme B inhibitors, pyroptosis inhibitors, necroptosis inhibitors, kinase inhibitors, Rho-kinase inhibitors, polyamines, integrated stress response inhibitors, reactive oxygen species scavengers, antioxidants, and combinations thereof.

### Biological Tissue Samples

The present disclosure relates to preservation of biological tissue samples. Non-limiting samples include a solid organ (e.g., a kidney, liver, heart, as well as portions thereof), a vascularized tissue sample, a tissue sample, a graft, or an allograft. The sample can include multiple tissue types including blood vessels (e.g., artery, vein, or a combination) and other tissues such as adipose, skin, muscle, nerves, ligaments, tendon, nerve, cartilage, and/or bone.

In some embodiments, a sample is a portion of a limb (e.g., all or part of an upper extremity including all or part of one or more digits, hand, nails, forearm, elbow, and/or upper arm, or all or part of a lower extremity including legs, ankles, feet, and one or more toes), face (e.g., all or part of a face including eye, periorbital tissue/eyelids, ear, nose, and/or a lip or lips), larynx, trachea, abdominal wall, genitourinary tissue (e.g., labia, a penis and/or urethra), uterine tissue (e.g., endometrium), or any tissues that can be perfused through a vessel such as limbs and other vascular composite allografts or a combination thereof. In some embodiments, the biological tissue sample is a solid organ or a functional portion thereof, e.g., all or part of a heart, kidney, lung, skin, ovary, pancreas, or liver, lung, skin, or bone for use in organ transplantation, where storage and transport of the organ is necessary between harvesting from an organ donor and transplantation of the organ in an organ recipient.

Methods herein can allow for extended preservation of biological tissue samples, for example, for days to months (e.g., greater than 12 hours, 18 hours, 1, 2, 3, 4, 5, 6, 7, 8, 9, 10, 20, or 30 days, greater than 1, 2, 3, 4, 5, or 6 weeks, or greater than 1, 2, 3, 4, 5, 6, 7, 8, 9, 10, or 11 months) to years (e.g., 1, 2, 3, 4, 5, or more years). In some embodiments, the preservation period is less than 2, 3, 4, 5, 6, 7, 8, 9, 10, 20, or 30 days; less than 1, 2, 3, 4, 5, or 6 weeks; less than 1, 2, 3, 4, 5, 6, 7, 8, 9, 10, or 11 months; or less than 1, 2, 3, 4, or 5 years.

Treated samples can be determined to be viable in any useful manner. In one embodiment, the treated sample is tested by measuring one or more of a tissue adenosine triphosphate (ATP) to adenosine monophosphate (AMP) ratio, a tissue ATP to adenosine diphosphate (ADP) ratio, lactate levels, potassium concentration, cell-free DNA (cfDNA) levels, damage-associated molecular pattern (DAMP) levels (e.g., any DAMP described herein), alanine aminotransferase (ALT) levels, aspartate aminotransferase (AST) levels, tissue specific injury marker levels (e.g., any injury markers described herein), bile levels, pH levels, flow rates, pressure levels, cytokine levels, caspase levels, cytokeratin levels, terminal deoxynucleotidyl transferase dUTP nick end labeling (TUNEL), swelling and weight gain, percentage of edema, vascular resistance, oxygen consumption, lactic acid dehydrogenase (LDH) levels, flavin mononucleotide (FMN) levels, and ischemia. The viability or transplant-worthiness of the organ can be assessed using methods known in the art, e.g., see Int. Pub. No. WO 2011/140241, which is incorporated herein by reference in its entirety.

In some embodiments, the viability of preserved tissues is improved by, for example, reducing edema or weight gain in preserved biological tissue samples as compared to biological tissue samples preserved via other methods (e.g., preservation methods used to preserve organs or standard static cold preservation techniques). Reducing edema or weight gain in preserved biological tissue samples is vital given that increased levels of edema or weight gain (e.g., greater than about 20%) can lead to transplant or graft failure or at least reduce viability of the preserved biological tissue sample.

### Machine Perfusion and Subzero Non-Freezing Preservation System

The present disclosure relates to machine perfusion systems that can perform the perfusion protocols described herein. The machine perfusion systems can include a pump (e.g., a roller pump) that is configured to produce flow, e.g., pulsatile or non-pulsatile flow (e.g., duplex non-pulsatile circulation), a perfusate reservoir (e.g., a jacketed organ chamber), a heat exchanger, a hollow fiber oxygenator, a jacketed bubble trap, a pressure sensor, and/or a sampling port. These components of the perfusion systems can be serially connected by a tubing (e.g., silicon tubing). In some embodiments, the perfusate and/or biological tissue sample temperature can be controlled by a separated warming/cooling circuits. The warming circuit can warmed by a warm water bath, while the cooling circuit can be cooled by a chiller. Both circuits can be pumped through heat exchanger and the jackets of the bubble traps and the organ chamber. The chiller can include a refrigerant basin that can hold the biological tissue sample during subzero non-freezing preservation. An exemplary system can include a perfusion solution that is pumped via a roller pump to the oxygenator and then is oxygenated with a carbogen mixture (5% CO₂ and 95% oxygen). The solution then goes through the bubble trap to prevent air bubbles going into the limb. The pressure can be measured at the level of the limb that is laying the basin. Inflow samples can be measured at the inflow valve with outflow samples are measured directly from the venous outflow cannula.

In some embodiments, the machine perfusion and preservation system can be controlled by a computer control unit that is operatively connected to the other components of the system such that the computer control unit can control parameters such as perfusate temperature, perfusate flow rate, and time duration and sequence with which these parameters are maintained, to perform the perfusion protocols described herein.

### EXAMPLES

### Example 1: Pan-Caspase Inhibition During Normothermic Machine Perfusion of Discarded Livers Mitigates Ischemia-Reperfusion Injury

Liver transplantation (LT) provides the only definitive cure for end-stage liver disease, though access is limited due to a shortage of donor organs. The growing use of ex situ machine perfusion technology for dynamic liver preservation prior to LT has significantly expanded the use of marginal and extended-criteria grafts in recent years (see, e.g., ref. 1, 2). However, sizeable knowledge gaps remain with respect to liver physiology during normothermic machine perfusion (NMP) that limit its potential use as a platform for rehabilitation of untransplantable or severely injured grafts. There may be differences in liver physiology during NMP relative to hepatocellular function as defined by the balance between ischemia-reperfusion injury (IRI) and recovery of cellular homeostasis via autophagy (see, e.g., ref. 3 and Examples 4-5 herein). Therefore, leveraging the equilibrium between graft injury and recovery with adjunct therapeutic interventions during NMP may present a reliable avenue for rehabilitation of graft function and transplantation of livers with inadequate function.

One non-limiting approach to tipping the scale between IRI and autophagy is to target cell death pathways that represent the consequence of irrecoverable injury (see, e.g., ref. 4, 5). Apoptosis, pyroptosis, and necroptosis represent different forms of tightly controlled stress-induced regulated cell death mechanisms in the liver (see, e.g., ref. 6). Under normal physiologic conditions, apoptosis allows controlled turnover of injured and senescent liver cells and is balanced by an equal amount of cell proliferation. In contrast, apoptosis can be pathologic if the equilibrium between turnover and proliferation is disrupted, resulting in chronic inflammation, fibrosis, and even cancer (see, e.g., ref. 7). Dysregulated apoptosis has been described in the setting of liver disease and transplant for decades, and numerous studies have shown that therapeutic inhibition of apoptosis results in mitigation of IRI (see, e.g., ref. 8-13).

Having demonstrated the association of hepatocellular function during NMP with the balance between liver injury and autophagy (see, e.g., Examples 4-5 herein), we hypothesized that discarded human livers with inadequate hepatocellular function during NMP were characterized by the presence of overwhelming apoptosis. We subsequently tested whether adjunct delivery of an irreversible pan-caspase inhibitor, emricasan, during NMP would improve hepatocellular function of discarded human livers by attenuating IRI and allowing graft rehabilitation by shifting the equilibrium between cell death and autophagy (see, e.g., FIG. 6).

Donor demographics and functional assessment: Eleven discarded DCD livers were included in the control cohort and stratified using predefined criteria for demonstrating adequate hepatocellular function (see Example 2 herein for additional details regarding non-limiting materials and methods). Table 1 displays donor and liver characteristics between 6 livers demonstrating adequate hepatocellular function (AHF) and 5 livers with inadequate hepatocellular function (IHF). No significant differences were found between groups, though there was a trend toward longer cold ischemic time in the AHF group and higher donor body mass index in the IHF group. Median donor risk index (DRI) was 2.4 [2.2,2.4] in IHF livers compared to 2.05 [1.9,2.2] in AHF livers (p=0.14). Donor demographics for the 5 emricasan-treated livers are also shown. Livers EM1 and EM2 were from young DCD donors with relatively low DRIs turned down due to logistic reasons and inability to find a suitable recipient. Livers EM3-5 were from older donors with extended warm and cold ischemic times, and therefore had notably high DRIs.

TABLE 1
Discarded liver donor demographics^{a}

| | Emricasan | | | | | | | | | AHF vs. |
|---|---|---|---|---|---|---|---|---|---|---|
| | N = 5 | | | | | AHF | | IHF | | IHF |
| Liver # | EM1 | EM2 | EM3 | EM4 | EM5 | N = 6 | | N = 5 | | P-value |
| DCD? | Y | Y | Y | Y | Y | 6 | (100%) | 5 | (100%) | |
| tWIT | 22 | 23 | 32 | 23 | 53 | 27.5 | (24-28) | 24 | (23-34) | 0.93 |
| fWIT | 9 | 8 | 7 | 12 | 13 | 8.5 | (8-10) | 11 | (9-11) | 0.36 |
| CIT | 347 | 553 | 758 | 703 | 679 | 625.5 | (458-697) | 358 | (357-367) | 0.082 |
| Age | 28 | 26 | 60 | 50 | 59 | 58.5 | (40-60) | 56 | (55-59) | 0.85 |
| Gender | M | M | F | F | F | 5M, 1F | | 2M, 3F | | 0.24 |
| BMI | 38.7 | 19.8 | 31.2 | 28.3 | 31.9 | 26 | (24.5-28.3) | 32.9 | (29.9-40.2) | 0.068 |
| Weight (kg) | 129.5 | 61.7 | 90.5 | 74.9 | 84.8 | 80.6 | (77.6-87) | 90.9 | (74.1-100) | 0.86 |
| Macrosteatosis | 30 | 0 | 2 | 0 | 0 | 3.5 | (0-5) | 35 | (0-40) | 0.35 |
| Microsteatosis | 10 | 5 | 0 | 30 | 0 | 3.8 | (0-50) | 5 | (0-55) | 0.85 |
| AST | 32 | 38 | 134 | 78 | 27 | 41.5 | (39-57) | 98.5 | (41.5-366) | 0.39 |
| ALT | 22 | 27 | 40 | 47 | 32 | 32.5 | (22-58) | 100.5 | (25.5-317.5) | 0.52 |
| Total bilirubin | 1.2 | 0.8 | 0.6 | 0.2 | 0.2 | 0.75 | (0.4-1) | 0.35 | (0.25-0.45) | 0.086 |
| ALP | 72 | 48 | 76 | 104 | 83 | 58 | (36-95) | 99 | (94-494) | 0.12 |
| DRI | 1.74 | 1.47 | 3.56 | 3.04 | 2.83 | 2.05 | (1.9-2.2) | 2.4 | (2.2-2.4) | 0.14 |

^{a}Median with interquartile range shown for continuous data. Wilcoxon rank-sum test or Fisher's exact test used for group comparisons.
AHF, adequate hepatocellular function group;
IHF, inadequate hepatocellular function group;
DCD, donation after circulatory death;
tWIT, total warm ischemic time (extubation to cold flush) in minutes;
fWIT, functional warm ischemic time (asystole to cold flush) in minutes;
CIT, cold ischemia time in minutes;
BMI, body mass index (kg/m²);
steatosis expressed in percentages;
DRI, donor risk index.
Terminal values prior to procurement shown for AST (aspartate aminotransferase), ALT (alanine aminotransferase), ALP (alkaline phosphatase).

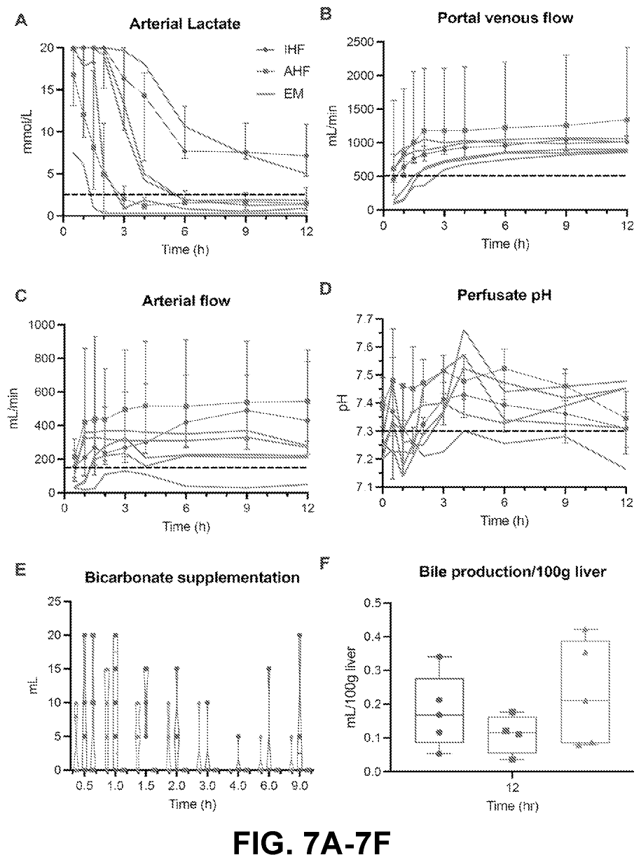

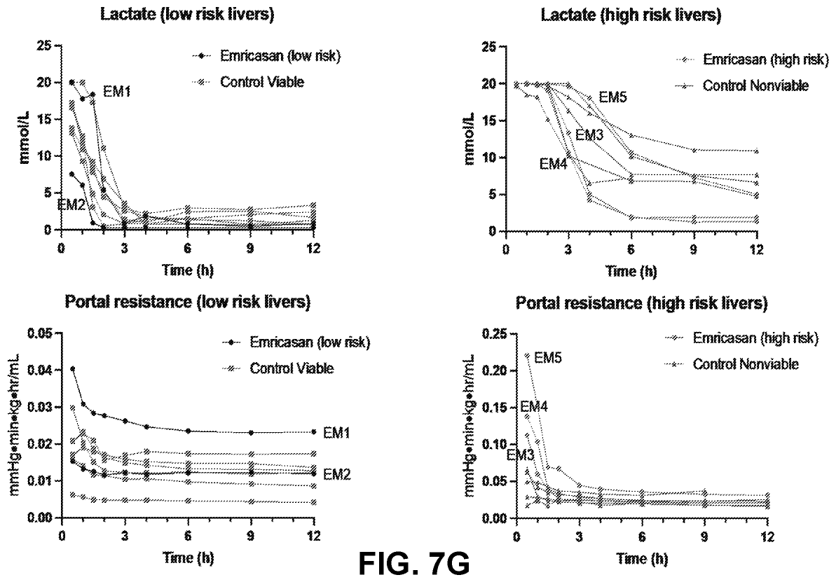

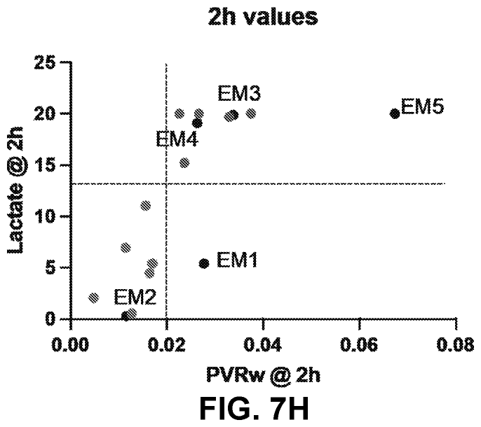

With respect to hepatocellular function (FIG. 7A-7G), 4 emricasan-treated livers demonstrated adequate hepatocellular function, including EM3 and EM4 (DRI 3.56 and 3.04, respectively). Low DRI livers EM1 and EM2 rapidly cleared lactate in similar fashion to AHF livers (FIG. 7G-7H). Livers EM3 and EM4 initially displayed delayed lactate clearance within the first two hours of NMP similar to IHF livers, but subsequently were able to demonstrate adequate lactate clearance by 6 hours of NMP (FIG. 7G-7H). Liver EM5, with the longest WIT, demonstrated IHF and failed to meet the lactate threshold despite a steady decrease in perfusate lactate throughout NMP (FIG. 7A). Like AHF livers, EM1-4 livers demonstrated stable vascular flows and perfusate pH (FIG. 7B-7D). Only liver EM5 required bicarbonate supplementation after 2 hours of NMP to maintain pH above 7.3 (FIG. 7E). Bile production was similar between the three groups (FIG. 7F).

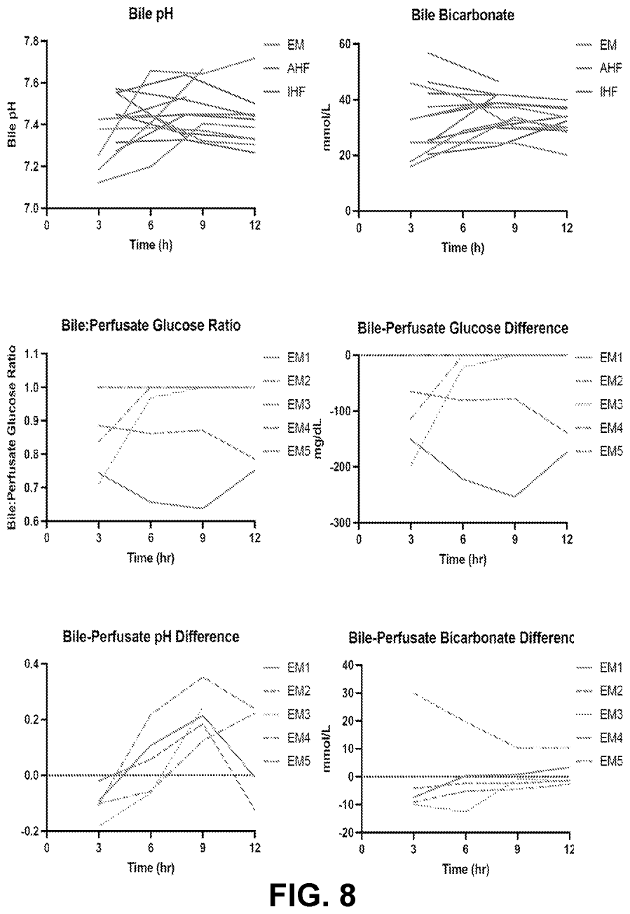

Analysis of cholangiocellular metrics demonstrated relatively adequate function in EM1 and EM2, which had the shortest ischemic times compared to EM3-5. Comparison of EM livers to the control groups was limited by differences in collection times and lack of corresponding perfusate chemistries (FIG. 8).

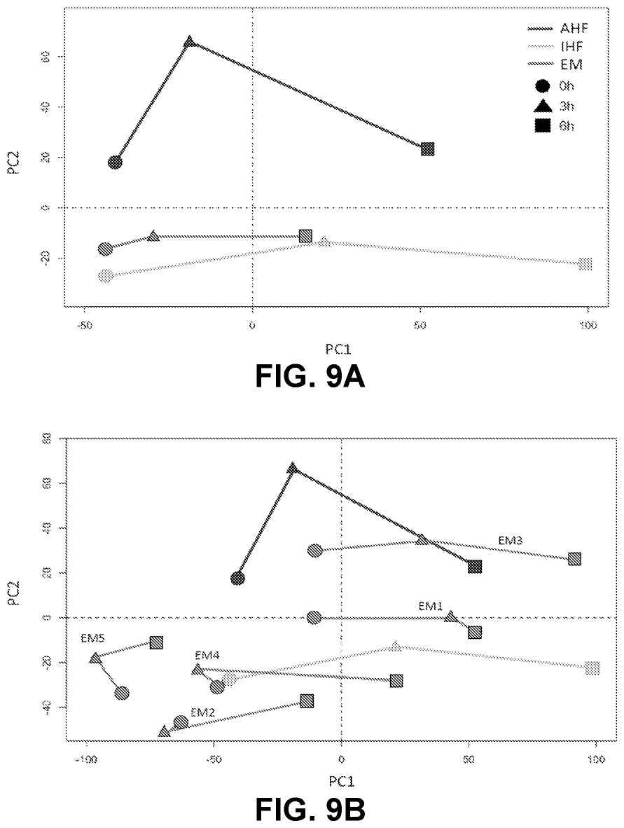

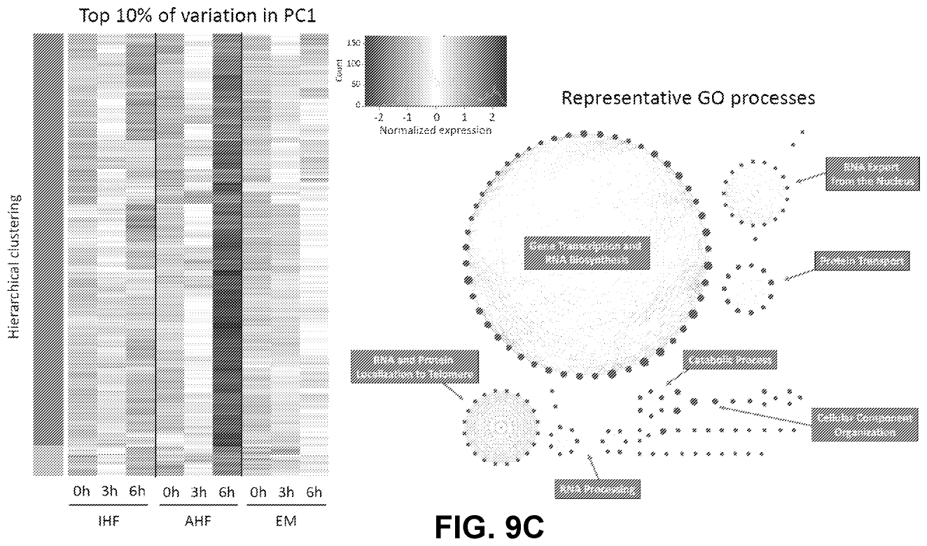

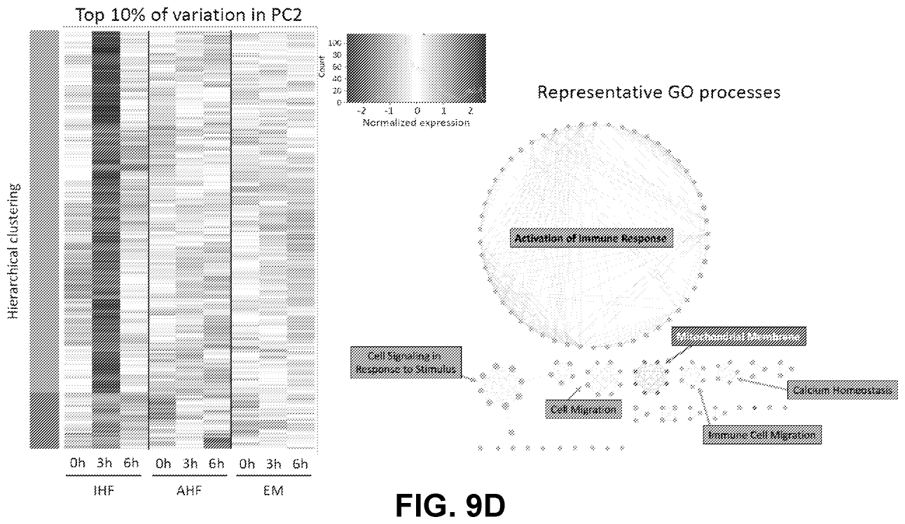

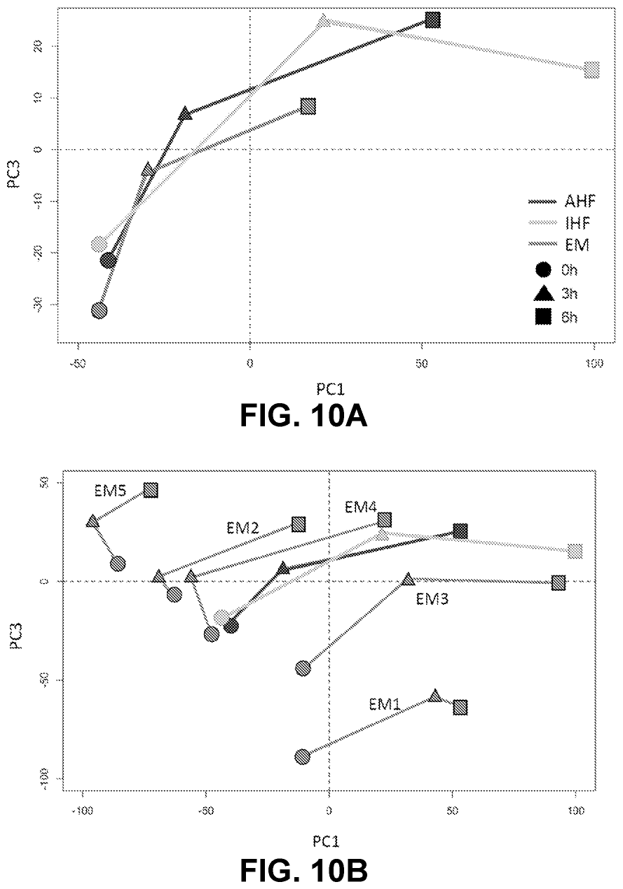

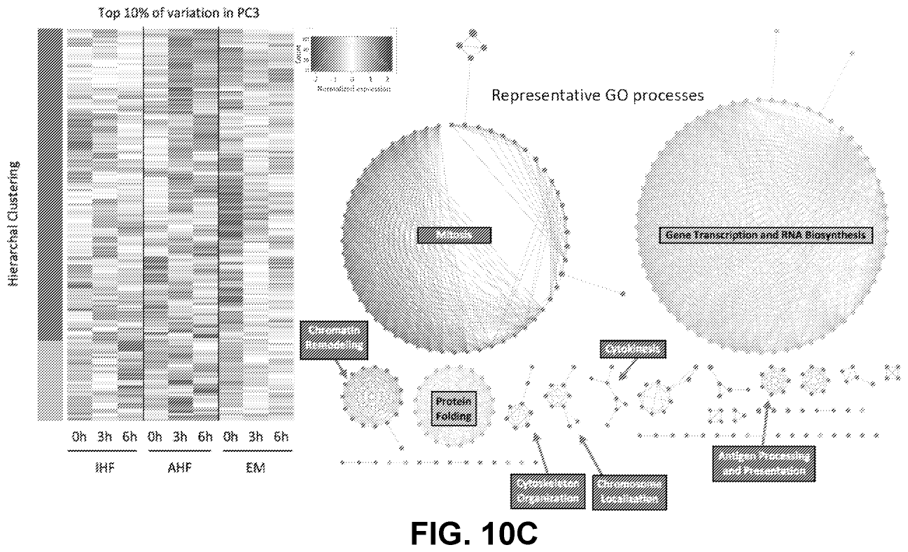

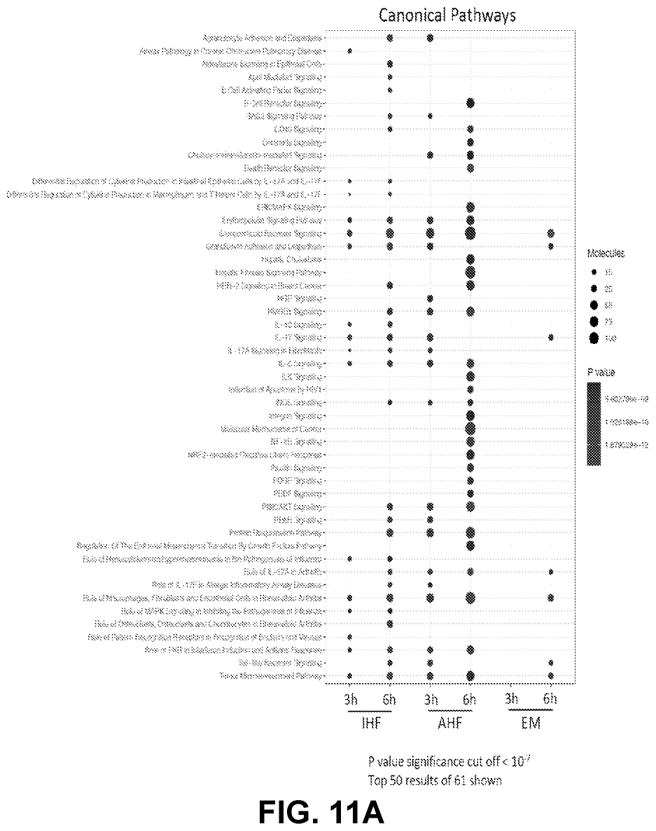

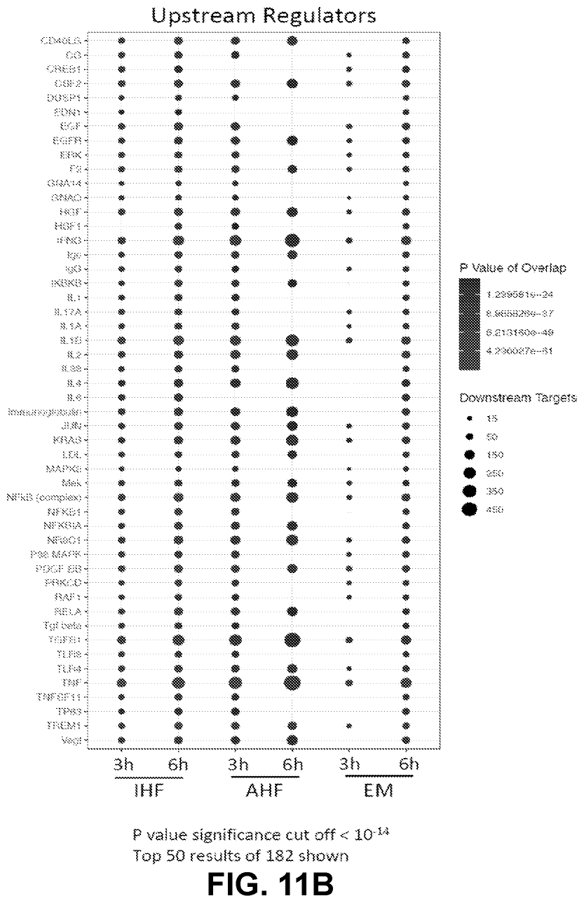

Principal component analysis (PCA) and gene expression: PCA demonstrated notable transcriptional trends among the 3 groups (FIG. 9A-9B). Principal component 1 (PC1) captured the time-dependent changes in gene expression. Livers with AHF demonstrated consistent large transcriptional shifts at 3 and 6 hours of perfusion while these changes were dampened in the IHF and emricasan-treated livers especially at the 3 h time point. Analysis of the top 10% of genes accounting for the variation in PCl revealed Gene Ontology (GO) processes related to RNA transcription, RNA processing, and protein translation. Compared to AHF and IHF livers, EM livers demonstrated muted upregulation of genes within the PCl subset (FIG. 9C). On the other hand, PC2 appeared to distinguish AHF from IHF livers. EM livers clustered closer to AHF livers on the PC2 axis. Analysis of the top 10% of genes accounting for PC2 revealed marked differences between groups both prior to initiation of and during NMP. This gene subset demonstrated functional enrichment of GO processes related to immune response activation, immune cell migration, and the mitochondrial membrane. The gene expression heatmap demonstrates strong upregulation of genes categorized under the immune response phenotype in the IHF group after initiation of perfusion. In contrast, AHF and EM livers demonstrate more robust activation of genes associated with the mitochondrial membrane phenotype and minimal immune response (FIG. 9D). Transcriptional changes accounting for PC3 were enriched for GO processes related to mitosis and microtubule organization (FIG. 10). Analysis of the canonical pathways and upstream regulators obtained from IPA are shown in FIG. 11A-11B.

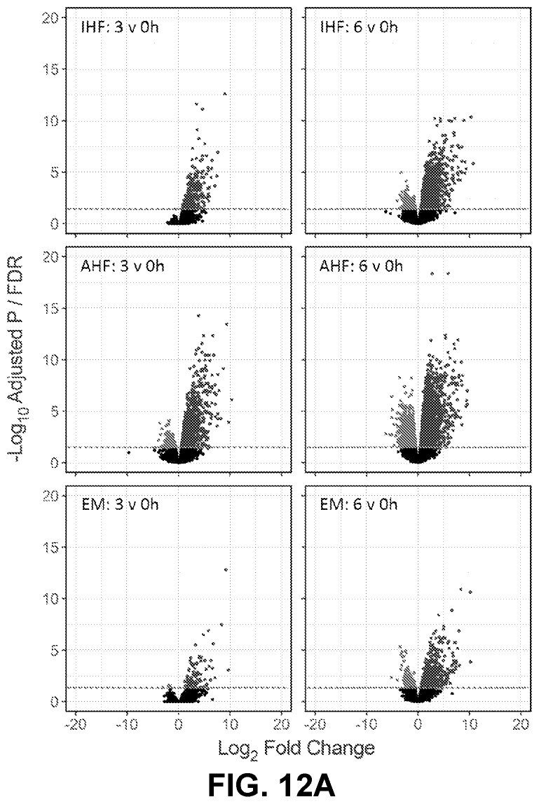

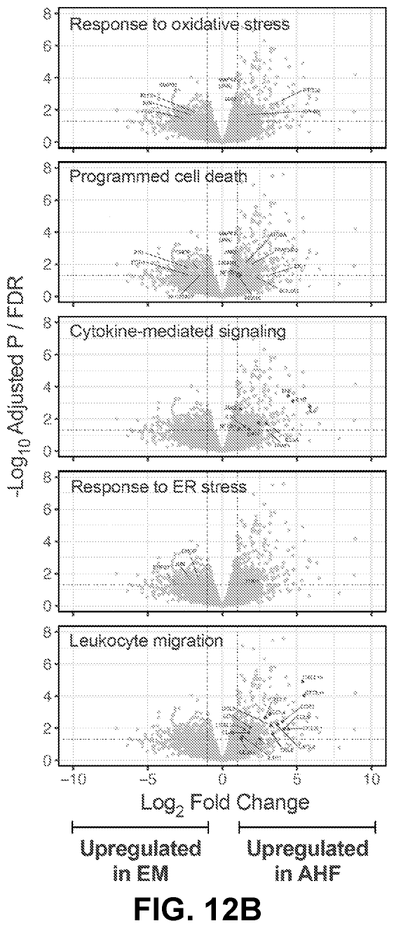

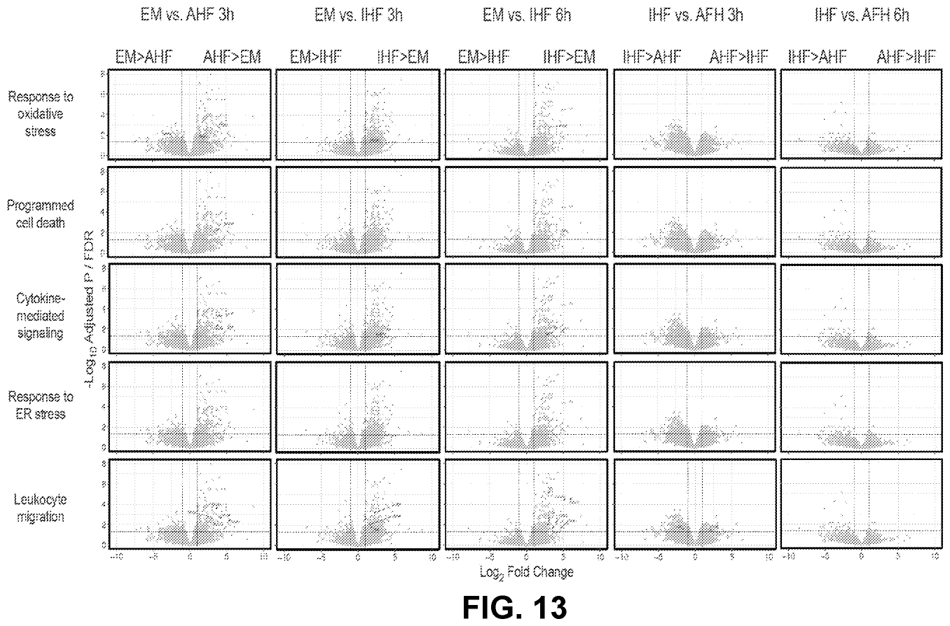

Volcano plots of differentially expressed genes after 3 and 6 hours of NMP compared to pre-perfusion biopsies demonstrated robust up- and down-regulation of genes in the AHF livers. In comparison, IHF livers demonstrated significant expression of a smaller number of genes. Emricasan-treated livers displayed a markedly smaller set of DEGs compared to both control groups (FIG. 12A). To further detail differences between AHF and EM livers, volcano plots comparing gene expression after 6 hours of NMP between the two groups were annotated for select GO processes. Compared to EM livers, the AHF group demonstrated more robust activation of genes associated with oxidative stress, cytokine-mediated signaling, programmed cell death, and leukocyte migration (FIG. 12B). Similar patterns were seen when comparing EM and IHF livers. No significant differences were noted between AHF and IHF groups given equally robust expression of genes within the GO processes of interest (FIG. 13).

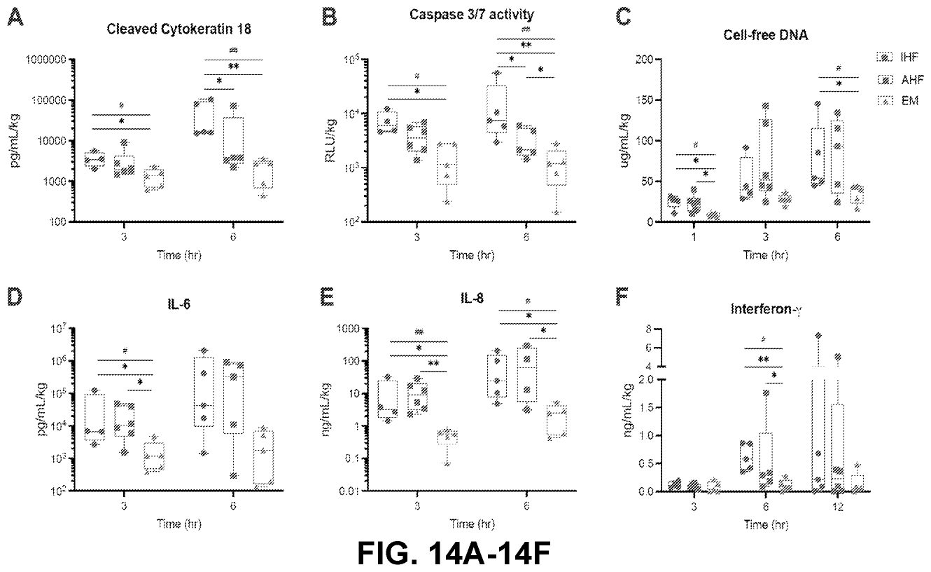

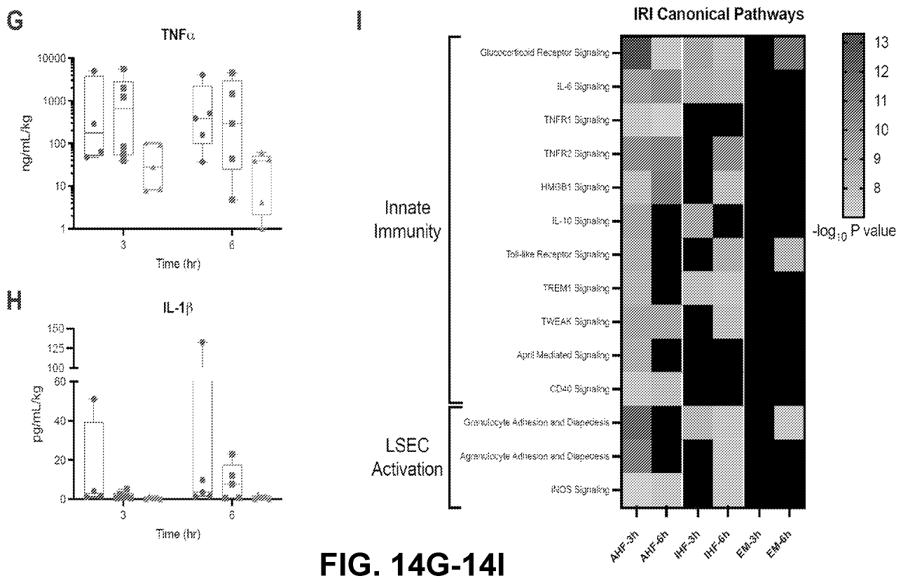

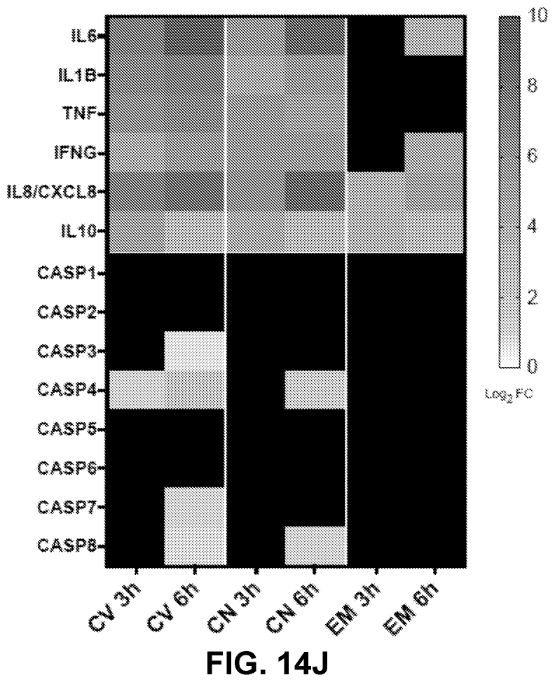

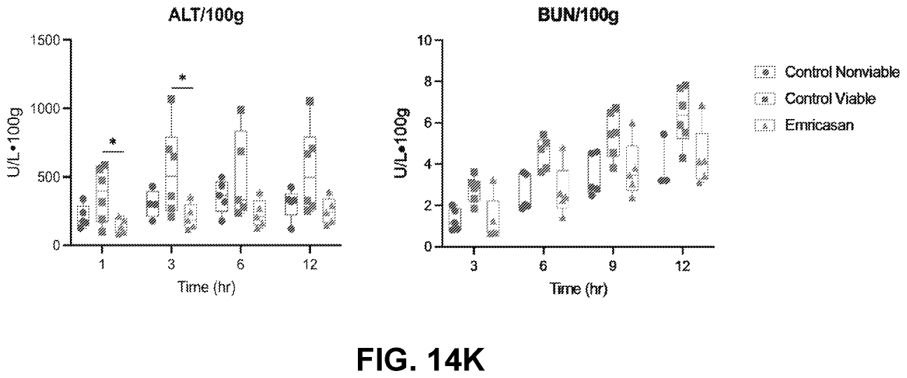

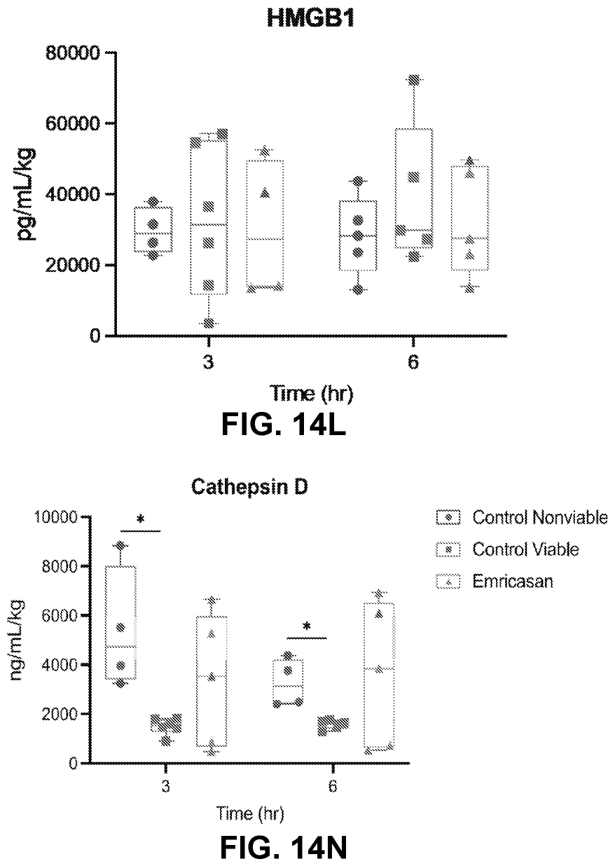

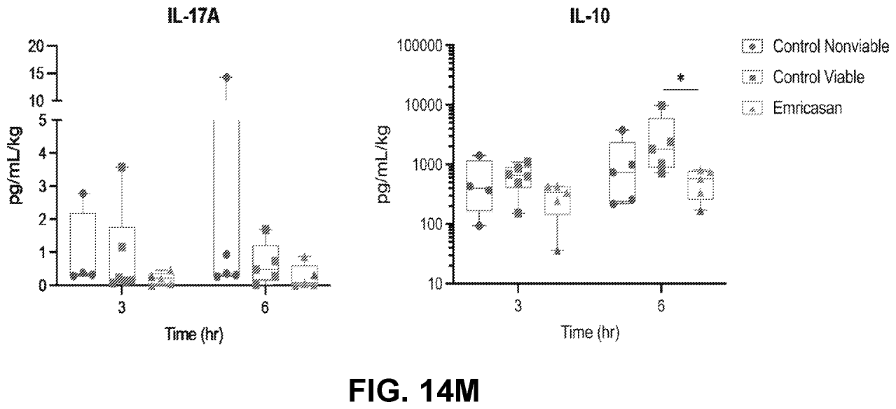

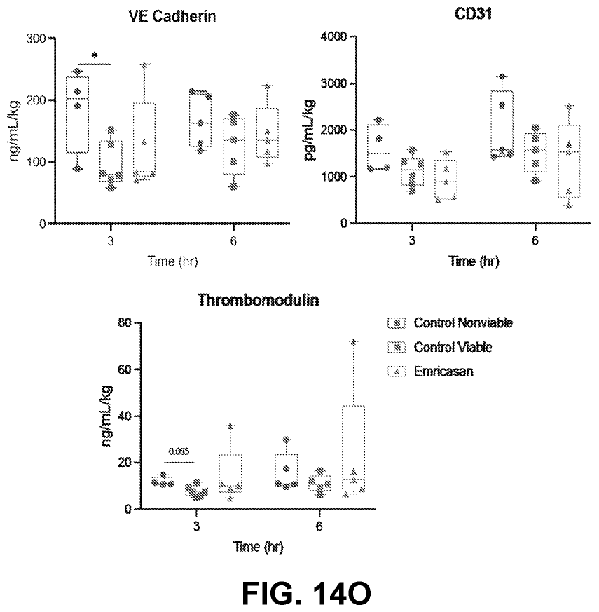

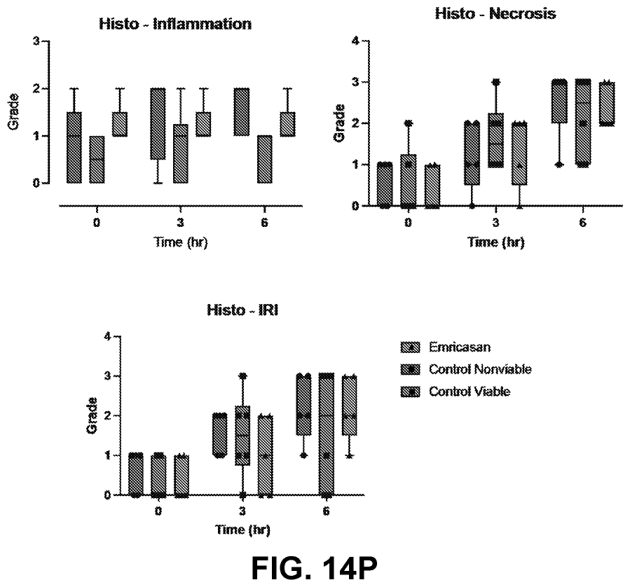

Adjunct delivery of caspase inhibitor mitigates IRI during liver NMP: Analysis of perfusate plasma samples for apoptosis biomarkers showed significantly higher circulating levels of cleaved cytokeratin 18 and caspase-3/7 activity after 6 hours of NMP in IHF compared to AHF livers (FIG. 14A-14B). Addition of emricasan significantly decreased evidence of apoptosis after both 3 and 6 hours of NMP. Circulating cell-free DNA, a damage-associated molecular pattern (DAMP), was also significantly reduced in the EM livers compared to control groups (FIG. 14C).

In order to determine the consequences of emricasan treatment on extracellular signaling proteins, plasma levels of numerous pro-inflammatory cytokines were evaluated. EM livers demonstrated significantly lower levels of interleukin-6 (IL-6), interleukin-8 (IL-8), and interferon-γ (IFNG) compared to AHF and IHF groups (FIG. 14D-14F). Circulating tumor necrosis factor-α (TNFα) and interleukin-1β (IL-1β) were lower compared only to IHF livers (FIG. 14G-14H).

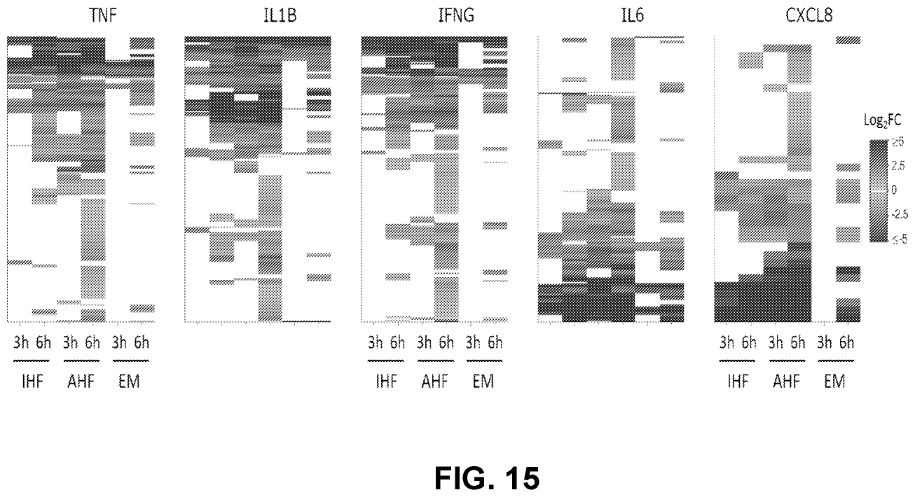

Given the decreased pro-inflammatory cytokine profile in the perfusate of EM livers, Ingenuity Pathway Analysis (IPA) was used to evaluate the downstream signaling effect of this finding. EM livers demonstrated minimal enrichment of IRI canonical pathways associated with innate immunity and sinusoidal endothelial cell activation (FIG. 14I). IHF livers also demonstrated a pattern of delayed activation of these CPs at 6 hours of NMP whereas AHF livers appeared to show early activation at 3 hours. EM livers also exhibited decreased upregulation of pro-inflammatory and pro-death genes, as compared to controls (viable and nonviable livers) (FIG. 14J). Moreover, downstream gene target expression analysis of the above pro-inflammatory upstream regulators revealed categorically fewer differentially expressed genes in EM livers compared to AHF and IHF groups (FIG. 15).

Other markers were assessed for EM livers, IHF livers, and AHF livers (FIG. 14K-14O); and histology analysis indicated no significant differences in inflammatory infiltrate or necrosis, which suggests that H&E staining and grading may not adequately capture functional/signaling differences between livers (FIG. 14P).

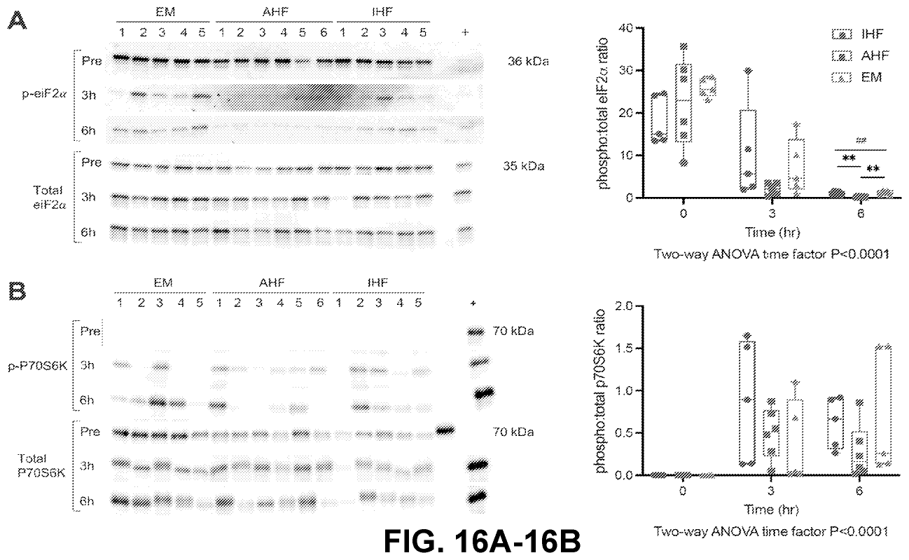

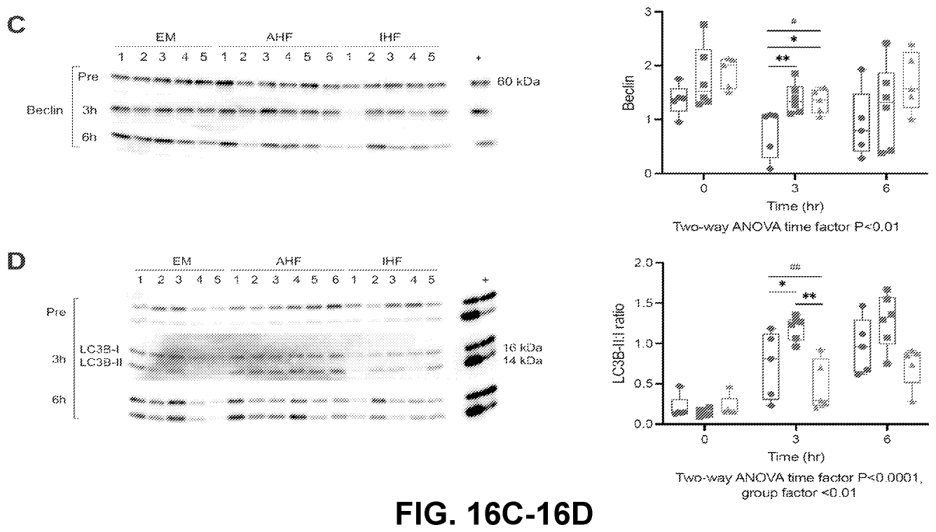

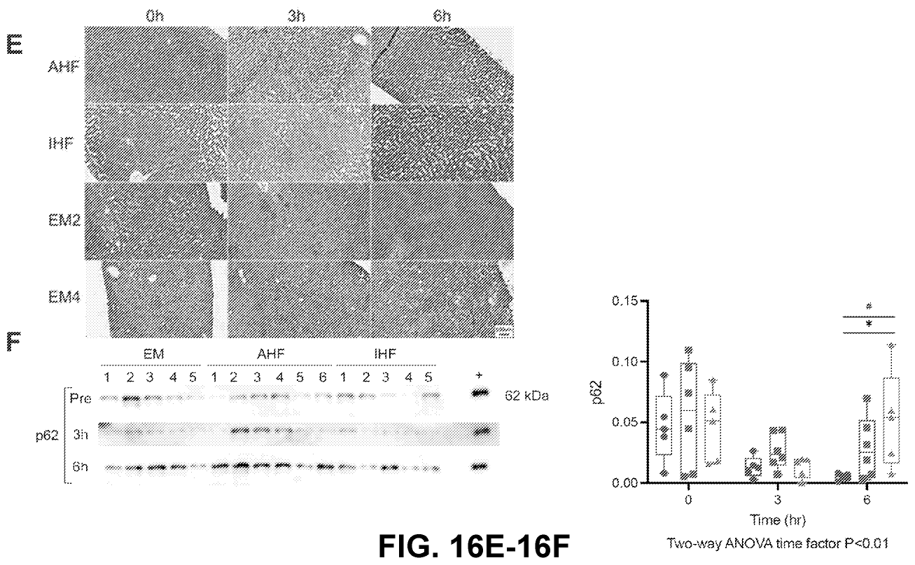

Stress response mechanisms in the setting of caspase inhibition: We have previously shown that functional livers demonstrate a more robust homeostatic stress response including activation of autophagy compared to inadequately functioning livers. To investigate the effect of inhibiting apoptosis on the unfolded protein response (UPR) and autophagy, we performed Western immunoblotting for key proteins involved in regulation of these processes. Eukaryotic initiation factor 2α (eIF2α) is phosphorylated by protein kinase RNA-activated-like ER kinase (PERK) in response to misfolded proteins accumulating in the ER. This phosphorylation of eIF2α leads to initiation of antioxidant signaling, repression of global protein translation and induction of autophagy. Western immunoblotting revealed high levels of phospho-eIF2α pre-perfusion in all groups. After initiation of perfusion all groups demonstrated a significant time-dependent decrease in phosphorylation. After 6 hours of perfusion, AHF livers had lower phospho:total-eiF2α ratios (0.21, IQR 0.14-0.31) compared to IHF (0.78, IQR 0.69-1.58, P<0.01 vs. AHF) and EM livers (1.22, IQR 0.73-0.78, P<0.01 vs. AHF) (FIG. 16A). The mechanistic Target of Rapamycin (mTOR) pathway also plays a key role in regulation of autophagy with activation of mTORC1 leading to suppression of autophagy. Phosphorylation of ribosomal protein S6 kinase (P70S6K), a downstream target of mTORC1, was not detectable pre-perfusion. NMP resulted in a significant time-dependent increase in phospho:total-P70S6K ratios in all groups. There was a trend toward higher levels in the IHF compared to AHF and emricasan treated livers. However, this did not reach significance due to the variation in individual livers.

Proteins directly involved in autophagic flux were investigated next (FIG. 16B). Beclin, a marker of autophagy induction, demonstrated a time-dependent decrease during perfusion. Beclin protein content in IHF livers after 3 hours of NMP was significantly lower compared to AHF and EM groups (FIG. 16C). This difference was qualitatively apparent at 6 hr although it was no longer statistically significant. Following initiation of autophagy, microtubule-associated protein 1 light chain 3 beta (LC3B) is converted from its inactive form LC3B-I to LC3B-II through lipidation by the autophagy machinery. LC3B-II then associates with the lipid membranes of the phagophore. LC3B-II:I ratios were significantly higher in AHF livers (1.33, IQR 0.99-1.57) at 3 hr compared to IHF (0.96, IQR 0.64-1.29, P<0.05 vs. AHF) and emricasan livers (0.85, IQR 0.51-0.89, P<0.01 vs. AHF) (FIG. 16D). The ratio increased in the IHF livers at 6 hr such that there was no difference between IHF and AHF livers. We confirmed the LC3B results using immunohistochemistry for LCBII (FIG. 16E). Pre-perfusion biopsies demonstrated cytosolic staining in all groups. In AHF livers, LC3B was localized to a granule staining pattern at 3 and 6 hr indicative of LCB-II association with the autophagosome. This shift in staining pattern was not observed in the IHF or emricasan groups. p62 content was investigated to determine whether autophagy was potently inhibited in IHF or EM livers. A trend toward lower levels of p62 was observed in all groups at 3 hr. By 6 hr of perfusion, IHF livers maintained significantly lower p62 content compared to the other groups. However, the overall level of p62 did not show a time-dependent increase suggesting that autophagic flux was not significantly impacted in any of the groups.

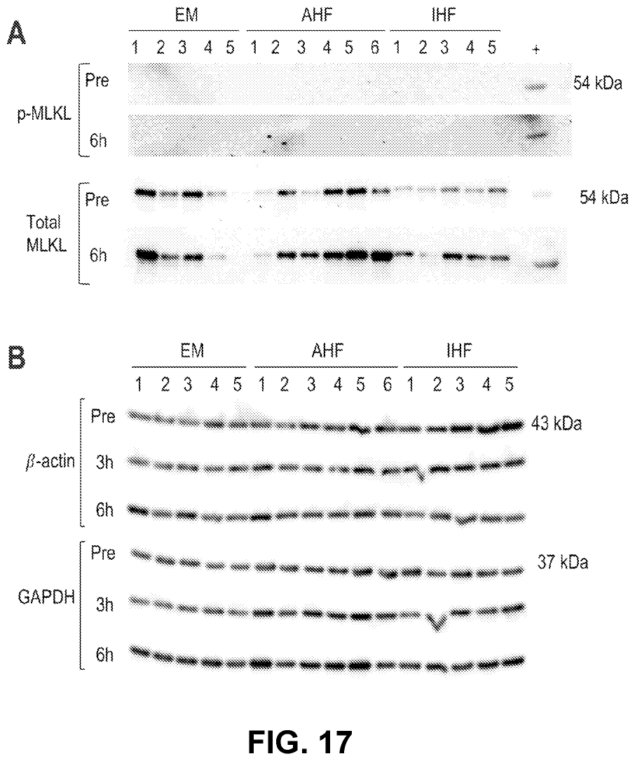

Pan-caspase inhibition may result off-target activation of other cell death pathways such as necroptosis (see, e.g., ref. 6, 18). To assess whether treatment with emricasan resulted in compensatory activation of necroptosis, we probed for phosphorylation of mixed lineage kinase domain-like (MLKL). MLKL is the terminal kinase in the necroptotic cell death program. Phosphorylation of MLKL is believed to lead to its oligomerization, transport to the membrane, and membrane destruction. Phospho-MLKL was below the limit of detection in all groups before and during perfusion, suggesting that treatment with emricasan did not lead to induction of necroptosis (FIG. 17).

Discussion: Pathologic apoptosis, represented by an imbalance between regulated cell death and cell renewal, is an unregulated process that can be sustained and injurious (see, e.g., ref. 7). Release of intra-cellular contents, including DAMPs and cytokines, activate immune cells and propagate the cycle of cell death and inflammation. In this study of discarded livers subjected to NMP, livers with IHF were characterized by abundant apoptotic cell death, robust and sustained activation of innate immunity, and decreased activation of ER stress response pathways (autophagy) when compared to livers with AHF. Addition of an irreversible pan-caspase inhibitor, emricasan, to the perfusate composition resulted in significantly lower levels of apoptotic cell death and mitigation of innate immune responses.

Early applications of emricasan in rodent LT models demonstrated improved survival when drug was given at the time of liver procurement (see, e.g., ref. 10-12). In a subsequent randomized clinical trial, Baskin-Bey et al. demonstrated significantly lower AST and ALT levels in LT recipients when emricasan was added to the preservation flush solution compared to a placebo group, though the trial was not powered to detect differences in graft survival or EAD (see, e.g., ref. 13). Despite these promising results, routine clinical application of emricasan never reached wider use likely owing to the complexity of incorporating drug therapies into the clinical workflow at the time of organ procurement. The advent of perfusion technologies as a platform for organ rehabilitation is likely to provide a solution to these obstacles as organs can be preserved, monitored, and treated ex situ prior to implant (see, e.g., ref. 19). This study is a step forward in this direction, demonstrating that treatment of discarded DCD livers with emricasan during NMP after a period of cold and warm ischemia mitigated ischemia-reperfusion injury in hepatocytes.

The physiologic benefits of emricasan-adjunct NMP are likely multifactorial. Studies of individual caspase enzymes in the last decade have revealed varying functionality, with some acting as initiators of cell death processes (caspase 8, 9, 10) and others as executioners involved in end-stage proteolysis (caspase 3, 6, 7). A third class named inflammatory caspases (caspase 1, 4, 5) play a significant role in inflammasome activation and IL-1β release, often characterized as pyroptosis (see, e.g., ref. 6, 18). Inhibition of inflammatory caspases by emricasan may be one reason EM-treated livers had uniformly depressed IL-1β perfusate levels and markedly suppressed transcriptional enrichment of innate immune responses. Similarly, preventing unregulated apoptosis and thus release of DAMPs by injured hepatocytes may prevent activation of resident immune cells and further cytokine release. This disrupts the vicious cycle wherein injured hepatocytes undergo unregulated apoptosis and activate a cascade of cytokine-driven innate immune responses that in turn drive further cell death. It is of interest that the cytokine signature seen in IHF and some AHF livers was redolent of the pattern seen in sera of liver transplant recipients who experienced IRI in a study by Sosa et al. (see, e.g., ref. 17). In contrast, the suppressed proinflammatory cytokine signature seen in EM livers more closely resembled non-IRI livers.

We further investigated ER stress responses to delineate potential crosstalk between apoptosis and autophagy. While we hypothesized that EM-treated livers would demonstrate more autophagic flux, we found a dampened response in contrast. AHF livers demonstrated significantly more activation of autophagy, corroborating our findings from a recent smaller study (see, e.g., ref. 3 and Examples 4-5 herein). On the other hand, EM livers demonstrated comparatively moderate autophagic flux, with an appropriate decrease in the ER stress marker phospho-eiF2α, a modest increase in LC3B-II:I ratios, and a cyclic reactivation of autophagy inhibition by 6 hours of NMP.

With respect to rehabilitation of liver hepatocellular function, isolated examination of EM-3 and EM-4 livers (and to a lesser extent EM-5) appear to demonstrate better than expected lactate clearance, based on the initial slow clearance followed by a more rapid drop. Mitigation of IRI with ex situ emricasan treatment may be worth evaluating in a clinical trial of extended-criteria grafts to determine if EAD and graft survival are modifiable outcomes. We were unable to evaluate post-transplant function of the research livers as no perfusion device had received regulatory approval in the United States at the time of this study. However, the feasibility of a clinical trial is no longer a barrier with recent FDA approval of two NMP devices. Another limitation was the apparent non-superiority in improving cholangiocellular function, as emricasan did not appear to improve IRI in cholangiocytes. This is a known limitation of end-ischemic NMP in DCD livers (see, e.g., ref. 20) and a precursor period of hypothermic oxygenated perfusion with or without controlled rewarming is likely required to prevent detrimental IRI in cholangiocytes (see, e.g., ref. 2, 21). The observed trend toward higher bile production in emricasan livers reflects the preserved hepatocyte function of bile secretion but not the cholangiocellular function of bile detoxification and alkalinization (see, e.g., ref. 22). In contrast, one factor that favors the wider application of emricasan is its excellent safety and tolerance profile, having been demonstrated in clinical trials for both liver transplant and non-alcoholic steatohepatitis (see, e.g., ref. 13, 23). Finally, the endpoints (cytokeratin 18, caspase-3/7 activity) used to determine therapeutic efficacy (see, e.g., ref. 23, 24) demonstrated a significant measurable difference within a clinically relevant perfusion timeframe, making incorporation of adjunct therapy a viable option during NMP.

### Example 2: Non-Limiting Materials and Experimental Methods

Human liver perfusions: Sixteen human livers from donation after circulatory death, with consent for research, were included in this study after being turned down by all transplant centers in the respective region of procurement. Human livers were procured in standard fashion through two Organ Procurement Organizations (OPO): New England Donor Services (Waltham, MA, USA) and LiveOnNewYork (New York, NY). In addition, one liver was obtained through the International Institute for the Advancement of Medicine (IIAM, Edison, NJ), which originated from the Gift of Life Donor Program (Philadelphia, PA). Informed consent was obtained from donors by the OPO. The Massachusetts General Hospital and Lifespan Institutional Review Boards, as well as the two OPOs and IIAM, approved this study (No. 2011P001496). No organs were procured from prisoners and no vulnerable populations were included in this study.

Procurement techniques based on donation after circulatory death followed standard methods. Donor livers were flushed in situ with University of Wisconsin solution. Total warm ischemic time was defined as the period from extubation to cold flush. Functional WIT was defined as the period from asystole to cold flush. Cold ischemic time was defined from cold flush to initiation of machine perfusion. All livers were transported via ground courier. After arrival to the laboratory under static cold storage, livers underwent standard back bench preparation for machine perfusion.

Eleven livers had been previously described in a research cohort of machine perfused discarded human livers (see, e.g., ref. 14) and comprised the control groups.

Grafts were perfused on the Liver Assist device (Organ Assist, Groningen, Netherlands) using a previously described protocol (see, e.g., ref. 14). Briefly, perfusate composition consisted of O+ packed red blood cells, human albumin, Lactated Ringer's solution, and heparin. Bile salts (taurocholate) and lipid-free parenteral nutrition were continuously infused. Perfusate, bile, and tissue biopsies were collected and analyzed at multiple time points. Grafts were assessed for adequate hepatocellular and cholangiocellular function. Hepatocellular function was defined as the ability to clear lactate below a threshold of 2.5 mmol/L, in addition to demonstrating stable vascular flow and pH without sustained bicarbonate supplementation. Cholangiocellular (biliary) viability metrics were measured according to van Leeuwen (see, e.g., ref. 15).

Of the 11 livers comprising the control groups, 6 demonstrated adequate hepatocellular function (AHF) and 5 did not (inadequate hepatocellular function, IHF). With respect to the experimental group (emricasan, EM), 5 consecutive human livers turned down for transplant were enrolled. Emricasan, also known as IDN-6556 (MedChemExpress, Monmouth Junction, NJ), dissolved in DMSO was added to the circulating perfusate prior to initiation of liver perfusion at a dose of 5 mg/kg liver weight (1 mL total volume, 0.05% v/v total perfusate). Vehicle control (1 mL DMSO) was previously incorporated in the control liver perfusions (FIG. 6).

RNA purification and sequencing: Core needle biopsies taken immediately prior to perfusion and after 3 and 6 hours of perfusion were used for transcriptome sequencing. Methods of tissue collection, purification, and bioinformatic analysis have been previously described (see, e.g., ref. 3). The differential gene expression threshold for significance was set to a Benjamini-Hochberg false discovery rate (FDR)<0.05.

In brief, tissues samples from livers taken immediately prior to perfusion and after 3 and 6 hours of perfusion were used for transcriptome sequencing. Core needle biopsies from the right liver lobe were collected in RNAlater solution (Sigma-Millipore, Waltham, MA, USA) and stored overnight at 4° C. Tissue samples were then removed from solution and stored at −80° C. Total RNA was isolated using the RNeasy Mini Kit (Qiagen, Germantown, MD, USA) according to manufacturer guidelines. 500 ng of each sample was sequenced on an Illumina HiSeq 4000 using 9 PCR cycles by GENEWIZ (South Plainfield, NJ, USA). Raw RNA-Seq data files were transferred to the Brown University computing cluster via sFTP and aligned to the human genome build 38 using STAR 2.7.3a (see, e.g., ref. 25). While sequencing was performed in two batches, the alignment was performed on all samples simultaneously using the same settings. To quantify any batch effect in our aligned data, we utilized MBatch 1.7.1 (see, e.g., ref. 26) to generate a Dispersion Separability Criterion (DSC) value for the pre-treatment (0 hr) time points from the two batches, resulting in a DSC of 0.197 (p=0.671). Due to this low batch effect severity score and insignificant p-value, we did not apply a batch correction to our data.

Protein Analysis: Perfusate collected at the indicated time points was centrifuged at 5000 g and the plasma collected and stored at −80° C. for later analysis. Enzyme-linked immunosorbent assays (ELISA) were performed for various proteins according to manufacturers' guidelines. A list of ELISA kits are provided in Table 2 below.

TABLE 2
Enzyme-linked immunosorbent assay (ELISA) kits

| Protein | Manufacturer^{a} | Product # |
|---|---|---|
| Tumor necrosis factor-alpha (TNFα) | Sigma-Millipore | RAB0476 |
| Interleukin-6 (IL-6) | Sigma-Millipore | RAB0306 |
| High mobility group box 1 (HMGB1) | Aviva Systems Biology | OKCD04074 |
| Interferon-gamma (IFNγ) | Abcam | ab174443 |
| 8-hydroxy 2-deoxy guanosine (8OHdG) | Abcam | ab201734 |
| Hepatic growth factor (HGF) | Abcam | ab100534 |
| Cathepsin D | Abcam | ab213470 |
| Cleaved cytokeratin 18 | Abcam | ab254515 |
| Caspase 3/7 | Promega | G8091 |
| Cell-free DNA | Sigma-Millipore | 11774425001 |
| Interleukin-8 (IL-8) | Abcam | ab214030 |
| Interleukin-1 Beta (IL-1B) | Sigma-Millipore | RAB0273 |

^{a}Abcam (Waltham, MA, USA), Aviva Systems Biology (San Diego, CA, USA), Sigma-Millipore (Waltham, MA, USA).

Sequential wedge biopsies from the right lobe of each liver were performed at indicated intervals, flash frozen in liquid nitrogen, and stored at −80° C. Tissue samples (20 mg) were homogenized and Western immunoblots performed as previously described (see, e.g., ref. 16). A full list of antibodies used is provided below in Table 3.

TABLE 3
Western immunoblot antibodies

| Antibody | Manufacturer^{a} | Product # |
|---|---|---|
| eIF2α | Santa Cruz Biotechnology | sc-11386 |
| Phospho-eIF2α | Cell Signaling Technology | 9721 |
| p70 S6 Kinase | Cell Signaling Technology | 2708 |
| Phospho-p70 S6 Kinase | Cell Signaling Technology | 9234 |
| (Thr389) | | |
| MAP Kinase 1/2 | Sigma-Millipore | 06-182 |
| Phospho-p44/42 MAPK | Cell Signaling Technology | 4370 |
| (Erk1/2) | | |
| (Thr202/Tyr204) | | |
| LC3B | Cell Signaling Technology | 2775 |
| β-actin | Santa Cruz Biotechnology | sc-47778 |
| GAPDH | Cell Signaling Technology | 5174 |
| P62 | Cell Signaling Technology | 39749 |
| Beclin | Cell Signaling Technology | 3738 |
| MLKL | Cell Signaling Technology | 14993 |
| Phospho-MLKL | Cell Signaling Technology | 91689 |

^{a}Cell Signaling Technology (Danvers, MA, USA), Santa Cruz Biotechnology (Dallas, TX, USA), Sigma-Millipore (Waltham, MA, USA).

To compare target protein expression, densitometry quantification was conducted. Blots for β-actin and GAPDH are shown in FIG. 17. Both proteins varied across samples and the changes were not consistent between the 2 proteins, with the variation representing the biologic variability in the human liver. As a result, target relative protein was expressed as a ratio of active to inactive protein intensity (or phosphorylated protein to total protein intensity).

Histology and immunohistochemistry: Core needle biopsies taken from the right liver lobe at indicated intervals were fixed in formalin and embedded in paraffin. Hematoxylin and eosin (H&E) stains were performed on all biopsies to assess the degree of necrosis, inflammatory cell infiltrate, and reperfusion injury using a validated scoring system (see, e.g., ref. 17). Immunohistochemistry for LC3 was performed as previously described (see, e.g., ref. 3).

In brief, immunohistochemistry was performed using antibodies directed toward LC3B (Product No. NB100-2220, Novus Biologicals, Littleton, CO, USA). Paraffin sections (6 μm) were deparaffinized with xylene and rehydrated with graded ethanol. Antigen retrieval was performed by sub-boiling in 1×-diluted Dako Target Retrieval Solution for 10 min (DakoCytomation, Inc., Carpinteria, CA). Slides were then quenched in 3% H₂O₂ and blocked in 2.5% Normal Horse Serum (Vector Labs, Burlingame, CA) before overnight incubation in primary antibody (1:200 dilution) at 4° C. Slides were incubated with a horseradish-peroxidase conjugated secondary rabbit antibody (Vector Laboratories) for 1 hr prior to staining with DAB (Vector Laboratories). Slides were counterstained with hematoxylin. Omission of the primary antibody served as a negative control.

Statistical analysis: Categorical data are presented as median with interquartile range (IQR) and frequency data as percentages. For statistical tests not related to RNA sequencing, the Kruskal-Wallis test was used to compare multiple groups. The Wilcoxon rank-sum test (Mann-Whitney U) and Fisher's exact test were used for two-group comparisons. A two-way analysis of variance (ANOVA) was used for comparisons between groups with repeated measures over time. The threshold for statistical significance was set at <0.05. Analyses were conducted using GraphPad Prism 8 (San Diego, CA, USA) and Stata 15 (College Station, TX, USA).

In brief, raw read counts were normalized using the Trimmed Mean of M method following removal of low-count genes (fewer than 10 reads in the smallest library). Differential gene expression analysis was conducted in R (see, e.g., ref. 27) using edgeR (see, e.g., ref. 28). The significance cutoff for differential gene expression was set to a Benjamini-Hochberg false-discovery rate (FDR or q-value)<0.05. Canonical pathway and upstream regulator enrichment analysis was generated through Ingenuity Pathway Analysis (IPA, Qiagen) (see, e.g., ref. 29). IPA categories were considered significant when the P value was below the P values obtained from 5 similarly sized sets of randomly selected genes with a fold-change in expression ≤1 (see, e.g., ref. 30). In this study, the threshold for significance was P<10E-7 for canonical pathways and P<10E-14 for upstream regulators.

Principal component analysis (PCA), volcano plots, Venn diagrams, and heatmaps were created using the following R packages: ggplot2 (2D PCA), plot3D/plot3Drgl (3D PCA), EnhancedVolcano (volcano plots), VennDiagram (Venn diagrams), and heatmaply (heatmaps).

Gene ontology (GO) enrichment analysis was performed using the R package GOseq (see, e.g., ref. 31). A Benjamini-Hochberg FDR adjusted p-value of <0.05 was used for determining significant GO term enrichment. The genes with the highest amount of variance explained by principal component 1, 2, or 3 cumulatively totaling to 10% of the total variance explained by the specified PC were further analyzed. The proportion of a gene's variance explained by a PC was calculated using the squared loading values generated by the prcomp function in R. GO term analysis was performed on these gene subsets and the significantly enriched GO terms in the biological processes category for each PC were summarized in 75% similarity networks generated in Cytoscape (see, e.g., ref. 32).

### Example 3: Quantifying the Effects of Anti-Apoptotic/Pro-Survival Drug Cocktails in Response to (Cryo)-Injury

Studies were conducted to determine the effect of a drug cocktail on cells during static cold storage (SCS) at 4° C. The tested cocktail included a non-limiting apoptosis inhibitor, emricasan. In particular, the CEPT cocktail included the following components: chroman 1, a rho-kinase (ROCK) inhibitor; emricasan, a pan-caspase inhibitor, also known as IDN-6556; polyamines, which contains polycations; and trans-ISRIB, an integrated stress-response (ISR) inhibitor.

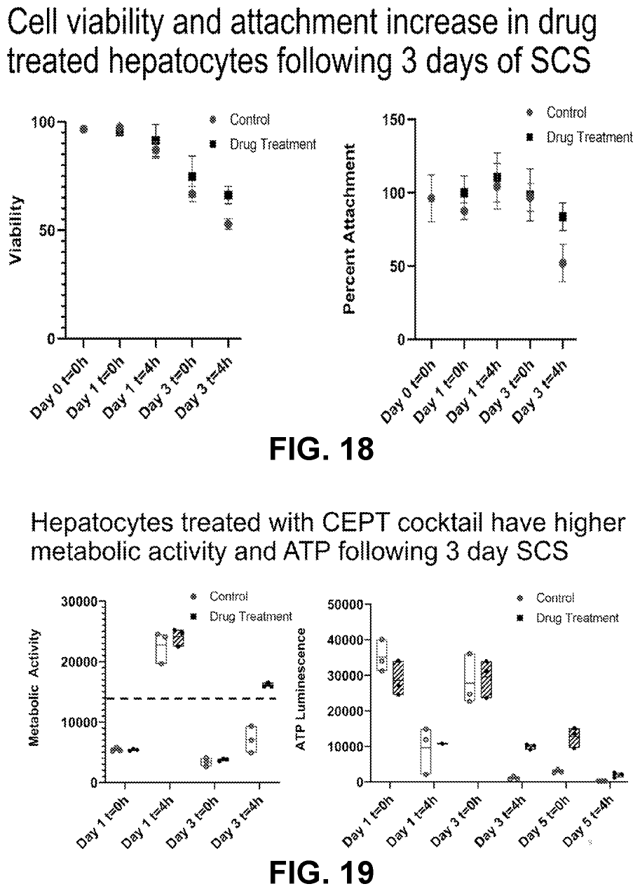

The effect of the cocktail on cell viability, cytotoxicity, and apoptosis was evaluated. FIG. 18 shows that cell viability and attachment increased in drug treated hepatocytes following three days of SCS. FIG. 19 shows that hepatocytes treated with a CEPT cocktail have higher metabolic activity and higher ATP levels following three days of SCS, as compared to control.

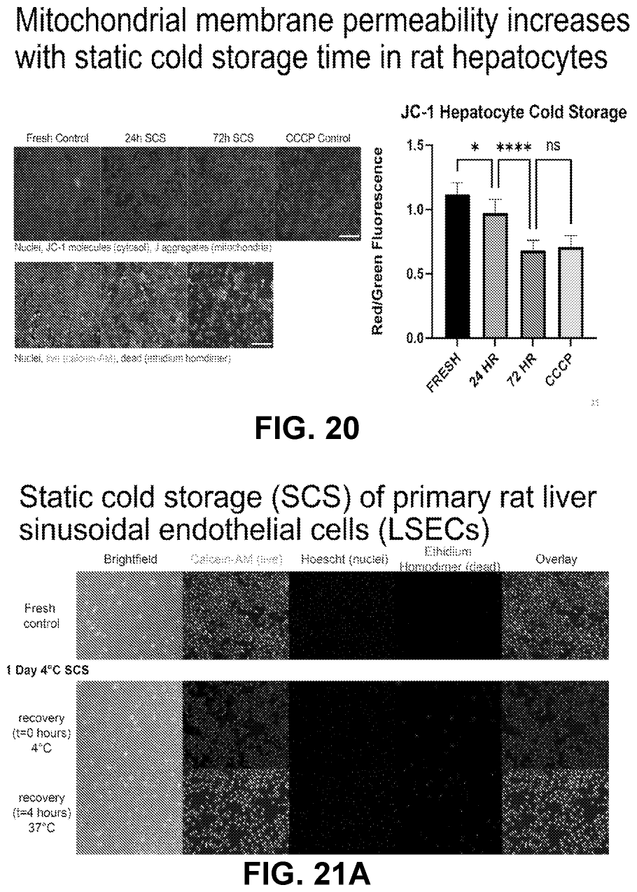

Various types of assays may be employed to quantify the effects of a drug or a drug cocktail in response to cryoinjury. In one instance, a mitochondrial membrane assay may be employed. In brief, JC-1 dye is a lipophilic, cationic dye (naturally exhibiting green fluorescence) that is able to enter into the mitochondria, where it accumulates and (in a concentration-dependent manner) starts forming reversible complexes called J aggregates. Differently, from JC-1 molecules, these J aggregates exhibit excitation and emission in the red spectrum (maximum at ˜590 nm) instead of green. Thus, in healthy cells with a normal mitochondrial membrane potential (ΔΨM), the JC-1 dye enters and accumulates in the energized and negatively charged mitochondria and spontaneously forms red fluorescent J-aggregates. By contrast, in unhealthy or apoptotic cells the JC-1 dye also enters the mitochondria but to a lesser degree since the inside of the mitochondria is less negative because of increased membrane permeability and consequent loss of electrochemical potential. Under this condition, JC-1 does not reach a sufficient concentration to trigger the formation of J aggregates thus retaining its original green fluorescence. FIG. 20 shows that mitochondrial membrane permeability increased with SCS time in rat hepatocytes, indicative of apoptosis as a result of cold storage in the cells. Also shown in FIG. 20 are data for CCCP/FCCP, which is a lipid-soluble weak acid and a potent mitochondrial uncoupling agent that increases the proton permeability across the mitochondrial inner membrane, thus dissipating the transmembrane potential and depolarizing the mitochondria.

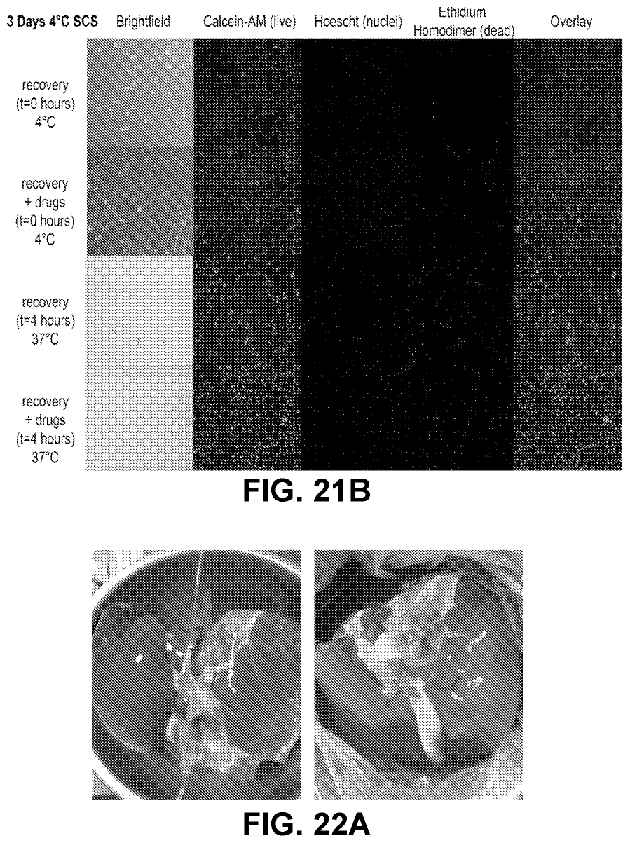

FIG. 21A-21B show increasing amount of cell death during 3 days cold storage, and that the use of apoptosis inhibitor cocktail qualitatively increases viability of cells after 3 days of storage.

Such studies can be conducted to understand the effect of apoptosis inhibitors, such as a caspase inhibitor, on maintaining native permeability in the mitochondrial membrane. Other assays may be employed, such as caspase apoptosis assays or other viability assays. Furthermore, other cell types from any organ may be tested, such as hepatic stellate cells (HSCs), Kupffer cells (KCs), liver sinusoidal endothelial cells (LSECs), glomerular endothelial cells, and the like.

### Example 4: Activation of Autophagy During Normothermic Machine Perfusion of Discarded Livers is Associated with Improved Hepatocellular Function

Abstract: Liver transplantation is hampered by a severe shortage of donor organs. Normothermic machine perfusion (NMP) of donor livers allows dynamic preservation in addition to viability assessment before transplantation. Little is known about the injury and repair mechanisms induced during NMP. To investigate these mechanisms, we examined gene and protein expression changes in a cohort of discarded human livers, stratified by hepatocellular function, during NMP. Six human livers acquired through donation after circulatory death (DCD) underwent 12 h of NMP. Of the six livers, three met predefined criteria for adequate hepatocellular function. We applied transcriptomic profiling and protein analysis to evaluate temporal changes in gene expression during NMP between functional and nonfunctional livers. Principal component analysis segregated the two groups and distinguished the various perfusion time points. Transcriptomic analysis of biopsies from functional livers indicated robust activation of innate immunity after 3 h of NMP followed by enrichment of prorepair and prosurvival mechanisms. Nonfunctional livers demonstrated delayed and persistent enrichment of markers of innate immunity. Functional livers demonstrated effective induction of autophagy, a cellular repair and homeostasis pathway, in contrast to nonfunctional livers.

In particular, we demonstrate that ischemia-reperfusion injury (IRI) occurs in all livers during NMP, though there are notable differences in gene expression between functional and nonfunctional livers. We further demonstrate that activation of the liver's repair and homeostasis mechanisms through autophagy plays a vital role in the graft's response to injury and may impact liver function. These findings indicate that liver autophagy might be a key therapeutic target for rehabilitating the function of severely injured or untransplantable livers. Overall, NMP of discarded DCD human livers results in innate immune-mediated injury, while also activating autophagy, a presumed mechanism for support of cellular repair. More pronounced activation of autophagy was seen in livers that demonstrated adequate hepatocellular function.

Introduction: Liver transplantation (LT) remains the only effective treatment for end-stage liver disease. Despite major progress in the safety and efficacy of LT, access to this life-saving procedure is limited because of a substantial organ shortage that results in significant waitlist mortality. Further compounding the shortage is the high discard rate of procured organs stemming from the increased risk of graft loss and dysfunction in livers transplanted from extended-criteria donors (see, e.g., ref. 1). Livers from donation after circulatory death (DCD) face increased scrutiny due to the additional warm ischemic time, resulting in up to 30% of recovered DCD grafts being turned down for transplant in the United States (see, e.g., ref. 2).

Machine perfusion technology has emerged in the past decade as an effective method of improving graft preservation and decreasing discard rates (see, e.g., ref. 3-5). Normothermic machine perfusion (NMP) allows real-time evaluation of liver function and viability assessment, providing additional objective data to the transplant surgeon before committing a recipient to LT. However, it is not clear whether NMP actually improves graft quality over immediate implantation or is just a superior preservation modality that happens to provide functional metrics. Recent work by Jassem et al. (see, e.g., ref. 6) compared transcriptional changes in the immediate postimplantation period of LT among donation after brain death (DBD) livers preserved by NMP versus static cold storage. Livers preserved with NMP demonstrated more robust enrichment of repair and regenerative pathways after reperfusion in situ. However, there was no examination of pathway activation during preservation (see, e.g., ref. 7). Furthermore, all the livers studied were determined to be functional and transplantable after preservation. Thus, these studies could not determine whether the postreperfusion changes that were observed represented functionally significant changes in the status of the donor tissue.

Despite growing adoption of NMP in the clinical setting, knowledge of the physiological changes that occur during ex situ perfusion is still limited. Here, we aimed to investigate the early-phase injury and repair mechanisms that might occur during normothermic machine perfusion of discarded DCD human livers, comparing grafts with and without adequate hepatocellular function, thereby providing a functional context for our work. Understanding the mechanistic differences between the patterns of injury and repair in these grafts will help in developing potential therapeutics for rehabilitation of currently discarded livers (see, e.g., ref. 3, 8), thereby increasing the pool of transplantable organs.

Assessment of Hepatocellular Function during Normothermic Perfusion: Donor demographics for the six study livers are provided in Table 4 below. See Example 5 herein for additional details regarding non-limiting materials and methods)

TABLE 4
Detailed characteristics of discarded grafts undergoing
normothermic machine perfusion

| | Adequate | | | Inadequate | | | |
|---|---|---|---|---|---|---|---|
| | Hepatocellular | | | Hepatocellular | | | |
| | Function | | | Function | | | |
| | (n = 3 subjects) | | | (n = 3 subjects) | | | |
| Liver no. | F1 | F2 | F3 | N1 | N2 | N3 | P Value |
| Total WIT, min | 28 | 24 | 33 | 23 | 26 | 70 | 0.83 |
| Functional WIT, min | 8 | 8 | 12 | 11 | 9 | 11 | 0.50 |
| CIT, h | 11.6 | 5 | 7.6 | 6 | 13.1 | 6.1 | 0.83 |
| Donor age, yr | 60 | 58 | 59 | 55 | 21 | 56 | 0.0495 |
| Sex | F | M | M | F | M | F | 0.50 |
| BMI, kg/m² | 24.5 | 28.3 | 27.3 | 24.6 | 27.4 | 44 | 0.51 |
| Macrosteatosis, % | 0 | 5 | 2 | 0 | 0 | 0 | 0.12 |
| Microsteatosis, % | 10 | 0 | 0 | 0 | 0 | 0 | 0.32 |
| AST, U/L | 39 | 41 | 57 | 24 | 82 | 138 | 0.51 |
| ALT, U/L | 27 | 22 | 38 | 11 | 97 | 161 | 0.51 |
| Total bilirubin, mg/dL | 0.6 | 0.9 | 0.4 | 0.2 | 0.4 | 0.4 | 0.10 |
| ALP, U/L | 95 | 36 | 31 | 94 | 234 | 494 | 0.13 |

^{a}Macrosteatosis defined as large droplet steatosis with nuclear displacement, provided as % of entire tissue field evaluated. Microsteatosis defined as small droplet steatosis without nuclear displacement, provided as % of entire tissue field evaluated.
Aspartate aminotransferase (AST), alanine aminotransferase (ALT), total bilirubin, and alkaline phosphatase (ALP) levels indicate last available values before procurement.
Group comparisons made using the Wilcoxon rank-sum (Mann-Whitney U) or Fisher's exact test, where appropriate.
BMI, body mass index (kg/m²);
CIT, cold ischemic time in minutes;
F, female;
M, male;
WIT, warm ischemic time in minutes.
Boldface value is a significant P value.

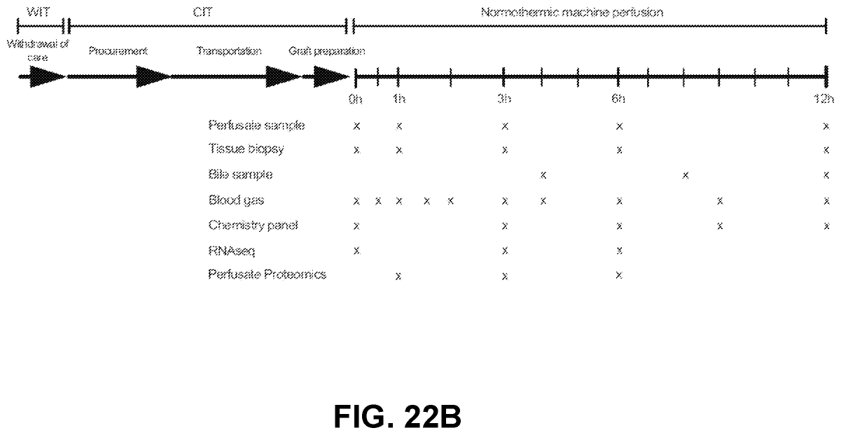

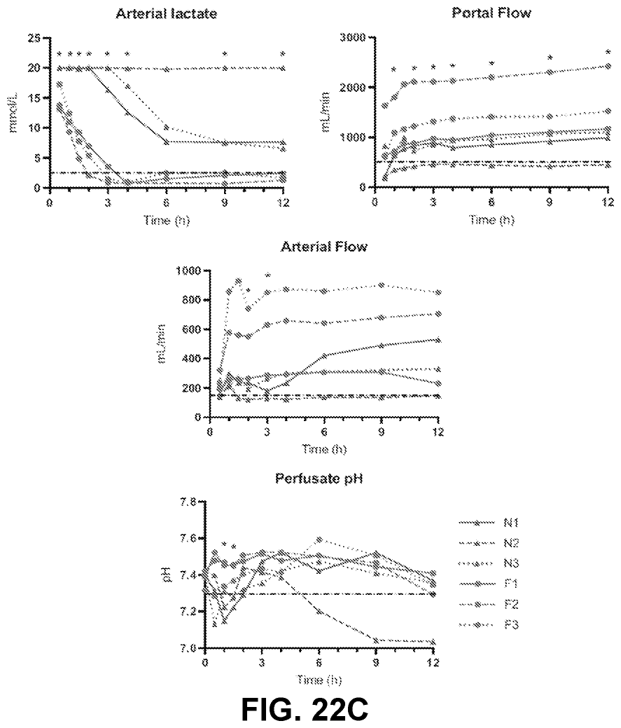

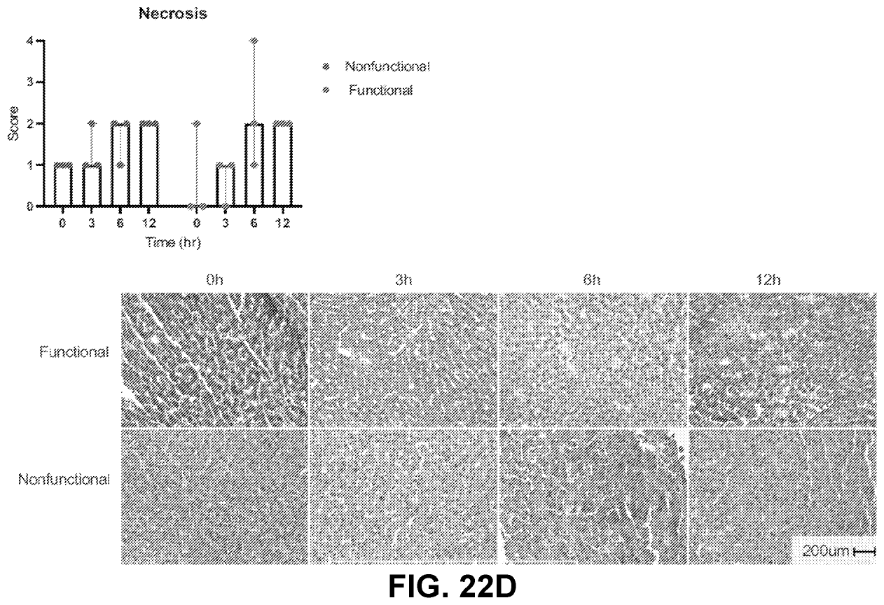

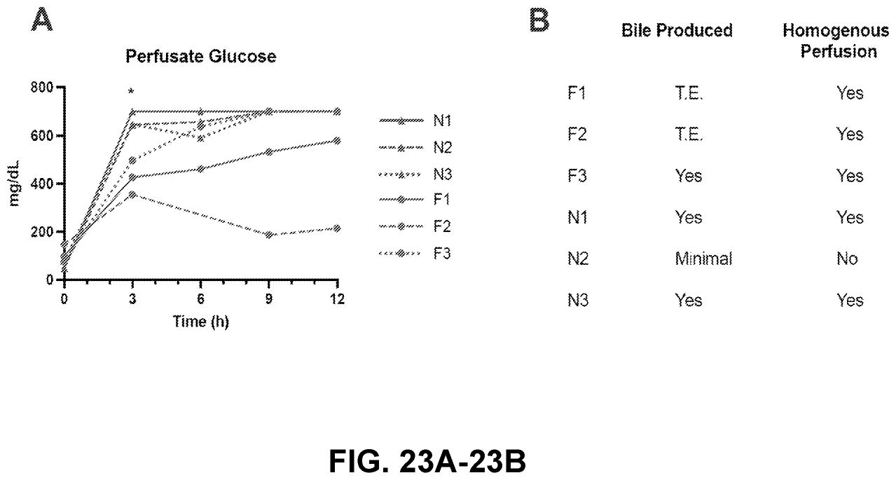

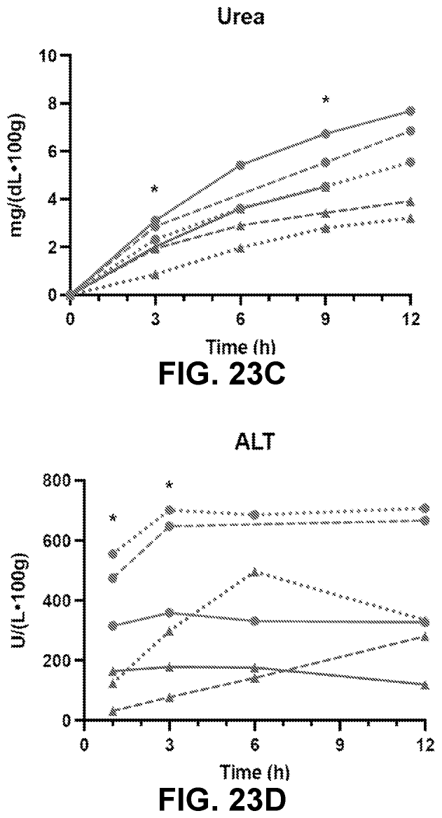

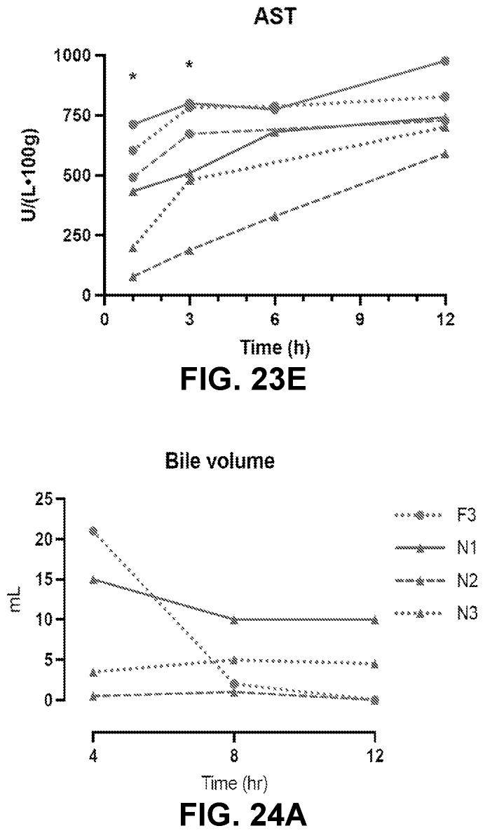

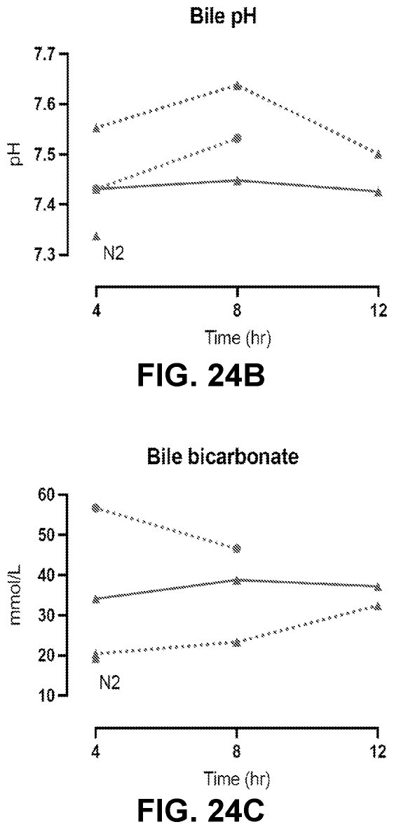

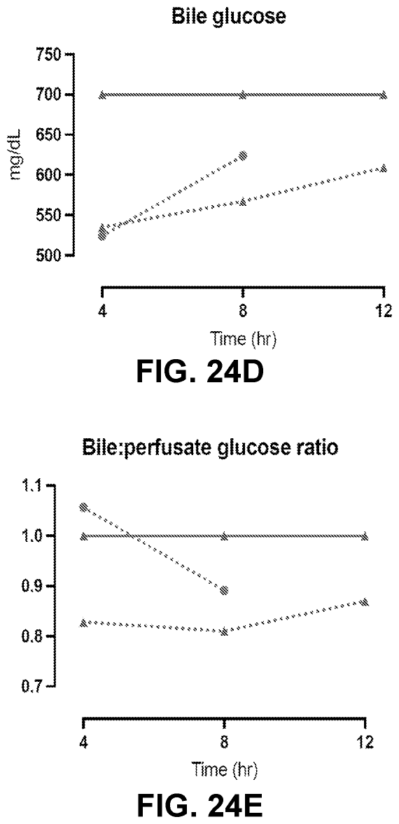

Machine perfusion criteria used to determine whether each liver demonstrated adequate (functional) or inadequate (nonfunctional) hepatocellular function are shown in FIG. 22C and FIG. 23. Functional livers (F1-F3) demonstrated evidence of increased glucose metabolism and increased urea synthesis over time (FIG. 23). Although some nonfunctional livers (N1-N3) were able to meet minor criteria, all failed to meet the perfusate lactate threshold. Aspartate aminotransferase (AST) and alanine aminotransferase (ALT) levels (FIG. 23) were higher for the functional livers than for the nonfunctional livers at 1 and 3 h of perfusion, though levels plateaued thereafter. In comparison, nonfunctional livers demonstrated AST and ALT levels that increased but were, in general, lower than the levels seen with the functional livers. Bile volume and cholangiocellular functional metrics are presented in FIG. 24, though statistical comparisons were limited by technical errors with bile collection in two functional livers. H&E staining demonstrated an increase in percent necrosis after initiation of NMP in both groups, with all livers demonstrating up to 30% histologic necrosis by 12 h of perfusion (FIG. 22D).

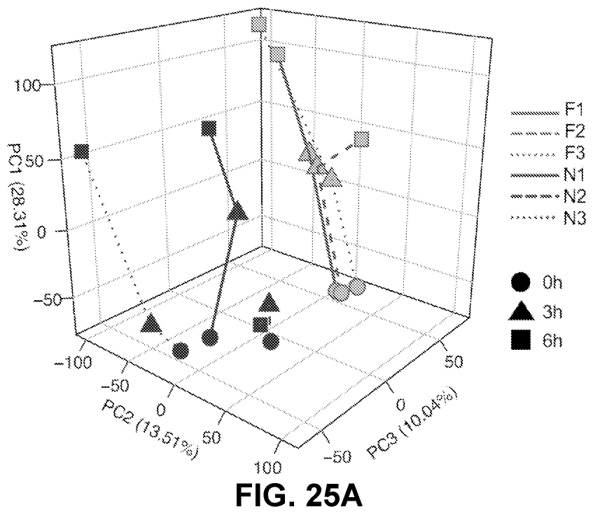

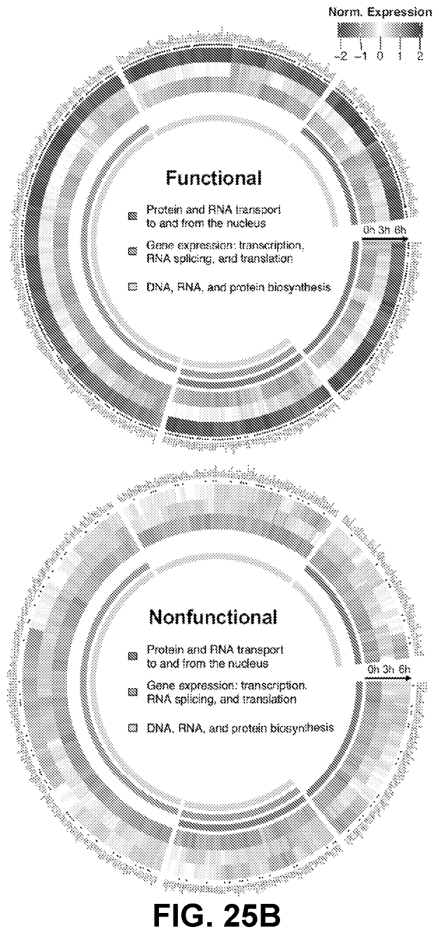

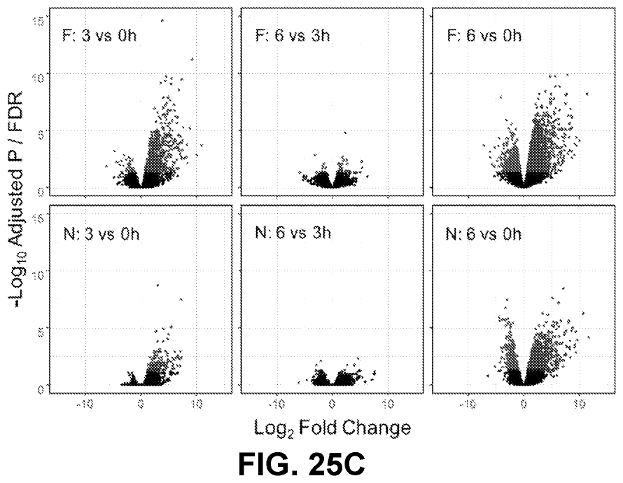

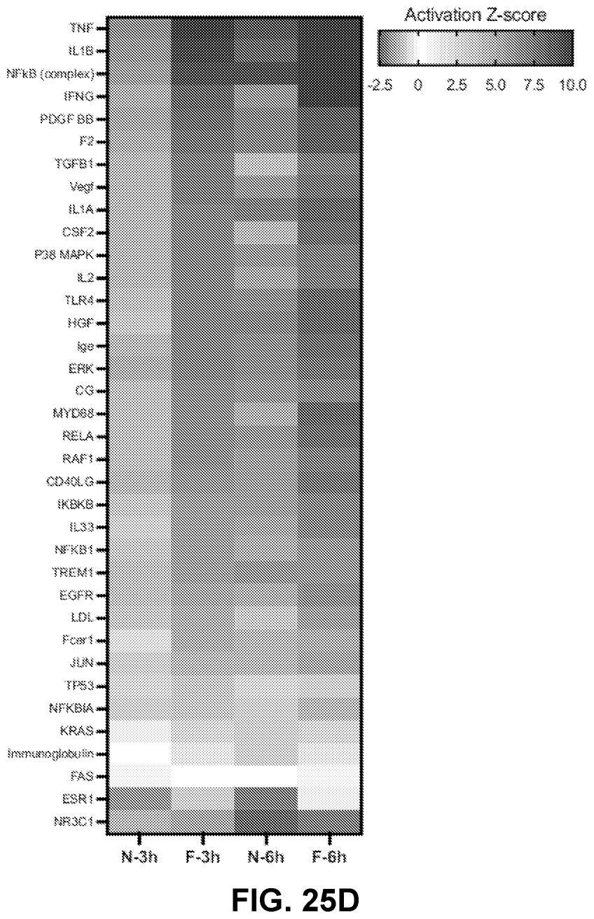

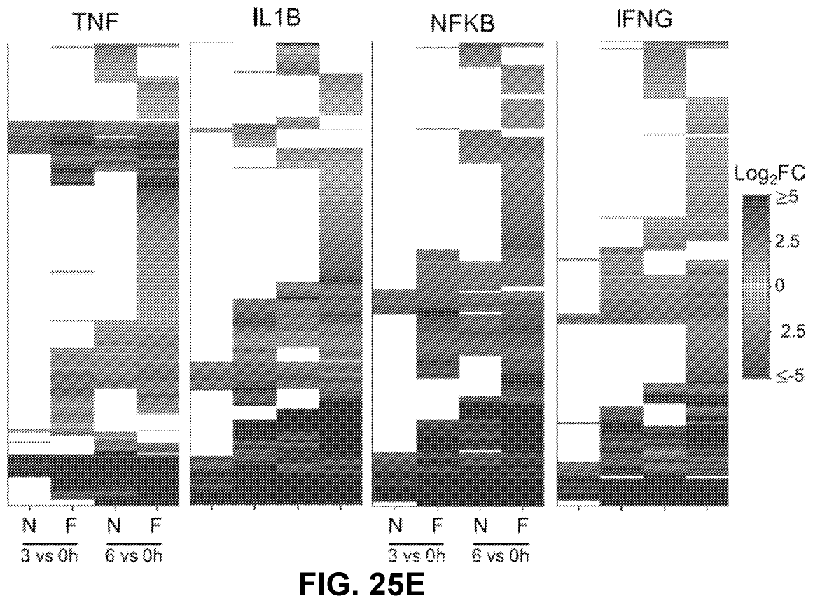

Principal Component Analysis of the Transcriptomic Analyses Discriminates Functional from Nonfunctional Livers: Principal component analysis (PCA) demonstrated distinct changes in gene expression at 0 h (preperfusion), 3 h, and 6 h of NMP among individual livers. The preperfusion gene expression profiles clustered together by hepatocellular function then diverged further once perfusion was initiated. Functional livers continued to cluster together after 3 and 6 h of NMP, whereas the nonfunctional livers demonstrated dissimilar profiles with respect to one another (FIG. 25A). Principal component 1 (PC1), which accounted for 28.3% of the variation in differentially expressed genes (DEG), captured the time-dependent changes in gene expression. The functional livers demonstrated a consistent transcriptional shift at each 3-h interval compared with lower magnitude changes in the nonfunctional livers. Analysis of the top 10% of genes contributing to PCl revealed enrichment of gene ontology (GO) terms related to gene transcription and protein synthesis. Detailed examination of the temporal response of these genes revealed a marked increase in expression by 6 h of perfusion in the functional compared with nonfunctional livers (FIG. 25B).

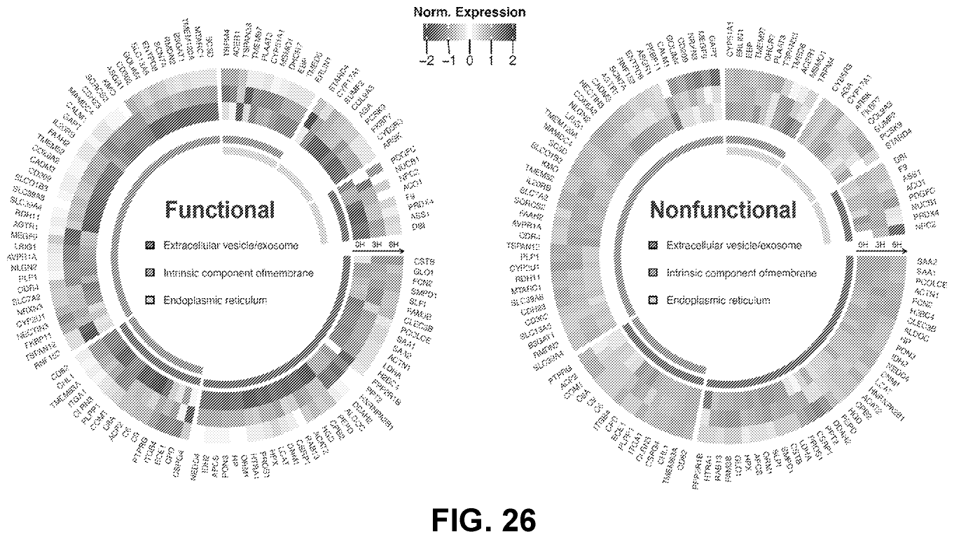

Principal component 2 did not distinguish any notable cellular processes despite accounting for 13.5% of the variation in DEG. Conversely, principal component 3 (PC3), representing 10.0% of the variation, was able to effectively discriminate functional from nonfunctional livers. The top 10% of genes contributing to PC3 were involved in GO cellular components related to extracellular vesicles and exosomes, endoplasmic reticulum, and membrane components, though none of the individual genes met the FDR cutoff for significance (FIG. 26).

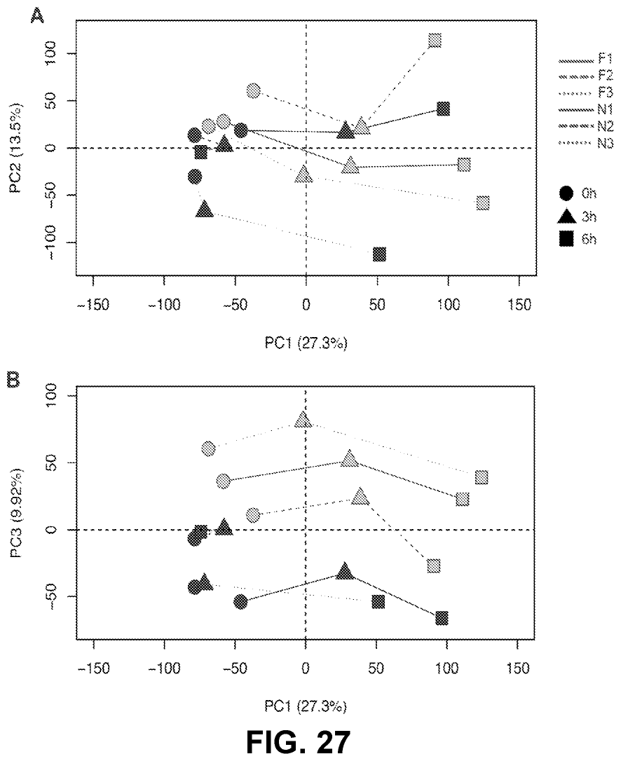

Transcription shifts captured by principal components were remarkably reflective of each liver's hepatocellular functional profile. For example, the nominal transcriptional shift in nonfunctional livers after initiation of NMP appeared to correspond with a delay in lactate clearance and perfusate pH stability in the first several hours of NMP. Furthermore, liver N2 demonstrated minimal changes in principal components compared with other livers, consistent with that liver's poor functional profile (lowest vascular flows, no evidence of lactate clearance, persistent metabolic acidosis, rising AST/ALT). Interestingly, liver N1 demonstrated changes over time most similar to the functional livers based on PCl and PC2 but diverged with the addition of PC3 (FIG. 27).

Overview of Differential Gene Expression: Although individual livers clustered according to function with PCA, this was less apparent with comparison of time-static gene sets between groups. Of the ˜14,000 transcripts sequenced, only two genes (ARL16, NLGN2) were significantly different (FDR <0.05) between functional and nonfunctional livers at the preperfusion time point. No genes were significant at 3 h. In contrast, 53 genes were differentially expressed at 6 h of perfusion (all Data Sets are available, see ref. no. 36). However, Ingenuity Pathway Analysis (IPA) did not reveal significant enrichment of any canonical pathways (CPs) or upstream regulators (URs) related to this gene set.

Analyses based on the temporal changes in gene expression during NMP relative to the preperfusion baseline were more informative of the physiological differences between functional and nonfunctional livers during perfusion. Volcano plots showed that functional livers responded to NMP at 3 h with a robust and statistically significant upregulation of genes (FIG. 25C). This was followed by both upregulation and downregulation of numerous genes at 6 h. In contrast, nonfunctional livers upregulated expression of only a handful of genes at 3 h. This was followed with a greater degree of change in gene expression (both upregulation and downregulation) at 6 h.

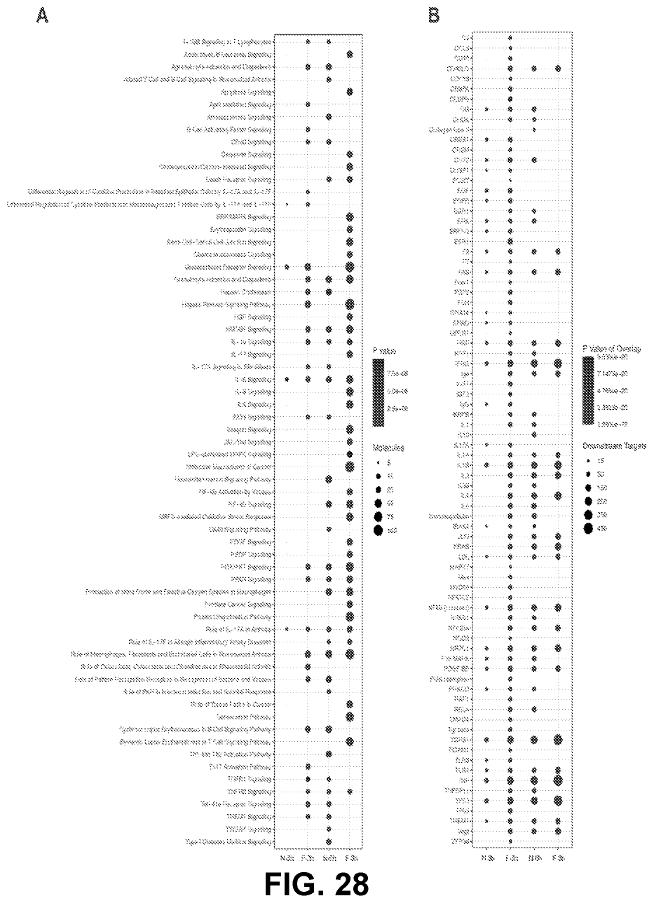

Using IPA, we identified canonical pathways and URs associated with the temporal differential gene expression unique to the two experimental groups. In functional livers, over 25 pathways related to inflammation and innate immunity were enriched at 3 h, whereas nonfunctional livers only had four significant pathways and many fewer genes in each pathway (FIG. 28). By 6 h, there was a shift in significant pathways to those associated with survival, protein ubiquitination, and growth in functional livers. The significant pathways in the nonfunctional livers were similar to those seen in the functional livers at 3 h of perfusion. The URs displayed similar temporal shifts (FIG. 28). Activation Z-scores of significant URs related to innate immunity were higher in functional compared with nonfunctional livers after 3 h of NMP, indicating more marked induction of downstream gene targets in the early perfusion phase in the functional livers. By 6 h of NMP, active URs in the nonfunctional livers more closely resembled those of the functional livers (FIG. 25D). Despite this, when the top four URs were examined for downstream signaling, the two groups differed greatly in activation of their gene targets (FIG. 25E). Results using CiiiDER (12) to identify enriched transcription factor binding sites in the promoter regions of the differentially expressed genes were very similar to those obtained using IPA (see, ref. no. 36).

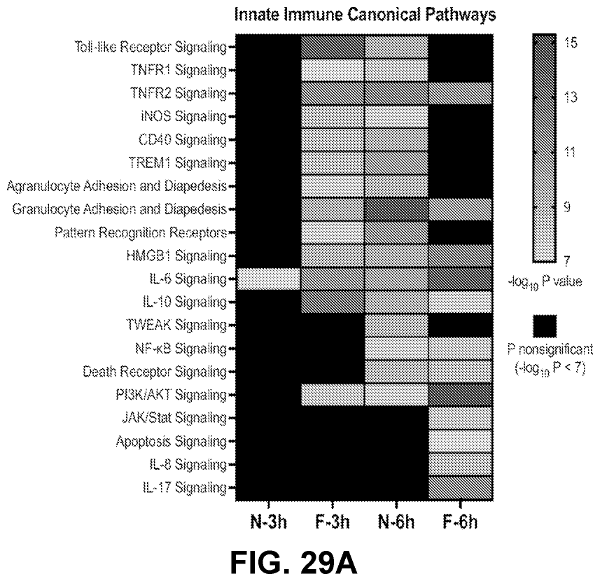

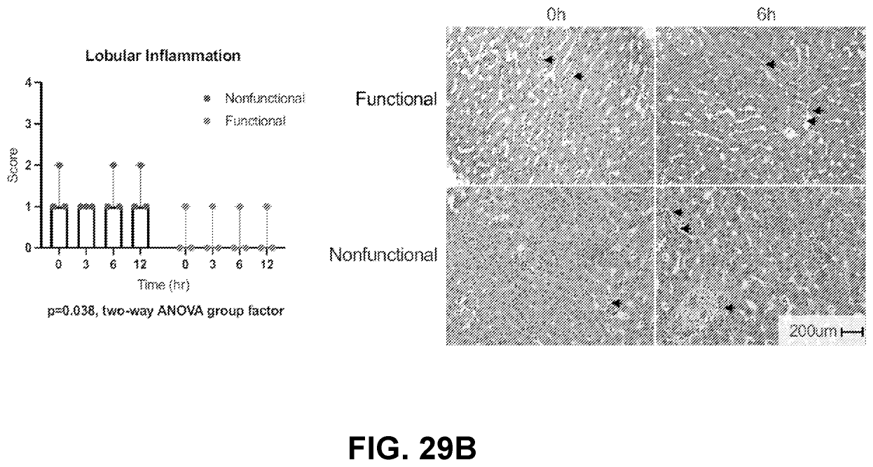

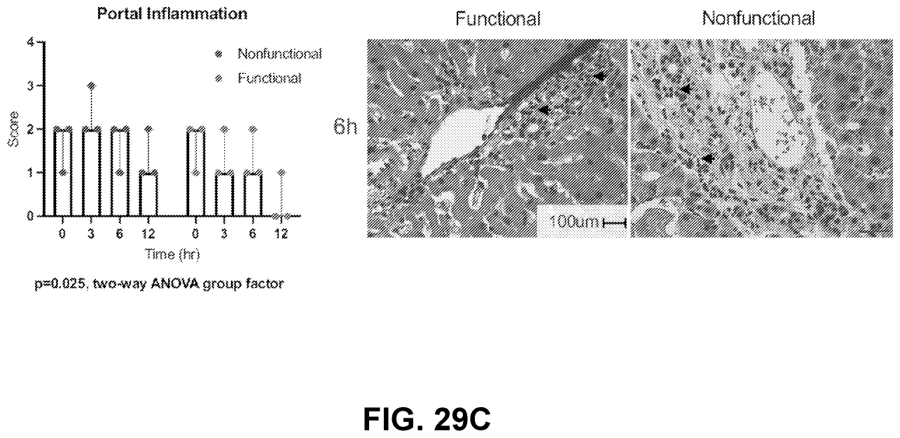

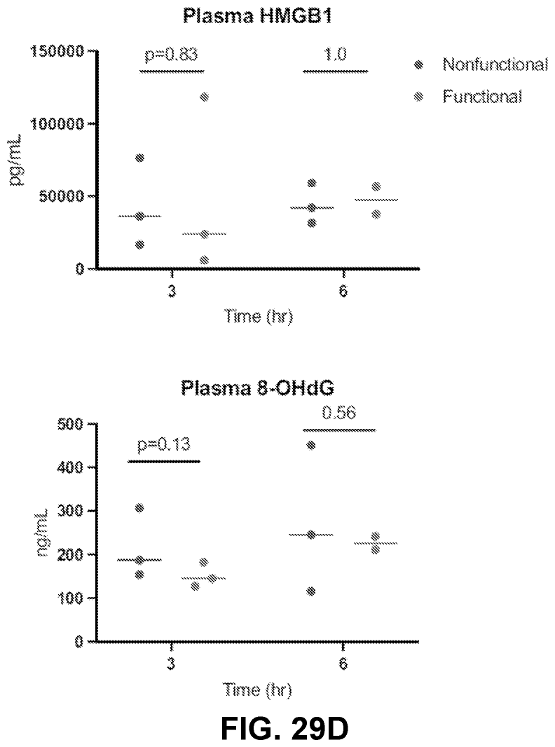

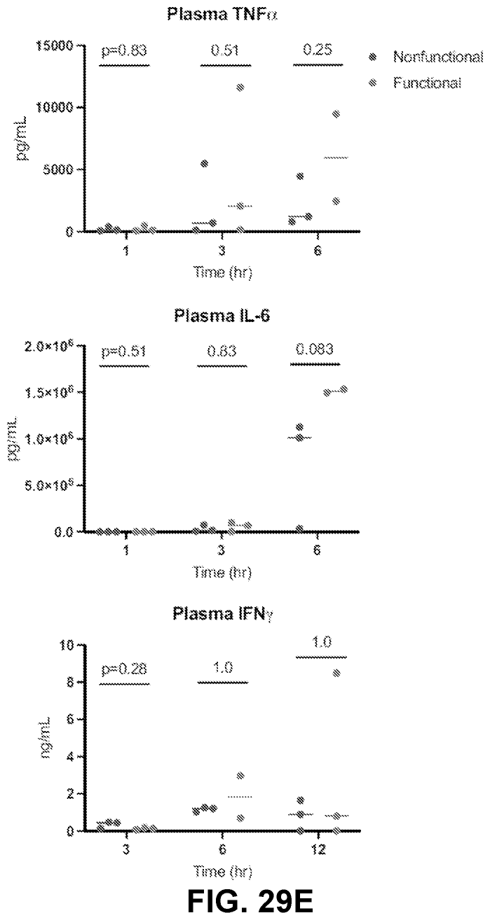

Ischemia-Reperfusion Injury and Innate Immune Activation: As noted earlier, the changes in gene expression that occurred during NMP suggested activation of innate immunity based on canonical pathways identified using pathway analysis (FIG. 29A). Functional livers demonstrated early enrichment of Toll-like receptor, high mobility group box 1, and interleukin-6 (IL-6) signaling pathways, among several others. Nonfunctional livers demonstrated activation of only the IL-6 canonical pathway after 3 h of NMP. However, after 6 h of perfusion, the nonfunctional livers displayed an expression profile that resembled that of the functional group at 3 h, whereas the functional group revealed pathway activation indicative of cell turnover and survival. These findings indicated that nonfunctional livers during NMP are distinguished by delayed onset of innate immune signaling. Examination of H&E stained liver biopsies supported these findings, with significantly more lobular and portal inflammatory cell infiltrates seen in nonfunctional livers (FIG. 29B-29C).

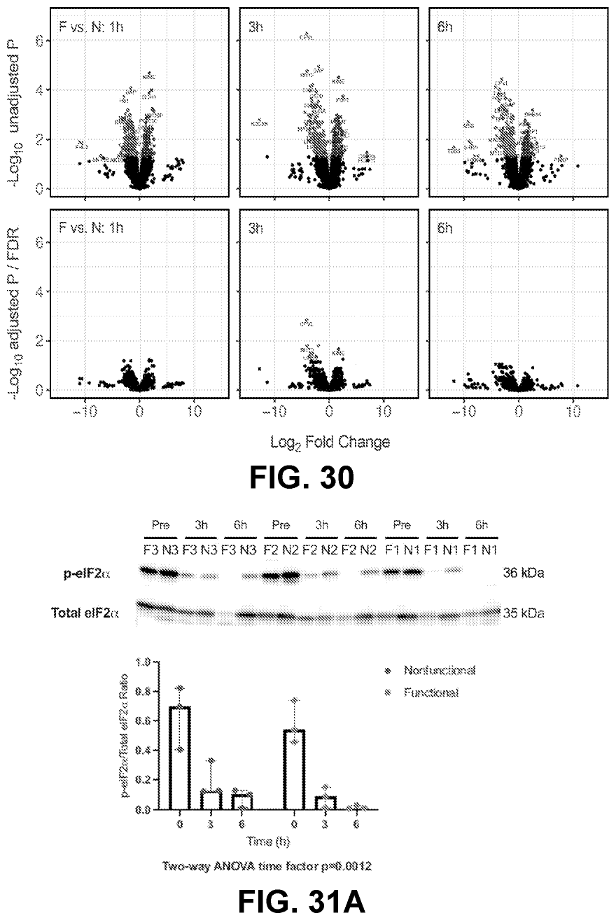

Given the findings related to immune activation, we analyzed damage-associated molecular patterns (DAMPs; FIG. 29D) and cytokines (FIG. 29E) in the circulating perfusate. Results were similar between groups at multiple time points when analyzed by ELISA. This was unexpected given the divergent expression profiles of the downstream gene targets noted earlier (FIG. 25E). To determine the presence of proteins differentiating functional from nonfunctional livers, we also performed untargeted plasma proteomics to further assess the DAMP and cytokine response to NMP. This revealed numerous enriched proteins varying between groups after 1, 3, and 6 h of perfusion, though only eight proteins remained statistically significant when a stringent FDR cutoff of <0.05 was applied (all at 3 h of NMP; FIG. 30). Within this subset, none was directly related to DAMP or cytokine signaling (see, ref. no. 36).

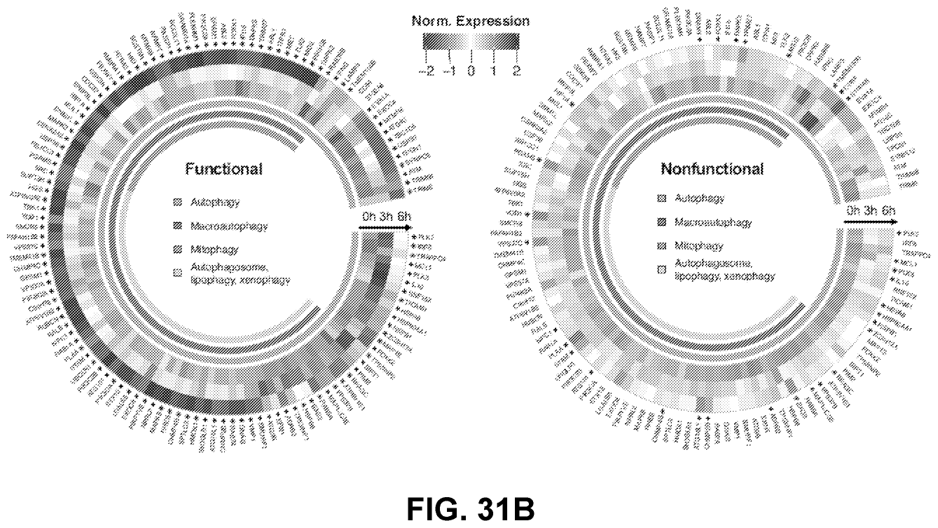

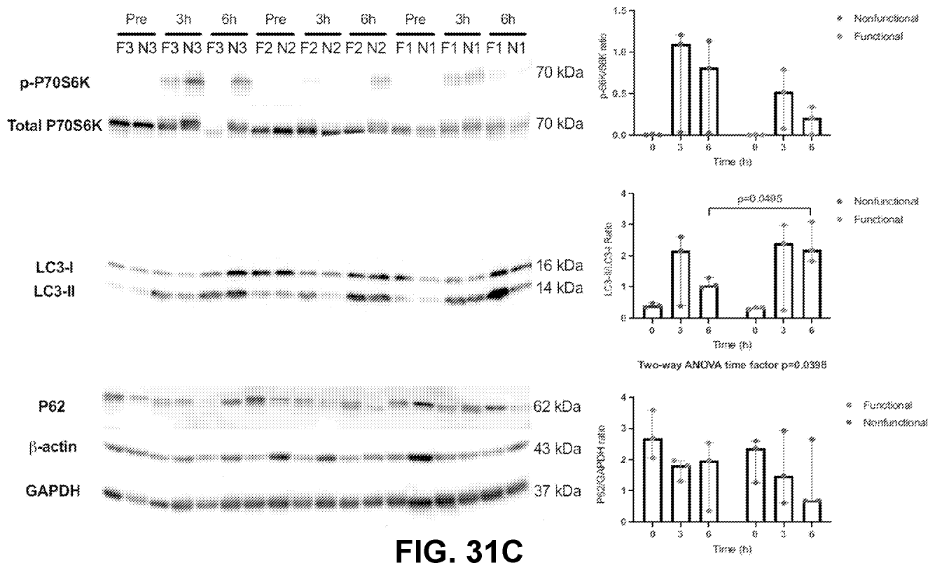

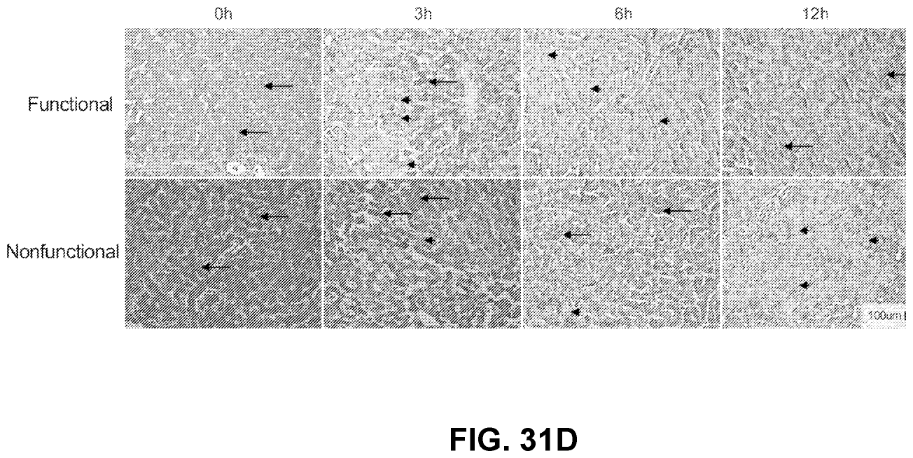

Role of the Unfolded Protein Response and Autophagy in Hepatocellular Function: Given the notable injury profile differences between functional and nonfunctional livers, we next examined repair responses to the accrued injuries. Accumulation of unfolded and misfolded proteins in the endoplasmic reticulum (ER) during ischemia activates the cellular stress mechanism referred to as the unfolded protein response (UPR) (see, e.g., ref. no. 13). Misfolded proteins bind to and activate protein kinase RNA-activated-like ER kinase (PERK) on the ER membrane, resulting in phosphorylation of eukaryotic initiation factor 2α (eIF2α). The phosphorylation of eIF2α leads to global inhibition of translation, initiation of antioxidant mechanisms, and induction of autophagy, the cell's repair and homeostasis mechanism (see, e.g., ref. 14). Analysis of eIF2α by Western immunoblot demonstrated increased phosphorylation ratios of eIF2α in preperfusion biopsies in both groups [functional=0.54 (IQR: 0.46-0.74) vs. nonfunctional=0.69 (0.40-0.82), P=0.83](FIG. 31A). After initiation of perfusion, both groups demonstrated a significant time-dependent decrease in phosphorylated eIF2α (two-way ANOVA time factor P=0.0012), with negligible activation in functional livers after 6 h of perfusion [0.0084 (0.0067-0.030)], potentially indicating resolution of ER stress. Qualitatively, there was a trend toward higher levels of eIF2α phosphorylation in the nonfunctional livers [0.10 (0.010-0.13), P=0.13], with liver N1 representing the outlier with the lowest ratio at 6 h. As noted previously, nonfunctional liver N1 was most transcriptionally similar to the functional group in PCA.

With respect to activation of autophagy, functional livers demonstrated a more robust response, with the majority of associated genes significantly increasing in expression after initiation of NMP compared with nonfunctional livers (FIG. 31B). The mechanistic Target of Rapamycin (mTOR) pathway plays a key role in regulating autophagy; active mTOR complex 1 inhibits autophagy through regulation of autophagy-related proteins and lysosome biogenesis (see, e.g., ref. 15). To assess mTOR complex 1 activation, we performed Western immunoblotting for phosphorylation of its downstream substrate p70 S6 kinase (p70S6K). Phospho-p70S6K was barely detectable before perfusion in both groups. In the functional livers, phosphorylation was increased at 3 h of perfusion and decreased by 6 h. In contrast, nonfunctional livers had high levels of phospho-p70S6K at both 3 and 6 h of perfusion (FIG. 31C). Comparisons between groups were nonsignificant due to an outlier, again nonfunctional liver N1. This liver had the lowest activated p70S6K protein ratio at 6 h (0.02) among the nonfunctional group despite having the highest ratio at 3 h (1.21), a pattern similar to the functional livers. In contrast, liver N2, the worst functioning nonfunctional liver, had a low ratio at 3 h (0.03) that greatly increased at 6 h (0.81). Despite not reaching statistical significance, the temporal pattern of p70S6K phosphorylation appeared consistent with sustained mTOR activation in nonfunctional livers.

Next, we investigated protein components involved in autophagic flux to determine if activation of autophagy was associated with liver function. The microtubule-associated protein 1 light chain 3 (LC3) family is vital to autophagosome formation. Posttranslational modification of LC3 generates LC3-I, which is subsequently conjugated with phosphatidylethanolamine to generate LC3-II, the active protein necessary for elongation of the autophagosome membrane. Both functional and nonfunctional livers demonstrated a time-dependent increase in LC3-II:LC3-I ratio (two-way ANOVA time factor P=0.0398), indicating autophagosome assembly in response to initiation of NMP (FIG. 31C). However, functional livers were found to have a significantly higher ratio after 6 h of NMP compared with nonfunctional livers [2.18 (1.82-3.09) vs. 1.05 (0.98-1.29), P=0.0495], consistent with the counterregulatory action of p70S6K. Determination of P62 content by Western blot did not demonstrate protein buildup in either group. We further confirmed the LC3 results using immunohistochemistry. Preperfusion biopsies demonstrated hepatocyte LC3 staining in a pan-cytosolic pattern in both groups. In functional livers, LC3 staining changed to demonstrate a granule-type staining pattern at 3 and 6 h of NMP, indicating autophagosome formation in the functional livers. By 12 h of NMP, functional livers again demonstrated pan-cytosolic LC3 staining. In contrast, nonfunctional livers displayed persistent pan-cytosolic and scant granule-type staining after 3 and 6 h, with more apparent granular staining by 12 h of NMP (FIG. 31D).

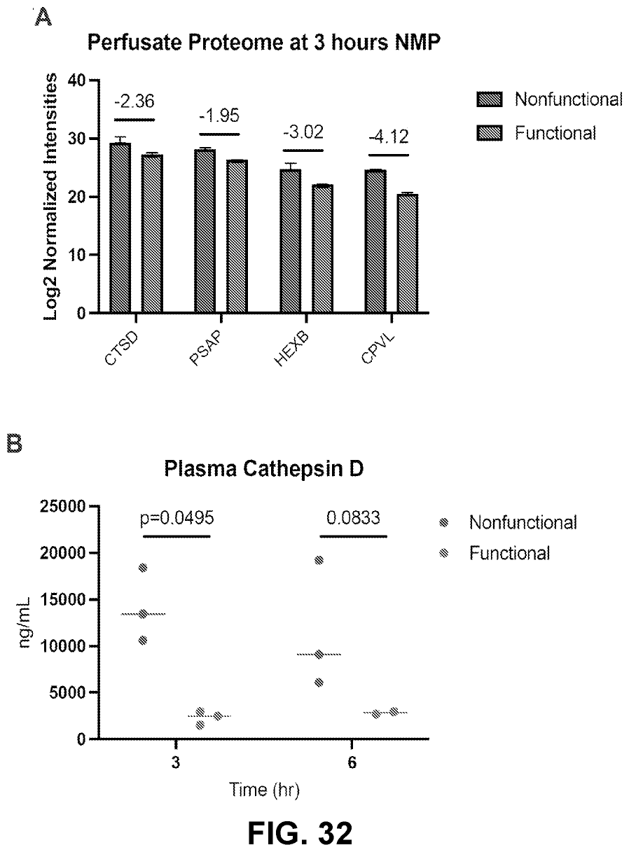

The final step in autophagy involves fusion of the autophagosome with lysosomes to form the autolysosome. Examination of the perfusate proteomic analysis results revealed that nonfunctional livers had significantly higher concentrations of the lysosomal components cathepsin D [log₂ fold change (log₂FC)=−2.36 compared with functional livers, FDR=0.043], prosaposin (log₂FC=−1.95, FDR=0.016), and hexosaminidase subunit-0 (log₂FC=−3.02, FDR=0.033) compared with functional livers at 3 h of NMP. A fourth protein, carboxypeptidase vitellogenic like, putatively involved in lysosomal function (see, e.g., ref. 16), was also enriched in nonfunctional liver perfusates (log₂FC=−4.12, FDR=0.0014) (FIG. 32). Confirmatory ELISA reinforced the proteomic analysis, demonstrating a fivefold greater abundance of cathepsin D in the perfusate of nonfunctional compared with functional livers [13,440 ng/mL (10,619-18,416) vs. 2,474 (1,514-2,946) at 3 h, P=0.0495; FIG. 32]. Numerous additional lysosomal components, including other cathepsins, demonstrated a trend toward enrichment in the perfusate of nonfunctional livers (log₂FC <−1 compared with functional livers) but failed to meet the FDR cutoff (see, ref. no. 36).

Prosurvival Signaling Is More Active in Functional Livers: Finally, we investigated the relevance of prosurvival signaling in response to reperfusion injury during NMP. Our transcriptome analysis revealed abundant prosurvival and early regenerative signals in functional relative to nonfunctional livers. Of note, several prosurvival pathways were concurrently involved in innate immune signaling, highlighting the bridge between injury and recovery. In functional livers, pathway analysis showed enrichment of components of the IL-6 and phosphatidylinositol-4,5-bisphosphate 3-kinase/AKT serine/threonine kinase (PI3K/AKT) canonical pathways by 3 h. Transcriptomic profiling and pathway analysis also showed activation by 6 h of downstream effectors: nuclear factor-x3 subunit (NF-κB), mitogen-activated protein kinase (ERK/MAPK), Janus kinase/signal transducer and activator of transcription (JAK/STAT), and hepatocyte growth factor (HGF) (FIG. 33A). In contrast, nonfunctional livers appeared to have limited enrichment of IL-6 signaling at 3 h and only subsequent activation of PI3K/AKT and NF-κB pathways by 6 h. To further examine the effects of prosurvival signaling, we assessed ERK1/2 activation by phospho-specific Western immunoblotting. There was a time-dependent increase in ERK activation in both groups after initiation of NMP (two-way ANOVA time factor P=0.014), though without significant differences between groups (attributable to marked sample-to-sample variability; FIG. 33B). Interestingly, examination of gene expression downstream of ERK revealed fewer differentially expressed target genes in nonfunctional compared with functional livers, similar to the pattern seen in innate immune and autophagy signaling (FIG. 33C).

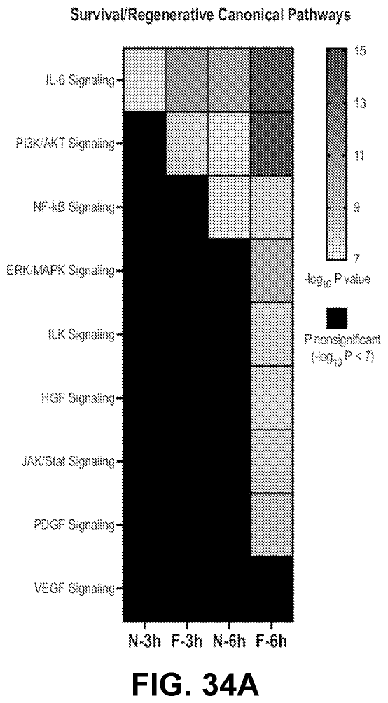

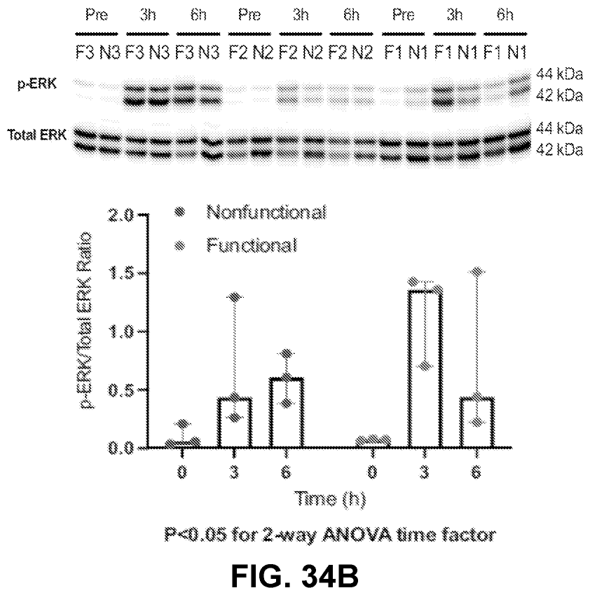

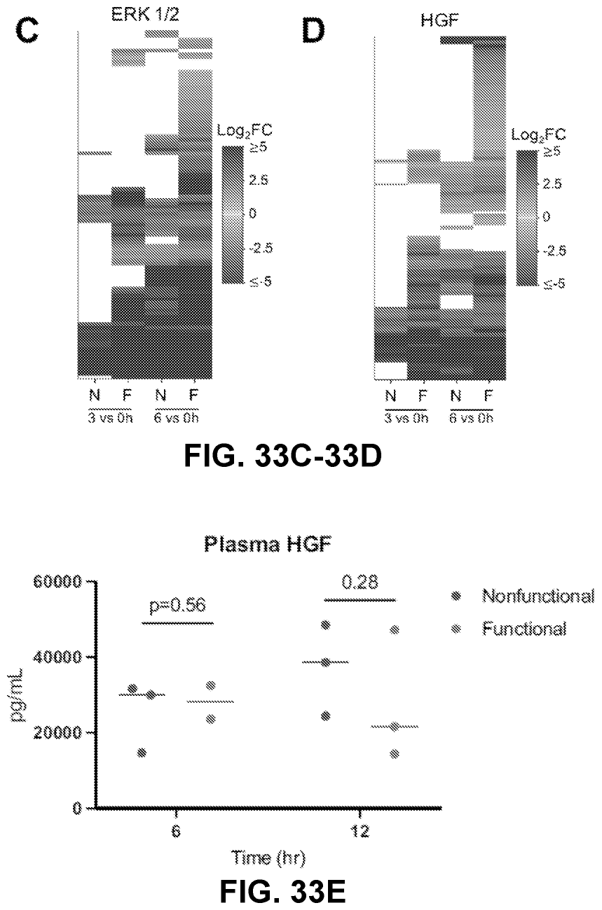

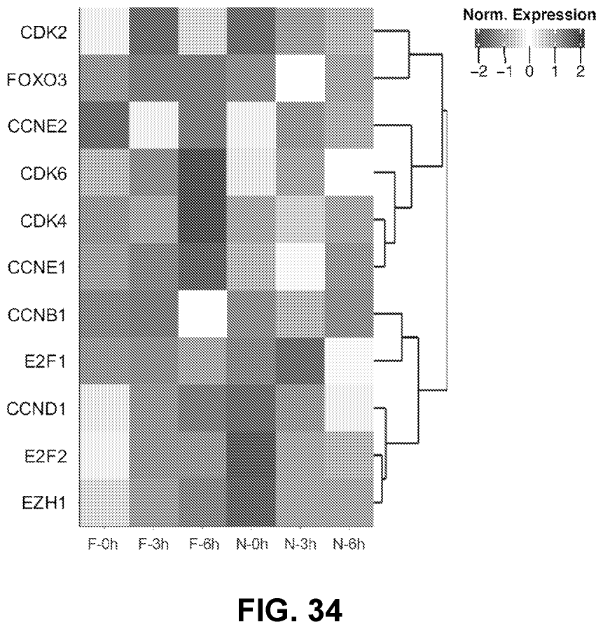

With respect to regenerative signaling, we again observed more robust downstream HGF target gene expression in functional compared with nonfunctional livers (FIG. 33D). Despite this, no significant difference was seen between groups in the perfusate concentration of HGF after 6 or 12 h of NMP (FIG. 33E). The 12-h plasma sample was used in this case given that regenerative pathways are activated in delayed fashion. Similar to the pattern seen in innate immune responses, prosurvival and regenerative signaling in nonfunctional livers lagged behind those seen in functional livers. Consistently, gene expression in nonfunctional livers at 6 h resembled gene expression at 3 h in functional livers. Of note, we did not find any evidence of hepatocellular regeneration as indicated by significant expression of genes involved in cell cycle entry (FIG. 34), although the 6-h perfusion timeframe may have been too early to detect these changes.

Discussion: Limited knowledge of liver physiology as it relates to hepatocellular function during normothermic machine perfusion remains a barrier to optimizing the application of this strategy to improve donor liver utilization. Here, we show discarded DCD human livers that demonstrate adequate hepatocellular function during NMP are characterized by an early innate immune response followed by activation of autophagy and prosurvival mechanisms. In contrast, livers with inadequate hepatocellular function are characterized by delayed gene induction, later onset of innate immune signaling, and diminished activation of autophagy and repair mechanisms in response to NMP. To our knowledge, this is the first study to profile the transcriptomic response of discarded human livers during NMP and highlight the potential relevance of injury and repair mechanisms in determining liver hepatocellular function.

One unanswered question forestalling widespread adoption of NMP is whether ex situ dynamic preservation facilitates rehabilitation of graft function or simply provides a platform to test liver viability. Our analysis of the transcriptome and plasma proteome of discarded DCD human livers demonstrates activation of innate immunity as the primary response to initiation of NMP, similar to ischemia-reperfusion injury (IRI) in clinical LT (see, e.g., ref. 17, 18). Graft hepatocellular function appeared to be associated with the ability to initiate cell repair and prosurvival mechanisms in response to the influx of proinflammatory effectors released after reperfusion, as well as the ability to mitigate subsequent injury. Despite similar perfusate concentrations of circulating cytokines and DAMPs, nonfunctional livers were characterized by delayed transcriptional activation of injury response pathways. As a result, proinflammatory signaling was initiated later in the perfusion time course and likely delayed activation of homeostatic mechanisms. In comparison, the innate immune response in functional livers was activated early on and transitioned to repair and survival signaling by 6 h. These data suggest that NMP facilitates repair mechanisms in response to IRI; however, its effectiveness may be dependent on perfusion duration and the severity of graft injury before initiation of NMP.

We examined the autophagy pathway using a multifaceted approach to determine if cellular repair and homeostasis mechanisms in response to reperfusion injury differed between functional and nonfunctional livers in the ex situ setting. Cold ischemia is known to induce ER stress through accumulation of unfolded and misfolded proteins, activating the unfolded protein response following reperfusion (see, e.g., ref. 13, 19). Our data indicate that ER stress resolves following initiation of NMP, as indicated by a time-dependent decrease in phosphorylated eIF2α. This effect was more pronounced in functional compared with nonfunctional livers. The consequences of persistent eIF2α activation was seen in the expression of genes involved in protein synthesis. Inhibition of global protein synthesis is a principal function of phosphorylated eIF2α and less robust upregulation of genes involved in protein biosynthesis was seen in nonfunctional compared with functional livers (FIG. 25B). Moreover, the UPR restores ER homeostasis through activation of antioxidative mechanisms, amino acid transport, and autophagy, though sustained stress can activate prodeath signaling (see, e.g., ref. 14). We interpret our results as indicating that activation of the UPR by ER stress and the resulting balance between recovery and cell death is essential to determining hepatocellular function during NMP.

At the transcriptome level, functional livers demonstrated more changes in the expression of genes associated with autophagy than did nonfunctional livers. Active autophagy in functional livers was evidenced by higher LC3-II:LC3-I protein ratios after 6 h of perfusion. In contrast, persistent p70S6K activation in nonfunctional livers likely resulted in repression of autophagy during the critical juncture of the liver's response to injury and stress during NMP. These data support the importance of repair and homeostatic mechanisms in determining hepatocellular function. Additional evidence gleaned from proteomic analysis of the circulating perfusate showed significantly higher concentrations of several lysosomal acid hydrolases in nonfunctional livers. Lysosomal damage and membrane permeabilization from overwhelming cellular injury releases cathepsins and hydrolases, which activate a cascade of cell death pathways, including apoptosis, necroptosis, and pyroptosis (see, e.g., ref. 15). Hyperactivation of such injury and stress response mechanisms appears to be detrimental to liver function. By extension, the key to facilitating graft repair or rehabilitation may be the minimization of these responses. Prior work has demonstrated the therapeutic value of inhibiting cathepsins in mitigating hepatic IRI (see, e.g., ref. 20), reflecting the potential benefit of minimizing the propagation of hepatocellular injury (see, e.g., ref. 21, 22). Future investigations aimed at restoring autophagy while decreasing cell death may be of significant clinical relevance (see, e.g., ref. 23).

Another element of graft hepatocellular function appears to be the ability to activate and propagate prosurvival signaling. Our data are consistent with a major role for IL-6 in the immediate response to reperfusion in both groups, but enrichment of noninjurious survival signaling was seen only in functional livers later in the perfusion time course. Upstream regulators involved in growth and survival also demonstrated more robust activation as early as 3 h in functional compared with nonfunctional livers. Examination of proteins involved in early cell cycle entry did not reveal any evidence of hepatocellular regeneration. However, we consider it likely that 6 h of perfusion detailed here is of too short a duration to induce the sort of rapid cell cycle entry that is seen in rodent and human partial hepatectomy models (see, e.g., ref. 24, 25).

This initial study did have a small sample size, which limited our ability to distinguish more nuanced differences between groups. Livers included in the study were chosen from a larger cohort of grafts that included additional differentiating factors, such as donation after brain death and steatosis (see, e.g., ref. 8). We chose to prioritize a homogeneous cohort for analysis at the cost of a smaller sample size, though we found notable variability between livers in each group. This was a limiting factor in our study and may have hindered identification of significant genes in the time-static comparisons, particularly since liver N2 demonstrated a more severe injury profile than N1 and N3. Despite this, we were able to find statistically and clinically significant differences in temporal RNA and protein level changes that have important implications for future studies on targeted therapeutics and potential biomarkers of liver function.

In addition, livers were not able to be transplanted, thus precluding our ability to validate the empirical criteria for determining hepatocellular function. Rather than create new criteria, we made use of benchmarks currently available. The study results will also aid in understanding whether the chosen criteria need to be adjusted before wider clinical validation. In addition, the absence of regulatory approval for any machine perfusion device outside the scope of a clinical trial at the time of this study in the United States prevented us from transplanting these discarded grafts. Notably, the prerequisite clinical trials required to demonstrate device safety and efficacy in standard-criteria donors are were in progress during this study. Finally, we did not closely examine cholangiocellular function due to technical (cannulation) issues with bile collection and as the requisite single-cell analysis or sequential bile duct biopsies necessary was beyond the scope of this study. It is increasingly accepted that NMP alone does not prevent biliary complications after LT. Therefore, additional interventions such as hypothermic-oxygenated perfusion may be required to minimize ischemic biliary injury to prevent post-transplant cholangiopathy, an issue for DCD livers (see, e.g., ref. 26).

In conclusion, our study offers a detailed examination of the injury and repair mechanisms induced during normothermic machine perfusion of discarded DCD human livers. Livers that demonstrated adequate hepatocellular function were characterized by more effective activation of autophagy and repair mechanisms in response to ischemia-reperfusion injury. Based on our results, therapeutic targeting of these pathways during NMP may improve hepatocellular function, thus allowing their use in transplantation.

### Example 5: Non-Limiting Materials and Experimental Methods

Donor Livers: Six human donor livers with similar donor demographics were chosen for further analysis from a previously reported research cohort of machine-perfused discarded human livers (see, e.g., ref. 8). All six livers were DCD livers without significant steatosis and were rejected for transplant by all transplant centers in the respective donor service area. Reasons for discard included a combination of DCD status, donor age, and length of warm ischemic time. Human livers were procured in standard fashion through two organ procurement organizations (OPOs): New England Donor Services (Waltham, MA) and LiveOnNewYork (New York, NY). Informed consent was obtained from donors by the OPOs. Table 4 describes the donor demographics for each organ. The Massachusetts General Hospital and Lifespan Institutional Review Boards, as well as the two OPOs, approved this study (No. 2011P001496). No organs were procured from prisoners and no vulnerable populations were included in this study.

Procurement of Grafts: Procurement techniques based on donation after circulatory death followed standard methods. Donor livers were flushed in situ with University of Wisconsin solution. Total warm ischemic time (WIT) was defined as the period from extubation to cold flush. Functional WIT was defined as the period from asystole to cold flush. Cold ischemic time (CIT) was defined from cold flush to initiation of machine perfusion. After transport to the laboratory under static cold storage, livers underwent standard back bench preparation for machine perfusion (FIG. 22A) (see, e.g., ref. 9).

Machine Perfusion: Grafts were perfused on the Liver Assist device (Organ Assist, Groningen, Netherlands) using a previously described protocol (see, e.g., ref. 8). Briefly, perfusate composition consisted of O+ packed red blood cells, human albumin, lactated Ringer solution, and heparin. Bile salts (taurocholate) and lipid-free parenteral nutrition were continuously infused. Perfusate, bile, and tissue biopsies were collected and analyzed at multiple time points (FIG. 22B). Grafts were deemed to demonstrate adequate hepatocellular function if they satisfied the criteria reported by Mergental et al. (see, e.g., ref. 3), namely, perfusate lactate ≤2.5 mmol/L and two or more of the following minor criteria within 4 h of starting perfusion: 1) perfusate pH ≥7.30 without supplemental bicarbonate, 2) arterial flow ≥150 mL/min and portal flow ≥500 mL/min, 3) evidence of glucose metabolism, 4) bile production, and 5) visually assessed homogenous perfusion. Cholangiocellular (biliary) functional metrics according to van Leeuwen (see, e.g., ref. 10) were measured but not used for functional stratification due to technical issues with bile collection in two livers.

Perfusate Analysis and Plasma Proteomics: Perfusate collected at the indicated time points was centrifuged at 5,000 g, and the plasma collected and stored at −80° C. for later analysis. Enzyme-linked immunosorbent assays (ELISAs) were performed for various proteins according to manufacturers' guidelines. A list of ELISA kits are provided in Table 5 below.

TABLE 5
Enzyme-linked immunosorbent assay (ELISA) kits^{a}

| Protein | Manufacturer | Product # |
|---|---|---|
| Tumor necrosis factor-alpha (TNFα) | Sigma-Millipore | RAB0476 |
| Interleukin-6 (IL-6) | Sigma-Millipore | RAB0306 |
| High mobility group box 1 (HMGB1) | Aviva Systems Biology | OKCD04074 |
| Interferon-gamma (IFNγ) | Abcam | ab174443 |
| 8-hydroxy 2-deoxy guanosine (8OHdG) | Abcam | ab201734 |
| Hepatic growth factor (HGF) | Abcam | ab100534 |
| Cathepsin D | Abcam | ab213470 |

^{a}Abcam (Waltham, MA, USA), Aviva Systems Biology (San Diego, CA, USA), Sigma-Millipore (Waltham, MA, USA).

Proteomic profiling of trypsinized perfusate proteins was performed following albumin depletion in collaboration with the University of Arkansas Medical Sciences Proteomics Core. The equipment used, protein processing, and analysis are detailed below.

Mass Spectrometry Data-Independent Acquisition (DIA): Following depletion of abundant proteins from serum samples using High Select Top 14 resin (Thermo Fisher, Waltham, MA, USA), remaining serum proteins were reduced, alkylated, and purified by chloroform/methanol extraction prior to digestion with sequencing grade modified porcine trypsin (Promega, Madison, WI, USA). Tryptic peptides were then separated by reverse phase XSelect CSH C18 2.5 micrometer resin (Waters, Milford, MA, USA) on an in-line 150×0.075 mm column using an UltiMate 3000 RSLCnano system (Thermo Fisher). Peptides were eluted using a 60 min gradient from 98:2 to 65:35 buffer A:B ratio (Buffer A, 0.1% formic acid, 0.5% acetonitrile; Buffer B, 0.1% formic acid, 99.9% acetonitrile). Eluted peptides were ionized by electrospray (2.2 kV) followed by mass spectrometric analysis on an Orbitrap Exploris 480 mass spectrometer (Thermo Fisher). To assemble a chromatogram library, six gas-phase fractions were acquired on the Orbitrap Exploris with 4 m/z DIA spectra (4 m/z precursor isolation windows at 30,000 resolution, normalized automatic gain control (AGC) target 100%, maximum inject time 66 ms) using a staggered window pattern from narrow mass ranges using optimized window placements. Precursor spectra were acquired after each DIA duty cycle, spanning the m/z range of the gas-phase fraction (i.e. 496-602 m/z, 60,000 resolution, normalized AGC target 100%, maximum injection time 50 ms). For wide-window acquisitions, the Orbitrap Exploris was configured to acquire a precursor scan (385-1015 m/z, 60,000 resolution, normalized AGC target 100%, maximum injection time 50 ms) followed by 50×12 m/z DIA spectra (12 m/z precursor isolation windows at 15,000 resolution, normalized AGC target 100%, maximum injection time 33 ms) using a staggered window pattern with optimized window placements. Precursor spectra were acquired after each DIA duty cycle.

Data Analysis: Following data acquisition, we searched the data using an empirically-corrected library and performed a quantitative analysis to obtain a comprehensive proteomic profile of the Homo sapiens proteome. Proteins were identified and quantified using EncyclopeDIA (see, e.g., ref. no. 27) and visualized with Scaffold DIA using 1% false discovery thresholds at both the protein and peptide level.

Protein exclusive intensity values were assessed for quality using our in-house ProteiNorm app, a user-friendly tool for a systematic evaluation of normalization methods, imputation of missing values and comparisons of different differential abundance methods (see, e.g., ref. no. 28). Popular normalization methods were evaluated including log 2 normalization (Log 2), median normalization (Median), mean normalization (Mean), variance stabilizing normalization (VSN) (see, e.g., ref. 29), quantile normalization (Quantile) (R software preprocessCore), cyclic loess normalization (Cyclic Loess) (see, e.g., ref. 30), global robust linear regression normalization (RLR) (see, e.g., ref. 31), and global intensity normalization (Global Intensity) (see, e.g., ref. 31). The individual performance of each method was evaluated by comparing the following metrices: total intensity, Pooled intragroup Coefficient of Variation (PCV), Pooled intragroup Median Absolute Deviation (PMAD), Pooled intragroup estimate of variance (PEV), intragroup correlation, sample correlation heatmap (Pearson), and log 2-ratio distributions.

The data was normalized using Cyclic Loess and differential abundance analysis was performed using Linear Models for Microarray Data (limma) with empirical Bayes (eBayes) smoothing to the standard errors (see, e.g., ref. 31). Proteins with an FDR adjusted p-value <0.05 and a fold change >2 were considered to be significant.

Total RNA Purification, Sequencing. and Analysis: Core needle biopsies taken immediately before perfusion and after 3 and 6 h of perfusion were used for transcriptome sequencing on an Illumina HiSeq 4000 using nine PCR cycles by GENEWIZ (South Plainfield, NJ). Tissue collection, purification, and bioinformatic analysis are detailed below.

RNA Purification and Sequencing: Tissues samples from livers taken immediately prior to perfusion and after 3 and 6 hours of perfusion were used for transcriptome sequencing. Core needle biopsies from the right liver lobe were collected in RNAlater solution (Sigma-Millipore, Waltham, MA, USA) and stored overnight at 4° C. Tissue samples were then removed from solution and stored at −80° C. Total RNA was isolated using the RNeasy Mini Kit (Qiagen, Germantown, MD, USA) according to manufacturer guidelines. 500 ng of each sample was sequenced on an Illumina HiSeq 4000 using 9 PCR cycles by GENEWIZ (South Plainfield, NJ, USA). Data files were aligned to the human genome build 38 and transferred to servers at Brown University via sFTP.

Bioinformatic analysis: Raw read counts were normalized using the Trimmed Mean of M method following removal of low-count genes (fewer than 10 reads in the smallest library). Differential gene expression analysis was conducted in R (see, e.g., ref. no. 32) using edgeR (see, e.g., ref. no. 33). The significance cutoff for differential gene expression was set to a Benjamini-Hochberg false-discovery rate (FDR or q-value)<0.05. Canonical pathway and upstream regulator enrichment analysis was generated through Ingenuity Pathway Analysis (IPA, Qiagen) (see, e.g., ref. no. 34). IPA categories were considered significant when the P value was below the P values obtained from 5 similarly sized sets of randomly selected genes with a fold-change in expression <1 (see, e.g., ref. no. 35). In this study, the threshold for significance was P<10E-7 for canonical pathways and P<10E-14 for upstream regulators.

Principal component analysis (PCA), volcano plots, Venn diagrams, and heatmaps were created using the following R packages: ggplot2 (2D PCA), plot3D/plot3Drgl (3D PCA), EnhancedVolcano (volcano plots), VennDiagram (Venn diagrams), and heatmaply (heatmaps).

Transcription factor binding site enrichment analysis was conducted using the software package CiiiDER. The total number of genes with putative transcription factor binding site motifs were compared between differentially expressed gene sets and the background gene set used in the differential expression analysis. Significance for transcription factor binding site enrichment is determined using a Fisher's exact test and a P value cutoff of 0.05. The analysis was performed using the lists of differentially expressed genes identified for the four individual perfusion conditions relative to their corresponding pre-perfused state (see, e.g., ref. no. 36).

Gene ontology (GO) enrichment analysis was performed using the R package GOseq. A Benjamini-Hochberg FDR adjusted p-value of <0.05 was used for determining significant GO term enrichment (see, e.g., ref. 37). The genes with the highest amount of variance explained by principal component 1 or 3 cumulatively totaling to 10% of the total variance explained by PC1/PC3 were further analyzed. The proportion of variance explained for a gene by PC1/PC3 was calculated using the squared loading values generated by the prcomp function in R. GO term analysis was performed on the genes from this subset that positively correlated with PC1/PC3. The significantly enriched GO terms in the biological processes category for PC1 and cellular components category for PC3 were organized in hierarchal networks and parsed in to three independent ‘regions’ of categories that best captured the majority of GO term nodes. These clusters were characterized by a parental GO term and included all sub-categories of that node found significantly enriched in our gene set (Parental and sub-categories are provided in, e.g., ref. 36). For PC1, the resulting individual sub-networks of significantly enriched GO terms were then functionally generalized in to “Protein and RNA transport to and from the nucleus”, “Gene expression: transcription, RNA splicing, and translation” and “DNA, RNA, and protein biosynthesis”. For PC3, the resulting individual sub-networks of significantly enriched GO terms were then functionally generalized in to “Extracellular vesicle/exosome”, “Intrinsic component of membrane” and “Endoplasmic reticulum”. Circular heatmaps were generated with the circlize package in R (see, e.g., ref. 38) using the means of biological replicates from the normalized counts per million read data then scaled by row to show relative gene expression across the 6 conditions (2 groups, 3 time points). Only genes associated with these GO terms were used in the heatmaps. The genes were clustered according to their association with the three GO term sub-networks, and the clusters were denoted by colored concentric rings inside the center of the circular heatmaps. The rows are labeled with the gene symbol and the columns are oriented from innermost to outermost as 0 hour (pre-perfusion), 3 hour, and 6 hour time points. The differential gene expression threshold for significance was set to a Benjamini-Hochberg false discovery rate (FDR) of <0.05 at 3 or 6 hours perfusion compared to pre-perfusion are indicated with a *.

Raw sequence data have been deposited in the Gene Expression Omnibus with Accession No. GSE165568 (reviewer access token: evwlimwuvjetfmf), which is incorporated herein by reference in its entirety.

Histology and Immunohistochemistry: Core needle biopsies taken from the right liver lobe at indicated intervals were fixed in formalin and embedded in paraffin. Hematoxylin and eosin (H&E) staining was performed on all biopsies to assess the degree of necrosis and inflammatory cell infiltrate. A pathologist evaluated and scored all slides in a blinded manner using a semi-quantitative scoring scheme. The H&E Scoring System included the following:
i) Necrosis:
   0=None
   1=Few scattered cells
   2=Mild (anything from “few” up to 30% of the section affected)
   3=Moderate (31% to 60%)
   4=Severe (61%+)
ii) Lobular Inflammation:
0=None
   1=Minimal (up to four scattered small foci of a few cells; or one/two cells seen multifocally)
   2=Mild (anything from “minimal” up to 25% of section affected)
   3=Moderate (26% to 60%)
   4=Severe (61% or greater)
iii) Portal Inflammation:
   0=None
   1=Minimal (focal; few scattered cells in one to ‘a few’ portal areas)
   2=Mild (focal, most portal areas affected)
   3=Moderate (inflammation beginning to expand portal tracts and/or beginning to become continuous/surround up to 50% of portal tracts/septa, +/− extending to interface)
   4=Severe (inflammation continuous and around 50% or more portal tracts/septa)

Immunohistochemistry was performed using antibodies directed toward LC3B (Product No. NB100-2220, Novus Biologicals, Littleton, CO, USA). Paraffin sections (6 μm) were deparaffinized with xylene and rehydrated with graded ethanol. Antigen retrieval was performed by sub-boiling in 1×-diluted Dako Target Retrieval Solution for 10 min (DakoCytomation, Inc., Carpinteria, CA). Slides were then quenched in 3% H₂O₂ and blocked in 2.5% Normal Horse Serum (Vector Labs, Burlingame, CA) before overnight incubation in primary antibody (1:200 dilution) at 4° C. Slides were incubated with a horseradish-peroxidase conjugated secondary rabbit antibody (Vector Laboratories) for 1 hr prior to staining with DAB (Vector Laboratories). Slides were counterstained with hematoxylin. Omission of the primary antibody served as a negative control.

Western Blots: Sequential wedge biopsies from the right lobe of each liver were performed at indicated intervals, flash frozen in liquid nitrogen, and stored at −80° C. Tissue samples (20 mg) were homogenized and Western immunoblots performed as previously described (see, e.g., ref. 11). A full list of antibodies used is provided in Table 6 below.

TABLE 6
Western immunoblot antibodies

| Antibody | Manufacturer^{a} | Product # |
|---|---|---|
| eIF2α | Santa Cruz Biotechnology | sc-11386 |
| Phospho-eIF2α | Cell Signaling Technology | 9721 |
| p70 S6 Kinase | Cell Signaling Technology | 2708 |
| Phospho-p70 S6 Kinase | Cell Signaling Technology | 9234 |
| (Thr389) | | |
| MAP Kinase 1/2 | Sigma-Millipore | 06-182 |
| Phospho-p44/42 MAPK | Cell Signaling Technology | 4370 |
| (Erk1/2) | | |
| (Thr202/Tyr204) | | |
| LC3B | Cell Signaling Technology | 2775 |
| β-actin | Santa Cruz Biotechnology | sc-47778 |
| GAPDH | Cell Signaling Technology | 5174 |
| P62 | Cell Signaling Technology | 39749 |

^{a}Cell Signaling Technology (Danvers, MA, USA), Santa Cruz Biotechnology (Dallas, TX, USA), Sigma-Millipore (Waltham, MA, USA).

To compare target protein expression, densitometry quantification was conducted. Blots for β-actin and GAPDH are shown in FIG. 31. Both proteins varied across samples and the changes were not consistent between the two proteins, with the variation representing the biologic variability in the human liver.

Statistical Analysis: Categorical data are presented as median with interquartile range (IQR) and frequency data as percentages. For statistical tests not related to RNA sequencing or proteomic analysis, the Wilcoxon rank-sum test (Mann-Whitney U) and Fisher's exact test were used for group comparisons. A two-way analysis of variance (ANOVA) was used for comparisons between groups with repeated measures over time. The threshold for statistical significance was set at <0.05. Analyses were conducted using GraphPad Prism 8 (San Diego, CA) and Stata 15 (College Station, TX).

### Example 6: Methods and Compositions for Extending Organ Preservation

Abstract: The limited preservation duration of donor organs critically contributes to the global shortage of organs for transplantation. Current clinical standards store organs for hours using hypothermic storage at +4° C. This limited storage duration can preclude optimal matching programs and burden the healthcare system with high costs of unplanned surgeries. In some instances, a tripling of the storage duration can be achieved with supercooling preservation, which relies on high subzero storage temperatures (between −4 and −6° C.) and retaining the preservation media in a liquid state. To achieve even deeper metabolic stasis, alternate methods may be useful because the probability of accidental, damaging ice formation increases as a function of decreasing temperature. Thus, we explored high subzero temperatures (−10 to −15° C.) using ice nucleating agents (INA) to control ice formation and cryoprotective agents to maintain an unfrozen water fraction. We present the results of this approach, termed partial freezing, by demonstrating the importance of gradual (un)loading of cryoprotective agents during machine perfusion, testing different cryoprotective agents, freezing temperatures, and storage durations with whole rat livers. Initial results indicate that the use of propylene glycol significantly improves liver function and reduces injury compared to the use of glycerol or ethylene glycol. While freezing injury is correlated to decreasing temperature from −10 to −15° C., the degree of injury is largely unaffected by an increase in storage duration from 1 to 5 days. Here, we present a nature inspired approach that promotes an equilibrium frozen state, resulting in up to 5-fold longer storage durations as compared to clinical standards.

Introduction: The need for transplantation is growing steadily while the supply of donor organs is nowhere near demand (see, e.g., ref. 1,2). Extending organ preservation has increasingly been identified as a national research priority (see, e.g., ref. 3-5) that would significantly impact organ allocation, handling, and transplantation in several important ways. Firstly, for livers that can currently reach their recipient using clinical hypothermic preservation, extending preservation duration would convert from emergency to planned surgeries, reduce the cost of transplantation, and enable improved matching according to HLA compatibility. Secondly, new immune tolerance induction protocols (see, e.g., ref. 6,7) are poised to eliminate rejection, thereby increasing the quality of life of recipients, extending in vivo graft life, and reducing the need for re-transplantation. However, these protocols can require more time to prepare the recipient than is currently possible with clinical preservation and hence extended preservation will be required to fully realize this breakthrough achievement. Thirdly, some organs that are procured for transplantation are discarded due to circumstantial factors that include donor/recipient location. These factors could be eliminated, mitigated, or minimized with extended preservation duration and could directly reduce organ discard rates. Finally, when complementary fields such as tissue engineering and regenerative medicine achieve future breakthroughs in artificial organ engineering, improved organ preservation methods may enable off-the-shelf access to these life-saving organs (see, e.g., ref. 1, 8).

Preservation methods can employ two non-limiting strategies to slow down deterioration of donor organs outside the human body: metabolic support and metabolic depression. Metabolic support through machine perfusion can resuscitate injured liver grafts, assess degree of injury, and moderately extend the preservation time (see, e.g., ref. 1, 9-12). Despite these advantages of resuscitation and assessment, technology to maintain ex vivo homeostasis can become more complex with increasing perfusion durations and may require continuous monitoring and adaptations to the system (see, e.g., ref. 8, 12). Metabolic depression employs the understanding that metabolic rate—and consequently tissue deterioration—slows down exponentially at decreasing temperatures (see, e.g., ref. 13). The clinical standard for organ preservation is hypothermic preservation at +4° C. However, this limits storage for vascular and metabolically active tissues such as the liver to the order of hours, with 9 hours being the typical clinical preservation duration for liver transplantation.

Decreasing the storage temperature below freezing holds great promise to depress metabolism and extend preservation durations beyond clinical standards. In some instances, an optimal preservation protocol may not need to choose one strategy versus the other since the advantages of machine perfusion in resuscitation and assessment can be combined with periods of deep metabolic stasis. Such protocols can further employ machine perfusion to recover rodent (see, e.g., ref. 14, 15) and human (see, e.g., ref. 13, 16) livers after a period of subzero metabolic rate depression to extend preservation duration. Thus, in some instance, preservation strategies can include machine perfusion and subzero preservation.

Most subzero preservation efforts have focused on low cryogenic temperature ranges (<−80° C., see, e.g., ref. 1). At these temperatures, freezing or vitrification approaches should minimize lethal intracellular ice formation, mechanical and thermal stresses, and/or cryoprotectant toxicity, as well as overcome or mitigate limited scalability from cell to human organ sized systems (see, e.g., ref. 17, 18). Other temperature ranges remain relatively unexplored, such as a “high subzero” temperature range from −4° C. to −20° C., which may enable deeper metabolic stasis than clinical hypothermic storage at +4° C., while avoiding challenges of deep cryogenic storage (see, e.g., ref. 19, 20). In one non-limiting instance, ice formation in rodent and human livers can be avoided at high subzero temperatures (−4° C. to −6° C.) with supercooling preservation, resulting in a tripling of the preservation duration of mammalian livers (3 days in rodents and 27 hours in humans) (see, e.g., ref. 13-15).

While retaining the preservation media (e.g., a perfusate) in the liquid state circumvented challenges in phase changes of water that have eluded cryopreservation scientists for decades (see, e.g., ref. 21-23), the ice-free supercooled state is thermodynamically unstable and may be at risk for spontaneous ice formation (which is far more injurious than equilibrium freezing). Since the risk of ice formation increases as the storage temperature decreases, supercooling may be limited by the depth of metabolic stasis that can be achieved. Yet, extensions of preservation duration of human livers beyond 27 hours would be required to enable global matching programs. Taken together, alternative strategies may be useful to reach lower storage temperatures and even longer preservation durations.

Freeze tolerance is an effective strategy utilized by multiple organisms in the nature (see, e.g., ref. 24). Wood frogs (Rana sylvatica) can survive in a frozen state at −6° C. to −16° C. (see, e.g., ref. 25) for weeks (see, e.g., ref. 26, 27). The wood frog employs both ice nucleating agents (INAs) and endogenous cryoprotective agents (CPAs) to orchestrate freezing and prevent injurious intracellular ice formation. Without wishing to be limited by mechanism, the INAs can promote ice formation within the vasculature as close as possible to melting point, in which studies in freeze-tolerant species showed that controlled freezing of extracellular water by INAs is a factor for freezing survival (see, e.g., ref. 28). As extracellular water gradually freezes, it is generally accompanied by an increase in the osmolality of the non-frozen extracellular fluid. This can result in cellular dehydration as water is pulled from the intracellular environment (see, e.g., ref. 26, 27). Another strategy that confers freeze-tolerance is the synthesis of high amounts of carbohydrates, such as glucose in wood frogs (see, e.g., ref. 29-31). For instance, glucose in the blood and tissues provides colligative resistance to detrimental decreases in cell-volume and together with INAs restricts the formation of intracellular ice.

Herein, we present a non-limiting protocol for freezing of whole rat livers that enters unchartered high subzero temperatures ranging from −10° C. to −15° C. for durations (e.g., of up to five days) in the presence of ice. With a focus on conferring a non-injurious frozen state, we challenge a central paradigm in cryopreservation that ice should be completely avoided. Our approach leverages CPAs and INAs, including a glucose analog: 3-O-methyl-D-glucose (3-OMG).

We further bolster our approach using gradual (un)loading of CPAs, and functional recovery of livers with machine perfusion after subzero preservation. Additionally, we compare the effectiveness of cell-permeating CPAs, such as glycerol (GLY), ethylene glycol (EG), and propylene glycol (PG), and evaluate outcomes based on storage temperatures (−10° C. and −15° C.) and duration of storage (1 and 5 days). Finally, we address engineering principles aimed at enhancing our machine perfusion system to improve the recovery of frozen livers after freezing. One strategy of this protocol is to promote a thermodynamically stable frozen state, while maintaining a sufficient unfrozen fraction to limit ice damage and excessive dehydration; therefore, we coined this approach “partial freezing.”

Described herein are methods and compositions to reduce endothelial injury during preservation, in particular during perfusion via integration of physical and biological improvements. We demonstrate that endothelial cell injury can correlate with graft viability and portal vein resistance during preservation of rat tissues in subzero environments and preservation of human livers with normothermic machine perfusion. We also demonstrate that endothelial injury can be minimized by reducing the shear stress and shock due to osmotic pressure changes during loading and unloading of CPAs (including 3-O-methyl-D-glucose, glycerol, ethylene glycol, propylene glycol, and DMSO, which may be extended to include polymers, like polyethylene glycol, sugars, like trehalose, raffinose, mannitol, hydroxyethyl starch (HES), dextran, and oncotic agents like albumin, among others) with base medias (e.g., Williams Media E and University of Wisconsin solution, which may extended to others). Furthermore, arrest of apoptotic pathways via caspase inhibition (e.g., pan caspase inhibitor IDN-6556 or any herein) can reduce endothelial injury, improve resistance, decrease neutrophil mediated injury, and/or improve graft viability. Any of the approaches described herein may be used in the presence of one or more apoptosis inhibitors (e.g., one or more caspase inhibitors), as well as drug cocktails including such apoptosis inhibitor(s).

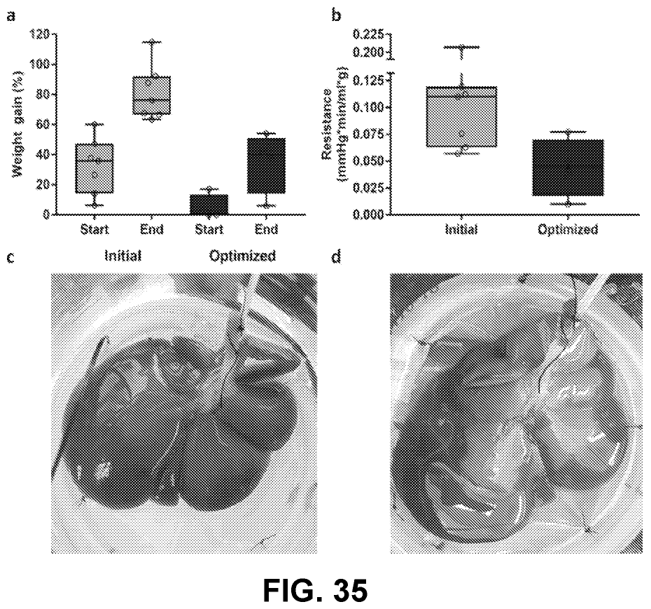

Optimization of Partial Freezing Protocol: Our initial efforts incorporated non-limiting INAs (Snomax 1 g/L), 3-O-methyl-D-glucose (3-OMG, 200 mM), and poly(ethylene glycol (PEG, 5%) in combination with the cryoprotectant glycerol (6% vol/vol) into the storage solution and stored livers at −6° C. in the frozen state. The storage solution was loaded and unloaded in one step with a syringe by hand, and the livers were thawed in a warm (37° C.) water bath with perfusate. However, this method resulted in excessive edema (>60%) and high vascular resistances (mean 0.11±0.05 mmHg*min/ml*g; mean±SD throughout the text, unless otherwise specified) during SNMP recovery after freezing (FIG. 35a-b). Gross morphological assessment indicated inadequate perfusion of the periphery, as shown on FIG. 35c-d, which was likely caused by the incomplete delivery of CPAs and dramatic shifts in osmolality during (un)loading, that were further aggravated by frozen storage.

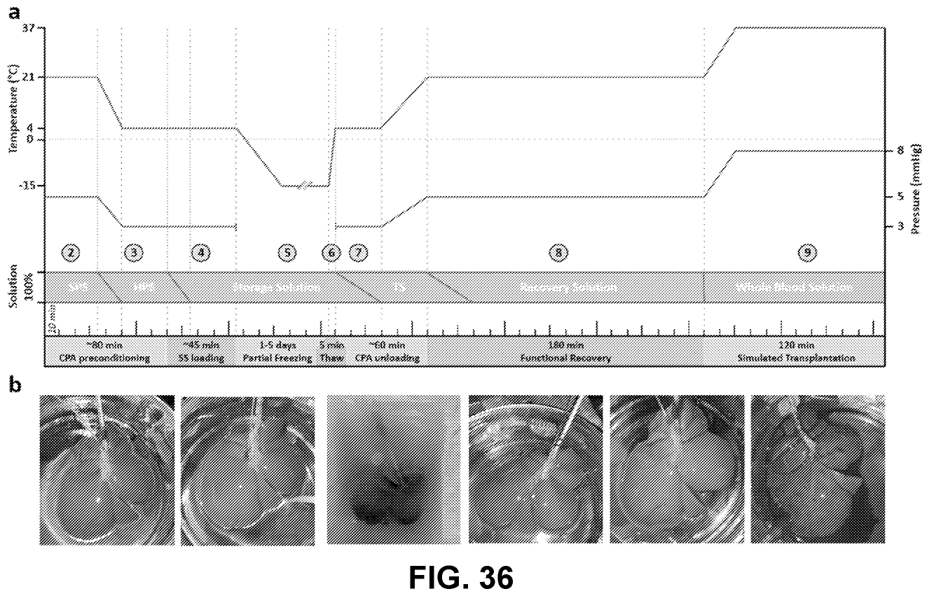

To improve these results, we modified our approach by 1) pressure- and temperature-controlled loading/unloading during machine perfusion instead of a hand syringe flush; 2) multi-step loading of CPAs with gradual changes between the different solutions; 3) higher concentration of permeating CPAs (12% instead of 6%); 4) addition of osmotic counterbalancing non-permeating CPAs (trehalose and raffinose); and 5) the use of glutathione during SNMP recovery. One or more of these changes (taken alone or together) may be implemented. In one instance, when taken together, these improvements resulted in significantly less edema, lower vascular resistance and improved flowrates during machine perfusion after freezing (see results of FIG. 35a-c). Ultimately, this optimized protocol (presented in FIG. 36 and Table 7) is described in detail in Example 7.

TABLE 7
Composition of solutions in a non-limiting partial freezing protocol

| | Subnormo- | | | | | | | | | | | |
|---|---|---|---|---|---|---|---|---|---|---|---|---|
| | thermic | | Hypo- | | | | | | | | | |
| | Pre- | | thermic | | | | | | | | Whole | |
| | conditioning | | Preloading | | Storage | | Thawing | | Recovery | | Blood | |
| | Solution | | Solution | | Solution | | Solution | | Solution | | Solution | |
| Base solution | WE | | WE | | UW | | WE | | WE | | WE | |
| Total volume | 250 | ml | 250 | ml | 100 | ml | 250 | ml | 500 | ml | 100 | ml |

Additives

| Insulin | 200 | U/l | 200 | U/l | 10 | U/l | 20 | U/l | 20 | U/l | 20 | U/l |
|---|---|---|---|---|---|---|---|---|---|---|---|---|
| Heparin | 10,000 | U/l | 4,000 | U/l | — | | 4,000 | U/l | 5,000 | U/l | 5,000 | U/l |
| Dexamethasone | 24 | mg/l | 24 | mg/l | 24 | mg/l | 24 | mg/l | 24 | mg/l | 24 | mg/l |

| | | | | | | | | | | | |
|---|---|---|---|---|---|---|---|---|---|---|---|
| Hydrocortisone | 25 | mg/ml | 25 | mg/ml | — | 25 | mg/ml | 25 | mg/ml | 25 | mg/ml |
| Penicillin | 40,000 | μg/l | 40,000 | μg/l | — | 40,000 | μg/l | 40,000 | μg/l | 40,000 | μg/l |
| Streptomycin | 40,000 | U/l | 40,000 | U/l | — | 40,000 | U/l | 40,000 | U/l | 40,000 | U/l |

| | | | | | | | | | |
|---|---|---|---|---|---|---|---|---|---|
| Glutathione | — | — | 0.922 | g/l* | 1.536 | g/l | 1.536 | g/l | — |

Blood

| Fresh whole rat | — | — | — | — | — | ~10-12 | ml/l |
|---|---|---|---|---|---|---|---|
| blood | | | | | | | |

Macromolecules

| | | | | | | | | | | | |
|---|---|---|---|---|---|---|---|---|---|---|---|
| BSA | 10 | g/l | 10 | g/l | — | 10 | g/l | 10 | g/l | 10 | g/l |

| | | | | | | | | | | | |
|---|---|---|---|---|---|---|---|---|---|---|---|
| 35 kDa PEG | 20 | g/l | 20 | g/l | 50 | g/l | 20 | g/l | 20 | g/l | — |

| | | | | | | | | | |
|---|---|---|---|---|---|---|---|---|---|
| HES | — | 30 | g/l | 50 | g/l* | 30 | g/l | — | — |

Saccharides

| | | | | | | | | | | |
|---|---|---|---|---|---|---|---|---|---|---|
| 3-OMG | 19.42 | g/l | 19.42 | g/l | 19.42 | g/l | 19.42 | g/l | — | — |

| | | | | | | | | | |
|---|---|---|---|---|---|---|---|---|---|
| Raffinose | — | 15.12 | g/l | 17.83 | g/l* | 15.12 | g/l | — | — |

| | | | | | | | | |
|---|---|---|---|---|---|---|---|---|
| Trehalose | — | — | 18.92 | g/l | 18.92 | g/l | — | — |

Permeating CPA

| | | | | | | | | | |
|---|---|---|---|---|---|---|---|---|---|
| GLY, EG, or PG | — | 60 | ml/l | 120 | ml/l | 60 | ml/l | — | — |

Ice nucleating agent

| | | | | | | | |
|---|---|---|---|---|---|---|---|
| Snomax | — | — | 1 | g/l | — | — | — |

*Present in UW.
BSA, bovine serum albumin;
PEG, polyethylene glycol;
HES,hydroxyethyl starch;
GLY, glycerol;
EG, ethylene glycol;
PG, propylene glycol;
3-OMG, 3-O-methyl-D-glucose;
UW, University of Wisconsin solution;
WE, Williams' Medium E.

In one embodiment, the optimized preservation protocol includes nine consecutive steps:
(1) procurement of the liver,
(2) preconditioning during subnormothermic machine perfusion (SNMP),
(3) preloading of CPAs during hypothermic machine perfusion (HMP),
(4) loading of the final storage solution during HMP,
(5) freezing,
(6) thawing,
(7) unloading of CPAs during HMP,
(8) functional recovery during SNMP, and
(9) viability assessment during ex vivo simulated transplantation.

Effect of permeating cryoprotective agents and warm ischemic injury on liver viability after partial freezing: Using this optimized protocol, we compared the effects of glycerol (GLY), ethylene glycol (EG) and propylene glycol (PG) on liver viability after partial freezing at −10° C. for 1 day to a control group of conventional hypothermic preservation for 1 day at +4° C. Previous studies have repeatedly shown this 1 day duration of hypothermic preservation results in 100% transplant survival in the same animal Model (see, e.g., ref. 14, 32, 33). While SNMP after freezing provides the opportunity to assess liver function/injury between the experimental groups (see, e.g., ref. 14, 34, 35), we also simulated transplantation with ex vivo normothermic reperfusion in the presence of whole blood. This is an established model to simulate transplantation that has been used in rat, swine and human livers (see, e.g., ref. 36-40). While this method does not completely capture the transplantation process, it has the advantage of being more controlled than transplantation as well as being more conducive to the different measurements of liver function and injury performed in this study. While we will focus on the viability assessment during simulated transplantation, parameters of liver function and injury during SNMP are also described herein.

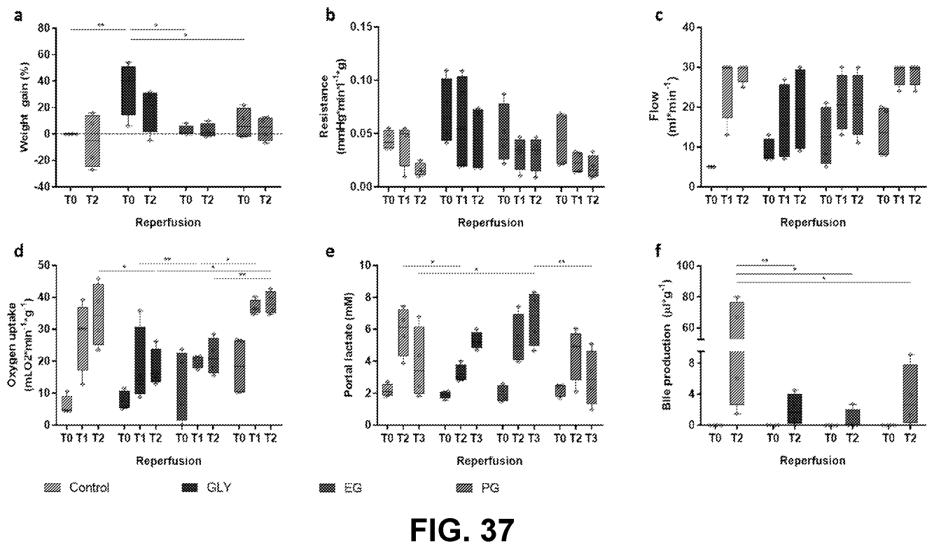

Although edema was substantially improved with gradual CPA loading/unloading, GLY livers still gained considerable weight during SNMP recovery (35.00±20.49% at 3 h) and the final weight gain during simulated transplantation was nonetheless 19.00±16.63% at 2 h (FIG. 37a). Conversely, the weight of the EG and PG livers as well as the controls was stable during simulated transplantation (2.50±5.26%; and 4.00±9.20% at 2 h, respectively). Of the three experimental groups, the vascular resistances of the PG livers were most comparable to the controls during simulated transplantation (0.019±0.011 vs 0.016±0.006 mmHg*min*mL⁻¹*g⁻¹ at 2 h, respectively, FIG. 37b).

It has been previously shown that oxygen uptake during SNMP recovery after supercooling (subzero non-frozen preservation) was significantly correlated to transplant survival in rat livers (see, e.g., ref. 14). The oxygen uptake during simulated transplantation (FIG. 37d) of the PG livers (38.22±3.66 mLO₂*min⁻¹*g⁻¹ at 2 h) was the same as control livers (34.45±9.91 at 2 h) while the oxygen uptake of the GLY livers (17.85±5.86 at 2 h) and EG livers (21.41±5.80 at 2 h) was significantly reduced compared to the controls (p=0.0186 and p=0.0879, respectively) and PG livers (p=0.0028 and p=0.0169, respectively). A similar trend was observed in portal lactate, which is an important parameter of liver function and indicative of viability (see, e.g., ref. 41). While the lactate concentration increased for all livers during the first hour of simulated transplantation (FIG. 37e), control and PG livers subsequently cleared lactate and this was not observed for GLY and EG livers. This resulted in significantly higher lactate concentrations at the end of simulated transplantation in the EG livers (6.68±1.71 mM at 2 h) compared to both the control (3.85 2.24 at 2 h) and PG (2.95±1.73 at 2 h) livers (p=0.017 and p=0.0012, respectively). We also assessed the effect of warm ischemia time (WIT) on perfusion outcomes after freezing to ascertain if our protocol would be compatible with livers that had already undergone mild to moderate injury. Using PG as the main permeating CPA, we also compared livers that were exposed to 30 minutes warm ischemia prior to freezing at −10° C. for 1 day versus livers frozen under the same conditions without exposure to warm ischemic injury. At the end of simulated transplantation (2 h), the results show that there were no statistically significant changes in all parameters measured, except for lactate (WIT was 6.37±1.09 mM versus PG 2.95±1.73 mM; p=0.0018).

Bile production is another important metric of liver function. Most GLY and EG livers did not produce bile during simulated transplantation (FIG. 37f). Conversely all but one PG livers did produce bile; however, the total cumulative volume was significantly lower compared to controls (3.56±4.02 vs 38.61±40.66 μl*g⁻¹ at 2 h; p=0.0111). Tissue adenylate energy content is considered the most representative metric for liver viability (see, e.g., ref. 35, 42-45). While all livers that were stored in the frozen state at −10° C. for 1 day showed a decreasing trend of tissue adenylate energy charge, statistically significant decreases were only reached for GLY (0.064±0.039 at 2 h) and EG (0.088±0.065 at 2 h), as compared to control livers (0.24±0.073 at 2 h; p=0.0033 and p=0.0097, respectively).

In addition to parameters of liver function, we assessed general and specific parameters of (hepato)cellular injury during simulated transplantation. Increased potassium concentrations are a general parameter of cellular injury as intracellular potassium is released after cell death. However, the release of the liver specific enzymes aspartate amino transferase (AST) and alanine aminotransferase (ALT) are more specific to hepatocellular injury. All three parameters showed indications of increased injury after partial freezing in all experimental groups compared to the controls. For example, AST levels in all experimental groups where significantly higher than the controls (p<0.0001, p=0.0003, and p=0.0003 for GLY, EG and PG at 2 h, respectively). The AST levels of the GLY livers (1528±388 U/L at 2 h) were significantly higher than the EG livers (967±330 at 2 h) and PG livers (979±520 at 2 h; p=0.0207 and p=0.0244, respectively). Finally, microscopic tissue structure was assessed using hematoxylin and eosin-stained liver slices by a blinded pathologist. Livers that were stored with GLY showed the most unfavorable results, which agrees with perfusion metrics reported above. In contrast, favorable to modest results were observed for livers stored in the presence of EG and PG.

Effects of storage temperature and duration on liver viability after partial freezing: Livers stored with PG and EG clearly outperformed GLY livers. While EG livers showed comparable if not slightly favorable results upon histological analysis, PG showed significantly higher viability in most perfusion parameters described above. For these reasons, we used PG as the main permeating CPA to test the effect of freezing temperature (−10° C. vs −15° C.) and storage duration (1 vs 5 days) on viability after partial freezing.

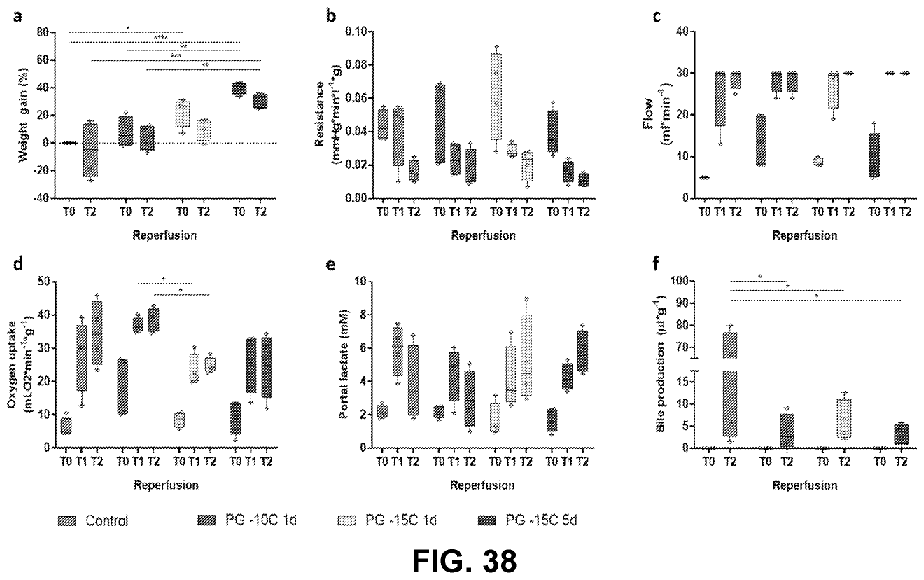

While there was no statistically significant change in weight gain during simulated transplantation of 1 day frozen livers at −10 and −15° C. (FIG. 38a), the increase in storage duration from 1- to 5-days resulted in significantly higher weight gain during SNMP recovery after freezing (40.00±4.32% at 3 h) that did not normalize during simulated transplantation (FIG. 38a, 30.25±5.56% at 2 h). Vascular resistance (FIG. 38b) was not significantly different after freezing at −10° C. and −15° C. (0.019±0.011 vs 0.021±0.010 mmHg*min*mL⁻¹*g⁻¹ at 2 h during simulated transplantation, respectively) as well as between livers frozen for 1- and 5-days (0.011±0.004 vs 0.021±0.021 mmHg*min*mL⁻¹*g⁻¹ at 2 h, respectively).

Although vascular resistance across all groups were comparable, parameters of liver function were negatively affected by the lower freezing temperature, yet unchanged by the increase in storage duration. The oxygen uptake during simulated transplantation (FIG. 38d) was significantly reduced after freezing at −15° C. for 1 day compared to −10° C. for 1 day (23.47±4.68 vs 36.86±2.34 at 1 h; 24.85±2.38 vs 38.22±3.66 mLO₂*min⁻¹*g⁻¹ at 2 h; p=0.0443 and p=0.0447, respectively), although not markedly different when comparing freezing at −15° C. for 1 vs 5-days (24.85±2.38 vs 25.35±9.78 mLO₂*min⁻¹*g⁻¹ at 2 h). Similarly, livers frozen at −15° C. for 1 day did not clear lactate during simulated transplantation while livers frozen at −10° C. for 1 day did (FIG. 38e), although differences between the lactate levels at the discrete time points did not reach statistical significance. When comparing livers frozen to −15° C. for 1- and 5-days, no lactate clearance was observed and lactate levels at the end of simulated transplantation were comparable (5.21±2.67 vs 5.73±1.29 mM at 2 h, respectively).

Even after freezing for 5 days at −15° C., livers produced bile during simulated transplantation (FIG. 38f); and this was not significantly different in livers that were frozen for 1 day at −15° C. (3.32±2.43 vs 6.11±4.69 μl*g⁻¹) or 1 day at −10° C. (3.32±2.43 vs 3.56±4.02 μl*g⁻¹); however, we note that the production after freezing for 5 days was significantly lower than controls (38.61±40.66 μl*g⁻¹, p=0.0111). With respect to tissue adenylate energy charge, all experimental groups showed a decreasing trend in adenylate energy charge as compared to controls (0.24±0.073), although only livers stored at −15° C. for 1 day (0.061±0.019; p=0.0004) and 5 days (0.062±0.029, p=0.0004) reached statistical significance.

With respect to markers of hepatocellular injury, the AST levels were significantly higher after freezing at −15° C. for 1 day compared to after freezing at −10° C. for 1 day (1283±224 vs 567±172 U/L at 1 h and 1995±530 vs 979±521 U/L at 2 h; p=0.0035 and p<0.0001, respectively) and this same trend was also evident in the ALT levels. The maximum potassium and ALT values during simulated transplantation after 1- and 5-days freezing at −15° C. were the same (potassium=5.05±0.48 vs 4.95±0.48 mM at 2 h; ALT=2335±597 vs 2316±242 U/L at 2 h, respectively). Finally, analysis of microscopic tissue structure showed livers stored at both −10° C. and −15° C. for 1 day showed some disruption of the lobular architecture with intact portal triads and hepatocyte swelling, although livers stored at −15° C. showed more loss of LSECs. For livers stored at −15° C. for 5 days, the central veins also showed early subendothelial congestion and endothelial cell disruption with moderate to marked loss of LSECs.

Effects of a perfusion system with a clinical grade oxygenator on liver viability after partial freezing: The flexibility, accessibility, and low cost of non-clinical grade oxygenator's enabled careful characterization of the effects of various permeating CPAs as well as storage temperature and duration on liver viability collected during ex vivo simulated transplantation. While normothermic temperatures and the presence of whole blood are essential to fully realize tissue injury, recirculating whole blood may interact with the surfaces of the perfusion system, thereby triggering coagulation and inflammatory events that are not reflective of in vivo events. As such, we improved our perfusion system by substituting with a clinical grade oxygenator (Affinity Pixie Oxygenator) that contains a hydrophilic polymer coating to reduce platelet adhesion and activation. We also determined perfusion outcomes that compare control data (1 day hypothermic preservation) using the Radnoti versus Affinity Pixie Oxygenator (denoted as “Clinical Oxy. Control”), as compared to livers that were partially frozen in the presence of propylene glycol (PG) at −15° C. for 1 and 5 days with the Affinity Pixie Oxygenator (denoted as “Clinical Oxy. PG”).

Liver weight gain during simulated transplantation was not significantly different for 1 day livers (12.00±8.66% at 2 h) but significantly elevated for 5 days livers (26.00±15.13% at 2 h; p=0.020), as compared to Clinical Oxy. Controls (−4.67±5.13% at 2 h). Vascular resistance was not significantly different after freezing at −15° C. for either 1 day (0.004±0.002 mmHg*min*mL-i*g⁻¹ at 2 h) or 5 day (0.007±0.010 mmHg*min*mL-i*g⁻¹ at 2 h), as compared to Clinical Oxy. Controls (0.010±0.001 mmHg*min*mL-i*g⁻¹ at 2 h) for all time points during simulated transplantation. By the end of simulated transplantation, parameters of liver function, including oxygen uptake and portal lactate, were similar with no statistically significantly differences observed across all experimental groups and controls. However, bile production was significantly reduced when comparing 1 day (0.67±0.92 μl*g⁻¹ at 2 h) and 5 day livers (2.92±3.74 μl*g⁻¹ at 2 h) partially frozen at −15° C., as compared to the Clinical Oxy. Controls (62.02±51.72 at 2 h). Despite a 5-fold longer storage, livers that were partially frozen for 5 days at −15° C. (0.131±0.031) did not show a statistically significant difference in tissue adenylate energy charge as compared to Clinical Oxy. Controls (0.242±0.084).

At the end of simulated transplantation, potassium levels were significantly elevated in experimental groups (Clinical Oxy. PG −15 1 day was 5.23±0.252 vs 5 day was 5.167±0.404 mM) as compared to Clinical Oxy. Controls (3.65±0.311). While the maximum AST and ALT values for partially frozen livers at −15° C. for 1 (AST 958.67±278.50 U/L; ALT 722.00±155.74 U/L) and 5 day (AST 1190.33±117.35 U/L; ALT 886.67±241.80 U/L) were significantly elevated above controls (AST 49.00±4.00 U/L; ALT 23.33±8.39 U/L), these values are nonetheless favorable in comparison to other literature values which approach ˜3,000 U/L46,47. We also quantified changes in DAMPs, including cfDNA, 8OHdG, TNFα, and HSP70. While an increasing trend was observed in cfDNA and HSP70 collected from partially frozen versus control livers, this mostly did not reach statistical significance, except for an increase in HSP70 between 1 day frozen and Clinical Oxy. Controls. In contrast, there were no changes in TNFα levels across all groups and 8OHdG values were significantly lower in frozen livers versus controls.

Discussion: The donor organ shortage indirectly claims hundreds of thousands of lives each year (see, e.g., ref. 1). The limited preservation time of donor organs has repeatedly been identified as a bottleneck in solving this crisis and additionally hinders translation of emerging technologies, such as immune tolerance induction and organ engineering approaches (see, e.g., ref. 1, 8, 19, 42). While benefits of extremely low preservation temperatures that near-completely halt metabolism and theoretically enable lifetime organ banking are obvious, both deep cryogenic freezing and vitrification approaches have inherent limitations that are directly coupled to the storage temperatures and have been proven hard to overcome (see, e.g., ref. 17, 18, 42). Instead of lifetime banking of donor organs, the current need for extended preservation can be met by extending the preservation time from a matter of hours to several days or weeks, which does not necessitate such low storage temperatures. In this capacity, we explored liver preservation at high-subzero temperatures (−10° C. to −15° C.) to benefit from substantial metabolic rate depression while abating challenges in deep cryogenic preservation. In particular, we developed a protocol for gradual CPA delivery/removal and reducing ice-dependent injury during high subzero freezing of rodent livers.

Preservation endeavors of whole organs in the frozen state at high subzero temperatures are limited and have thus far been unsuccessful. With the first report dating back to 1966, canine livers were frozen for 1 day to 2 weeks at −20° C. using Glycerol (33% vol/vol). Substantial endothelial injury and disruption of tissue architecture was observed, and no animals survived after orthotopic transplantation (see, e.g., ref. 23). Three decades later, attempts were made to translate learnings from freeze tolerant animals to mammalian livers. Rat livers were only frozen at −2° C. for 2 hours using glycerol (GLY) and antifreeze proteins derived from arctic fish. Despite relatively high subzero temperatures and short storage durations, success was limited by excessive endothelial injury after freezing (see, e.g., ref. 21, 22). Since these first and only attempts more than 20 years ago, no one has attempted to mimic freeze-tolerant strategies in nature for the purpose of whole organ preservation, and we aimed to be the first to show functional recovery of partially frozen grafts. In recognizing the challenges of high subzero freezing approaches, especially with respect to endothelial injury, we recently leveraged tissue engineering techniques to build on current knowledge and interrogate the impact of cryopreservation approaches on endothelial cells adherent to a structural scaffold (see, e.g., ref. 20). With direct microscopic observation in endothelialized microchannels, we introduced an INA (Snomax) and modem intracellular and extracellular CPAs (3-O-methyl-D-glucose and poly(ethylene glycol), respectively) to rescue endothelial cells from injury during partial freezing at −10° C.

With a deeper understanding of endothelial injury during high subzero freezing and identification of key protective strategies, we focused our initial optimization strategies on safely delivering CPAs to protect endothelial cells. Such strategies can include gradual and controlled perfusion of cryoprotective agents (see, e.g., ref. 49-53), as well as gradual (un)loading and the presence of osmotic counter ions. As described herein, we compared the effects of glycerol (GLY), ethylene glycol (EG) and propylene glycol (PG) on liver viability after partial freezing at −10° C. to a control group of conventional hypothermic preservation (+4° C.), both of which were stored for 24 hours. It should be noted that equivalent volumes of these permeating CPAs were used in the final storage solution (see Table 7), yet their molecular masses differ (EG 62.07 g/mol, PG 76.09 g/mol, GLY 92.09 g/mol). Since depression of freezing point or amount of total ice at a given temperature can be considered a molar effect, these differences could be one factor that influenced outcomes, in addition to compounding stressors such as viscosity and toxicity. We showed that the use of PG as the main permeating CPA during partial freezing substantially improves liver function and reduces injury compared to the use of GLY or EG (FIGS. 37-38).

Furthermore, liver function—based on oxygen uptake and lactate clearance—in livers that were frozen for 24 hours at −10° C. with PG was the same as transplantable control livers. Impaired oxygen consumption has been shown to correlate to transplant survival in preclinical studies (see, e.g., ref. 13, 54, 55). Whereas the implications of oxygen consumption during NMP in clinical setting are unclear, lactate clearance translated well to clinical studies and is considered a useful parameter for determining liver viability (see, e.g., ref. 2, 41, 56-58). In contrast to lactate and oxygen consumption, all frozen livers produced significantly less bile and released significant more transaminases after freezing, as compared to controls. Preclinical studies showed that reduced bile production and elevated transaminase levels can negatively correlate to transplant survival (see, e.g., ref. 13, 54). In a clinical setting, bile production and low transaminase levels during NMP are considered favorable however not necessary for safe transplantation of the graft if other parameters are viable (see, e.g., ref. 41, 48, 57). Nonetheless, in the present study, we consider these as potential signs of hepatocellular injury after freezing.

The differences in post freezing viability as a function of various permeating CPAs could be explained by one or more factors. First, GLY, EG, and PG have different toxicity profiles. These agents were loaded at hypothermic temperatures to reduce potential toxicity; however, even at low temperatures potential toxicity as a result of the extended exposure should be considered. Although specific information about liver toxicity of the used CPAs at the temperatures and concentrations we implemented is limited, in general PG is considered less toxic than EG which is consistent with the post freezing viability that we found in the present study (see, e.g., ref. 17). Second, the CPAs have different membrane permeabilities, with EG being the fastest and GLY the slowest to diffuse through cell membranes. To reduce the osmotic gradients, we gradually increased the CPA concentrations and used the extracellular (non-permeating) CPAs trehalose and raffinose. However, the increase in CPA concentration during preconditioning and the trehalose and raffinose concentrations were the same between groups. Without wishing to be limited by mechanism, this approach may have caused differences in transmembrane osmotic stress between the experimental groups. Third and finally, the CPAs have different physical properties that influence ice formation—e.g., witnessed by the differences in CPA-water phase diagrams (see, e.g., ref. 48, 59)—which may impact freezing injury.

After identification of PG as the preferable permeating CPA for partial freezing, we aimed to systematically address the effect of deeper storage temperatures (by comparing −10 and −15° C. storage temperatures for 24 hours) vs longer preservation times (−15° C. storage for 24 hours vs 5 days). First, the reduction in temperature from −10° C. to −15° C. resulted in significantly reduced metabolic function after partial freezing. This was evident from a reduction in oxygen uptake as well as lack of lactate clearance during simulated transplantation in the livers that were partially frozen at −15° C. In addition to the negative impact on liver function, the reduction of the freezing temperature may have also led to a significant increase in hepatocellular injury that was conspicuous from the higher levels of transaminase release during simulated transplantation.

Lowering the freezing temperature has three potential consequences that may explain the observed reduction in liver viability at −15° C. as compared to −10° C. First, without wishing to be limited by mechanism, when water freezes, solutes are excluded from the growing ice crystal which increases the osmolarity and therefore decreases the freezing point of the unfrozen water fraction. This can result in a physical equilibrium between the temperature and the amount of ice present in the organ. Thus, a lower freezing temperature can result in more ice and osmotic shock, resulting in potentially more injury. Second, the physical structure and dynamics of the ice crystal growth can be directly dependent on temperature (see, e.g., ref. 60) and becomes increasingly injurious at lower temperatures. Although experimental studies and natural model systems suggest this is especially the case at lower temperatures than those used in the present study, this effect cannot be completely excluded. Third, cold temperatures can increase the rigidity of lipid membranes. For supercooling preservation, we overcame this by using 35 kDa PEG to provide cell membrane stabilization at subzero temperatures (see, e.g., ref. 14). We anticipated this effect may be aggravated at the lower temperature during partial freezing. Therefore, we leveraged the cell stabilizing properties of trehalose and raffinose (see, e.g., ref. 61) in addition to PEG during partial freezing at −10° C. However, it must be noted that the PEG, trehalose, and raffinose concentrations were the same in both −10° C. and −15° C. experimental conditions.

We also aimed to evaluate the impact of longer preservation durations by comparing 24 hour vs 5 day preservation at −15° C. These preservation lengths were chosen since for every 10° C. temperature reduction, the metabolic rate is approximately reduced by a factor 2-2.5 (see, e.g., ref. 14). Further, based on the 100% transplant successes that our group previously achieved after 24 hour storage at 4° C. and 72 hour supercooled storage at −6° C. followed by SNMP recovery, we estimated that a storage temperature of −15° C. with SNMP recovery would enable an increase in the preservation duration to 5 days (see, e.g., ref. 14, 15, 54). Increasing the storage duration from 1 to 5 days caused a moderate increase in edema, while all other viability parameters of liver function and injury during simulated transplantation were largely unaffected by the substantially increased storage duration. In conjunction with the results of the 24 h partially frozen livers at −15° C., this suggests that the major contributor to injury is the process of freezing/thawing and not extended subzero preservation duration. It seems that the low storage temperature provides adequate depression of metabolism and livers can be stored for 5 days without considerable reduction in viability, as compared to livers stored for 1 day at the same temperature. However, we emphasize that this deduction should be made with caution as both the 1- and 5-day frozen livers show reduction in viability after partial freezing at −15° C.

The protocol can be modified in any useful manner, e.g., to improve viability and result in successful liver transplantation after partial freezing. In one instance, the cooling rate can be modified. For example, the importance of the cooling rate and maintaining a critical cell volume has been shown to be of importance to avoid injury in studies with liver slices of the wood frog (see, e.g., ref. 62, 63). Optimizing the cooling rate during freezing and its effect on ice formation and osmotic cellular dehydration may, in some instances, improve organ viability after freezing. Additionally, the amount of ice present in the organ can be dependent on the temperature and CPA concentration. We optimized the permeating CPAs—and thus indirectly the liquid vs frozen fractions—at a freezing temperature of −10° C. When we tested the lower freezing temperature at −15° C., we deliberately did not increase the PG concentration to avoid confounding the results as a function of temperature and storage duration. However, increasing the CPA concentration may supersede the increased amount of ice present during freezing at lower temperatures and therefore improve viability. Although we tested three important permeating CPAs, others (e.g., dimethyl sulfoxide, methyl formamide, urea, and the like) could be explored. Furthermore, a cocktail of several lower dosed permeating CPAs may be explored to improve freezing outcomes. In addition, cell membrane stabilization by introducing other CPAs could be considered. Finally, we used a UW solution as the base for the storage solution. Although storage solutions with high potassium concentrations may be used during hypothermic storage, ice formation increases the electrolyte concentrations in the unfrozen water fraction. A carrier solution with a lower potassium concentration that increases to intracellular levels during freezing could be explored to potentially reduce transmembrane osmotic stress.

In summary, we developed a protocol for partial freezing of rat livers for the longest storage duration (up to 5 days) and deepest high subzero storage temperatures (−10° C. to −15° C.) that incorporates new advances in the field of cryopreservation and machine perfusion. Using this protocol, we demonstrated multiple essential strategies that significantly improve post freezing liver viability, including the process of (un)loading and strategic selection of CPAs. Such protocols may be employed to reduce hepatocellular injury after freezing before successful transplantation of the frozen grafts.

### Example 7: Non-Limiting Materials and Experimental Methods

Experimental design: As shown in FIG. 36, the liver partial freezing protocol entails nine consecutive steps; (1) procurement of the liver, (2) preconditioning during subnormothermic machine perfusion (SNMP), (3) preloading of CPAs during hypothermic machine perfusion (HMP), (4) loading of the final storage solution during HMP, (5) freezing, (6) thawing, (7) unloading of CPAs during HMP, (8) functional recovery during SNMP, and (9) viability assessment during ex vivo simulated transplantation.

Within this standardized protocol, we first compared GLY, EG, and PG as main permeating CPA using a freezing temperature of −10° C. and storage duration of 1 day (FIG. 37). Using PG as the CPA, we subsequently tested the effect of freezing temperature (−10° C. vs −15° C.) and storage duration (1 day vs 5 days) on liver viability after partial freezing using the same protocol (FIG. 38).

Once understanding the effects of various permeating CPAs as well as the effect of storage temperature and duration on liver viability after freezing, we improved our perfusion system by substituting the Radnoti (Cat #130144) with an Affinity Pixie Oxygenator (Cat #BBP241). The Affinity Pixie Oxygenator is a clinical grade oxygenator that has graduated fiber bundle density technology and radial flow path that is designed to create a more uniform blood flow, enhance gas transfer, reduce pressure drops, and decrease prime volume. Moreover, it also contains a Balance® Biosurface that contains a hydrophilic polymer coating to reduce platelet adhesion and activation. This adaptation to the oxygenator is essential since recirculating whole blood during simulated transplantation may trigger coagulation and inflammatory events that are not representative of in vivo events and could skew observed outcomes.

An additional control group of 1 day HP (+4° C.) was included as our previous studies have repeatedly shown this duration of conventional preservation results in 100% transplant survival in the same animal model. After freezing, liver viability during SNMP recovery and ex vivo simulated transplantation was compared between the experimental group and a hypothermic preservation control group.

Machine perfusion system: The perfusion system provides a continuous perfusion through the portal vein that is pressure, flow, and temperature controlled. The perfusates can be either recirculated or flushed with a single pass though the liver and perfusates can be changed without interrupting perfusion. The setup and operation of the perfusion system is described in detail elsewhere (see, e.g., ref. 15). There were two oxygenators used in this study, including the Radnoti (Cat #130144) and Affinity Pixie Oxygenator (Cat #BBP241). Due to the flexibility and low cost of the Radnoti oxygenator, it was first used for initial optimization and characterization studies, including determining the effect of permeating CPAs (GLY vs EG vs PG; FIG. 37), temperature (−10 vs −15° C., FIG. 38) storage duration (1 vs 5 days, FIG. 38), and warm ischemic injury. Once the major aspects of the protocol were optimized and characterized, we used the clinical grade Affinity Pixie Oxygenator.

Liver procurement: The experimental protocol was approved by the Institutional Animal Care and Use Committee (IACUC) of Massachusetts General Hospital (Boston, MA). Livers were procured from male Lewis rats (250-300 g, age 10-12 weeks. Charles River Laboratories, Wilmington, MA). The rats' bile duct was cannulated and were then heparinized with 30U (see Table 8 for suppliers of reagents).

TABLE 8
List of suppliers for each reagent used in partial freezing solutions

| Reagent | Supplier |
|---|---|
| University of Wisconsin (UW) solution | Bridge to Life |
| Williams' Medium E | Sigma-Aldrich |
| Insulin (Humulin R) | MGH pharmacy |
| Sodium heparin | MGH pharmacy |
| Dexamethasone | Sigma-Aldrich |
| Hydrocortisone | MGH pharmacy |
| Penicillin-Streptomycin | Invitrogen |
| L-Glutathione | Sigma-Aldrich |
| Bovine Serum Albumin (BSA) | Sigma-Aldrich |
| 35 kDa Polyethylene glycol (PEG) | Sigma-Aldrich |
| Hydroxyethyl starch 130/0.4 (HES) | AK Scientific |
| 3-O-methyl glucose | Chem-Impex |
| D-Raffinose pentahydrate | Chem-Impex |
| D-(+)-Trehalose dihydrate | Sigma-Aldrich |
| Glycerol | Fisher Scientific |
| Ethylene Glycol | Fisher Scientific |
| Propylene Glycol | Fisher Scientific |
| Snomax | Telemet |

The portal vein's splenic, gastric branches and hepatic artery were all ligated. The portal vein was then cannulated with a 16 gauge catheter and immediately flushed with 40 ml heparinized saline (1000 U/ml at room temperature). Next, the liver was freed from the abdomen and flushed with and additional 20 ml of heparinized saline to remove any residual blood within the liver. The perfusion was always initiated within 5 minutes of procurement, except for livers that were exposed to a warm ischemic event. After procurement, warm ischemic livers were held at 34° C. for 30 minutes in the presence of lactated Ringers solution prior to initiation of perfusion, as we have done before (see, e.g., ref. 55).

Hypothermic preservation: During procurement, the livers were flushed with ice cold instead of room temperature heparinized saline. After removal of the liver from the abdomen, the livers were directly flushed with 30 ml of ice-cold University of Wisconsin solution (UW). The livers were place in a bag with 50 ml of ice-cold UW and stored at 4° C. for 24 hours.

Partial freezing protocol: Components of compositions used during this protocol are provided in Table 7. Suppliers for components are provided in Table 8.

Preconditioning during SNMP: Directly after procurement the livers were perfused with 250 ml of SNMP preloading solution (see Table 7 for composition of all solutions). The perfusion temperature was set at 21° C. and perfusion was initiated at 5 ml/min. The flows were gradually increased (1 ml/min) until a maximum perfusion pressure of 5 mmHg or flow of 25 ml/min was reached. Next, the livers were perfused for 30 additional minutes to allow for cellular uptake of 3-O-methyl-D-glucose (3-OMG).

Preloading of CPAs during HMP: The SNMP preloading solution was gradually switched to HMP preloading solution in 10, 25 ml increments, each with 10% decreasing and 10% increasing volumetric fractions of SNMP and HMP preloading solution, respectively. During this switch, the perfusion temperature was lowered to 4° C., and flows were adjusted to a maximum perfusion pressure of 3 mmHg. Dependent on the flowrate, the solution switch took 10-15 minutes. The HMP preloading was continued for 30 additional minutes to ensure complete equilibration of the solution throughout the peripheral liver tissue.

Loading of the final storage solution during HMP: Next, the CPA concentrations were gradually increased whereby the base solution was switched from William's Medium E (WE) to University of Wisconsin (UW) solution. This was done in 10 fractions of 10 ml, each with 10% decreasing and 10% increasing volumetric fractions of HMP preloading solution and storage solution, respectively. During this switch, the perfusion temperature was maintained at 4° C., and the flowrates were lowered to ensure a maximum perfusion pressure of 3 mmHg. The final 15 ml fraction of 100% storage solution was loaded at a fixed flowrate of 0.5 ml/min.

Partial freezing: After loading of the storage solution, the liver was placed in a bag with 50 ml fresh storage solution and suspended in a pre-cooled chiller (Engel, Schwertberg, Austria). Depending on the experimental condition the chiller temperature was pre-cooled to −10° C. or −15° C. and the liver stored for 1 of 5 days.

Thawing: After storage, the liver with the frozen storage solution was removed from the bag and placed in a 37° C. bath (Thermo Fisher, Waltham, MA) with 50 ml thawing solution. The bath was turned off, and the liver was gently agitated until thawed. This took 5 minutes and resulted in a final bath and a liver surface temperature of 4° C.

Unloading of CPAs during HMP: The liver was connected to the perfusion system and perfused with thawing solution for 30 min at a constant flow rate of 2 ml/min and a temperature of 4° C. Next, the perfusion temperature was increased to 21° C., and flows were adjusted to a maximum perfusion pressure of 5 mmHg once the liver reached 21° C. Also, the thawing solution was gradually switched to SNMP recovery solution in 10, 25 ml increments, each with 10% decreasing and 10% increasing volumetric fractions of thawing and SNMP recovery solution, respectively.

Functional recovery during SNMP: After rewarming and gradual removal of the storage solution, the livers were perfused with 300 ml of SNMP recovery solution that was recirculated during 3 hours of perfusion using a maximum perfusion pressure of 5 mmHg and up to a flow of 25 ml/min.

Simulated transplantation model: All whole blood from one Lewis rat (˜13 ml) was reconstituted up to a total volume of 100 ml with supplemented WE solution (Table 7). The whole blood solution was stored at 21° C. and always used within 4 hours of blood draw. The perfusion system was emptied and primed with 100 ml whole blood solution and the temperature was increased to 37° C. while the livers were briefly disconnected from the system to be weighed. For the control group, the system was primed the same and the UW solution was flushed from the livers with 25 ml of ice-cold saline before the livers were connected to the machine perfusion system. For all livers a maximum perfusion pressure of 11 mmHg and up to a flow of 30 ml/min was used once the livers reached a normothermic temperature of 37° C., and reperfusion was continued for 2 hours.

Viability assessment: Perfusate measurements were performed hourly during the functional recovery and ex vivo simulated transplantation, unless otherwise specified. PO₂, O₂ saturation, pH, and Lactate were measured in the inflow (portal vein) and outflow (infrahepatic vena cava), and potassium and glucose were measured only in the outflow using an i-STAT blood analyzer (Abbott, Chicago, IL). AST and ALT concentrations were measured in the outflow using the Piccolo Xpress Chemistry Analyzer (Abbott). Perfusate samples were also collected at 1 h during simulated transplantation for quantification of damage-associated molecular patterns (DAMPs). Perfusate samples were centrifuged at 5000 g, and the plasma stored at −80° C. for subsequent analysis. Enzyme-linked immunosorbent assays were performed according to manufacturer instructions for the following: cell-free DNA (Thermo Fisher, P7589), heat shock protein 70 (HSP70, Abcam, ab133061), tumor necrosis factor-alpha (TNFα, Abcam, ab236712), and 8-hydroxy 2-deoxyguanosine (8-OHdG, Abcam, ab201734).

Liver weight: Liver weight was measured directly after procurement, just prior to freeze, post thaw, post recovery, and after simulated transplantation. Weight gain was calculated as the percentage weight increase and any time point compared to the liver weight after procurement.

Bile production: Cumulative bile production was measured by weighing the bile-containing Eppendorf tube on a microscale at the end the functional recovery step of the partial freezing protocol at the end of simulated transplantation a microscale.

Wedge Biopsies: Wedge biopsies were taken at the end of simulated transplantation. Biopsies were either fixed in buffered 5% formaldehyde for 24 h and stored in 70% ethanol until outsourced processing and staining for hematoxylin and eosin staining (Massachusetts General Hospital Histology Molecular Pathology Core). Hematoxylin and eosin-stained slides were blindly assessed by an experienced liver pathologist (E.O.A.H). Processed slides were scanned under x40 magnification using an Aperio ImageScope (Leica Biosystems). Additional wedge biopsies were flash frozen in liquid nitrogen and stored at −80° C. Adenosine triphosphate (ATP), adenosine diphosphate (ADP), adenosine monophosphate (AMP) were determined as described elsewhere (see, e.g., ref. 35). In short, the tissue was homogenized in liquid nitrogen and analyzed with targeted multiple reaction monitoring on a 3200 triple quadrupole liquid chromatography-mass spectrometry system (AB Sciex).

Data processing: Vascular resistance was calculated by dividing the perfusion pressure in the portal vein by the flow rate that was then corrected for weight of the liver after procurement. The oxygen uptake rate (OUR) was calculated by multiplication of the difference in the oxygen content in the inflow and outflow by the flow rate. We recently described the exact formula and calculation in detail elsewhere (see, e.g., ref. 13). The OUR was divided by the liver weight. Energy charge was calculated with the following formula: ATP+0.5ADP/(ATP+ADP+AMP).

Statistical analysis: All statistical analyses were performed with Prism 7.03 (GraphPad Software Inc., La Jolla, CA) with a (two-sided) significance level of 0.05. Repeated measures two-way ANOVAs were used for the comparison of the time-course perfusion data, followed by Tukey's post-hoc test to examine statistical differences between the experimental groups and to correct for multiple comparisons.

### Example 8: The Role of Antifreeze Glycopeptides (AFGP) and Polyvinyl Alcohol/Polyglycerol (X/Z-1000) Cocktails as Ice Modulators During Partial Freezing of Rat Livers

Abstract: The current liver organ shortage has pushed the field of liver transplantation to develop new methods to prolong the preservation time of livers from the current clinical standard of static cold storage. Our approach, termed partial freezing, aims to induce a thermodynamically stable frozen state at deeper storage temperatures (−10° C. to −15° C.) than can be achieved with supercooling, while simultaneously maintaining a sufficient unfrozen fraction to limit dehydration and ice damage. This research first demonstrated that partially frozen glycerol treated rat livers were functionally similar after thawing from either −10 or −15° C. with respect to subnormothermic machine perfusion metrics and histology. Next, we assessed the effect of adding either of two ice modulators, antifreeze glycoprotein (AFGP) and a polyvinyl alcohol/polyglycerol combination (X/Z-1000), on the viability and structural integrity of partially frozen rat livers compared to glycerol-only control livers. Results showed that AFGP livers had high levels of ATP and the least edema but suffered from significant endothelial cell damage. X/Z-1000 livers had the highest levels of ATP and energy charge (EC) but also demonstrated endothelial damage and post-thaw edema. Glycerol-only control livers exhibited the least DNA damage on Terminal deoxynucleotidyl transferase dUTP nick end labeling (TUNEL) staining but also had the lowest levels of ATP and EC. Further optimization of the ice modulator cocktail for our partial-freezing protocol is encompassed by the present disclosure. Modifications to cryoprotective agent (CPA) combinations, as well as improvements to machine perfusion CPA loading and unloading, could, in some instances, help improve the viability of these partially frozen organs.

Introduction: The liver organ shortage has pushed the field of transplantation to develop bold new strategies to preserve transplantable organs. Currently, the clinical standard of preserving transplantable livers is static cold storage (SCS) at 4° C., which keeps organs viable for a maximum of 12 hours (see, e.g., ref. 1). Prolonging this preservation time would improve the allocation of organs in many ways. For example, it could reduce organ discard due to unacceptably long ischemic times, lower operating room costs by making liver transplant (LT) operations elective, enhance donor-recipient selection with human leukocyte antigen (HLA) matching and global matching programs, and make tolerance induction protocols more feasible (see, e.g., ref. 2-4).

Preservation methods to slow organ deterioration after procurement can be broadly categorized into two strategies: metabolic support and metabolic depression. Metabolic support through ex-vivo machine perfusion allows for continuous quality and viability assessment of organs. However, the major challenge with long term machine perfusion is maintaining organ homeostasis ex vivo, which becomes exponentially more complex with longer perfusion durations that require continuous monitoring and adaptations (see, e.g., ref. 3, 5-8). On the other hand, metabolic depression strategies leverage the fact that tissue deterioration slows down at decreasing temperatures. Furthermore, lowering the hypothermic preservation temperature below 4° C. harbors great potential to extend preservation times beyond clinical standards and does not require the long-term, constant maintenance of machine perfusion (see, e.g., ref. 9).

Within metabolic depression preservation strategies, most subzero preservation efforts have centered on low cryogenic temperature ranges (<−80° C.) (see, e.g., ref. 3). However, recent work has investigated prospects for expanding storage within the high subzero temperature range from −4° C. to −20° C. These temperatures allow for more metabolic depression than hypothermic SCS, while also potentially avoiding lethal ice formation and vitrification-related cryoprotectant toxicity and thermal stresses. The most prominent present example of the potential of this approach has involved storage below the thermodynamic freezing point at −4° C. to −6° C. in the absence of ice (termed supercooling), which has enabled 3-fold extensions of liver preservation duration (see, e.g., ref. 9-11). While these studies have shown that ice formation in rodent and human livers can be completely circumvented with supercooling (see, e.g., ref. 9, 11, 12), the depth of metabolic stasis that can be achieved by this method is limited by the risk of spontaneous nucleation leading to damaging ice formation, which increases as temperature is lowered to below −6° C. (see, e.g., ref. 13).

Although there is extensive evidence that ice formation can be severely damaging in tissues and organs (see, e.g., ref. 14-17), recent studies based on the survival of frozen animals such as frogs and turtles in nature have suggested that carefully limited and controlled ice formation may be tolerable during attempted cryopreservation of solid organs (see, e.g., ref. 2, 18). Ishine et al. showed that ice modulators such as antifreeze glycoproteins (AFGP) can have protective effects in high subzero liver freezing protocols by inhibiting ice recrystallization and preventing ionic leakage through cell membranes at low temperatures, although the authors report damage to the endothelial layer. The authors froze their rat livers for 2 hours used livers frozen with glycerol as the only cryoprotective agent (CPA) as controls (see, e.g., ref. 19). Here, we aimed to test extended preservation durations (up to 5 days) in the presence of two ice modulators, antifreeze glycoprotein (AFGP) and a polyvinyl alcohol/polyglycerol combination (X/Z-1000), for their ability to confer freeze tolerance of rodent livers. The inclusion of these agents is called for in part because although the total quantity of ice present during long term storage at a fixed temperature is constant, the ice may still cause injury due to recrystallization that could be overcome by ice modulators.

AFGP has been shown to inhibit both ice recrystallization and ice growth below TM (the thermodynamic freezing point). These glycopeptides inhibit ice growth by attaching to multiple faces of ice crystals (see, e.g., ref. 20-23). AFGPs have also been shown to raise the homogenous ice nucleation temperature (TH) by organizing water into a more ice-like state (see, e.g., ref. 24). However, since the temperature range in our partial freezing protocol is well above TH (see, e.g., ref. 25), the issues at hand involve the role of AFGP in ice shaping and ice recrystallization inhibition. Although AFGP can shape ice into damaging spicules (see, e.g., ref. 26), this effect may be outweighed under our storage conditions by the ice growth and recrystallization inhibitory effects of AFGP. X-1000 is a 2 kilodalton (kDa) polyvinyl alcohol (see, e.g., ref. 27) that contains 20% vinyl acetate, which improves the solubility and ice-inhibiting effects of X-1000 presumably by preventing self-association between X-1000 chains. Polyvinyl alcohol is known to inhibit ice recrystallization (see, e.g., ref. 28, 29). Z-1000 is a polyglycerol that inhibits heterogeneous ice nucleation (see, e.g., ref. 30), and together X/Z-1000 has been shown to protect rat hearts during supercooling (see, e.g., ref. 31-33) and is functional from 0° C. to temperatures below −120° C. (see, e.g., ref. 16).

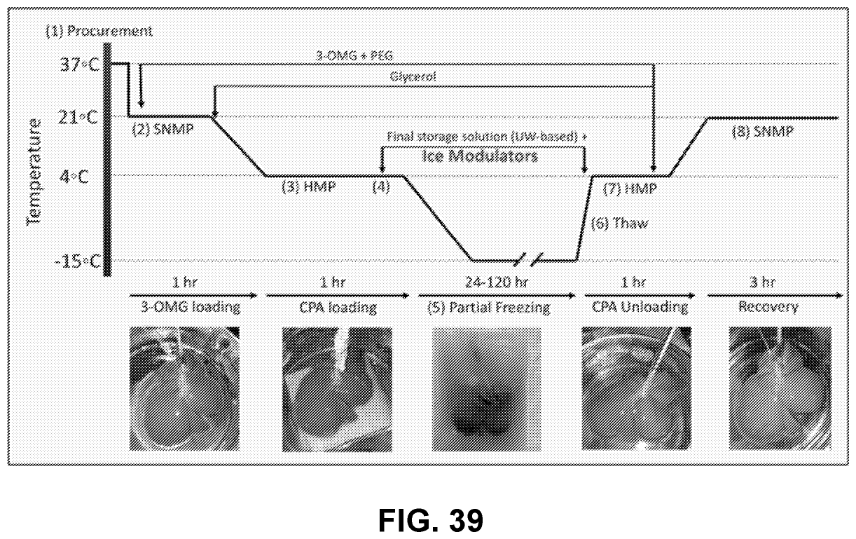

Here, whole rat livers were frozen for up to 5 days at high subzero temperatures (−10° C. to −15° C.) by combining glycerol and ice nucleating agents (INAs) with the use of subnormothermic machine perfusion (SNMP) at 21° C. Further, two ice modulators, antifreeze glycoprotein (AFGP) and a polyvinyl alcohol/polyglycerol combination (X/Z-1000), were tested. Livers frozen with the inclusion of either AFGP or X/Z-1000 were compared to the control group (with glycerol as the main CPA) with primary outcomes being perfusion metrics, ATP, energy charge (EC), weight gain, and histology. We call this protocol “partial freezing” (see, e.g., FIG. 39) since it induces a thermodynamically stable frozen state at deeper storage temperatures (as low as −15° C.) than can be achieved with supercooling, while simultaneously maintaining a sufficient unfrozen fraction to limit dehydration and ice damage.

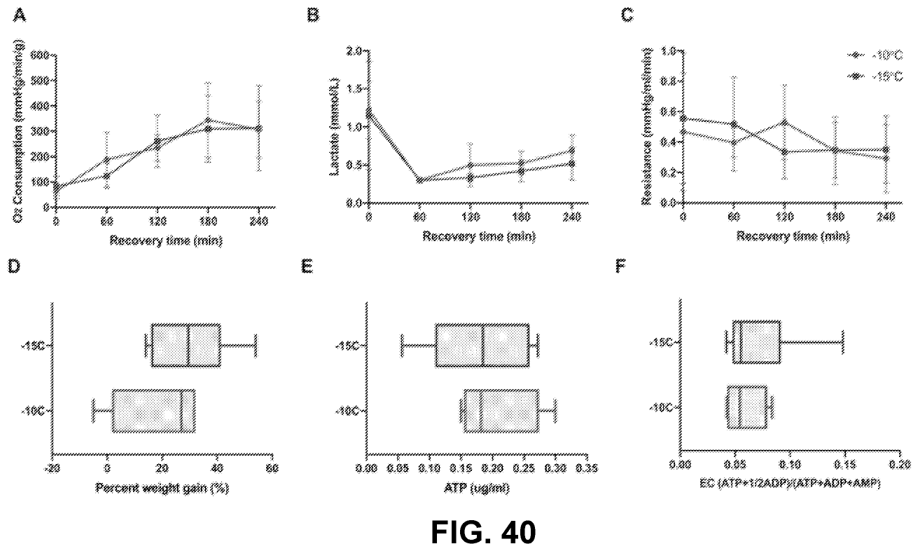

Comparison of partially frozen rat livers at −10° C. vs −15° C. with 12% glycerol: Pooled results for livers stored for 1 and 5 days at −10° C. (n=4) or −15° C. (n=9) with a cocktail containing 12% glycerol were compared 1 hour after CPA unloading and 3 hours after recovery with SNMP at 21° C. There was no statistically significant difference between the two groups with respect to oxygen consumption (FIG. 40A), PV lactate (FIG. 40B), vascular resistance (FIG. 40C), and perfusate potassium on two-way ANOVA/Tukey testing. Similarly, there were no statistically significant differences between −10° C. and −15° C. livers with respect to percent weight gain (FIG. 40D), ATP (FIG. 40E), and EC (FIG. 40F) by unpaired, two-tailed t-testing. Thus, rat livers partially frozen with 12% glycerol at −10° C. and −15° C. were not functionally different, and as a result, were grouped together to form a more statistically robust control group (n=13) for comparison against the ice modulator groups.

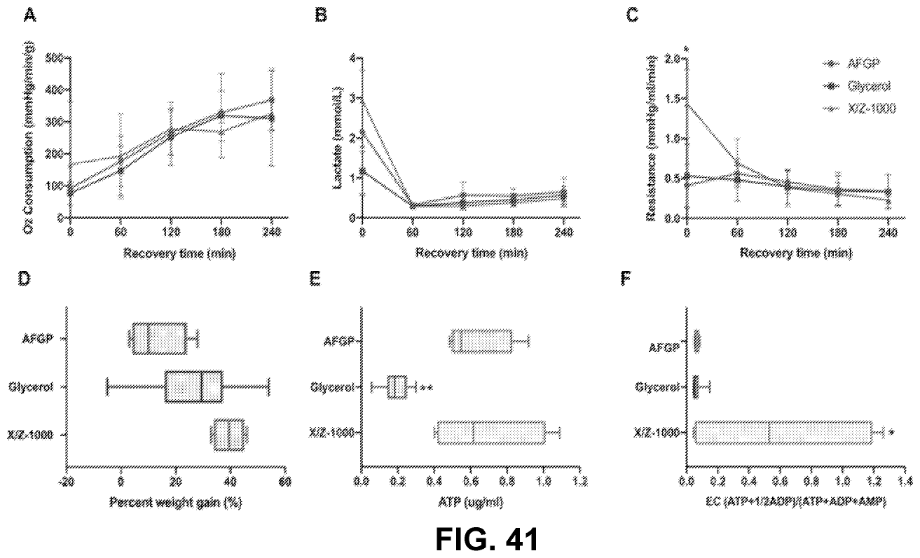

Comparison of partially frozen control rat livers to livers frozen with AFGP or X/Z-1000 ice modulators (pooled results for 1 and 5 days): There was no statistically significant difference between the three groups with respect to oxygen consumption based on two-way ANOVA/Tukey testing (FIG. 41A). Control glycerol-only livers had the lowest mean perfusate lactate (1.17±0.61 mmol/L) at time zero. Over the first hour of SNMP, there was a decrease in lactate among all three groups. There were no significant differences between the groups at any time point according to the two-way ANOVA/Tukey test (FIG. 41B). X/Z-1000 frozen livers had significantly higher mean vascular resistance (1.44±0.37 mmHg/[(ml/min)/g] at 0 hours compared to both 12% glycerol control livers (0.528±0.39 mmHg/ml/min, p-value 0.0315) and AFGP livers (0.413±0.27, p-value 0.0215) (by ANOVA/Tukey). However, these differences were no longer significant at the remaining time points as the resistance levels converged over time (FIG. 41C). At 1 hour, glycerol only livers had higher mean perfusate potassium levels (6.5±1.01 mmol/L) compared to both AFGP livers (5.1±0.22 mmol/L, p-value 0.0167) and X/Z-1000 livers (5.6±0.14 mmol/L, p-value 0.0275) (ANOVA/Tukey). However, these differences were no longer significant at the remaining time points as the potassium levels converged over time.

Final mean weight gains for the glycerol-only control, the +AFGP, and the +X/Z-1000 groups were 26.9±15.3%, 12.8±13.2%, and 39.5±5.69% respectively. Livers frozen with AFGP had the least edema, significantly less compared to X/Z-1000 livers (p-value 0.0294 by one-way ANOVA/Tukey; FIG. 41D). Mean ATP for the glycerol control group, AFGP, and X/Z-1000 were 0.187±0.075, 0.624±0.20, and 0.680±0.32 μg/ml respectively. ATP concentrations were significantly lower for livers stored with glycerol only compared with AFGP (p=0.0057) and X/Z-1000 (p=0.0023) (ANOVA/Tukey). There was no significant difference in ATP levels between AFGP and X/Z-1000 frozen livers (p=0.91) (FIG. 41E).

Finally, mean EC for the glycerol control group, AFGP, and X/Z-1000 was 0.066±0.032, 0.063±0.015, and 0.591±0.62 (ATP+1/2ADP)/(ATP+ADP+AMP) respectively. EC was dramatically higher in livers stored with X/Z-1000 and glycerol compared to glycerol alone (p=0.0159) and to glycerol plus AFGP (p=0.0428) (one-way ANOVA/Tukey). There was no significant difference in EC between AFGP and glycerol frozen livers (p=0.99) (FIG. 41F).

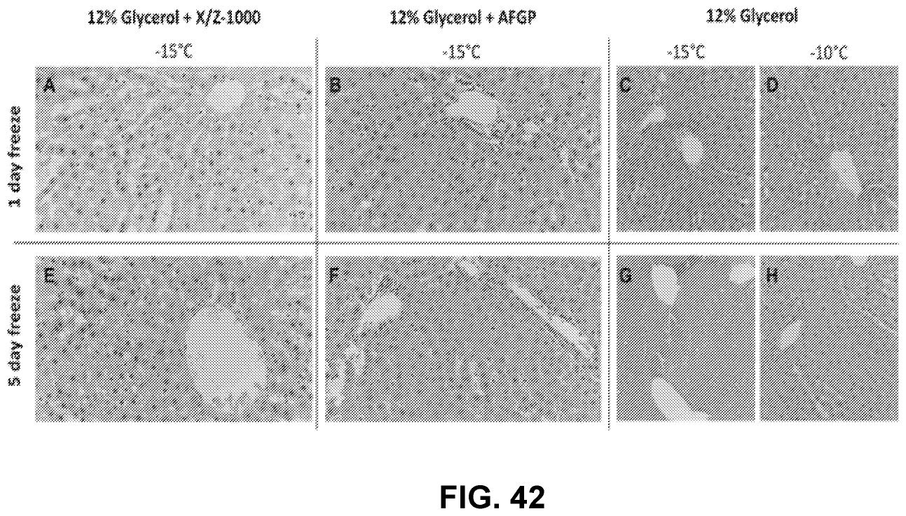

H&E staining of rat liver parenchyma following both 1 and 5 day partial freezing showed sinusoidal, hepatocellular, and endothelial cell damage in all groups. In glycerol plus X/Z-1000 frozen livers, H&E showed better preservation of sinusoidal patency (seemingly caused by less hepatocyte cell swelling) than seen in the other groups after 1 day of storage, which deteriorated somewhat after 5 days of storage. Endothelial patency also deteriorated between days 1 and 5, with almost complete endothelial cell destruction around the PV vasculature (after 1 day: FIG. 42A; after 5 days, FIG. 42E). After 1 day of storage, glycogen staining was decreased in glycerol plus X/Z-1000 livers, but not in the glycerol plus AFGP or glycerol-only groups. Glycerol plus AFGP frozen livers exhibited cellular swelling at the expense of sinusoidal patency and suffered from endothelial cell layer disruption that was mild after 1 day (FIG. 42B) and considerably worse after 5 days (FIG. 42F) of storage. Livers frozen with only glycerol at −10° C. had sinusoidal damage and compression, peri-portal endothelial destruction (FIG. 42D) and linear cracks in the liver parenchyma (FIG. 42H). Decreasing the storage temperature of these control glycerol livers to −15° C. did not alter the H&E pathology after either 1 (FIG. 42C) or 5 (FIG. 42G) days of frozen storage.

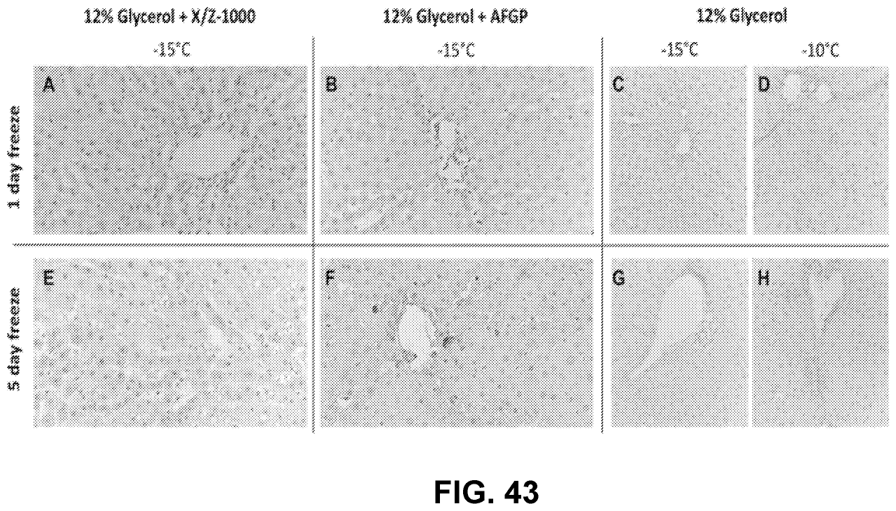

TUNEL staining was observed in both the endothelium and the sinusoids after 1 and 5 days of frozen storage in the presence of X/Z-1000, but appeared to be less intense after 5 days of storage (FIG. 43A and FIG. 43E). AFGP frozen livers had primarily endothelial staining with mild sinusoidal staining after 1 day (FIG. 43B), but after 5 days, TUNEL staining had increased both around the vasculature and within the sinusoids (FIG. 43F). Compared to the other groups, AFGP frozen livers at −15° C. and five days of partial freezing had the most TUNEL staining. Glycerol only livers stored at −10° C. had remarkably less TUNEL staining compared to X/Z-1000 and AFGP livers with only mild sinusoidal staining after 1 day (FIG. 43D), and 5 days (FIG. 43H) of storage. As in the H&E results, decreasing the storage temperature of glycerol only livers to −15° C. did not exacerbate TUNEL staining after 1 day (FIG. 43C) or 5 days (FIG. 43G) of storage.

Discussion: Extending the preservation time of donor organs has tremendous clinical application in the field of transplantation. For liver transplantation, lengthening the allograft preservation time from the current standard of SCS at 4° C. could reduce the burden placed on the healthcare system from high costs of unplanned surgeries, decrease organ rejection rates by incorporating more HLA typing into clinical practice, and possibly even open avenues for global matching programs (see, e.g., ref. 3, 35).

Prior cryogenic organ preservation efforts have typically (although not universally (see, e.g., ref. 36)) encountered either lethal (see, e.g., ref. 14, 15) or unacceptably damaging (see, e.g., ref. 16, 37-39) amounts of extracellular ice, or the challenge of introducing the enormous concentrations of CPA needed to preclude such damage (see, e.g., ref. 16, 40, 41). So far, these difficult challenges have not been adequately overcome, and therefore, other approaches should be investigated and may produce practical results more rapidly.

Our current approach primarily used cold but not cryogenic temperatures to extend organ preservation time. We explored rat liver preservation at high subzero temperatures (−10° C. and −15° C.) combined with recovery SNMP to maximize the benefits of metabolic rate depression and ex vivo organ assessment, while avoiding the dangers of deep cryogenic temperatures. Ice modulators have been shown to modify ice crystal shape and inhibit ice recrystallization, potentially decreasing ice-induced cellular damage. In the context of the partial freezing of rat livers, ice modulators create an intriguing opportunity to preserve organs at subzero temperatures in the presence of ice, allowing these stored organs to reap the benefits of deeper metabolic stasis than current hypothermic standards while avoiding ice-related cellular damage.

This study first demonstrated that rat livers frozen at −10° C. versus −15° C. with glycerol were functionally similar regarding perfusion metrics, cellular architecture, and DNA damage, indicating that the reduction in partial freezing did not significantly reduce metabolic function. The reduction in storage temperature from −10° C. to −15° C. can have implications for organ viability on a cellular level. As water freezes, solutes are excluded from the ice crystals, which increases the osmolality and reduces the freezing point of the unfrozen water fraction. Thus, a lower freezing temperature can result in more ice and a higher level of osmotic shift (see, e.g., ref. 42). In our case, 12% v/v glycerol (1.64M), equates to 1.86 molality. According to the freezing point depression approximation, freezing point is lowered by about 1.86° C. for every 1 osmolal increase in concentration. Adding the 0.3 osmolal contribution of the glycerol vehicle solution, the melting point of our storage media should be in the vicinity of −4° C. At −10° C., about 60% of the water in the solution will be converted to ice, and at −15° C., about 73% of the water will be frozen out, which is a significant increase. Although the membrane stabilizing saccharides, trehalose and raffinose (see, e.g., ref. 43) were employed, they do not enter cells and therefore may not nominally protect the inner membrane leaflet or reduce cell shrinkage induced by water extraction during freezing.

One aim of this research was to assess the effect of ice modulators such as AFGP and X/Z-1000 on partially frozen rat livers compared to glycerol-only controls. AFGP frozen livers had the least amount of edema and high levels of ATP. However, the AFGP-mediated ice modulation had adverse effects on endothelial cells, which was reflected in both H&E and TUNEL staining, particularly after prolonged storage. As the duration of freezing increased from 1 to 5 days, the AFGP TUNEL staining expanded from predominately endothelial damage to diffuse sinusoidal cellular damage as well. AFGP has an established role in dynamic ice shaping, ice recrystallization inhibition, and hysteretic freezing point depression (see, e.g., ref. 22, 44, 45). Since endothelial cells would make direct contact with the ice, it is possible that AFGP may be causing less favorable ice crystal shapes that are disrupting the endothelial cells of the liver. In a study by Rubinsky et al., antifreeze proteins resulted in the killing of all red blood cells during freezing despite the use of directional solidification methods that normally minimize ice damage (see, e.g., ref. 26, 46). Yet, AFGP may offer protection to hepatocytes through its other mechanism of action, ice recrystallization inhibition. (AFGP freezing point depression is typically limited to 1-2° C., which is smaller than the difference between our solutions' TMs and our chosen storage temperatures and therefore was not able to contribute a protective effect in these experiments). Isothermal freeze fixation (see, e.g., ref. 15) could be useful in future studies for relating the details of ice distribution and characteristics to observed outcomes (see, e.g., ref. 47).

X/Z-1000 was the second ice modulator combination assessed in this study. X/Z-1000 frozen livers had the highest ATP and by far the highest EC but suffered from the highest SNMP resistance at t=0 and had the most edema after recovery. On staining, X/Z-1000 frozen livers had less TUNEL staining compared to AFGP frozen livers, but still exhibited both endothelial and sinusoidal staining in excess of that seen for the glycerol only group. X/Z-1000 livers had a large variation in both ATP and EC levels, which could potentially be explained by the competing mechanisms of action of X-1000/Z-1000 with the potent ice nucleator, Snomax (see, e.g., ref. 30). Snomax would tend to reduce the number of ice crystals and, therefore, to increase their mean size and the range of grain sizes. Without wishing to be limited by mechanism, this might relate to the larger observed size of the sinusoids and to stochastic differences in local nucleation and ice crystal size that affected the consistency of hepatocyte viability. While X/Z-1000 is appealing for its high ATP and EC, the high level of edema after partial freezing is concerning and might also be related to vascular damage caused by larger local intravascular or interstitial ice grains, which would be consistent with previous observations by Rubinsky et al. relating injury in frozen livers to vascular distension by intravascular ice (see, e.g., ref. 48).

One non-limiting future direction related to this ice modulator should be to explore the use of X-1000, which is a recrystallization inhibitor, without the use of Z-1000, which is an antinucleator. On the other hand, total vascular distension should have been similar in all groups, as dictated by the phase diagram of glycerol-water solutions, and yet edema was more moderate in the glycerol-only group. In any case, X/Z-1000 seems promising for use with the isolation or preservation of isolated hepatocytes, for which maintenance of high ATP/EC would be the main goal.

Finally, glycerol-only control livers had the lowest lactate levels at t=0 and minimal TUNEL staining. However, these livers also had very low ATP and EC compared to the ice modulator groups. A potential biological reason for this difference is that glycerol induces glycerol kinase to convert glycerol to glycerol-3-phosphate, which is an ATP dependent pathway. Thus, the activity of glycerol as a CPA could depress ATP levels (see, e.g., ref. 49). The unexpected ability of both ice modulators to prevent this has no clear explanation, but it seemed that use of glycogen to generate ATP and lactate was more effective in the X/Z-1000 group and to a lesser extent in the AFGP group, based on more intense glycogen staining (suggesting less glycogen metabolism) in the glycerol-only group. It would be interesting to see if structurally unrelated small molecule ice recrystallization inhibitors (IRIs) (see, e.g., ref. 50) would have a similar effect and also better protect the vascular system. Without the effects of the ice modulators preventing damaging ice recrystallization, glycerol-only livers also consistently had parenchymal cracks and endothelial cell obliteration on H&E staining, despite adding Snomax and 3-OMG to rescue endothelial cells from partial freezing injury. Thus, the concept of adding ice modulation to the basic methodology for high temperature freezing appears to be well supported.

Finally, all liver groups cleared lactate over the 2 hour perfusion and (while incurring hepatocellular damage) had viable H&E histology after perfusion, meeting two criteria for transplantation (see, e.g., ref. 51, 52). Thus, future experiments transplanting these partially frozen livers after SNMP can be conducted to assess if perfusion performance correlates with in vivo hepatic function.

Overall, the ideal ice modulator combination to enhance the partial freezing protocol would retain the positive effects of high ATP and high EC seen in X/Z-1000, the low levels of edema with AFGP, without the cellular damage to endothelial and sinusoidal cells seen with both ice modulator groups. Thus, future directions to expand the preservation of livers for transplantation with the partial freezing approach depend on both modifications to the freezing protocol as well as the ice modulator combination. Specifically, increasing the CPA concentration to decrease ice formation at lower temperatures and improving the loading and unloading of CPAs with SNMP could improve liver viability. Additionally, there are other permeating CPAs that could be tested in the partial freezing protocol such as dimethyl sulfoxide, ethylene glycol, N-methylformamide, propylene glycol, and urea (see, e.g., 40, 53, 54). Finally, altering the base solution from UW to a lower potassium carrying solution could decrease the transmembrane osmotic stress in the unfrozen water fraction.

In summary, this work incorporated ice modulators into the rat liver partial freezing protocol to prolong the preservation time of livers. We demonstrated that there was no difference in partially frozen livers with only glycerol at −10° C. versus −15° C. with respect to perfusion metrics, cellular architecture, and DNA damage. Additionally, we showed that AFGP and X/Z-1000 ice modulators can have beneficial effects on partially frozen rat liver ATP and EC levels, respectively. Further compositions included in this disclosure can include, for instance, modifications to CPA combinations, as well as improvements to machine perfusion CPA loading and unloading, to improve the viability of partially frozen organs.

### Example 9: Non-Limiting Materials and Experimental Methods

Experimental design: FIG. 39 outlines the rat liver partial freezing protocol in eight consecutive steps: (1) liver procurement, (2) preconditioning during SNMP, (3) CPA preloading during hypothermic machine perfusion (HMP), (4) loading of final storage solution and ice modulators during HMP, (5) partial freezing of rat liver, (6) thawing of rat liver, (7) unloading of CPAs during HMP, and (8) functional recovery of frozen rat livers during SNMP.

Within this protocol, we first compared partially frozen livers at −10° C. (n=4 livers) and −15° C. (n=9 livers) with 12% glycerol. Upon finding minimal differences between these two groups, we combined them as a control and compared them to livers partially frozen with 0.5 mg/ml (0.05% w/v) of AFGP (n=4 livers) or 0.1% X-1000/0.2% Z-1000 (total, 0.3% w/v; n=4 livers) ice modulating agents added to the preservation solution. After freezing, liver viability on SNMP was compared between the 12% glycerol control group and the two ice modulated groups.

Partial freezing protocol: The rat liver perfusion system involved perfusion through the cannulated portal vein (PV) with regulation of pressure, flow, and temperature. Detailed set-up of the perfusion system has been previously described (see, e.g., ref. 34). The total rat hepatectomy protocol was approved by the Institutional Animal Care and Use Committee (IACUC) of Massachusetts General Hospital (Boston, MA). Livers were procured from male Lewis rats (250-300 g, age 10-12 weeks. Charles River Laboratories, Wilmington, MA) (FIG. 39, step 1). The bile duct was isolated and cannulated, and the rats were heparinized with 30U sodium heparin. PV splenic and gastric branches, as well as the hepatic artery were ligated prior to cannulation. The PV was subsequently cannulated with a 16-gauge catheter and immediately flushed with 40 ml of heparinized saline (1000U/ml at room temperature). The liver was then freed from all peritoneal attachments, flushed with an additional 20 ml of heparinized saline. After procurement, the liver was weighed, and machine perfusion was immediately initiated.

Preconditioning during SNMP was initiated at 21° C. with a flow rate of 5 ml/min (FIG. 39, step 2). The flow rate was gradually increased [(1 ml/min)/min] until a maximum PV pressure of 5 mmHg, or a flow rate of 25 ml/min, was reached (whichever was reached first). The rat livers were perfused for 1 hour with 500 ml of preconditioning solution including Williams E, 200 U/l of insulin, 2% w/v PEG, 50 g/L BSA, 100 mM 3-O-methylglucose (3-OMG), 10,000 U/l of heparin, 24 mg/L of dexamethasone, 25 mg/ml of hydrocortisone, 40,000 μg/l of penicillin, and 40,000 U/l of streptomycin and sodium bicarbonate as needed to maintain a physiological pH (see Table 9 for composition of all solutions).

TABLE 9
Composition of all solutions used in a non-limiting partial freezing protocol

| | Subnormothermic | | Hypothermic | | | | | | Subnormothermic | |
|---|---|---|---|---|---|---|---|---|---|---|
| | Preconditioning | | Preloading | | Storage | | Thawing | | Recovery | |
| | Solution | | Solution | | Solution | | Solution | | Solution | |
| Base solution | WE | | WE | | UW | | WE | | WE | |
| Total volume | 250 | ml | 250 | ml | 100 | ml | 250 | ml | 500 | ml |

Additives

| Insulin | 200 | U/l | 200 | U/l | 10 | U/l | 10 | U/l | 20 | U/l |
|---|---|---|---|---|---|---|---|---|---|---|
| Heparin | 10,000 | U/l | 4,000 | U/l | — | | 1,000 | U/l | 1,000 | U/l |
| Dexamethasone | 24 | mg/l | 24 | mg/l | 24 | mg/l | 24 | mg/l | 24 | mg/l |

| | | | | | | | | | |
|---|---|---|---|---|---|---|---|---|---|
| Hydrocortisone | 25 | mg/ml | 25 | mg/ml | — | 25 | mg/ml | 25 | mg/ml |
| Penicillin | 40,000 | μg/1 | 40,000 | μg/1 | — | 40,000 | μg/1 | 40,000 | μg/1 |
| Streptomycin | 40,000 | U/l | 40,000 | U/l | — | 40,000 | U/l | 40,000 | U/l |

| | | | | | | | | |
|---|---|---|---|---|---|---|---|---|
| Glutathione | — | — | 0.922 | g/l* | 1.536 | g/l | 1.536 | g/l |

Macromolecules

| | | | | | | | | | | |
|---|---|---|---|---|---|---|---|---|---|---|
| 35 kDa PEG | 20 | g/1 | 20 | g/1 | 50 | g/l | 20 | g/l | 20 | g/l |

| | | | | | | | | | |
|---|---|---|---|---|---|---|---|---|---|
| BSA | 50 | g/l | 50 | g/l | — | 50 | g/1 | 50 | g/l |

| | | | | | | | | |
|---|---|---|---|---|---|---|---|---|
| HES | — | 30 | g/1 | 50 | g/l* | 30 | g/l | — |

Saccharides

| | | | | | | | | |
|---|---|---|---|---|---|---|---|---|
| 3-OMG | 19.42 | g/l | 19.42 | g/l | — | 19.42 | g/l | — |

| | | | | | | | | |
|---|---|---|---|---|---|---|---|---|
| Raffinose | — | 15.12 | g/1 | 17.83 | g/l* | 15.12 | g/l | — |

| | | | | | | |
|---|---|---|---|---|---|---|
| Trehalose | — | 18.92 | g/l | 18.92 | g/l | — |

CPA/INA

| | | | | | | | |
|---|---|---|---|---|---|---|---|
| Glycerol | — | 60 | ml/l | 120 | ml/l | — | — |

| | | | | | | |
|---|---|---|---|---|---|---|
| Snomax | — | — | 1 | g/l | — | — |

*Present in UW. WE = Williams' Medium E, UW = University of Wisconsin solution, PEG = polyethylene glycol, BSA = bovine serum albumin, HES = hydroxyethyl starch, 3-OMG = 3-O-methyl-D-glucose, CPA = cryoprotective agent, INA = ice nucleating agents, U/l = Units per liter.

Suppliers (for materials in Table 9) are provided in Table 10 below.

TABLE 10
List of suppliers for each reagent used in partial freezing solutions

| Reagent | Supplier |
|---|---|
| University of Wisconsin (UW) solution | Bridge to Life |
| Williams' Medium E | Sigma-Aldrich |
| Insulin (Humulin R) | MGH pharmacy |
| Sodium heparin | MGH pharmacy |
| Dexamethasone | Sigma-Aldrich |
| Hydrocortisone | MGH pharmacy |
| Penicillin-Streptomycin | Invitrogen |
| L-Glutathione | Sigma-Aldrich |
| Bovine Serum Albumin (BSA) | Sigma-Aldrich |
| 35 kDa Polyethylene glycol (PEG) | Sigma-Aldrich |
| 3-O-methyl glucose | Chem-Impex |
| D-(+)-Trehalose dihydrate | Sigma-Aldrich |
| Glycerol | Fisher Scientific |
| Antifreeze glycopeptides (AFGP) | A/F Protein Inc. |
| X/Z-1000 | 21st Century Medicine |
| Snomax | Telemet |

After 1 hour of preconditioning during SNMP, the temperature was decreased to 4° C. at a rate of ˜1° C./min. Flow rates were gradually adjusted as necessary to ensure a maximum perfusion pressure of 3-5 mmHg during HMP. The SNMP preconditioning solution was switched to 500 ml CPA preloading solution at 4° C. (including Williams E, 200 U/l of insulin, 2% PEG, 50 g/L BSA, 100 mM 3-OMG, 30 mM raffinose, 3% hydroxyethyl starch (HES), 6% glycerol, 4000 U/l of heparin, 24 mg/l of dexamethasone, 25 mg/ml of hydrocortisone, 40,000 μg/l of penicillin, 40,000 U/l of streptomycin, and sodium bicarbonate as needed to maintain a physiological pH) (FIG. 39, step 3; Table 9). HMP was continued for 1 hour to ensure complete equilibration of solution throughout the liver parenchyma.

After CPA preloading during HMP, rat livers were loaded with 50 ml of final storage solution (including University of Wisconsin (UW) Solution (Bridge to Life Ltd., Columbia, SC, USA), 5% PEG, 50 mM trehalose, 12% v/v (1.64 M) glycerol, 1 g/L Snomax (Telemet, Hunter, NY, USA) to promote nucleation, 10 U/l of insulin, 24 mg/l of dexamethasone, sodium bicarbonate as needed to maintain a physiological pH, and either 0.5 mg/ml of AFGP or 0.1% x-1000/0.2% z-1000 (FIG. 39, step 4). During the perfusion of the final storage solution the liver was perfused at a fixed flow rate of 0.5 ml/min for 30 min, resulting in a perfusion pressure of 3 mmHg.

Once the final storage solution during HMP had been perfused through the liver, the livers were placed in a storage bag with 50 ml of storage solution in a pre-cooled chiller (Engel, Schwertberg, Austria; model no. ENG65-B) for partial freezing (FIG. 39, step 5). Note: the concentrations of raffinose and HES were higher in the storage solution than in the pre-loading solution because the storage solution was made with UW which contains both raffinose and HES. In the case of livers frozen with glycerol only, the chiller temperature was pre-cooled to either −10° C. or −15° C., and the liver was stored at one of these temperatures for 1 to 5 days. Livers frozen with either of the two ice modulation candidates were stored at −15° C.

After partial freezing, livers were thawed (FIG. 39, step 6) by placement in 50 ml of thawing solution including Williams E, 10 U/l of insulin, 2% PEG, 50 g/L BSA, 100 mM 3-OMG, 30 mM raffinose, 3% HES, 50 mM trehalose, 5 mM L-glutathione, 200 μM cyclic AMP, 1,000 U/l of heparin, 24 mg/l of dexamethasone, 25 mg/ml of hydrocortisone, 40,000 μg/l of penicillin, and 40,000 U/l of streptomycin, which was pre-warmed to 37° C. in a constant temperature bath (Thermo Fisher, Waltham, MA, USA). Livers were gently agitated until fully thawed, which required approximately 5 min based on superficial observation and thermal equilibration between the final thawing solution temperature and the liver surface temperature of 4° C.

After thawing, CPAs and INAs were unloaded during HMP (FIG. 39, step 7). The thawed livers were perfused at 4° C. with thawing solution for 60 min with an initial flow rate of 2 ml/min. Flows were increased so as to keep a maximum pressure of 3 mmHg. After 60 min, the perfusion temperature was increased to 21° C., and the perfusion solution was changed to 750 ml of SNMP recovery solution (including Williams E, 20 U/l of insulin, 2% PEG, 50 g/L BSA, 5 mM L-glutathione, 200 uM cyclic AMP, 1,000 U/l of heparin, 24 mg/l of dexamethasone, 25 mg/ml of hydrocortisone, 40000 μg/l of penicillin, and 40000 U/l of streptomycin; Table 9), discarding the first 50-100 ml to ensure complete CPA removal. Functional recovery of frozen rat livers during SNMP with recovery solution continued for 3 hours (FIG. 39, step 8) with a maximum intrahepatic perfusion pressure of 5 mmHg and a maximum flow rate of 25 ml/min.

Viability Assessment: Perfusate measurements were done hourly during the SNMP recovery period. Time zero (t=0) was defined as being at approximately 5 min of HMP, and the first outflow samples were taken at this time (flow, 2 ml/min). PV and infrahepatic vena cava (IVC) oxygen partial pressures and lactate levels were measured with a Cg4+i-STAT cartridge (catalog no. 03P85-50) and handheld blood analyzer. Similarly, potassium and other electrolytes were measured in IVC samples using a Chem 8+i-STAT cartridge (catalog no. 09P31-26) with the same blood analyzer (catalog no. WD7POC012; Abbott, Chicago, IL).

Rat liver weight was measured directly after procurement, prior to freezing, after thawing, and after viability testing. Weight gain was calculated as the percentage increase at the end of recovery compared to the liver weight after procurement. Vascular resistance was calculated by dividing the perfusion pressure in the PV by the flow rate per gram of liver using the weight of the liver after procurement as the reference standard weight. Oxygen consumption rates were calculated as (pO₂ⁱⁿ−pO₂^{out})*F/W where pO₂ⁱⁿ and pO₂^{out} were the oxygen contents per ml of inflowing and outflowing perfusate, respectively, and the difference between them multiplied by the perfusion rate (F, in ml/min) provided the total oxygen uptake per minute. This value was then normalized by liver weight (W) to calculate the oxygen uptake per minute, per gram of liver.

After thawing and SNMP recovery, rat liver tissue was either flash frozen in liquid nitrogen or fixed in 10% formalin, embedded in paraffin, sectioned, and stained with Hematoxylin and Eosin (H&E). Terminal deoxynucleotidyl transferase dUTP nick end labeling (TUNEL) was also performed on rat liver tissue after freezing to detect DNA breaks as an indicator of apoptosis (see, e.g., ref. 9). Liver tissue that was flash frozen was used to quantify ATP and EC by the Massachusetts General Hospital (MGH) Mass Spectrometry Core (Boston, MA).

Statistical analysis was performed with Prism 8 software (GraphPad Software, San Diego, CA, USA) with a significance level of 0.05. Analysis of variance (ANOVA), followed by Tukey's post-hoc test (ANOVA/Tukey) was used for the comparison of the time-course perfusion data. ATP and EC in the −10° C. vs. −15° C. group were compared using unpaired, two-tailed t-tests.

Whilst the invention has been disclosed in particular embodiments, it will be understood by those skilled in the art that certain substitutions, alterations and/or omissions may be made to the embodiments without departing from the spirit of the invention. Accordingly, the foregoing description is meant to be exemplary only, and should not limit the scope of the invention. All references (including those listed above), scientific articles, patent publications, and any other documents cited herein are hereby incorporated by reference for the substance of their disclosure.

### REFERENCES FOR EXAMPLES 1-2

1. Nasralla D, Coussios C C, Mergental H, et al. A randomized trial of normothermic preservation in liver transplantation. Nature 2018; 557:50-56.
2. van Rijn R, Schurink I J, de Vries Y, et al. Hypothermic Machine Perfusion in Liver Transplantation—A Randomized Trial. N. Engl. J. Med. 2021; 384:1391-1401.
3. Ohman A, Raigani S, Santiago J C, et al. Activation of autophagy during normothermic machine perfusion of discarded livers is associated with improved hepatocellular function. Am. J. Physiol. Gastrointest. Liver Physiol. 2022; 322(1):G21-G33.
4. Brenner C, Galluzzi L, Kepp O, et al. Decoding cell death signals in liver inflammation. J. Hepatol. 2013; 59:583-94.
5. Fairlie W D, Tran S, Lee E F. Crosstalk between apoptosis and autophagy signaling pathways. Int. Rev. Cell Mol. Biol. 2020; 352:115-158.
6. Galluzzi L, Lopez-Soto A, Kumar S, et al. Caspases Connect Cell-Death Signaling to Organismal Homeostasis. Immunity 2016; 44:221-31.
7. Guicciardi M E, Gores G J. Apoptosis: a mechanism of acute and chronic liver injury. Gut 2005; 54:1024-33.
8. Guicciardi M E, Malhi H, Mott J L, et al. Apoptosis and necrosis in the liver. Compr. Physiol. 2013; 3:977-1010.
9. Natori S, Selzner M, Valentino K L, et al. Apoptosis of sinusoidal endothelial cells occurs during liver preservation injury by a caspase-dependent mechanism. Transplantation 1999; 68:89-96.
10. Natori S, Higuchi H, Contreras P, et al. The caspase inhibitor IDN-6556 prevents caspase activation and apoptosis in sinusoidal endothelial cells during liver preservation injury. Liver Transpl. 2003; 9:278-84.
11. Mueller T H, Kienle K, Beham A, et al. Caspase 3 inhibition improves survival and reduces early graft injury after ischemia and reperfusion in rat liver transplantation. Transplantation 2004; 78:1267-73.
12. Hoglen N C, Anselmo D M, Katori M, et al. A caspase inhibitor, IDN-6556, ameliorates early hepatic injury in an ex vivo rat model of warm and cold ischemia. Liver Transpl. 2007; 13:361-6.
13. Baskin-Bey E S, Washburn K, Feng S, et al. Clinical Trial of the Pan-Caspase Inhibitor, IDN-6556, in Human Liver Preservation Injury. Am. J. Transplant. 2007; 7:218-25.
14. Raigani S, De Vries R J, Carroll C, et al. Viability testing of discarded livers with normothermic machine perfusion: Alleviating the organ shortage outweighs the cost. Clin. Transplant. 2020; 34:e14069.
15. van Leeuwen O B, de Vries Y, Fujiyoshi M, et al. Transplantation of High-risk Donor Livers After Ex Situ Resuscitation and Assessment Using Combined Hypo- and Normothermic Machine Perfusion: A Prospective Clinical Trial. Ann. Surg. 2019; 270:906-914.
16. Sanders J A, Lakhani A, Phomphutkul C, et al. The effect of rapamycin on DNA synthesis in multiple tissues from late gestation fetal and postnatal rats. Am. J. Physiol. Cell Physiol. 2008; 295:C406-13.
17. Sosa R A, Zarrinpar A, Rossetti M, et al. Early cytokine signatures of ischemia/reperfusion injury in human orthotopic liver transplantation. JCI Insight 2016; 1:e89679.
18. Orning P, Lien E. Multiple roles of caspase-8 in cell death, inflammation, and innate immunity. J. Leukoc. Biol. 2021; 109:121-141.
19. Raigani S, De Vries R J, Uygun K, et al. Pumping new life into old ideas: Preservation and rehabilitation of the liver using ex situ machine perfusion. Artif Organs 2020; 44:123-128.
20. Mergental H, Laing R W, Kirkham A J, et al. Transplantation of discarded livers following viability testing with normothermic machine perfusion. Nat. Commun. 2020; 11:2939.
21. de Vries Y, Matton A P M, Nijsten M W N, et al. Pretransplant sequential hypo- and normothermic machine perfusion of suboptimal livers donated after circulatory death using a hemoglobin-based oxygen carrier perfusion solution. Am. J. Transplant. 2019; 19:1202-1211.
22. Martins P N, Buchwald J E, Mergental H, et al. The role of normothermic machine perfusion in liver transplantation. Int. J. Surg 2020; 825:52-60.
23. Harrison S A, Goodman Z, Jabbar A, et al. A randomized, placebo-controlled trial of emricasan in patients with NASH and F1-F3 fibrosis. J. Hepatol. 2020; 72:816-827.
24. Kramer G, Erdal H, Mertens H J, et al. Differentiation between cell death modes using measurements of different soluble forms of extracellular cytokeratin 18. Cancer Res. 2004; 64:1751-6.
25. Dobin A, Davis C A, Schlesinger F, Drenkow J, Zaleski C, Jha S, et al. STAR: ultrafast universal RNA-seq aligner. Bioinformatics 2013; 29(1):15-21.
26. Akbani R. MBatch: MD Anderson Cancer Center. Available from: bioinformatics.mdanderson.org/public-software/mbatch/; 2020.
27. Team R C. R: A language and environment for statistical computing. www.R-project.org/; 2020.
28. Robinson M D, McCarthy D J, Smyth G K. edgeR: a Bioconductor package for differential expression analysis of digital gene expression data. Bioinformatics 2010; 26:139-140.
29. Qiagen. Qiagen Ingenuity Pathway Analysis (IPA). www.qiagenbioinformatics.com/products/ingenuity-pathway-analysis; 2020.
30. Lamming D W, Demirkan G, Boylan J M, Mihaylova M M, Peng T, Ferreira J, et al. Hepatic signaling by the mechanistic target of rapamycin complex 2 (mTORC2). FASEB J. 2014; 28(1):300-15.
31. Young M D, Wakefield M J, Smyth G K, Oshlack A. Gene ontology analysis for RNA-seq: accounting for selection bias. Genome Biol. 2010; 11(2):R14.
32. Shannon P, Markiel A, Ozier O, Baliga N S, Wang J T, Ramage D, et al. Cytoscape: a software environment for integrated models of biomolecular interaction networks. Genome Res. 2003; 13(11):2498-504.

### REFERENCES FOR EXAMPLES 4-5

1. Vodkin I, Kuo A. Extended criteria donors in liver transplantation. Clin. Liver. Dis. 2017; 21:289-301.
2. US Department of Health and Human Services. Scientific Registry of Transplant Recipients (SRTR) Health Resources and Services Administration. www.srtr.org/reports-tools/opo-specific-reports/; 2020 Jan. 5.
3. Mergental H, Laing R W, Kirkham A J, Perera M, Boteon Y L, Attard J, Barton D, Curbishley S, Wilkhu M, Neil D A H, Hubscher S G, Muiesan P, Isaac J R, Roberts K J, Abradelo M, Schlegel A, Ferguson J, Cilliers H, Bion J, Adams D H, Morris C, Friend P J, Yap C, Afford S C, Mirza D F. Transplantation of discarded livers following viability testing with normothermic machine perfusion. Nat. Commun. 2020; 11:2939.
4. Nasralla D, Coussios C C, Mergental H, Akhtar M Z, Butler A J, Ceresa C D L, Chiocchia V, Dutton S J, García-Valdecasas J C, Heaton N, Imber C, Jassem W, Jochmans I, Karani J, Knight S R, Kocabayoglu P, Malagò M, Mirza D, Morris P J, Pallan A, Paul A, Pavel M, Perera MTPR, Pirenne J, Ravikumar R, Russell L, Upponi S, Watson C J E, Weissenbacher A, Ploeg R J, Friend P J; Consortium for Organ Preservation in Europe. A randomized trial of normothermic preservation in liver transplantation. Nature 2018; 557:50-56.
5. Yeh H, Uygun K. Increasing donor liver utilization through machine perfusion. Hepatology 2019; 70:431-433.
6. Jassem W, Xystrakis E, Ghnewa Y G, Yuksel M, Pop O, Martinez-Llordella M, Jabri Y, Huang X, Lozano J J, Quaglia A, Sanchez-Fueyo A, Coussios C C, Rela M, Friend P, Heaton N, Ma Y. Normothermic machine perfusion (NMP) inhibits proinflammatory responses in the liver and promotes regeneration. Hepatology 2019; 70:682-695.
7. Schlegel A, Dutkowski P. Letter to editor: repair or prevent: what is the real impact of normothermic machine perfusion in liver transplantation? Hepatology 2019; 70:2231-2232.
8. Raigani S, De Vries R J, Carroll C, Chen Y W, Chang D C, Shroff S G, Uygun K, Yeh H. Viability testing of discarded livers with normothermic machine perfusion: Alleviating the organ shortage outweighs the cost. Clin. Transplant. 2020; 34:e14069.
9. Karimian N, Matton A P, Westerkamp A C, Burlage L C, Op den Dries S, Leuvenink H G, Lisman T, Uygun K, Markmann J F, Porte R J. Ex Situ normothermic machine perfusion of donor livers. J. Vis. Exp. 2015; 19:e52688.
10. van Leeuwen O B, de Vries Y, Fujiyoshi M, Nijsten M W N, Ubbink R, Pelgrim G J, Werner M J M, Reyntjens K, van den Berg A P, de Boer M T, de Kleine R H J, Lisman T, de Meijer V E, Porte R J. Transplantation of high-risk donor livers after ex situ resuscitation and assessment using combined hypo- and normothermic machine perfusion: a prospective clinical trial. Ann. Surg. 2019; 270:906-914.
11. Sanders J A, Lakhani A, Phomphutkul C, Wu K Y, Gruppuso P A. The effect of rapamycin on DNA synthesis in multiple tissues from late gestation fetal and postnatal rats. Am. J. Physiol. Cell Physiol. 2008; 295:C406-C413.
12. Gearing L J, Cumming H E, Chapman R, Finkel A M, Woodhouse I B, Luu K, Gould J A, Forster S C, Hertzog P J. CiiiDER: a tool for predicting and analysing transcription factor binding sites. PLoS One 2019; 14:e0215495.
13. Emadali A, Nguyen D T, Rochon C, Tzimas G N, Metrakos P P, Chevet E. Distinct endoplasmic reticulum stress responses are triggered during human liver transplantation. J. Pathol. 2005; 207:111-118.
14. Almanza A, Carlesso A, Chintha C, Creedican S, Doultsinos D, Leuzzi B, Luis A, McCarthy N, Montibeller L, More S, Papaioannou A, Puschel F, Sassano M L, Skoko J, Agostinis P, de Belleroche J, Eriksson L A, Fulda S, Gorman A M, Healy S, Kozlov A, Muñoz-Pinedo C, Rehm M, Chevet E, Samali A. Endoplasmic reticulum stress signalling—from basic mechanisms to clinical applications. FEBS J. 2019; 286:241-278.
15. Zhu S Y, Yao R Q, Li Y X, Zhao P Y, Ren C, Du X H, Yao Y M. Lysosomal quality control of cell fate: a novel therapeutic target for human diseases. Cell Death Dis. 2020; 11:817.
16. Behrends C, Sowa M E, Gygi S P, Harper J W. Network organization of the human autophagy system. Nature 2010; 466:68-76.
17. Zhai Y, Petrowsky H, Hong J C, Busuttil R W, Kupiec-Weglinski J W. Ischaemia-reperfusion injury in liver transplantation—from bench to bedside. Nat. Rev. Gastroenterol. Hepatol. 2013; 10:79-89.
18. Sosa R A, Zarrinpar A, Rossetti M, Lassman C R, Naini B V, Datta N, Rao P, Harre N, Zheng Y, Spreafico R, Hoffmann A, Busuttil R W, Gjertson D W, Zhai Y, Kupiec-Weglinski J W, Reed E F. Early cytokine signatures of ischemia/reperfusion injury in human orthotopic liver transplantation. JCI Insight 2016; 1: e89679.
19. Liu X, Green R M. Endoplasmic reticulum stress and liver diseases. Liver Res. 2019; 3:55-64.
20. Baskin-Bey E S, Canbay A, Bronk S F, Werneburg N, Guicciardi M E, Nyberg S L, Gores G J. Cathepsin B inactivation attenuates hepatocyte apoptosis and liver damage in steatotic livers after cold ischemia-warm reperfusion injury. Am. J. Physiol. Gastrointest. Liver Physiol. 2005; 288:G396-G402.
21. Shen Y, Malik S A, Amir M, Kumar P, Cingolani F, Wen J, Liu Y, Zhao E, Farris A B, Raeman R, Czaja M J. Decreased hepatocyte autophagy leads to synergistic IL-1β and TNF mouse liver injury and inflammation. Hepatology 2020; 72:595-608.
22. Boteon Y L, Laing R, Mergental H, Reynolds G M, Mirza D F, Afford S C, Bhogal R H. Mechanisms of autophagy activation in endothelial cell and their targeting during normothermic machine liver perfusion. World J. Gastroenterol. 2017; 23:8443-8451.
23. Xu D, Zhao H, Jin M, Zhu H, Shan B, Geng J, Dziedzic S A, Amin P, Mifflin L, Naito M G, Najafov A, Xing J, Yan L, Liu J, Qin Y, Hu X, Wang H, Zhang M, Manuel V J, Tan L, He Z, Sun Z J, Lee V M Y, Wagner G, Yuan J. Modulating TRADD to restore cellular homeostasis and inhibit apoptosis. Nature 2020; 587:133-138.
24. Michalopoulos G K, Bhushan B. Liver regeneration: biological and pathological mechanisms and implications. Nat. Rev. Gastroenterol. Hepatol. 2021; 18:40-55.
25. Cho H, Lim I K, Lee J-H. Changes in the expression of cell cycle regulators during rat liver regeneration after partial hepatectomy. Exp. Mol. Med. 1996; 28:187-191.
26. van Rijn R, Schurink I J, de Vries Y, van den Berg A P, Cortes Cerisuelo M, Darwish Murad S, Erdmann J I, Gilbo N, de Haas R J, Heaton N, van Hoek B, Huurman V A L, Jochmans I, van Leeuwen O B, de Meijer V E, Monbaliu D, Polak W G, Slangen J J G, Troisi R I, Vanlander A, de Jonge J, Porte R J; DHOPE-DCD Trial Investigators.
Hypothermic machine perfusion in liver transplantation—a randomized trial. N. Engl. J. Med. 2021; 384:1391-1401.
27. Searle B C, Pino L K, Egertson J D, Ting Y S, Lawrence R T, MacLean B X, Villen J, et al. Chromatogram libraries improve peptide detection and quantification by data independent acquisition mass spectrometry. Nat. Commun. 2018; 9:5128.
28. Graw S, Tang J, Zafar M K, Byrd A K, Bolden C, Peterson E C, Byrum S D. proteiNorm—A User-Friendly Tool for Normalization and Analysis of TMT and Label-Free Protein Quantification. ACS Omega 2020; 5:25625-25633.
29. Huber W, von Heydebreck A, Sültmann H, Poustka A, Vingron M. Variance stabilization applied to microarray data calibration and to the quantification of differential expression. Bioinformatics 2002; 18 Suppl 1:596-104.
30. Ritchie M E, Phipson B, Wu D, Hu Y, Law C W, Shi W, Smyth G K. limma powers differential expression analyses for RNA-sequencing and microarray studies. Nucleic Acids Res. 2015; 43:e47.
31. Chawade A, Alexandersson E, Levander F. Normalyzer: a tool for rapid evaluation of normalization methods for omics data sets. J. Proteome Res. 2014; 13:3114-3120.
32. Team R C. R: A language and environment for statistical computing. www.R-project.org/; 2020.
33. Robinson M D, McCarthy D J, Smyth G K. edgeR: a Bioconductor package for differential expression analysis of digital gene expression data. Bioinformatics 2010; 26:139-140.
34. Qiagen. Qiagen Ingenuity Pathway Analysis (IPA). www.qiagenbioinformatics.com/products/ingenuity-pathway-analysis; 2020.
35. Lamming D W, Demirkan G, Boylan J M, Mihaylova M M, Peng T, Ferreira J, et al. Hepatic signaling by the mechanistic target of rapamycin complex 2 (mTORC2). FASEB J. 2014; 28(1):300-15.
36. Data from Ohman A, Raigani S, Santiago J C, et al. Activation of autophagy during normothermic machine perfusion of discarded livers is associated with improved hepatocellular function. Am. J. Physiol. Gastrointest. Liver Physiol. 2022; 322(1):G21-G33, accessible from doi.org/10.5281/zenodo.5206547.
37. Young M D, Wakefield M J, Smyth G K, Oshlack A. Gene ontology analysis for RNA-seq: accounting for selection bias. Genome Biol. 2010; 11(2):R14.
38. Gu Z, Gu L, Eils R, Schlesner M, Brors B. circlize Implements and enhances circular visualization in R. Bioinformatics 2014; 30(19):2811-2.

### REFERENCES FOR EXAMPLES 6-7

1. Giwa S et al. The promise of organ and tissue preservation to transform medicine. Nat. Biotechnol. 2017; 35:530-542.
2. Raigani S, De Vries R J, Uygun K, Yeh H. Pumping new life into old ideas: Preservation and rehabilitation of the liver using ex situ machine perfusion. Artif Organs 2020; 44:123-128.
3. Buying time for transplants. Nat. Biotechnol. 2017; 35:801.
4. de Vries R J, Yarmush M, Uygun K. Systems engineering the organ preservation process for transplantation. Curr. Opin. Biotechnol. 2019; 58:192-201.
5. Ardehali A et al. Ex-vivo perfusion of donor hearts for human heart transplantation (PROCEED II): a prospective, open-label, multicentre, randomised non-inferiority trial. The Lancet 2015; 385:2577-2584.
6. Warnecke G et al. Normothermic ex-vivo preservation with the portable Organ Care System Lung device for bilateral lung transplantation (INSPIRE): a randomised, open-label, non-inferiority, phase 3 study. Lancet Respir. Med. 2018; 6:357-367.
7. Nasralla D et al. A randomized trial of normothermic preservation in liver transplantation. Nature 2018; 557:50-56.
8. Eshmuminov D et al. An integrated perfusion machine preserves injured human livers for 1 week. Nat. Biotechnol. 2020; 38:189-198.
9. de Vries R J et al. Supercooling extends preservation time of human livers. Nat. Biotechnol. 2019; 37:1131-1136.
10. Best B P. Cryoprotectant Toxicity: Facts, Issues, and Questions. Rejuvenation Res. 2015; 18:422-436.
11. Fahy G M et al. Cryopreservation of organs by vitrification: perspectives and recent advances. Cryobiology 2004; 48:157-178.
12. Taylor M J, Weegman B P, Baicu S C, Giwa S E. New Approaches to Cryopreservation of Cells, Tissues, and Organs. Transfus. Med. Hemotherapy 2019; 46:197-215.
13. Tessier S N et al. Effect of Ice Nucleation and Cryoprotectants during High Subzero-Preservation in Endothelialized Microchannels. ACS Biomater. Sci. Eng. 2018; 4:3006-3015.
14. Berendsen T A et al. Supercooling enables long-term transplantation survival following 4 days of liver preservation. Nat. Med. 2014; 20:790-793.
15. Bruinsma B G et al. Supercooling preservation and transplantation of the rat liver. Nat. Protoc. 2015; 10:484-494.
16. Luu B E, Storey K B. Solving Donor Organ Shortage with Insights from Freeze Tolerance in Nature: Activating endogenous antioxidant systems with non-coding RNA to precondition donor organs. BioEssays News Rev. Mol. Cell. Dev. Biol. 2018: e1800092.
17. Costanzo J P, do Amaral M C F, Rosendale A J, Lee R E. Hibernation physiology, freezing adaptation and extreme freeze tolerance in a northern population of the wood frog. J. Exp. Biol. 2013; 216:3461-3473.
18. Wolanczyk J P, Storey K B, Baust J G. Ice nucleating activity in the blood of the freezetolerant frog, Rana sylvatica. Cryobiology 1990; 27:328-335.
19. Zachariassen K E, Kristiansen E. Ice Nucleation and Antinucleation in Nature. Cryobiology 2000; 41:257-279.
20. Perk S et al. A fitness index for transplantation of machine-perfused cadaveric rat livers. BMC Res. Notes 2012; 5:325.
21. Layne J R, Costanzo J P, Lee R E. Freeze duration influences postfreeze survival in the frog Rana sylvatica. J. Exp. Zool. 1998; 280:197-201.
22. do Amaral M C F, Lee R E, Costanzo J P. Hepatocyte responses to in vitro freezing and β-adrenergic stimulation: Insights into the extreme freeze tolerance of subarctic Rana sylvatica. J. Exp. Zool. Part Ecol. Genet. Physiol. 2015; 323:89-96.
23. Storey K B. Living in the Cold: Freeze-Induced Gene Responses in Freeze-Tolerant Vertebrates. Clin. Exp. Pharmacol. Physiol. 1999; 26:57-63.
24. Bruinsma B G et al. Subnormothermic Machine Perfusion for Ex Vivo Preservation and Recovery of the Human Liver for Transplantation: Subnormothermic Machine Perfusion of Human Livers. Am. J. Transplant. 2014; 14:1400-1409.
25. Bruinsma B G et al. Metabolic profiling during ex vivo machine perfusion of the human liver. Sci. Rep. 2016; 6:22415.
26. Sridharan G V et al. Metabolomic Modularity Analysis (MMA) to Quantify Human Liver Perfusion Dynamics. Metabolites 2017; 7(4):58.
27. Gringeri E et al. Subnormothermic machine perfusion for non-heart-beating donor liver grafts preservation in a Swine model: a new strategy to increase the donor pool?Transplant. Proc. 2012; 44:2026-2028.
28. op den Dries S et al. Hypothermic Oxygenated Machine Perfusion Prevents Arteriolonecrosis of the Peribiliary Plexus in Pig Livers Donated after Circulatory Death. PLoS ONE 2014; 9; e88521.
29. Uygun K et al. Diluted blood reperfusion as a model for transplantation of ischemic rat livers: alanine aminotransferase is a direct indicator of viability. Transplant. Proc. 2010; 42:2463-2467.
30. Nassar A et al. Ex Vivo Normothermic Machine Perfusion Is Safe, Simple, and Reliable: Results From a Large Animal Model. Surg. Innov. 2015; 22:61-69.
31. Avruch J H et al. A novel model for ex situ reperfusion of the human liver following subnormothermic machine perfusion. Technology (Singap World Sci.) 2017; 5(4); 196-200.
32. Watson C J E, Jochmans I. From “Gut Feeling” to Objectivity: Machine Preservation of the Liver as a Tool to Assess Organ Viability. Curr. Transplant. Rep. 2018; 5:72-81.
33. Bruinsma B G, Uygun K. Subzero organ preservation: the dawn of a new ice age?Curr. Opin. Organ Transplant. 2017; 22:281-286.
34. Moss G S, Reed P C, Riddell A G. Observations on the effects of glycerol on the cold storage of the canine liver. J. Surg. Res. 1966; 6:147-151.
35. Ishine N, Rubinsky B, Lee C Y. Transplantation of Mammalian Livers Following Freezing: Vascular Damage and Functional Recovery. Cryobiology 2000; 40:84-89.
36. Ishine N, Rubinsky B, Lee C Y. A Histological Analysis of Liver Injury in Freezing Storage. Cryobiology 1999; 39:271-277.
37. Bruinsma B G, Berendsen T A, Izamis M L, Yarmush M L, Uygun K. Determination and extension of the limits to static cold storage using subnormothermic machine perfusion. Int. J. Artif Organs 2013; 36:775-780.
38. Tolboom H et al. Recovery of warm ischemic rat liver grafts by normothermic extracorporeal perfusion. Transplantation 2009; 87:170-177.
39. de Vries Y et al. Pretransplant sequential hypo- and normothermic machine perfusion of suboptimal livers donated after circulatory death using a hemoglobin-based oxygen carrier perfusion solution. Am. J. Transplant. Off J. Am. Soc. Transplant. Am. Soc. Transpl. Surg. 2019; 19:1202-1211.
40. Laing R W et al. Viability testing and transplantation of marginal livers (VITTAL) using normothermic machine perfusion: study protocol for an open-label, non-randomised, prospective, single-arm trial. BMJ Open 2017; 7(11):e017733.
41. Mergental H et al. Transplantation of Declined Liver Allografts Following Normothermic Ex-Situ Evaluation. Am. J. Transplant. Off J. Am. Soc. Transplant. Am. Soc. Transpl. Surg. 2016; 16:3235-3245.
42. Watson C J E. et al. Observations on the ex situ perfusion of livers for transplantation. Am. J. Transplant. 2018; 18(8):2005-2020.
43. Murata K, Tanaka H. Liquid-liquid transition without macroscopic phase separation in a water-glycerol mixture. Nat. Mater. 2012; 11:436-443.
44. Ott J B, Goates J R, Lamb J D. Solid-liquid phase equilibria in water+ethylene glycol. J. Chem. Thermodyn. 1972; 4:123-126.
45. Libbrecht K G. Physical Dynamics of Ice Crystal Growth. Annu. Rev. Mater. Res. 2017; 47:271-295.
46. Van den Ende W. Multifunctional fructans and raffinose family oligosaccharides. Front. Plant Sci. 2013; 4:247.
47. Devireddy R V, Barratt P R, Storey K B, Bischof J C. Liver Freezing Response of the Freeze-Tolerant Wood Frog, Rana sylvatica, in the Presence and Absence of Glucose. I. Experimental Measurements. Cryobiology 1999; 38:310-326.
48. Storey K B, Bischof J, Rubinsky B. Cryomicroscopic analysis of freezing in liver of the freezetolerant wood frog. Am. J. Physiol.-Regul. Integr. Comp. Physiol. 1992; 263:R185-R194.

### REFERENCES FOR EXAMPLES 8-9

1. Ray K. Preserving the liver for transplantation. Nat. Rev. Gastroenterol. Hepatol. 2018; 15:327.
2. Taylor M J, Weegman B P, Baicu S C, Giwa S E. New Approaches to Cryopreservation of Cells, Tissues, and Organs. Transfus. Med. Hemotherapy 2019; 46(3):197-215.
3. Giwa S, Lewis J K, Alvarez L, Langer R, Roth A E, Church G M, et al. The promise of organ and tissue preservation to transform medicine. Nat. Biotechnol. 2017; 35:530-542.
4. Yamada K, Sykes M, Sachs D H. Tolerance in xenotransplantation. Curr. Op. Organ Transplant. 2017; 22(6):522-528.
5. Ardehali A, Esmailian F, Deng M, Soltesz E, Hsich E, Naka Y, et al. Ex-vivo perfusion of donor hearts for human heart transplantation (PROCEED II): A prospective, open-label, multicentre, randomised non-inferiority trial. Lancet 2015; 27(9987):2577-2584.
6. Warnecke G, Van Raemdonck D, Smith M A, Massard G, Kukreja J, Rea F, et al. Normothermic ex-vivo preservation with the portable Organ Care System Lung device for bilateral lung transplantation (INSPIRE): a randomised, open-label, non-inferiority, phase 3 study. Lancet Respir. Med. 2018; 6(5):357-367.
7. Nasralla D, Coussios C C, Mergental H, Akhtar M Z, Butler A J, Ceresa C D L, et al. A randomized trial of normothermic preservation in liver transplantation. Nature 2018; 557(7703):50-56.
8. Eshmuminov D, Becker D, Bautista Borrego L, Hefti M, Schuler M J, Hagedorn C, et al. An integrated perfusion machine preserves injured human livers for 1 week. Nat. Biotechnol. 2020; 38:189-198.
9. de Vries R J, Tessier S N, Banik P D, Nagpal S, Cronin S E J, Ozer S, et al. Supercooling extends preservation time of human livers. Nat. Biotechnol. 2019; 37:1131-1136.
10. de Vries R, Tessier S N, Banik P D, Ozer S, Crorin S E J, Nagpal S, et al. Extending the Human Liver Preservation Time for Transplantation by Supercooling. Transplantation 2018; 102:615.
11. Berendsen T A, Bruinsma B G, Puts C F, Saeidi N, Usta O B, Uygun B E, et al. Supercooling enables long-term transplantation survival following 4 days of liver preservation. Nat. Med. 2014; 20(7):790-793.
12. Bruinsma B G, Berendsen T A, Izamis M L, Yeh H, Yarmush M L, Uygun K. Supercooling preservation and transplantation of the rat liver. Nat. Protoc. 2015; 10(3):484-494.
13. Zachariassen K E, Kristiansen E. Ice nucleation and antinucleation in nature. Cryobiology 2000; 41(4):257-279.
14. Pegg D E. The relevance of ice crystal formation for the cryopreservation of tissues and organs. Cryobiology 2010; 60(3 supp):S36-44.
15. Hunt C J. Studies on cellular structure and ice location in frozen organs and tissues: The use of freeze-substitution and related techniques. Cryobiology 1984; 21(4):385-402.
16. Fahy G M, Wowk B, Pagotan R, Chang A, Phan J, Thomson B, et al. Physical and biological aspects of renal vitrification. Organogenesis 2009; 5(3):167-175.
17. Fahy G M. Analysis of “solution effects” injury: Cooling rate dependence of the functional and morphological sequellae of freezing in rabbit renal cortex protected with dimethyl sulfoxide. Cryobiology 1981; 18(6):550-570.
18. Tessier S N, Weng L, Moyo W D, Au S H, Wong K H K, Angpraseuth C, et al. Effect of Ice Nucleation and Cryoprotectants during High Subzero-Preservation in Endothelialized Microchannels. ACS Biomater. Sci. Eng. 2018; 4(8):3006-3015.
19. Ishine N, Rubinsky B, Lee C Y. Transplantation of Mammalian Livers Following Freezing: Vascular Damage and Functional Recovery. Cryobiology 2000; 40(1):84-89.
20. Celik Y, Drori R, Pertaya-Braun N, Altan A, Barton T, Bar-Dolev M, et al. Microfluidic experiments reveal that antifreeze proteins bound to ice crystals suffice to prevent their growth. Proc. Nat'l Acad. Sci. USA 2013; 110(4):1309-1314.
21. Kuiper M J, Morton C J, Abraham S E, Gray-Weale A. The biological function of an insect antifreeze protein simulated by molecular dynamics. Elife 2015; 4: e05142.
22. Weng L, Stott S L, Toner M. Molecular Dynamics at the Interface between Ice and Poly(vinyl alcohol) and Ice Recrystallization Inhibition. Langmuir 2018; 34(17):5116-5123.
23. Naullage P M, Lupi L, Molinero V. Molecular Recognition of Ice by Fully Flexible Molecules. J. Phys. Chem. C 2017; 121(48):26949-26957.
24. Weng L, Swei A, Toner M. Role of synthetic antifreeze agents in catalyzing ice nucleation. Cryobiology 2018; 84:91-94.
25. Eickhoff L, Dreischmeier K, Zipori A, Sirotinskaya V, Adar C, Reicher N, et al. Contrasting Behavior of Antifreeze Proteins: Ice Growth Inhibitors and Ice Nucleation Promoters. J. Phys. Chem. Lett. 2019; 10(5):966-972.
26. Ishiguro H, Rubinsky B. Mechanical interactions between ice crystals and red blood cells during directional solidification. Cryobiology 1994; 31(5):483-500.
27. Wowk B, Leitl E, Rasch C M, Mesbah-Karimi N, Harris S B, Fahy G M. Vitrification enhancement by synthetic ice blocking agents. Cryobiology 2000; 40(3):228-236.
28. Burkey A A, Riley C L, Wang L K, Hatridge T A, Lynd N A. Understanding Poly(vinyl alcohol)-Mediated Ice Recrystallization Inhibition through Ice Adsorption Measurement and pH Effects. Biomacromolecules 2018; 19(1):248-55.
29. Hasan M, Fayter A E R, Gibson M I. Ice Recrystallization Inhibiting Polymers Enable Glycerol-Free Cryopreservation of Microorganisms. Biomacromolecules 2018; 19(8):3371-3376.
30. Wowk B, Fahy G M. Inhibition of bacterial ice nucleation by polyglycerol polymers. Cryobiology 2002; 44(1):14-23.
31. Amir G, Horowitz L, Rubinsky B, Yousif B S, Lavee J, Smolinsky A K. Subzero nonfreezing cryopresevation of rat hearts using antifreeze protein I and antifreeze protein III. Cryobiology 2004; 48(3):273-282.
32. Amir G, Rubinsky B, Horowitz L, Miller L, Leor J, Kassif Y, et al. Prolonged 24-hour subzero preservation of heterotopically transplanted rat hearts using antifreeze proteins derived from arctic fish. Ann. Thorac. Surg. 2004; 77(5):1648-1655.
33. Amir G, Rubinsky B, Basheer S Y, Horowitz L, Jonathan L, Feinberg M S, et al. Improved viability and reduced apoptosis in sub-zero 21-hour preservation of transplanted rat hearts using anti-freeze proteins. J. Heart Lung Transplant. 2005; 24(11):1915-1929.
34. Watson C J E, Jochmans I. From “Gut Feeling” to Objectivity: Machine Preservation of the Liver as a Tool to Assess Organ Viability. Curr. Transplant Reports 2018; 5(1):72-81.
35. de Vries R J, Yarmush M, Uygun K. Systems engineering the organ preservation process for transplantation. Curr. Op. Biotechnol. 2019; 58:192-201.
36. Campbell B K, Hernandez-Medrano J, Onions V, Pincott-Allen C, Aljaser F, Fisher J, et al. Restoration of ovarian function and natural fertility following the cryopreservation and autotransplantation of whole adult sheep ovaries. Hum. Reprod. 2014; 29(8):1749-1763.
37. Hamilton R, Holst H I, Lehr H B. Successful preservation of canine small intestine by freezing. J. Surg. Res. 1973; 14(4):313-318
38. Lin J H, Carroll P M. The effect of calcium and magnesium on frozen rat uteri, and the calcium content of uteri frozen by various procedures. Cryobiology 1968; 5(2):105-108.
39. Taylor M J, Pegg D E. The effect of ice formation on the function of smooth muscle tissue stored at −21 or −60° C. Cryobiology 1983; 20(1):36-40.
40. Fahy G M, Wowk B, Wu J, Phan J, Rasch C, Chang A, et al. Cryopreservation of organs by vitrification: Perspectives and recent advances. Cryobiology 2004; 48(2):157-178.
41. Farrant J. Mechanism of cell damage during freezing and thawing and its prevention. Nature 1965; 205:1284-1287.
42. Libbrecht K G. Physical Dynamics of Ice Crystal Growth. Annu. Rev. Mater. Res. 2017; 47:271-295.
43. Van den Ende W. Multifunctional fructans and raffinose family oligosaccharides. Front. Plant Sci. 2013; 4:247.
44. Urbańczyk M, Góra J, Latajka R, Sewald N. Antifreeze glycopeptides: from structure and activity studies to current approaches in chemical synthesis. Amino Acids 2017; 49(2):209-222.
45. Bang J K, Lee J H, Murugan R N, Lee S G, Do H, Koh H Y, et al. Antifreeze peptides and glycopeptides, and their derivatives: Potential uses in biotechnology. Marine Drugs 2013; 11(6):2013-2041.
46. Mugnano J A, Wang T, Layne J R, DeVries A L, Lee R E. Antifreeze glycoproteins promote intracellular freezing of rat cardiomyocytes at high subzero temperatures. Am. J. Physiol. Regul. Integr. Comp. Physiol. 1995; 269(2):474-479.
47. Hunt C J, Taylor M J, Pegg D E. Freeze-substitution and isothermal freeze-fixation studies to elucidate the pattern of ice formation in smooth muscle at 252 K (−21° C.). J. Microsc. 1982; 125(2):177-186.
48. Rubinsky B, Lee C Y, Bastacky J, Onik G. The process of freezing and the mechanism of damage during hepatic cryosurgery. Cryobiology 1990; 27(1):85-97.
49. Robinson J, Newsholme E A. Some properties of hepatic glycerol kinase and their relation to the control of glycerol utilization. Biochem. J. 1969; 112(4):455-464.
50. Briard J G, Poisson J S, Turner T R, Capicciotti C J, Acker J P, Ben R N. Small molecule ice recrystallization inhibitors mitigate red blood cell lysis during freezing, transient warming and thawing. Sci. Rep. 2016; 29(6):23619.
51. Tolboom H, Pouw R, Uygun K, Tanimura Y, Izamis M L, Berthiaume F, et al. A model for normothermic preservation of the rat liver. Tissue Eng. 2007; 13(8):2143-2151.
52. Nosser M, Gassner JMGV, Moosburner S, Wyrwal D, Claussen F, Hillebrandt K H, et al. Development of a Rat Liver Machine Perfusion System for Normothermic and Subnormothermic Conditions. Tissue Eng. Part A 2020; 26(1):57-65.
53. Katenz E, Vondran F W R, Schwartlander R, Pless G, Gong X, Cheng X, et al. Cryopreservation of primary human hepatocytes: The benefit of trehalose as an additional cryoprotective agent. Liver Transplant. 2007; 13(1):38-45.
54. Spindler R, Wolkers W F, Glasmacher B. Dimethyl sulfoxide and ethylene glycol promote membrane phase change during cryopreservation. Cryo Lett. 2011; 32(2):148-157.

1. A method for preserving a biological tissue sample, the method comprising:
providing the biological tissue sample with a perfusate and/or a solution comprising an apoptosis inhibitor for a first time period, thereby providing a treated biological tissue sample.

2. The method of claim 1, wherein said providing comprises perfusing the biological tissue sample with the perfusate or storing the biological tissue sample in the solution.

3. The method of claim 1, wherein the perfusate or the solution comprises a normothermic perfusion solution, a subnormothermic perfusion solution, a hypothermic perfusion solution, a subzero perfusion solution, or a storage solution.

4. The method of claim 1, wherein said providing is conducted prior to, during, and/or after cooling the biological tissue sample to a subnormotheric condition, a hypothermic condition, or a subzero condition.

5. The method of claim 4, wherein the hypothermic condition or the subzero condition comprises hypothermic cooling, supercooling, subzero non-freezing, partial freezing, cryopreservation, or vitrification.

6. The method of claim 1, wherein said providing comprises:
storing the biological tissue sample in a storage solution comprising a first apoptosis inhibitor; and
perfusing the biological tissue sample with the perfusate comprising a second apoptosis inhibitor, wherein the first and second apoptosis inhibitors are same or different.

7. The method of claim 6, wherein said storing comprises a hypothermic condition or a subzero condition.

8. The method of claim 1, wherein the apoptosis inhibitor is a caspase inhibitor, a BID inhibitor, a BAD inhibitor, a BAX inhibitor, a BAK inhibitor, a cytochrome C inhibitor, a cathepsin inhibitor, a granzyme B inhibitor, a pyroptosis inhibitor, and/or a necroptosis inhibitor.

9. The method of claim 8, wherein the caspase inhibitor is a pan-caspase inhibitor.

10. The method of claim 8, wherein the caspase inhibitor is emricasan (IDN-6556), VX-765 (belnacasan), Q-VD-OPh, VX-166, VX-740, GS-9540, Ac-DEVD-CHO, Ac-FLTD-CMK, Z-DEVD-FMK, INF 4E, Z-VAD-FMK, or a derivative thereof.

11. The method of claim 8, wherein the caspase inhibitor is a caspase 3 inhibitor, a caspase 7 inhibitor, a caspase 4 inhibitor, a caspase 8 inhibitor, a caspase 1 inhibitor, a caspase 2 inhibitor, a caspase 6 inhibitor, a caspase 9 inhibitor, or a caspase 10 inhibitor.

12. The method of claim 8, wherein a concentration of the caspase inhibitor is maintained during the first time period.

13. The method of claim 1, wherein the perfusate or the solution further comprises one or more kinase inhibitors, Rho-kinase inhibitors, polyamines, integrated stress response inhibitors, reactive oxygen species scavengers, and/or antioxidants.

14. The method of claim 1, wherein said providing comprises delivering to an in vitro system further comprising the biological tissue sample.

15. The method of claim 1, wherein said providing comprises injecting the biological tissue sample.

16. The method of claim 1, further comprising after said providing:
loading the biological tissue sample with one or more agents;
cooling the biological tissue sample by exposure to a subnormothermic condition, a hypothermic condition, and/or a subzero condition;
unloading the one or more agents from the biological tissue sample; and
delivering the apoptosis inhibitor to the biological tissue sample for a second time period.

17. The method of claim 16, wherein a concentration of the apoptosis inhibitor is maintained or altered during the second time period.

18. The method of claim 16, wherein the one or more agents are selected from the group consisting of protectants, cryoprotectants, ice nucleators, ice modulators, oxygen carrier agents, oncotic agents, crystalloid components, colloidal components, growth factors, vasodilators, kinase inhibitors, Rho-kinase inhibitors, polyamines, integrated stress response inhibitors, reactive oxygen species scavengers, antioxidants, and combinations thereof.

19. A method for preserving a biological tissue sample, the method comprising:
flushing the biological tissue sample with a solution; and
perfusing the biological tissue sample with a perfusate by machine perfusion, wherein at least one of the solution or the perfusate comprises an apoptosis inhibitor.

20. The method of claim 19, wherein the solution and/or the perfusate comprises one or more agents selected from the group consisting of protectants, cryoprotectants, ice nucleators, ice modulators, oxygen carrier agents, oncotic agents, crystalloid components, colloidal components, growth factors, vasodilators, kinase inhibitors, Rho-kinase inhibitors, polyamines, integrated stress response inhibitors, reactive oxygen species scavengers, antioxidants, and combinations thereof.

21. A method for preserving a biological tissue sample, the method comprising:
storing the biological tissue sample in a solution, wherein the solution comprises an apoptosis inhibitor.

22. The method of claim 21, wherein the solution comprises one or more agents selected from the group consisting of protectants, cryoprotectants, ice nucleators, ice modulators, oxygen carrier agents, oncotic agents, crystalloid components, colloidal components, growth factors, vasodilators, kinase inhibitors, Rho-kinase inhibitors, polyamines, integrated stress response inhibitors, reactive oxygen species scavengers, antioxidants, and combinations thereof.

23. A method for preserving a biological tissue sample, the method comprising:
providing the biological tissue sample with:
an optional first perfusate or an optional first solution at a normothermic temperature;
an optional second perfusate or an optional second solution at a subnormothermic temperature;
a third perfusate or a third solution at a hypothermic temperature; and
an optional fourth perfusate or an optional fourth solution at a subzero temperature;
cooling the biological tissue sample to a hypothermic temperature or a subzero temperature;
warming the biological tissue sample to a recovery temperature; and
perfusing the biological tissue sample with a recovery solution, thereby providing a treated and recovered biological tissue sample.

24. The method of claim 23, wherein the first perfusate, the first solution, the second perfusate, the second solution, the third perfusate, the third solution, the fourth perfusate, the fourth solution, and/or the recovery solution comprises an apoptosis inhibitor.

25. The method of claims 23-24, wherein the first perfusate, the first solution, the second perfusate, the second solution, the third perfusate, the third solution, the fourth perfusate, the fourth solution, and/or the recovery solution comprises one or more agents selected from the group consisting of protectants, cryoprotectants, ice nucleators, ice modulators, oxygen carrier agents, oncotic agents, crystalloid components, colloidal components, growth factors, vasodilators, kinase inhibitors, Rho-kinase inhibitors, polyamines, integrated stress response inhibitors, reactive oxygen species scavengers, antioxidants, and combinations thereof.

26. A method of mitigating ischemia-reperfusion injury in a biological tissue sample, the method comprising:
perfusing the biological tissue sample with a perfusate comprising an apoptosis inhibitor for a first time period, thereby providing a treated biological tissue sample.

27. The method of claim 26, wherein said perfusing comprises delivering to an in vitro system further comprising the biological tissue sample.

28. The method of claim 26, wherein said perfusing comprises injecting the biological tissue sample.

29. The method of any one of claims 1-28, wherein the apoptosis inhibitor is a caspase inhibitor, a pan-caspase inhibitor, a broad spectrum caspase inhibitor, a selective caspase inhibitor, an irreversible caspase inhibitor, a reversible caspase inhibitor, a caspase 1 inhibitor, a caspase 2 inhibitor, a caspase 3 inhibitor, a caspase 4 inhibitor, a caspase 5 inhibitor, a caspase 6 inhibitor, a caspase 7 inhibitor, a caspase 8 inhibitor, a caspase 9 inhibitor, a caspase 10 inhibitor, a caspase 11 inhibitor, a caspase 12 inhibitor, or a caspase 14 inhibitor.

30. The method of claim 29, wherein the caspase inhibitor is emricasan (IDN-6556), VX-765 (belnacasan), Q-VD-OPh, VX-166, VX-740, GS-9540, Ac-DEVD-CHO, Ac-FLTD-CMK, Z-DEVD-FMK, INF 4E, Z-VAD-FMK, or a derivative thereof.

31. The method of claims 1-30, wherein the perfusate or the solution further comprises one or more agents selected from the group consisting of protectants, cryoprotectants, ice nucleators, ice modulators, oxygen carrier agents, oncotic agents, crystalloid components, colloidal components, growth factors, vasodilators, kinase inhibitors, Rho-kinase inhibitors, polyamines, integrated stress response inhibitors, reactive oxygen species scavengers, antioxidants, and combinations thereof.

32. The method of claims 1-30, wherein the perfusate or the solution further comprises one or more agents selected from the group consisting of a sugar, glycerol, ethylene glycol, polyethylene glycol (PEG), 3-O-methyl-D-glucose (3-OMG), 1,2-propanediol, trehalose, dimethyl sulfoxide (DMSO), trolox (6-hydroxy-2,5,7,8-tetramethylchroman-2-carboxylic acid), 3-O-methyl-D-glucopyranose, trehalose, and combinations thereof.

33. The method of claims 1-32, wherein the perfusate or the solution further comprises a Histidine-Tryptophan-Ketoglutarate (HTK) solution, a University of Wisconsin cold storage solution (UW-CSS), a University of Wisconsin machine perfusion solution (UW-MPS), an Institute-George-Lopez (IGL-1) solution, a Celsior solution, a Polysol solution, gelofusine, a EuroCollins (EC) solution, a hypertonic citrate/Marshalls (HOC) solution, a Steen solution, a Unisol solution, Dulbecco's Modified Eagle Medium (DMEM), Williams' Medium E (WE), reconstituted blood, a hemoglobin-based oxygen carrier, a synthetic hemoglobin substitute, a perfluorocarbon-based oxygen carrier (PFC), plasma, or a component thereof.

34. The method of claims 1-32, wherein the perfusate or the solution further comprises University of Wisconsin cold storage solution (UW-CSS), and wherein the University of Wisconsin cold storage solution comprises:
about 100 mM potassium lactobionate,
about 25 mM KH₂PO₄,
about 5 mM MgSO₄,
about 30 mM raffinose,
about 5 mM adenosine,
about 3 mM glutathione,
about 1 mM allopurinol, and
about 50 g/L hydroxyethyl starch.

35. The method of claims 1-34, wherein the biological tissue sample is a solid organ, a vascularized tissue sample, a tissue sample, a graft, or an allograft.

36. The method of claims 1-35, wherein the treated biological tissue sample or the treated and recovered biological tissue sample is viable, as determined by measuring one or more of a tissue adenosine triphosphate (ATP) to adenosine monophosphate (AMP) ratio, a tissue ATP to adenosine diphosphate (ADP) ratio, lactate levels, potassium concentration, cell-free DNA (cfDNA) levels, damage-associated molecular pattern (DAMP) levels, alanine aminotransferase (ALT) levels, aspartate aminotransferase (AST) levels, tissue specific injury marker levels, bile levels, pH levels, flow rates, pressure levels, cytokine levels, caspase levels, cytokeratin levels, terminal deoxynucleotidyl transferase dUTP nick end labeling (TUNEL), swelling and weight gain, percentage of edema, vascular resistance, oxygen consumption, lactic acid dehydrogenase (LDH) levels, flavin mononucleotide (FMN) levels, and/or ischemia.

37. A perfusate, a storage solution, or a recovery solution comprising, per 500 mL volume:
between 50 nM to 100 μM of an apoptosis inhibitor; and
one or more crystalloid or colloidal components.

38. A normothermic perfusate or a subnormothermic perfusate comprising, per 500 mL volume:
between 50 nM to 100 μM of an apoptosis inhibitor; and
a base medium selected from the group consisting of Dulbecco's Modified Eagle Medium (DMEM), Williams' Medium E (WE), gelofusine, a Steen solution, reconstituted blood, a hemoglobin-based oxygen carrier, a synthetic hemoglobin substitute, a perfluorocarbon-based oxygen carrier (PFC), and plasma.

39. A normothermic perfusate comprising, per 500 mL volume:
between 50 nM to 100 μM of an apoptosis inhibitor;
between 50 mL and 200 mL of an oxygen carrier agent;
between 1 g and 20 g of albumin; and
between 1,000 and 10,000 units (U) of heparin.

40. A subnormothermic perfusate comprising, per 500 mL volume:
between 50 nM to 100 μM of an apoptosis inhibitor;
between 1 g and 20 g of albumin;
between 0 g and 50 g of poly(ethylene glycol); and
between 2 g and 30 g of 3-O-methyl D-glucose.

41. A hypothermic perfusate comprising, per 500 mL volume:
between 50 nM to 100 μM of an apoptosis inhibitor; and
a base medium selected from the group consisting of a Histidine-Tryptophan-Ketoglutarate (HTK) solution, a University of Wisconsin cold storage solution (UW-CSS), a University of Wisconsin machine perfusion solution (UW-MPS), and an Institute-George-Lopez (IGL-1) solution.

42. A hypothermic perfusate comprising, per 500 mL volume:
between 50 nM to 100 μM of an apoptosis inhibitor;
between 1 g and 20 g of albumin;
between 1 g and 50 g of poly(ethylene glycol);
between 1 g and 80 g of hydroxyethyl starch;
between 2 g and 30 g of 3-O-methyl D-glucose;
between 2 g and 30 g of raffinose; and
between 5 mL and 120 mL of a cryoprotectant.

43. A subzero perfusate comprising, per 500 mL volume:
between 50 nM to 100 μM of an apoptosis inhibitor;
between 5 μL and 150 μL of insulin;
between 0.1 g and 2 g of glutathione;
between 1 g and 50 g of poly(ethylene glycol);
between 1 g and 80 g of hydroxyethyl starch;
between 2 g and 30 g of 3-O-methyl D-glucose;
between 2 g and 30 g of raffinose;
between 2 g and 30 g of trehalose;
between 10 mL and 120 mL of a cryoprotectant; and
between 0.1 g and 2 g of an ice nucleator/modulator.

44. A recovery solution comprising, per 500 mL volume:
between 50 nM to 100 μM of an apoptosis inhibitor;
between 0.1 g and 5 g of glutathione;
between 1 g and 20 g of albumin; and
between 0 g and 50 g of poly(ethylene glycol).

45. The perfusate or solution of claims 37-44, wherein the apoptosis inhibitor is a caspase inhibitor, a pan-caspase inhibitor, a broad spectrum caspase inhibitor, a selective caspase inhibitor, an irreversible caspase inhibitor, a reversible caspase inhibitor, a caspase 1 inhibitor, a caspase 2 inhibitor, a caspase 3 inhibitor, a caspase 4 inhibitor, a caspase 5 inhibitor, a caspase 6 inhibitor, a caspase 7 inhibitor, a caspase 8 inhibitor, a caspase 9 inhibitor, a caspase 10 inhibitor, a caspase 11 inhibitor, a caspase 12 inhibitor, or a caspase 14 inhibitor.

46. The perfusate or solution of claims 37-45, wherein the apoptosis inhibitor is a caspase inhibitor selected from the group consisting of emricasan (IDN-6556), VX-765 (belnacasan), Q-VD-OPh, VX-166, VX-740, GS-9540, Ac-DEVD-CHO, Ac-FLTD-CMK, Z-DEVD-FMK, INF 4E, Z-VAD-FMK, and a derivative thereof.

47. The perfusate or solution of claims 37-46, further comprising one or more BID inhibitors, BAD inhibitors, BAX inhibitors, BAK inhibitors, cytochrome C inhibitors, cathepsin inhibitors, granzyme B inhibitors, pyroptosis inhibitors, necroptosis inhibitors, kinase inhibitors, Rho-kinase inhibitors, polyamines, integrated stress response inhibitors, reactive oxygen species scavengers, antioxidants, and/or combinations thereof.
